(19) United States
(12) Patent Application Publication
(10) Pub. No.: US 2026/0173002 A1
(43) Pub. Date: Jun. 18, 2026

(54) METHOD AND DEVICE FOR TRANSMISSION BASED ON MULTIPLE TRANSMISSION AND RECEPTION POINTS IN COMMUNICATION SYSTEM

(71) Applicant: ELECTRONICS AND TELECOMMUNICATIONS RESEARCH INSTITUTE, Daejeon (KR)

(72) Inventors: Kap Seok CHANG, Daejeon (KR); Yong Sun KIM, Daejeon (KR); Sung Hyun MOON, Daejeon (KR); Young Jo KO, Daejeon (KR); Cheul Soon KIM, Daejeon (KR); Jung Hoon LEE, Daejeon (KR)

(73) Assignee: ELECTRONICS AND TELECOMMUNICATIONS RESEARCH INSTITUTE, Daejeon (KR)

(21) Appl. No.: 19/124,285

(22) PCT Filed: Oct. 25, 2023
(86) PCT No.: PCT/KR2023/016641

§ 371 Date: Apr. 24, 2025

(30) Foreign Application Priority Data
Oct. 25, 2022 (KR) 10-2022-0138266
Mar. 2, 2023 (KR) 10-2023-0028107
Mar. 10, 2023 (KR) 10-2023-0032074
Oct. 24, 2023 (KR) 10-2023-0143105

(51) Int. Cl. H04W 56/00; H04W 74/0833

(52) U.S. Cl. CPC H04W 56/0045; H04W 74/0833

(57) ABSTRACT

A method of a terminal may comprise: establishing a first communication link by receiving a first SSB included in a first SSB group allocation to a first TRP from the first TRP; assigning a first tag to the first communication link; establishing a second communication link by receiving a second SSB included in a second SSB group allocated to a second TRP from the second TRP; and assigning a second tag to the second communication link according to a mapping relationship between the second SSB group and the second TRP.

### TECHNICAL FIELD

The present disclosure relates to a transmission technique based on multiple transmission and reception points in a communication system, and more particularly, to a transmission technique based on multiple transmission and receptions points in a communication system, which allows a terminal to transmit signals using different transmission times for the multiple transmission and receptions points.

### BACKGROUND ART

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eM BB), Ultra-Reliable and Low-Latency Communication (URLLC), and massive Machine Type Communication (mMTC).

Meanwhile, in a communication system, a plurality of transmission and reception points (TRPs) and a user equipment (UE) may transmit and receive signals either simultaneously or sequentially. In this case, the plurality of TRPs may be within the same cell, and may share the same configuration and resources. Alternatively, the plurality of TRPs may be within different cells. In such scenarios, the UE may manage a single timing advance (TA). In this time, propagation delays between the TRPs and the UE may vary. Consequently, signals transmitted and received between the TRPs and the UE may experience inter-symbol interference (ISI) and inter-carrier interference (ICI).

### DISCLOSURE

### Technical Problem

The present disclosure for resolving the above-described problems is directed to providing a transmission method and apparatus based on multiple TRPs which allow a terminal to transmit signals using different transmission times for the multiple TRPs.

### Technical Solution

A transmission method based on multiple TRPs in a communication system, according to a first exemplary embodiment of the present disclosure for achieving the above-described objective, may comprise: receiving, from a first transmission and reception point (TRP), a first synchronization signal block (SSB) included in a first SSB group allocated to the first TRP; receiving, from the first TRP and based on the first SSB, system information including a mapping relationship between the first SSB group and the first TRP and a mapping relationship between a second SSB group and a second TRP; establishing a first communication link between the first TRP and the terminal based on the first SSB; assigning a first tag identifier for communication link identification to the first communication link according to the mapping relationship between the first SSB group and the first TRP; receiving, from the second TRP, a second SSB included in the second SSB group allocated to the second TRP; establishing a second communication link between the second TRP and the terminal based on the second SSB; and assigning a second tag identifier to the second communication link according to the mapping relationship between the second SSB group and the second TRP.

The establishing of the first communication link between the first TRP and the terminal based on the first SSB may comprise: obtaining information on a first random access occasion indicated by a first system information block (SIB) acquired based on the first SSB; performing a first random access procedure with the first TRP in the first random access occasion; and establishing the first communication link between the first TRP and the terminal according to the first random access procedure.

The method may further comprise: receiving a measurement request from the first TRP; in response to the measurement request, transmitting a measurement report to the first TRP, the measurement report including information on the second SSB and information on a time difference between a reception time of the first SSB and a reception time of the second SSB; and receiving an establishment instruction for the second communication link from the first TRP based on the time difference, wherein the second communication link is established based on the second SSB and the establishment instruction.

The received establishment instruction may instruct link establishment without performing a random access (RA) procedure when the time difference is less than a threshold, and the second communication link may be established between the second TRP and the terminal without performing the RA procedure.

The received establishment instruction may instruct a random access channel (RACH)-based link establishment when the time difference is greater than or equal to a threshold, and the establishing of the second communication link between the second TRP and the terminal based on the second SSB may comprise: obtaining information on a second random access occasion indicated by a second SIB acquired based on the second SSB; performing a second random access procedure with the second TRP in the second random access occasion; and establishing the second communication link between the second TRP and the terminal according to the second random access procedure.

The first TRP may be included in a serving cell, and the second TRP may be included in a non-serving cell.

The first tag identifier and the second tag identifier may be same when a time difference between a reception time of the first SSB and a reception time of the second SSB is less than a threshold, and the first tag identifier and the second tag identifier may be different when the time difference between the reception time of the first SSB and the reception time of the second SSB is equal to or greater than a threshold.

The first SSB group and the second SSB group may be grouped based on SSB indexes or resource periods of a frame.

The method may further comprise: receiving, from the first TRP, a first downlink transmission configuration indication (TCI) associated with the first tag identifier and first downlink scheduling information; receiving downlink data from the first TRP based on the first downlink TCI and the first downlink scheduling information; receiving, from the second TRP, a second downlink TCI associated with the second tag identifier and second downlink scheduling information; and receiving downlink data from the second TRP based on the second downlink TCI and the second downlink scheduling information.

The method may further comprise: receiving, from the first TRP, a first uplink TCI associated with the first tag identifier and first uplink scheduling information; transmitting uplink data to the first TRP based on the first uplink TCI and the first uplink scheduling information;
receiving, from the second TRP, a second uplink TCI associated with the second tag identifier and second uplink scheduling information; and transmitting uplink data to the second TRP based on the second uplink TCI and the second uplink scheduling information.

A transmission time of transmitting uplink data to the first TRP and a transmission time of transmitting uplink data to the second TRP may be same when a time difference between a reception time of the first SSB and a reception time of the second SSB is less than a threshold.

A difference between the transmission time of transmitting uplink data to the first TRP and the transmission time of transmitting uplink data to the second TRP may include the time difference when the time difference between the reception time of the first SSB and the reception time of the second SSB is greater than or equal to a threshold.

A transmission method based on multiple TRPs in a communication system, according to a second exemplary embodiment of the present disclosure for achieving the above-described objective, may comprise: receiving, from a first transmission and reception point (TRP), a first synchronization signal block (SSB) included in a first SSB group allocated to the first TRP; receiving, from a second TRP, a second SSB included in a second SSB group allocated to the second TRP; starting a first random access procedure with the first TRP based on the first SSB; transmitting, to the first TRP and in the first random access procedure, information on the second SSB and information on a time difference between a reception time of the first SSB and a reception time of the second SSB; establishing a first communication link between the first TRP and the terminal through the first random access procedure; receiving, from the first TRP, an establishment instruction for a second communication link with the second TRP based on the time difference through the first random access procedure; and establishing the second communication link with the second TRP according to the received establishment instruction.

The method may further comprise: assigning a first tag identifier for communication link identification to the first communication link according to a mapping relationship between the first SSB group and the first TRP; and assigning a second tag identifier to the second communication link according to a mapping relationship between the second SSB group and the second TRP.

The received establishment instruction may instruct link establishment without performing a random access (RA) procedure when the time difference is less than a threshold, and the second communication link may be established between the second TRP and the terminal without performing the RA procedure.

The received establishment instruction may instruct a random access channel (RACH)-based link establishment when the time difference is greater than or equal to a threshold, and the establishing of the second communication link with the second TRP according to the received establishment instruction may comprise: obtaining information on a second random access occasion indicated by a second system information block (SIB) acquired based on the second SSB; performing a second random access procedure with the second TRP in the second random access occasion; and establishing the second communication link between the second TRP and the terminal according to the second random access procedure.

The method may further comprise: receiving a first uplink TCI and first uplink scheduling information from the first TRP; transmitting uplink data to the first TRP based on the first uplink TCI and the first uplink scheduling information; receiving a second uplink TCI and second uplink scheduling information from the second TRP; and transmitting uplink data to the second TRP based on the second uplink TCI and the second uplink scheduling information, wherein a transmission time of transmitting uplink data to the first TRP and a transmission time of transmitting uplink data to the second TRP may be same when a time difference between a reception time of the first SSB and a reception time of the second SSB is less than a threshold, and a difference between the transmission time of transmitting uplink data to the first TRP and the transmission time of transmitting uplink data to the second TRP may include the time difference when the time difference between the reception time of the first SSB and the reception time of the second SSB is greater than or equal to a threshold.

A transmission apparatus based on multiple TRPs in a communication system, as a terminal, according to a third exemplary embodiment of the present disclosure for achieving the above-described objective, may comprise a processor, and the processor may cause the terminal to perform: receiving, from a first transmission and reception point (TRP), a first synchronization signal block (SSB) included in a first SSB group allocated to the first TRP; receiving, from the first TRP and based on the first SSB, system information including a mapping relationship between the first SSB group and the first TRP and a mapping relationship between a second SSB group and a second TRP; establishing a first communication link between the first TRP and the terminal based on the first SSB; assigning a first tag identifier for communication link identification to the first communication link according to the mapping relationship between the first SSB group and the first TRP; receiving, from the second TRP, a second SSB included in the second SSB group allocated to the second TRP; establishing a second communication link between the second TRP and the terminal based on the second SSB; and assigning a second tag identifier to the second communication link according to the mapping relationship between the second SSB group and the second TRP.

The processor may further cause the terminal to perform: receiving a measurement request from the first TRP; in response to the measurement request, transmitting a measurement report to the first TRP, the measurement report including information on the second SSB and information on a time difference between a reception time of the first SSB and a reception time of the second SSB; and receiving an establishment instruction for the second communication link from the first TRP based on the time difference, wherein in the establishing of the second communication link between the second TRP and the terminal based on the second SSB, the processor may further cause the terminal to perform: establishing the second communication link based on the establishment instruction.

The received establishment instruction may instruct a random access channel (RACH)-based link establishment when the time difference is greater than or equal to a threshold, and in the establishing of the second communication link based on the received establishment instruction, the processor may further cause the terminal to perform: obtaining information on a second random access occasion indicated by a second SIB acquired based on the second SSB; performing a second random access procedure with the second TRP in the second random access occasion; and establishing the second communication link between the second TRP and the terminal according to the second random access procedure.

### Advantageous Effects

According to the present disclosure, a terminal can configure different transmission times for a plurality of transmission and reception points. In particular, according to the present disclosure, the terminal can configure transmission times by reflecting propagation delays for the respective transmission and reception point. As a result, according to the present disclosure, signals transmitted and received between the terminal and the multiple transmission and reception points can be less affected by inter-symbol interference (ISI) and inter-carrier interference (ICI).

### DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3A is a conceptual diagram illustrating a first exemplary embodiment of a communication system having a plurality of transmission and reception points.

FIG. 3B is a conceptual diagram illustrating a second exemplary embodiment of a communication system having a plurality of transmission and reception points.

FIG. 4A is a conceptual diagram illustrating a first exemplary embodiment of propagation delays in a communication system having a plurality of transmission and reception points.

FIG. 4B is a conceptual diagram illustrating a second exemplary embodiment of propagation delays in a communication system having a plurality of transmission and reception points.

FIG. 5 is a sequence chart illustrating a first exemplary embodiment of an initial access stage.

FIG. 6 is a sequence chart illustrating a first exemplary embodiment of a random access setup procedure.

FIG. 7 is a sequence chart illustrating a second exemplary embodiment of a random access setup procedure.

FIG. 8 is a sequence chart illustrating a third exemplary embodiment of a random access setup procedure.

FIG. 9 is a conceptual diagram illustrating a first exemplary embodiment of a method for grouping synchronization signal blocks.

FIG. 10 is a conceptual diagram illustrating a second exemplary embodiment of a method for grouping synchronization signal blocks.

FIG. 11 is a conceptual diagram illustrating a third exemplary embodiment of a method for grouping synchronization signal blocks.

FIG. 12 is a conceptual diagram illustrating a fourth exemplary embodiment of a method for grouping synchronization signal blocks.

FIG. 13 is a conceptual diagram illustrating a first exemplary embodiment of a tag ID configuration method.

FIG. 14 is a conceptual diagram illustrating a second exemplary embodiment of a tag ID configuration method.

FIG. 15 is a sequence chart illustrating a first exemplary embodiment of a TCI triggering method.

FIG. 16 is a sequence chart illustrating a first exemplary embodiment of a method for recognizing a TCI state.

FIG. 17 is a conceptual diagram illustrating a first exemplary embodiment of a U E-specific TCI state table.

FIG. 18 is a sequence chart illustrating a second exemplary embodiment of a method for recognizing a TCI state.

FIG. 19 is a conceptual diagram illustrating a second exemplary embodiment of a UE-specific TCI state table.

FIG. 20 is a sequence chart illustrating a first exemplary embodiment of a link configuration method in a multi-TRP environment.

FIG. 21 is a sequence chart illustrating a second exemplary embodiment of a link configuration method in a multi-TRP environment.

FIG. 22 is a conceptual diagram illustrating a third exemplary embodiment of a tag ID configuration method.

FIG. 23 is a sequence chart illustrating a third exemplary embodiment of a link configuration method in a multi-TRP environment.

FIG. 24 is a sequence chart illustrating a fourth exemplary embodiment of a link configuration method in a multi-TRP environment.

FIG. 25 is a conceptual diagram illustrating a fifth exemplary embodiment of a method for grouping synchronization signal blocks.

FIG. 26 is a conceptual diagram illustrating a sixth exemplary embodiment of a method for grouping synchronization signal blocks.

FIG. 27 is a conceptual diagram illustrating a fourth exemplary embodiment of a tag ID configuration method.

FIG. 28 is a conceptual diagram illustrating a fifth exemplary embodiment of a tag ID configuration method.

FIG. 29 is a conceptual diagram illustrating a sixth exemplary embodiment of a tag ID configuration method.

FIG. 30 is a sequence chart illustrating a fifth exemplary embodiment of a link configuration method in a multi-TRP environment.

FIG. 31 is a conceptual diagram illustrating a seventh exemplary embodiment of a tag ID configuration method.

FIG. 32 is a conceptual diagram illustrating an eighth exemplary embodiment of a tag ID configuration method.

FIG. 33 is a sequence chart illustrating a sixth exemplary embodiment of a link configuration method in a multi-TRP environment.

FIG. 34 is a sequence chart illustrating a seventh exemplary embodiment of a link configuration method in a multi-TRP environment.

FIG. 35 is a conceptual diagram illustrating a ninth exemplary embodiment of a tag ID configuration method.

FIG. 36 is a conceptual diagram illustrating a tenth exemplary embodiment of a tag ID configuration method.

FIG. 37 is a sequence chart illustrating an eighth exemplary embodiment of a link configuration method in a multi-TRP environment.

FIG. 38 is a sequence chart illustrating a ninth exemplary embodiment of a link configuration method in a multi-TRP environment.

FIG. 39 is a sequence chart illustrating a first exemplary embodiment of a transmission method in a multi-TRP environment.

FIG. 40 is a sequence chart illustrating a second exemplary embodiment of a transmission method in a multi-TRP environment.

FIG. 41 is a sequence chart illustrating a third exemplary embodiment of a transmission method in a multi-TRP environment.

FIG. 42 is a sequence chart illustrating a fourth exemplary embodiment of a transmission method in a multi-TRP environment.

FIG. 43 is a sequence chart illustrating a fifth exemplary embodiment of a transmission method in a multi-TRP environment.

FIG. 44 is a sequence chart illustrating a sixth exemplary embodiment of a transmission method in a multi-TRP environment.

FIG. 45 is a sequence chart illustrating a seventh exemplary embodiment of a transmission method in a multi-TRP environment.

FIG. 46 is a sequence chart illustrating an eighth exemplary embodiment of a transmission method in a multi-TRP environment.

FIG. 47 is a conceptual diagram illustrating a first exemplary embodiment of a method for controlling downlink timings of multiple transmission and reception points in a communication system.

FIG. 48 is a conceptual diagram illustrating a second exemplary embodiment of a method for controlling downlink timings of multiple transmission and reception points in a communication system.

FIG. 49 is a conceptual diagram illustrating a first exemplary embodiment of a method for controlling uplink timings of multiple transmission and reception points in a communication system.

FIG. 50 is a conceptual diagram illustrating a second exemplary embodiment of a method for controlling uplink timings of multiple transmission and reception points in a communication system.

FIG. 51 is a sequence chart illustrating a ninth exemplary embodiment of a transmission method in a multi-TRP environment.

FIG. 52 is a sequence chart illustrating a tenth exemplary embodiment of a transmission method in a multi-TRP environment.

FIG. 53 is a sequence chart illustrating an eleventh exemplary embodiment of a transmission method in a multi-TRP environment.

FIG. 54 is a sequence chart illustrating a twelfth exemplary embodiment of a transmission method in a multi-TRP environment.

FIG. 55 is a sequence chart illustrating a thirteenth exemplary embodiment of a transmission method in a multi-TRP environment.

FIG. 56 is a sequence chart illustrating a fourteenth exemplary embodiment of a transmission method in a multi-TRP environment.

FIG. 57 is a sequence chart illustrating a fifteenth exemplary embodiment of a transmission method in a multi-TRP environment.

FIG. 58 is a sequence chart illustrating a sixteenth exemplary embodiment of a transmission method in a multi-TRP environment.

FIG. 59 is a sequence chart illustrating a seventeenth exemplary embodiment of a transmission method in a multi-TRP environment.

FIG. 60 is a sequence chart illustrating an eighteenth exemplary embodiment of a transmission method in a multi-TRP environment.

FIG. 61 is a sequence chart illustrating a nineteenth exemplary embodiment of a transmission method in a multi-TRP environment.

FIG. 62 is a sequence chart illustrating a twentieth exemplary embodiment of a transmission method in a multi-TRP environment.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

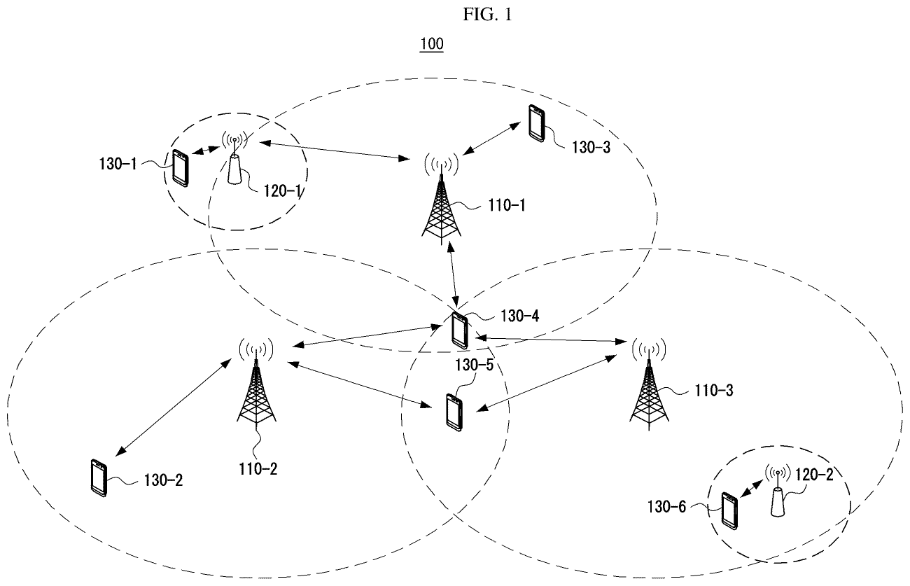

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDM A) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDM A) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

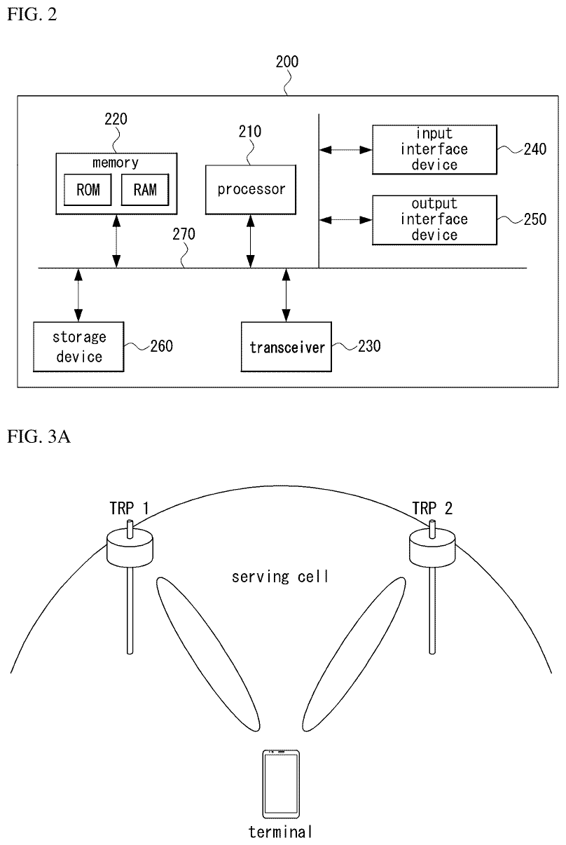

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g. LTE, LTE-Advanced (LTE-A), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDM A-based uplink (UL) transmission. In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, in a communication system, a user equipment (UE) (i.e. terminal) and a plurality of transmission and reception points (TRPs) may transmit and receive signals simultaneously or sequentially.

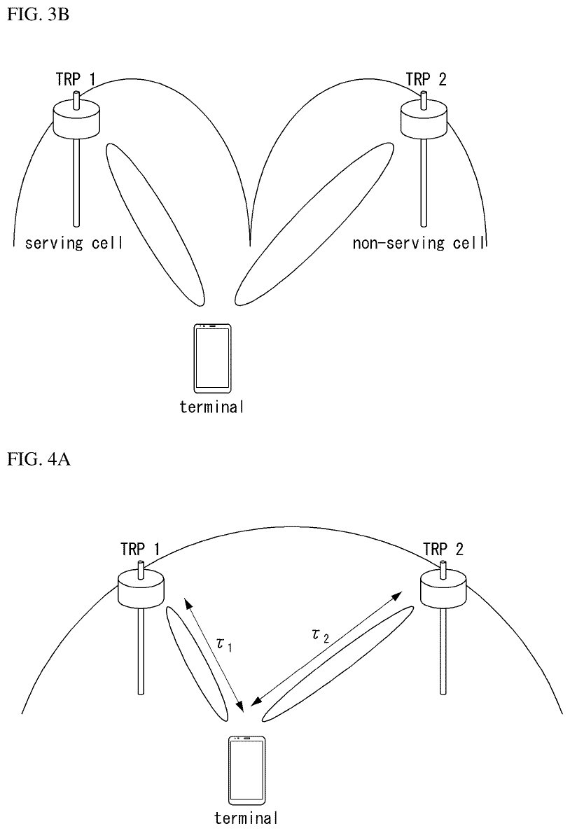

FIG. 3A is a conceptual diagram illustrating a first exemplary embodiment of a communication system having a plurality of transmission and reception points.

Referring to FIG. 3A, a terminal may exist within a coverage of a serving cell having a physical cell identity (PCI). There may be two TRPs (i.e. TRP 1, TRP 2) having the same PCI within the serving cell. This communication system may be referred to as an intra-cell multi-TRP (or M-TRP or MTRP) communication system. Here, the serving cell is equipped with two TRPs but may include more TRPs.

FIG. 3B is a conceptual diagram illustrating a second exemplary embodiment of a communication system having a plurality of transmission and reception points.

Referring to FIG. 3B, a terminal may exist within a coverage of a serving cell having a PCI. There may be more than one TRP (i.e. TRP 1) having the same PCI within the serving cell. Additionally, a TRP (i.e. TRP 2) having a PCI different from that of the serving cell may exist in an area adjacent to the serving cell. This communication system may be referred to as an inter-cell M-TRP communication system. Here, the serving cell is equipped with two TRPs but may include more TRPs. Such intra-cell M-TRP-based or inter-cell M-TRP-based communication system may support downlink and uplink transmission. Here, ‘downlink’ may be a link from the TRP to the terminal, and ‘uplink’ may be a link from the terminal to the TRP.

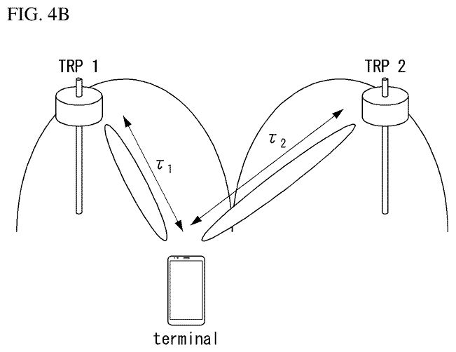

FIG. 4A is a conceptual diagram illustrating a first exemplary embodiment of propagation delays in a communication system having a plurality of transmission and reception points.

Referring to FIG. 4A, two TRPs (i.e. TRP 1 and TRP 2) may be within the same serving cell and may share the same configuration and resources. In other words, one serving cell may manage one timing advance (timing advance/adjustment/alignment, TA). The two TRPs within the serving cell may share one TA. In the intra-cell M-TRP-based communication system as described above, the terminal may perform downlink and uplink transmission by adjusting a reception synchronization point and a transmission synchronization point according to one TA managed by the serving cell, regardless of the number of TRPs. Here, the reception synchronization point may refer to a reception time point, and the transmission synchronization point may refer to a transmission time point.

As described above, the terminal may manage one TA. In this case, TRP 1 and TRP 2 located in one serving cell may be far apart. In this situation, the terminal close to TRP 1 may perform downlink and uplink transmission by adjusting a reception synchronization point and a transmission synchronization point according to a TA for TRP 1. In addition, the terminal may perform downlink and uplink transmission for TRP 2 by equally applying the reception synchronization point and transmission synchronization point according to the TA for TRP 1. In this case, a difference between a propagation delay t1 between TRP 1 and the terminal and a propagation delay τ2 between TRP 2 and the terminal may be larger than αTCP, which is proportional to a cyclic prefix (CP) length TCP. Accordingly, when downlink transmission is performed, a signal received from TRP 2 at the terminal may experience inter-symbol interference (ISI) and inter-carrier interference (ICI). Conversely, when uplink transmission is performed, a signal received from the terminal at TRP 2 may experience ISI and ICI.

FIG. 4B is a conceptual diagram illustrating a second exemplary embodiment of propagation delays in a communication system having a plurality of transmission and reception points.

Referring to FIG. 4B, one TRP (i.e. TRP 1) may be located in one serving cell. Further, another TRP (i.e. TRP 2) may be in a non-serving cell having a PCI different from that of the serving cell. The terminal may manage one TA for the TRP of the serving cell and may not manage a TA for the TRP of the non-serving cell. However, the terminal may use the TA for the TRP of the serving cell for the TRP of the non-serving cell to perform downlink and uplink transmission. As described above, in the inter-cell M-TRP-based communication system, the terminal may perform downlink and uplink transmission by adjusting a reception synchronization point and a transmission synchronization point according to one TA managed by the serving cell, regardless of the number of TRPs.

As described above, the terminal may manage one TA. TRP 1 connected to the serving cell and TRP 2 connected to the non-serving cell may be far apart. The terminal close to TRP 1 may use a TA for TRP 1 for communication with TRP 2 of the non-serving cell. In this case, a difference between a propagation delay t1 between TRP 1 and the terminal and a propagation delay t2 between TRP 2 and the terminal may be larger than αTCP, which is proportional to a CP length TCP. Accordingly, when downlink transmission is performed, a signal received from TRP 2 at the terminal may experience ISI and ICI. Conversely, when uplink transmission is performed, a signal received from the terminal at TRP 2 may experience ISI and ICI.

Therefore, each of the intra-cell M-TRP-based communication system and the inter-cell M-TRP-based communication system may need a procedure for identifying the propagation delays, TAs, or information related thereto between the terminal and different TRPs, thereby enabling access and connection establishment between the terminal and the TRPs. In addition, each of the intra-cell M-TRP-based communication system and the inter-cell M-TRP-based communication system may need a downlink transmission method that allows the terminal to synchronously receive signals transmitted from the TRPs. In addition, each of the intra-cell M-TRP-based communication system and the inter-cell M-TRP-based communication system may need an uplink transmission method that allows the TRPs to synchronously receive simultaneous or sequential signals from the terminal.

In the present disclosure, a wireless device may refer to a mobile station (MS). A TRP may refer to a device that transmits a signal to or receives a signal from the MS. A base station (BS) may refer to a device that manages TRP(s). An area managed by the BS may be referred to a cell. The MS may be referred to as a UE or terminal.

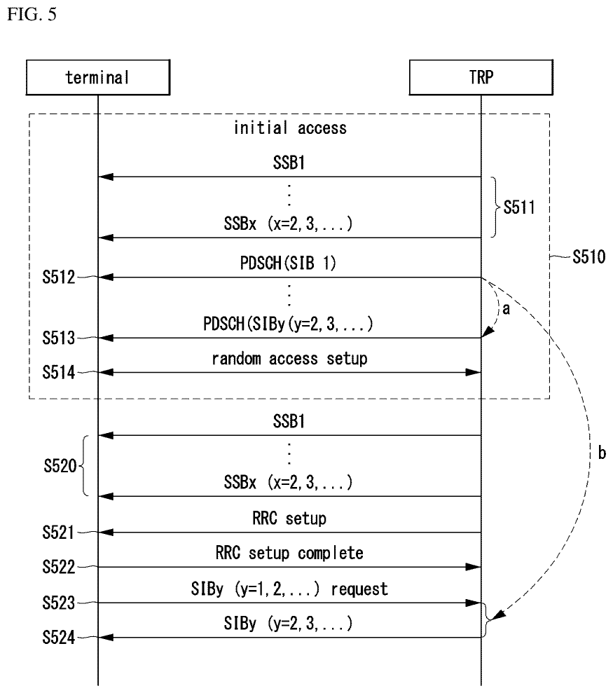

FIG. 5 is a sequence chart illustrating a first exemplary embodiment of an initial access stage.

Referring to FIG. 5, a terminal may be turned on and initially access TRP (S510). To this end, TRP may transmit beamformed synchronization signal blocks (SSBs) in multiple directions (S511). Accordingly, the terminal may receive SSBs. In addition, the terminal may perform synchronization of a downlink from TRP toward the terminal based on one SSB among the received SSBs. Here, TRP may transmit SSBs periodically or aperiodically for initial synchronization and maintenance of beamforming-based downlink. After performing such synchronization, the terminal may obtain a master information block (MIB) from the SSB. The MIB may be transmitted to the terminal on a physical broadcast channel (PBCH). The MIB may be first system information obtained by the terminal.

Then, TRP may transmit a system information block 1 (SIB1) to the terminal using a time resource and frequency resource indicated by the MIB (S512). The terminal may obtain the SIB1 located in the time resource and frequency resource indicated by the MIB. In this case, TRP may transmit the SIB1 to the terminal on a PDSCH. The SIB1 may be second system information obtained by the terminal. TRP may transmit SIBs other than the SIB1 (i.e. SIBy, y is a positive integer of 2 or more) to the terminal in the initial access stage (S513). In this case, TRP may transmit control information to the terminal through the SIB1 to inform that SIBs following the SIB1 are delivered in succession as indicated by ‘a’. Thereafter, the terminal and TRP may proceed with a random access setup procedure (S514).

On the other hand, TRP may not deliver multiple SIBs other than the SIB1 in the initial access stage in order to speed up the access procedure. In this case, the TRP may transmit control information through the SIB1 to inform that TRP does not deliver multiple SIBs other than the SIB1. Then, TRP may retransmit the beamformed SSBs in multiple directions (S520). Accordingly, the terminal may receive SSBs. Then, TRP may transmit a radio resource control (RRC) setup message to the terminal (S521). Then, the terminal may establish an RRC connection by receiving the RRC setup message from TRP. Thereafter, the terminal may transmit an RRC setup complete message to TRP (S522). Accordingly, TRP may receive the RRC setup complete message from the terminal.

Meanwhile, when the terminal completes the RRC setup and is in a system connected state, the terminal may transmit an SIB request message to TRP, requesting all or part of SIBy from TRP (S523), as indicated by ‘b’. Then, TRP may receive the SIB request message from the terminal. TRP may transmit SIBs to the terminal (S524). Accordingly, the terminal may receive the SIBs from TRP. Alternatively, the terminal may complete the RRC setup by requesting all or part of SIBy from TRP to obtain the requested SIBs during the process of completing RRC setup as indicated by ‘b’. For convenience of description, TRP may be assumed to transmit all SIBs including the SIB1 in the initial access stage as indicated by ‘a’. However, the present disclosure may not be limited thereto.

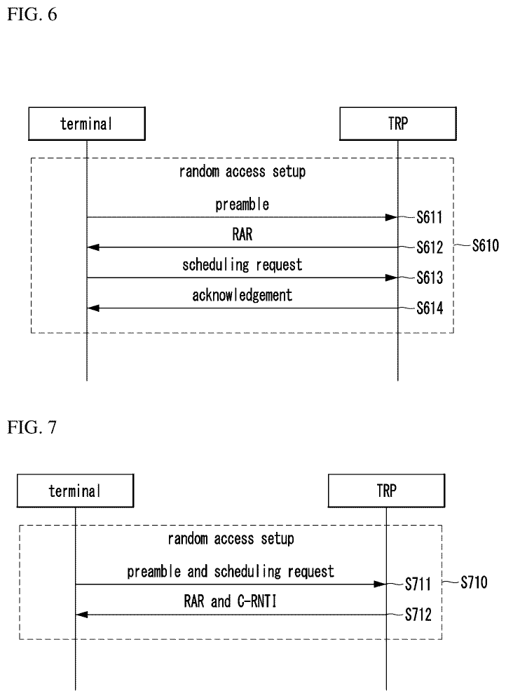

FIG. 6 is a sequence chart illustrating a first exemplary embodiment of a random access setup procedure.

Referring to FIG. 6, after completing downlink synchronization and system information acquisition, the terminal may perform a 4-step contention based random access (CBRA)-based random access setup procedure for uplink synchronization (S610). First, in the first step, the terminal may randomly select one preamble among all preambles provided by TRP. Then, the terminal may transmit the selected preamble to TRP on a physical random access channel (PRA CH) (S611). Then, TRP may receive the preamble from the terminal on the PRACH. In this case, a beam direction may follow an uplink direction, which is reciprocal to a beam direction when receiving a signal in downlink. A resource for transmitting the preamble from the terminal to TRP may be based on information on association between SSBs and RACH occasions, which is obtained in advance. TRP may estimate the terminal's propagation delay based on the preamble.

Then, in the second step, TRP may determine whether the preamble is present in a signal received through the PRACH. The preamble may be randomly selected and transmitted by the terminal. Therefore, TRP cannot specify which terminal transmitted the preamble based on whether or not the preamble is detected. Therefore, TRP cannot determine how many terminals used the detected preamble. Accordingly, TRP may transmit a random access response (RAR) based on an index of the detected preamble to the terminal on a PDSCH (S612). Then, the terminal may receive the RAR from TRP. In this case, the RAR may include the preamble index, a TA value, uplink grant information, and a temporary cell radio network temporary identifier (C-RNTI).

Then, in the third step, the terminal may use an uplink radio resource indicated by the uplink grant information included in the RAR to transmit a scheduling request message (or connection request message) and a terminal-specific identifier to TRP on a physical uplink shared channel (PUSCH) by applying the temporary C-RNTI (S613). Then, TRP may receive the connection request message and the terminal-specific ID from the terminal. Here, there may be more than one terminal that transmitted the same preamble in step S611. As a result, preamble collisions may occur. In this case, all terminals that transmitted the same preamble may refer to the same RAR, and transmit messages using the same radio resource. This may cause a collision.

In other words, the terminals that transmitted the same preamble in the first step may eventually experience resource collisions when transmitting the third-step messages. Therefore, each terminal may start a contention resolution timer when transmitting the third-step message as a part of a procedure to check whether the transmitted third-step message collides and whether decoding of the message is successful.

Finally, in the fourth step, TRP may decode the received third-step message. Then, TRP may transmit an acknowledgment message for the successfully decoded message to the terminal on a PDSCH (S614). Then, the terminal may receive the acknowledgement message from TRP. The terminal may receive the acknowledgment message before expiration of the contention resolution timer started in the third step. In this case, the terminal may consider that random access has been successfully performed and may regard the temporary C-RNTI as its own C-RNTI in order to continue using it in the system connected state. On the other hand, the terminal may not receive any acknowledgment message before expiration of the contention resolution timer. In this case, the terminal may determine that decoding has failed due to a collision occurring in the message transmitted in the third step. Accordingly, the terminal may perform a backoff procedure. Thereafter, the terminal may reattempt the random access procedure. TRP may define the maximum number of random access attempts to prevent random access channel congestion. Accordingly, the terminal ay not succeed in random access during the maximum number of attempts. In this case, the terminal may give up random access and perform downlink synchronization again.

FIG. 7 is a sequence chart illustrating a second exemplary embodiment of a random access setup procedure.

Referring to FIG. 7, the terminal that has completed downlink synchronization and system information acquisition may perform a 2-step CBRA-based random access setup procedure for uplink synchronization (S710). To this end, in the first step, the terminal may randomly select one preamble from all preambles. Then, the terminal may transmit one selected preamble to TRP on a PRACH. Additionally, at the same time, the terminal may transmit a scheduling request (i.e. connection request) to TRP through a pre-allocated uplink radio resource (i.e. uplink shared channel) (S711). Then, TRP may receive the message including the preamble and the scheduling request from the terminal.

Then, in the second step, TRP may determine whether the preamble is detected. Additionally, TRP may determine whether the message has been successfully decoded. The TRP may transmit different types of messages to the terminal depending on a result of the determination. This may cause a subsequent procedure to be different.

Describing in further detail, if TRP does not detect the preamble, TRP may not perform any operation. In other words, TRP may not even check whether a message is received through an uplink radio resource associated with a preamble. As a result, TRP may not make any response in the case where a preamble is not detected. Accordingly, the terminal may reattempt random access because it has not received any message from TRP. This case may be referred to as ‘Case 1’.

On the other hand, TRP may detect the preamble normally and successfully decode the message from an uplink radio resource associated with the preamble. In this case, TRP may transmit a message including an RAR (i.e. successful RAR) and a C-RNTI to the terminal on a PDSCH (S712). Accordingly, the terminal may receive the message including the successful RAR and C-RNTI from TRP. The message may serve as acknowledgment. Accordingly, the terminal may successfully terminate the random access. This case may be referred to as ‘Case 2’. Meanwhile, although TRP detects the preamble normally, TRP may not be able to successfully decode the message from the uplink radio resource associated with the preamble. In this case, TRP may transmit a message including a fallback RAR to the terminal on a PDSCH. In this case, the terminal receiving the message may retransmit the message the terminal wished to transmit using an uplink radio resource indicated by uplink grant information included in the fallback RAR.

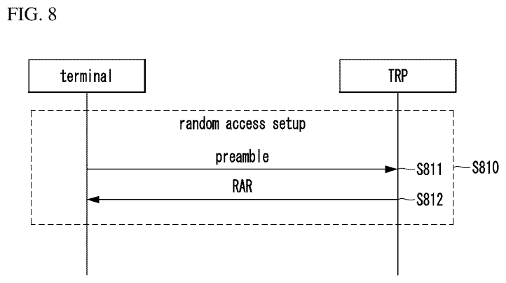

FIG. 8 is a sequence chart illustrating a third exemplary embodiment of a random access setup procedure.

Referring to FIG. 8, the terminal that has completed downlink synchronization and system information acquisition may perform a 2-step contention-free random access (CFRA)-based random access setup procedure for uplink synchronization (S810). To this end, in the first step, the terminal may randomly select one preamble among preambles specified by TRP. Then, the terminal may transmit one selected preamble to TRP on a PRACH (S811). TRP may receive a message including the preamble from the terminal. Then, TRP may perform TA estimation for the received preamble. Additionally, TRP may determine whether a TA has been detected through the TA estimation, generate an RAR based on a result of the determination, and transmit the RAR to the terminal (S812). Then, the terminal may receive the RAR from TRP.

Referring again to FIG. 5, TRP may transmit an RRC setup message to the terminal. Then, the terminal may complete RRC setup by receiving the RRC setup message from TRP. Accordingly, a series of system connection operations may be completed. Thereafter, the terminal may enter a system connected state and communicate with other terminals through TRP.

Hereinafter, procedures, transmission methods, and communication devices for transmitting and receiving signals synchronously or sequentially in downlink and uplink by a terminal belonging to one serving cell in synchronization with TRPs existing within the cell will be described. In addition, procedures, transmission methods, and communication devices for transmitting and receiving signals synchronously or sequentially in downlink and uplink by a terminal belonging to one serving cell in synchronization with a TRP belonging to the serving cell and TRP(s) belonging to an adjacent non-serving cell will be described. These procedures and transmission methods may be referred to as intra-cell/inter-cell M-TRP procedures/methods. Here, the intra-cell/inter-cell M-TRP procedures/methods may be transmission procedures/methods based on multiple TRPs.

The description of the present disclosure may assume that a maximum of two TRPs can be connected to one serving cell, and one TRP can be connected to an adjacent non-serving cell, as shown in FIGS. 3A and 3B. However, the present disclosure is not limited thereto, and a case where two or more TRPs may be connected to a serving cell, and one or more TRPs may be connected to a non-serving cell may also be included in the scope of the present disclosure.

Referring again to FIG. 5, all TRPs within one serving cell may transmit identically beamformed SSBs to the terminal. Then, the terminal may receive the identically beamformed SSBs from the TRPs. In this case, the terminal may not be able to know whether an estimated best SSB and an estimated second best SSB belong to TRP 1 or TRP 2. Accordingly, it may be difficult for the terminal to transmit signals synchronously or sequentially by synchronizing with each of two different TRPs. Here, the best SSB may be an SSB with the maximum correlation value, and the second best SSB may have the second maximum correlation value. Alternatively, the best SSB may be an SSB with the largest signal to interference plus noise ratio (SINR), and the second best SSB may have the second largest SIN R. The best SSB may be the first best SSB (i.e. 1st best SSB), and the second best SSB may be the second best SSB (i.e. 2nd best SSB).

To solve the above-described problem, the intra-cell/inter-cell M-TRP methods may divide the available beamformed SSBs into SSB groups. Each of the SSB groups may be mapped to TRP. This method may be referred to as ‘SSB grouping method’. Here, as a first SSB grouping method, the SSBs may be divided into SSB groups without intersection with each other within the same SSB period and the same half frame, while maintaining the same number of available beamformed SSBs. Then, each of the SSB groups may be mapped to TRP.

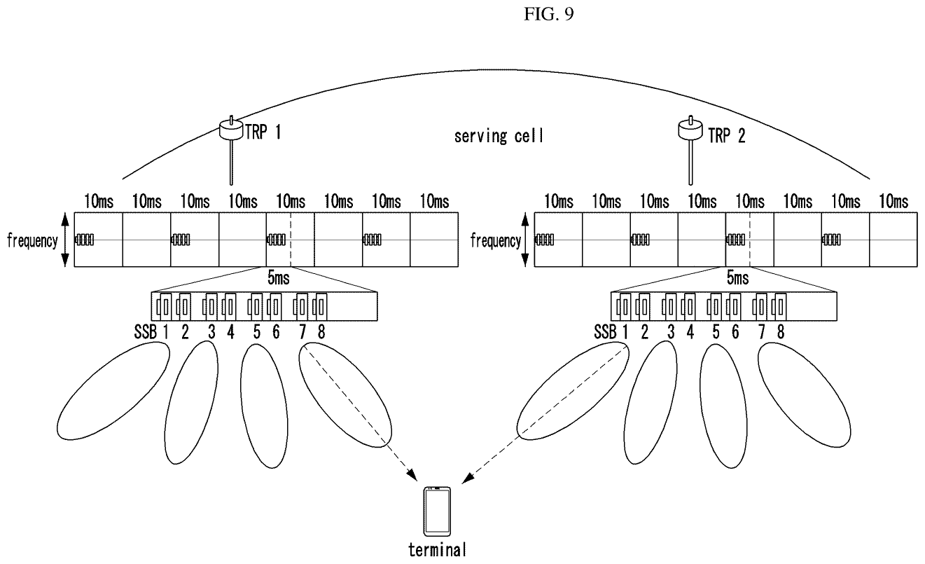

FIG. 9 is a conceptual diagram illustrating a first exemplary embodiment of a method for grouping synchronization signal blocks.

Referring to FIG. 9, SSBs (SSB 1 to SSB 8) may be divided into two SSB groups (i.e. SSB group 1 and SSB group 2). In this case, the SSB group 1 may include SSB 1, SSB 3, SSB 5, and SSB 7. The SSB group 1 may be mapped to TRP 1. On the other hand, the SSB group 2 may include SSB 2, SSB 4, SSB 6, and SSB 8. The SSB group 2 may be mapped to TRP 2. Here, mapping the SSB group 1 to TRP 1 may mean that TRP 1 transmits beamformed SSBs using only SSB 1, SSB 3, SSB 5, and SSB 7 to the corresponding directions during SSB sweeping. Similarly, mapping the SSB group 2 to TRP 2 may mean that TRP 2 transmits beamformed SSBs using only SSB 2, SSB 4, SSB 6, and SSB 8 to the corresponding directions during SSB sweeping. In this case, the number of available SSBs may be 8, but may not be limited to this and may be 4, 16, 64, or the like. Here, TRP 1 and TRP 2 may belong to a serving cell.

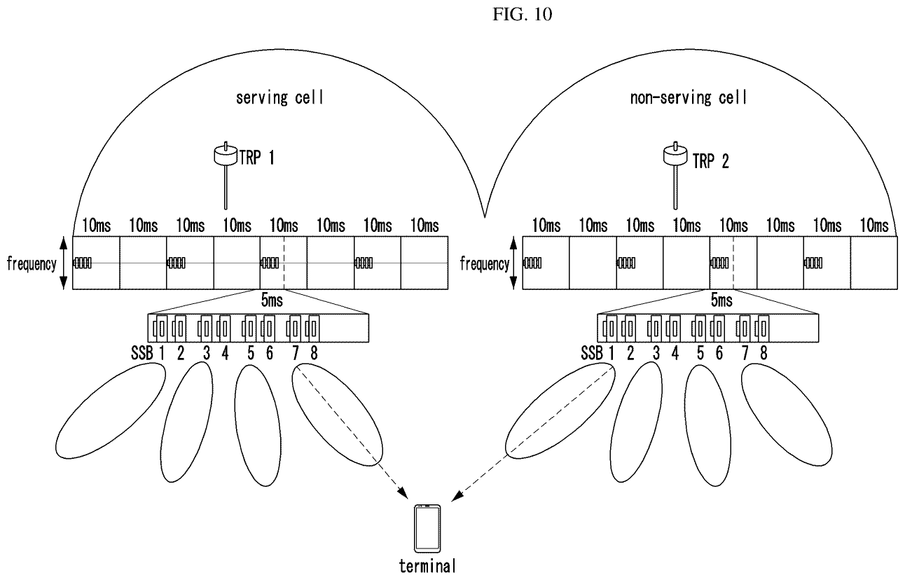

FIG. 10 is a conceptual diagram illustrating a second exemplary embodiment of a method for grouping synchronization signal blocks.

Referring to FIG. 10, SSBs (SSB 1 to SSB 8) may be divided into two SSB groups (i.e. SSB group 1 and SSB group 2). In this case, the SSB group 1 may include SSB 1, SSB 3, SSB 5, and SSB 7. The SSB group 1 may be mapped to TRP 1 belonging to a serving cell. On the other hand, the SSB group 2 may include SSB 2, SSB 4, SSB 6, and SSB 8. The SSB group 2 may be mapped to TRP 2 belonging to a non-serving cell. Here, mapping the SSB group 1 to TRP 1 may mean that TRP 1 transmits beamformed SSBs using only SSB 1, SSB 3, SSB 5, and SSB 7 to the corresponding directions during SSB sweeping. Similarly, mapping the SSB group 2 to TRP 2 may mean that TRP 2 transmits beamformed SSBs using only SSB 2, SSB 4, SSB 6, and SSB 8 to the corresponding directions during SSB sweeping. In this case, the number of available SSBs may be 8, but may not be limited to this and may be 4, 16, 64, or the like. Here, TRP 1 may belong to a serving cell, and TRP 2 may belong to a non-serving cell.

The first SSB grouping method described in FIGS. 9 and 10 is merely an exemplary embodiment, and all methods of dividing SSBs into SSB groups without intersection within the same SSB period and the same half frame, while maintaining the same number of available beamformed SSBs, and mapping each of the SSB groups to TRP may be included in the scope of the present disclosure. On the other hand, a second grouping method may be a method of dividing SSBs into SSB groups that do not intersect within the same SSB period but span different half frames, while maintaining the same number of available beamformed SSBs, and mapping each of the SSB groups to TRP.

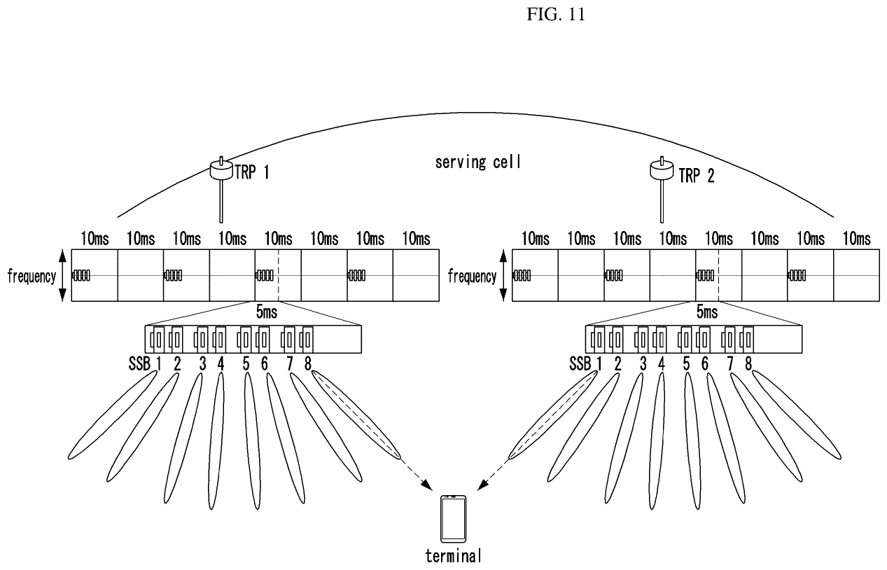

FIG. 11 is a conceptual diagram illustrating a third exemplary embodiment of a method for grouping synchronization signal blocks.

Referring to FIG. 11, SSBs (SSB 1 to SSB 8) of a first half frame within one frame may be classified as an SSB group 1. In addition, SSBs (SSB 1 to SSB 8) of a second half frame within the one frame may be classified as an SSB group 2. The SSB group 1 may include SSB 1 to SSB 8 of the first half frame. The SSB group 1 may be mapped to TRP 1. On the other hand, the SSB group 2 may include SSB 1 to SSB 8 of the second half frame. The SSB group 2 may be mapped to TRP 2. Here, mapping the SSB group 1 to TRP 1 may mean that TRP 1 transmits beamformed SSBs using all of SSB 1 to SSB 8 of the first half frame to the corresponding directions during SSB sweeping. Similarly, mapping the SSB group 2 to TRP 2 may mean that TRP 2 transmits beamformed SSBs using all of SSB 1 to SSB 8 of the second half frame to the corresponding directions during SSB sweeping. In this case, the number of available SSBs may be 8, but may not be limited to this and may be 4, 16, 64, or the like. Here, TRP 1 and TRP 2 may belong to a serving cell.

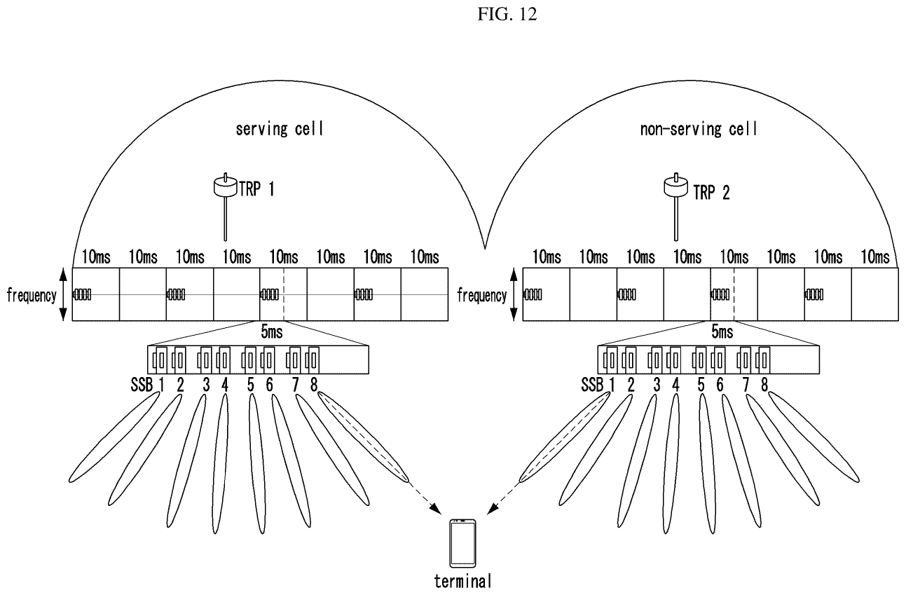

FIG. 12 is a conceptual diagram illustrating a fourth exemplary embodiment of a method for grouping synchronization signal blocks.

Referring to FIG. 12, SSBs (SSB 1 to SSB 8) of a first half frame within one frame may be classified as an SSB group 1. In addition, SSBs (SSB 1 to SSB 8) of a second half frame within the one frame may be classified as an SSB group 2. The SSB group 1 may include SSB 1 to SSB 8 of the first half frame. The SSB group 1 may be mapped to TRP 1 belonging to a serving cell. On the other hand, the SSB group 2 may include SSB 1 to SSB 8 of the second half frame. The SSB group 2 may be mapped to TRP 2 belonging to a non-serving cell. Here, mapping the SSB group 1 to TRP 1 may mean that TRP 1 transmits beamformed SSBs using all of SSB 1 to SSB 8 of the first half frame to the corresponding directions during SSB sweeping. Similarly, mapping the SSB group 2 to TRP 2 may mean that TRP 2 transmits beamformed SSBs using all of SSB 1 to SSB 8 of the second half frame to the corresponding directions during SSB sweeping. In this case, the number of available SSBs may be 8, but may not be limited to this and may be 4, 16, 64, or the like.

The second SSB grouping method described in FIGS. 11 and 12 is merely an exemplary embodiment, and the first half frame may be generally referred to as a first resource, and the second half frame may be generally referred to as a second resource. The respective resources may correspond to different time resources, time periods, frequency resources, or time and frequency resources. The scope of the present disclosure may include all methods of dividing SSBs transmitted from these resources into groups without intersection and mapping each of the groups to TRP. In addition, the present disclosure may include all grouping methods which combine the first SSB grouping method and the second SSB grouping method. These grouping methods may involve dividing SSBs into non-overlapping groups within the same SSB period, across the same or different half-frames, using either the same number or different numbers of available beamformed SSBs. Each of these groups may then be mapped to one or more TRPs. In FIGS. 9 to 12, the SSB group 1 may be associated with a first TA, and the SSB group 2 may be associated with a second TA. In FIGS. 9 to 12, the SSB group 1 may be associated with a first tag identifier (i.e. timing advance group (TAG) ID), and the SSB group 2 may be associated with a second tag ID. In FIGS. 9 to 12, the respective SSBs of the SSB group 1 may be associated with one TAG ID, and the respective SSBs of the SSB group 2 may also be associated with one TAG ID.

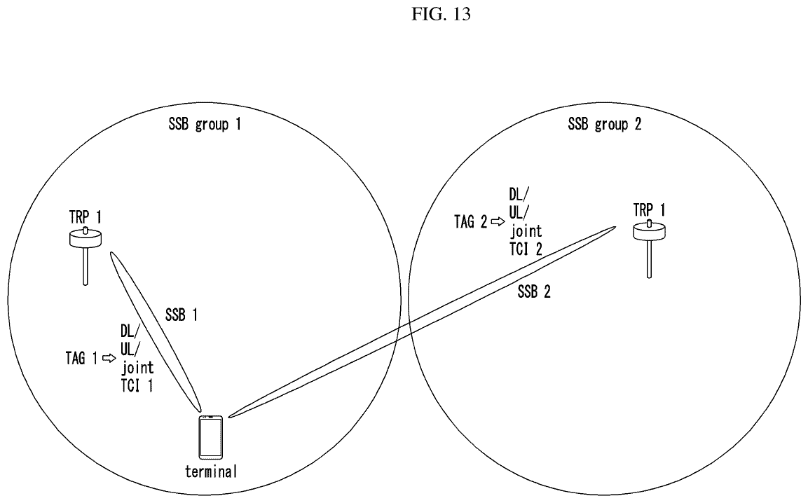

FIG. 13 is a conceptual diagram illustrating a first exemplary embodiment of a tag ID configuration method.

Referring to FIG. 13, to adjust TAs required for uplink synchronization, each SSB group may be mapped to one TRP and may be associated with one tag ID (e.g. TAG 1, TAG 2, etc.). As an example, the SSB group 1 may be associated with a TAG 1, and the SSB group 2 may be associated with a TAG 2. In this case, the TAG 1 may be associated with a joint transmission configuration indication (TCI) 1, and the TAG 2 may be associated with a joint TCI 2. As described above, since the TAG is managed for each SSB group, the terminal may perform uplink synchronization and communication for each TAG when establishing one communication link for each of TRP 1 and TRP 2.

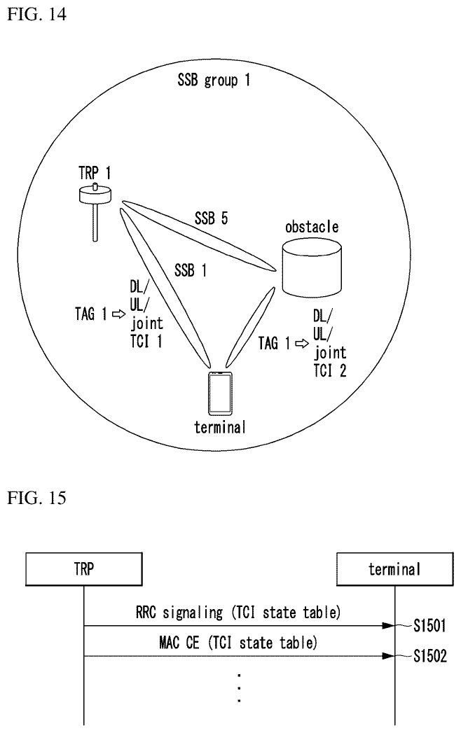

FIG. 14 is a conceptual diagram illustrating a second exemplary embodiment of a tag ID configuration method.

Referring to FIG. 14, when two communication links are established with one TRP, the terminal may perform uplink synchronization and communication by allocating the same TAG to both links. Here, one communication link may pass through an obstacle.

Meanwhile, a TCI may refer to a transmission configuration indication that defines a quasi-co-location (QCL) relation for downlink or uplink physical channels and physical signals. A joint TCI may define a QCL relation for downlink and uplink physical channels and physical signals to reduce control overhead. TRP may dynamically deliver a TCI to the terminal through a physical downlink control channel (PDCCH), which is a control channel, or a PDSCH including a medium access control (MAC) control element (CE) or RRC information. Alternatively, TRP may aperiodically deliver a TCI to the terminal through a PDCCH or a PDSCH including a MAC CE or RRC information. Alternatively, TRP may periodically deliver TCI(s) to the terminal through a PDCCH or a PDSCH including a MAC CE or RRC information. Alternatively, TRP may semi-persistently deliver TCI(s) to the terminal through a PDCCH or a PDSCH including a MAC CE or RRC information. In this case, TRP may apply a TCI according to a beam direction and QCL relation of an antenna port for each communication link. In addition, TRP may deliver beam directions and QCL relations of antenna ports of two communication links through one communication link by using one TCI.

FIG. 15 is a sequence chart illustrating a first exemplary embodiment of a TCI triggering method.

Referring to FIG. 15, TRP (or network (NW)) may transmit a TCI state table to the terminal on a PDSCH using higher layer RRC signaling (S1501). Then, the terminal may receive the TCI state table from TRP. Here, the TCI state table may be configured by tci-StatesToAddModList defined within PDSCH configuration (e.g. PDSCH-Config). The maximum size of the TCI state table may be 128, for example. Here, a TCI may be defined as follows.

A TCI may define each QCL relation for each of antenna ports used in various physical channels (beams) and physical signals (beams). Here, various QCL types may be defined in form of functions of a Doppler shift, Doppler spread, average delay, spatial Rx parameters, and/or the like. For example, QCL types may be as follows.
QCL-Type A: Doppler shift, Doppler spread, average delay, delay spread
QCL-Type B: Doppler shift, Doppler spread
QCL-Type C: A verage delay, Doppler shift
QCL-Type D: spatial Tx parameters
128 downlink TCI configurations defined by RRC signaling may depend on QCL relations of downlink physical channels (e.g. PDSCH, PDCCH, etc.) and downlink physical signals (e.g. SSB, DL channel state information-reference signal (CSI-RS), etc.) as follows. Uplink TCI configurations may depend on QCL relations of uplink physical channels (e.g. PUSCH, PUCCH, etc.) and uplink physical signals (e.g. sounding reference signal (SRS), UL CSI-RS, etc.).
PDCCH/PDSCH QCL (with SSB)
PDCCH/PDSCH QCL (with DL CSI-RS)
PDCCH/PDSCH QCL (with SSB and DL CSI-RS)
DL CSI-RS beam QCL (with SSB beam)

Then, TRP (or NW) may transmit the TCI state table to the terminal through a UE-specific PDCCH or a UE-specific MAC CE of a PDSCH (S1502). Then, the terminal may receive the TCI state table from TRP.

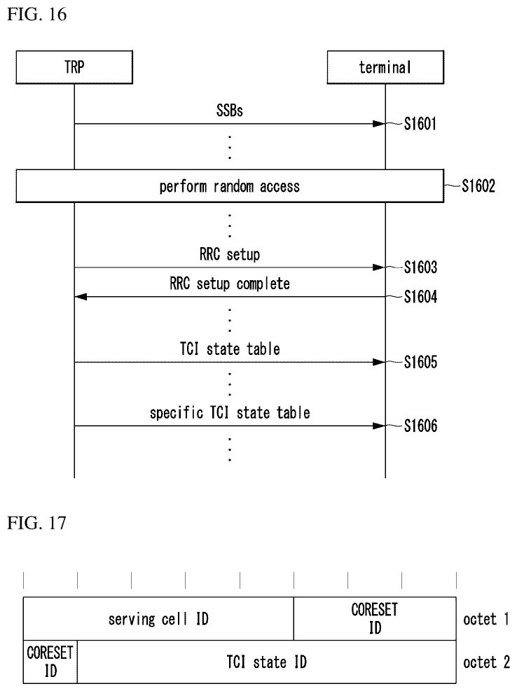

FIG. 16 is a sequence chart illustrating a first exemplary embodiment of a method for recognizing a TCI state.

Referring to FIG. 16, TRP may transmit SSBs based on SSB beam sweeping (S1601). Then, a terminal may receive SSB(s) from TRP, and may select an SSB indicated by the best beam. The terminal may obtain system information such as MIB and SIBy from the selected SSB. The terminal may perform uplink synchronization by performing a random access procedure using random access-related information in the system information (S1602).

TRP may transmit an RRC setup message to the terminal (S1603). Then, the terminal may receive the RRC setup message from TRP. When the terminal completes RRC setup according to the received RRC setup message, the terminal may transmit an RRC setup complete message to TRP (S1604). Then, TRP may receive the RRC setup complete message from the terminal. Through this process, the terminal may be connected to TRP. Thereafter, the terminal may communicate with other terminals through TRP in the connected state.

For example, TRP may transmit a TCI state table with a maximum size of 128, which is configured by tci-StatesToAddModList, to the terminal through a PDSCH (S1605). Then, the terminal may receive the TCI state table. Accordingly, the terminal may obtain and store a PDCCH-related TCI state table with a maximum size of 64, as an example, which is configured by tci-StatesToAddModList. TRP may transmit a UE-specific TCI state table of FIG. 17 to the terminal using a UE-specific PDCCH MAC CE on a PDSCH (S1606). The terminal may receive the UE-specific TCI state table from the TRP, and store and manage the UE-specific TCI state table.

FIG. 17 is a conceptual diagram illustrating a first exemplary embodiment of a U E-specific TCI state table.

Referring to FIG. 17, an octet 1 in the UE-specific TCI state table may be composed of a serving cell ID and a part of a common control resource set (CORESET) ID for PDCCHs corresponding thereto. An octet 2 may be composed of the remaining part of the CORESET ID and a TCI state ID indicating one of the 64 TCI states in the TCI state table.

Here, two communication links may be established. Additionally, each communication link may correspond to a different TAG and uplink synchronization therefor may be performed based on the TAG. In this case, a UE-specific PDCCH MAC CE may be transmitted separately for each link. Alternatively, UE-specific PDCCH MAC CEs may be transmitted separately on one link (e.g. first communication link). Alternatively, UE-specific PDCCH MAC CEs may be integrated and transmitted on one link. When UE-specific PDCCH MAC CEs are transmitted in form of an integrated MAC CE, a TCI ID/TAG ID for each link may be assigned to a field of the MAC CE. Meanwhile, the terminal may obtain its TCI state specified in the TCI state table, decode its PDCCH, and perform downlink communication.

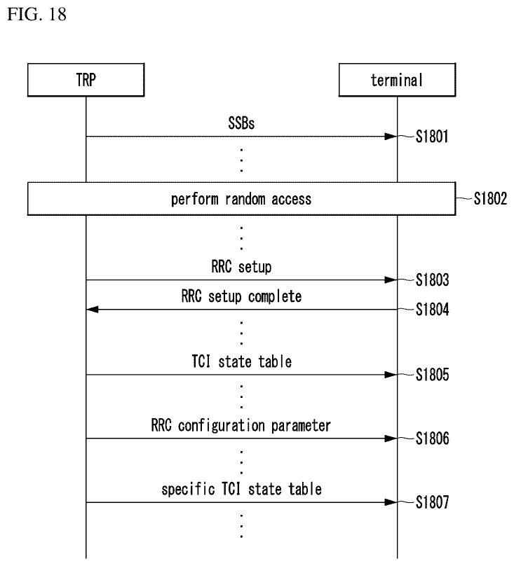

FIG. 18 is a sequence chart illustrating a second exemplary embodiment of a method for recognizing a TCI state.

Referring to FIG. 18, TRP may transmit SSBs based on SSB beam sweeping (S1801). Then, a terminal may receive SSB(s) from TRP, and may select an SSB indicated by the best beam. The terminal may obtain system information such as MIB and SIBy from the selected SSB. The terminal may perform uplink synchronization by performing a random access procedure using random access-related information in the system information (S1802).

TRP may transmit an RRC setup message to the terminal (S1803). Then, the terminal may receive the RRC setup message from TRP. When the terminal complete RRC setup according to the received RRC setup message, the terminal may transmit an RRC setup complete message to TRP (S1804). Then, TRP may receive the RRC setup complete message from the terminal. Through this process, the terminal may be connected to TRP. Afterwards, the terminal may communicate with others terminal through TRP in the connected state.

For example, TRP may transmit a TCI state table with a maximum size of 128, which is configured by tci-StatesToAddModList, to the terminal through a PDSCH (S1805). Then, the terminal may receive the TCI state table. Accordingly, the terminal may obtain and store a PDCCH-related TCI state table with a maximum size of 64, as an example, which is configured by tci-StatesT oA ddModList.

Then, TRP may broadcast an RRC configuration parameter (e.g. tci-PresentInDCI) indicating whether a TCI state is present within DCI on a PDSCH through high layer signaling (S1806). Then, the terminal may receive the RRC configuration parameter and identify whether a TCI state exists within DCI. The terminal may perform the following process according to the obtained information on whether a TCI state exists within DCI.

The parameter (e.g. tci-PresentInDCI) indicating whether a TCI state exists within DCI may be set to ‘omit’ state. In other words, tci-PresentInDCI may be set as ‘tci-PresentInDCI=omit’. In this case, a TCI state for a PDSCH may be the same as a TCI state for the corresponding CORESET/PDCCH. Then, the terminal may perform the following process.

First, TRP may transmit a UE-specific TCI state to the terminal by including it in a UE-specific PDCCH MAC CE on a PDSCH (S1807). The terminal may obtain its TCI state by receiving the UE-specific TCI state table as shown in FIG. 17. The terminal may obtain its TCI state specified in the UE-specific TCI state table FIG. 17 and perform downlink communication by decoding its PDCCH according to the TCI state.

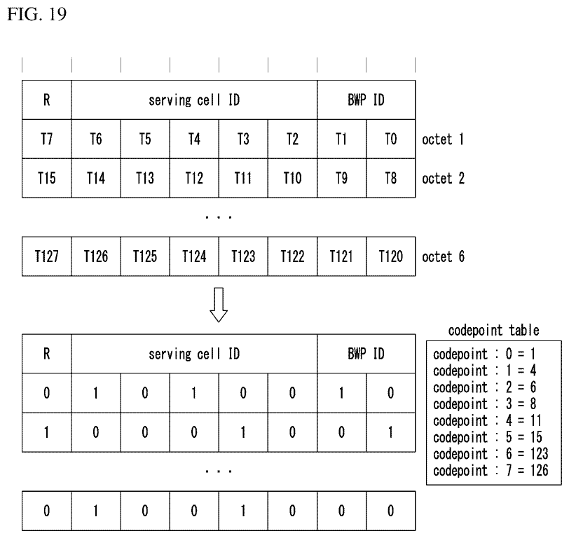

The parameter tci-PresentInDCI may be set to ‘enabled’ state. In other words, when the parameter tci-PresentInDCI is set as ‘tci-PresentInDCI=enabled’, the terminal may perform the following process. First, the TRP may transmit a U E-specific TCI state table as shown in FIG. 19 for the UE-specific PDSCH MAC CE to the terminal on a PDSCH. The terminal may receive the UE-specific TCI state table as shown in FIG. 19 from the TRP.

FIG. 19 is a conceptual diagram illustrating a second exemplary embodiment of a UE-specific TCI state table.

Referring to FIG. 19, the UE-specific TCI state table may include a serving cell ID, a bandwidth part (BWP) ID for the corresponding PDSCH, and 128 bits respectively indicating activation (defined as 1) or deactivation (defined as 0) for 128 TCI states. In a bottom of FIG. 19, a case where 8 TCI states configured for the terminal are activated is shown. Here, two communication links may be established. Additionally, each communication link may correspond to a different TAG and uplink synchronization may be performed based on the TAG. In this case, a UE-specific PDCCH MAC CE may be transmitted separately for each link. Alternatively, UE-specific PDCCH MAC CEs may be integrated and transmitted on one link. When UE-specific PDCCH MAC CEs are transmitted in form of an integrated MAC CE, a TCI ID/TAG ID for each link may be assigned to a field of the MAC CE. Meanwhile, the terminal may obtain its TCI state specified in the TCI state table, decode its PDCCH, and perform downlink communication.

Then, the terminal may map the 8 activated TCI states to a code point table in ascending order as shown on the right. Meanwhile, TRP may transmit a DL TCI and DCI (e.g. DCI 1_1) through a UE-specific PDCCH. The terminal may receive the DL TCI and DCI from TRP. Accordingly, the terminal may perform downlink communication by recognizing its scheduled codepoint index through a TCI field including in the DCI (e.g. DCI 1_1).

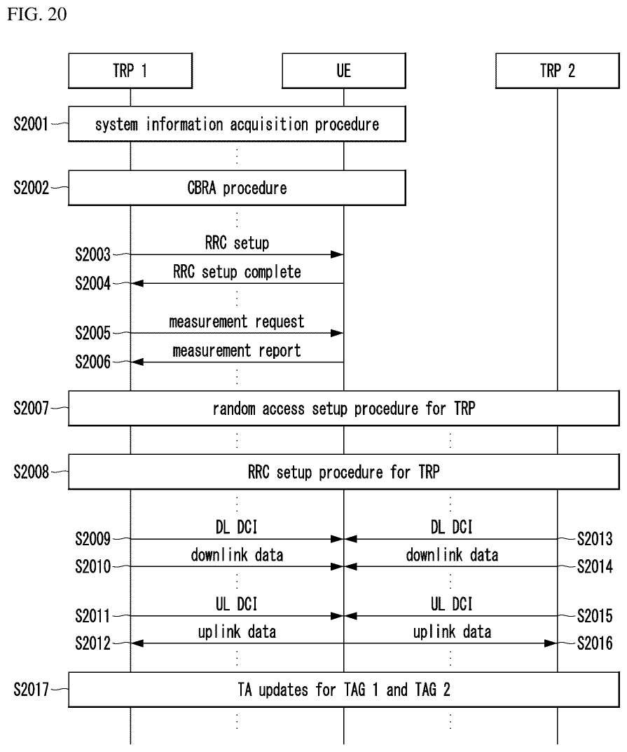

FIG. 20 is a sequence chart illustrating a first exemplary embodiment of a link configuration method in a multi-TRP environment.

Referring to FIG. 20, a terminal may establish communication links with two TRPs belonging to different SSB groups, respectively. In this case, the terminal may establish two communication links from an initial access stage. To this end, the terminal may perform SSB beam measurement on beamformed SSBs transmitted from each TRP of TRP 1 and TRP 2. In this case, the terminal may select an SSB 1 as the best SSB (i.e. 1st best SSB) and an SSB 2 as the second best SSB (i.e. 2nd best SSB). The terminal may obtain system information based on the best SSB (S2001). The system information may be carried on a PBCH and PDSCH channels transmitted in time/frequency resources determined according to the SSB.

The terminal may recognize the SSB 1 as the best SSB through the PBCH. In addition, the terminal may recognize a mapping relationship between SSB groups and TRPs and an association relationship between TAG IDs and SSB groups from the PDSCH channel(s) including SIBy (i.e. system information block y). TRP may allow the terminal to recognize the mapping relationship between SSB groups and TRPs and the association relationship between SSB groups and TAG IDs during an RRC setup procedure after performing a random access process. Alternatively, TRP may allow the terminal to recognize the mapping relationship between SSB groups and TRPs and the association relationship between SSB groups and TAG IDs through RRC signaling after the RRC setup procedure is completed. In addition, TRP may not inform the terminal of the mapping relationship between SSB groups and TRPs and the association relationship between SSB groups and TAG IDs. Here, the terminal may recognize the mapping relationship between SSB groups and TRPs and the association relationship between SSB groups and TAG IDs from the PDSCH including SIBy that is system information.

Then, TRP 1 and the terminal may perform uplink synchronization according to a 4-step or 2-step CBRA procedure according to a random access channel (RACH) occasion (RO) according to indication of the SIB obtained from the system information (S2002). Here, the RO may refer to an uplink time/frequency resource location for random access. In this process, the terminal may configure a TAG 1 to a communication link with TRP 1. The terminal may perform uplink synchronization and update of uplink synchronization according to configuration of the TAG 1 for the communication link.

Then, TRP 1 may transmit an RRC setup message to the terminal (S2003). The terminal may receive the RRC setup message from TRP 1. Accordingly, the terminal may compete RRC setup and transmit an RRC setup complete message to TRP 1 (S2004). TRP 1 may confirm the RRC setup by receiving the RRC setup complete message from the terminal. Through this process, the terminal may complete system connection to TRP 1. In the connected state, the terminal may communicate with other terminals through TRP 1.

To this end, TRP 1 may transmit downlink-related DCI to the terminal (S2009). Then, the terminal may receive the downlink-related DCI from TRP 1. Here, the downlink-related DCI may indicate a DL/joint TCI 1 indicating a reception configuration of the terminal and a scheduling resource location for data reception of the terminal, and may be transmitted on a PDCCH. Thereafter, TRP 1 may transmit downlink data to the terminal according to the downlink-related DCI (S2010). Then, the terminal may receive the downlink data from TRP 1 based on the downlink-related DCI.

On the other hand, TRP 1 may transmit uplink-related DCI to the terminal (S2011). Then, the terminal may receive the uplink-related DCI from TRP 1. Here, the uplink-related DCI may indicate a UL/joint TCI 1 indicating a transmission configuration of the terminal and a scheduling resource location for data transmission of the terminal, and may be transmitted on a PDCCH. Thereafter, the terminal may transmit uplink data to TRP 1 according to the uplink-related DCI (S2012). Then, TRP 1 may receive the uplink data from the terminal based on the uplink-related DCI.

Meanwhile, the terminal may be in an RRC-connected state. TRP 1 may request measurement from the terminal (S2005). Accordingly, the terminal may perform measurement by receiving SSBs from neighbor TRPs. Additionally, the terminal may report SSB-based measurement results for neighbor TRPs to TRP 1 through RRC signaling (S2006). In this case, the terminal may report the SSB 2 as the second best SSB to TRP 1. Accordingly, TRP 1 may receive the measurement report from the terminal. TRP 1 may recognize the SSB 2 as the second best SSB through the measurement report. In this case, the SSB 2 may not be included in the SSB group used by TRP 1. Accordingly, TRP 1 may recognize TRP 2 as a TRP transmitting the SSB 2 based on the relationship between SSB groups and TRPs.

In this case, the measurement report may include a first SSB index (i.e. the best SSB index), a second SSB index (i.e. the second best SSB index), a third SSB index, etc. Additionally, the measurement report may include information on a time difference between a reception synchronization point of the current communication link and each of reception synchronization points of communication links corresponding to the second SSB index and the third SSB index.

If the time differences between the reception synchronization point of the current communication link and the reception synchronization points of communication links corresponding to the second SSB index and the third SSB index do not exceed a predetermined threshold, the terminal may request TRP 1 to configure a TAG therefor identically to that of the current communication link. Alternatively, if the time differences between the reception synchronization point of the current communication link and the reception synchronization points of communication links corresponding to the second SSB index and the third SSB index exceed the predetermined threshold, the terminal may request TRP 1 to configure a TAG therefor differently from that of the current communication link. If TRP 1 configure the same TAG for the current communication link and other communication links, a load for reverse synchronization of the terminal and update thereof can be reduced.

In addition, the terminal may know the time differences between the reception synchronization point of the current communication link and the reception synchronization points of communication links corresponding to the second SSB index and the third SSB index. Therefore, if the time differences between the reception synchronization point of the current communication link and the reception synchronization points of communication links corresponding to the second SSB index and the third SSB index do not exceed the predetermined threshold, the terminal may request a RACH-less second link establishment procedure to TRP 1. On the other hand, if the time differences between the reception synchronization point of the current communication link and the reception synchronization points of communication links corresponding to the second SSB index and the third SSB index exceed the predetermined threshold, the terminal may a RACH-based second link establishment procedure to TRP 1.

Then, the terminal may perform a random access setup procedure with TRP 2 (S2007). In this process, the terminal may allocate a TAG 2 to a communication link with TRP 2 for uplink synchronization and update thereof. The random access setup procedure for TRP 2 may be triggered by TRP 1. Alternatively, the random access setup procedure for TRP 2 may be triggered by the terminal.

First, in the triggering method by TRP 1, TRP 1 may trigger the random access setup procedure for TRP 2 by indicating the terminal to perform CFRA or CBRA random access through high layer signaling or PDCCH. On the other hand, in the triggering method by the terminal, the terminal may recognize a need to manage another TAG through a random access process with TRP 1. Accordingly, the terminal may request random access using the SSB 2 or TRP 2 through high layer signaling or a physical layer control channel (i.e. PUSCH, etc.) to trigger the random access setup procedure for TRP 2.

TRP 1 receiving the request may proceed with the random access setup procedure for TRP 2 by indicating the terminal to perform CFRA or CBRA random access through high layer signaling or PDCCH. In this manner, the terminal may receive from TRP 1 the indication for the random access setup procedure for TRP 2. Accordingly, the terminal and TRP 2 may complete the random access setup procedure by performing a random access procedure.

Then, TRP 2 and the terminal may perform an RRC setup procedure (S2008). In other words, TRP 2 may transmit an RRC setup message to the terminal. The terminal may receive the RRC setup message from TRP 2. Accordingly, the terminal may complete RRC setup, and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 1 and TRP 2.

To this end, TRP 2 may transmit downlink-related DCI to the terminal (S2013). Then, the terminal may receive the downlink-related DCI from TRP 2. Here, the downlink-related DCI may indicates a DL/joint TCI 2 indicating a reception configuration of the terminal and a scheduled resource location for data reception of the terminal, and may be transmitted on a PDCCH. Thereafter, TRP 2 may transmit downlink data to the terminal according to the downlink-related DCI (S2014). Then, the terminal may receive the downlink data from TRP 2 based on the downlink-related DCI.

On the other hand, TRP 2 may transmit uplink-related DCI to the terminal (S2015). Then, the terminal may receive the uplink-related DCI from TRP 2. Here, the uplink-related DCI may indicate a UL/joint TCI 2 indicating a transmission configuration of the terminal and a scheduled resource location for data transmission of the terminal, and may be transmitted on a PDCCH. Thereafter, the terminal may transmit uplink data to TRP 2 according to the uplink-related DCI (S2016). Then, TRP 2 may receive the uplink data from the terminal based on the uplink-related DCI. Then, the terminal may update TAs by performing uplink synchronization for the TAG 1 and TAG 2 with TRP 1 or TRP 2 periodically or aperiodically (S2017).

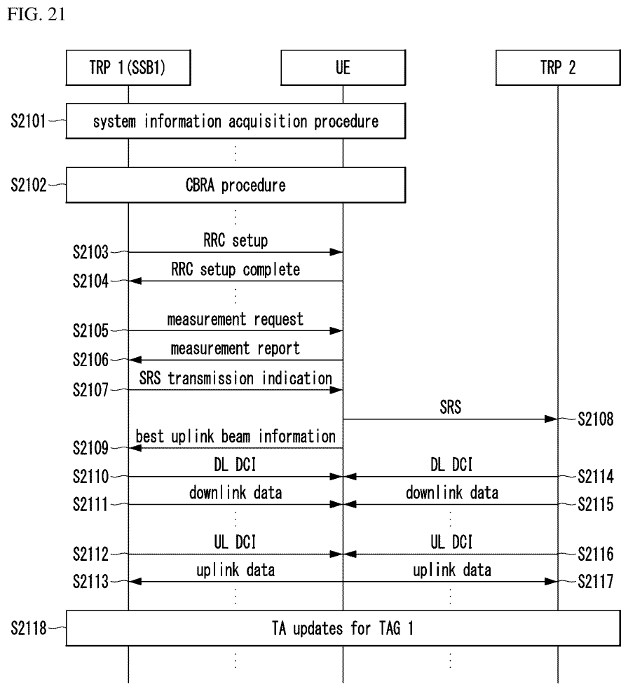

FIG. 21 is a sequence chart illustrating a second exemplary embodiment of a link configuration method in a multi-TRP environment.

Referring to FIG. 21, a terminal may establish two communication links with on TRP belonging to one SSB group. In this case, the terminal may establish two communication links from an initial access stage. To this end, the terminal perform SSB beam measurement on beamformed SSBs transmitted from TRP 1. In this case, the terminal may select an SSB 1 as the best SSB (i.e. 1st best SSB) and an SSB 5 as the second best SSB (i.e. 2nd best SSB). The terminal may obtain system information based on the best SSB (S2101). This system information may be carried on a PBCH and PDSCH(s) transmitted in time/frequency resources determined according to the SSB.

The terminal may recognize the SSB 1 as the best SSB through the PBCH. In addition, the terminal may recognize a mapping relationship between SSB groups and TRPs and an association relationship between TAG IDs and SSB groups based on PDSCH(s) including SIB y. TRP may allow the terminal to recognize the relationship between SSB groups and TRPs and the relationship between SSB groups and TAG IDs during an RRC setup procedure after performing a random access procedure. Alternatively, TRP may allow the terminal to recognize the relationship between SSB groups and TRPs and the relationship between SSB groups and TAG IDs through RRC signaling after the RRC setup procedure is completed. Additionally, TRP may not inform the terminal of the relationship between SSB groups and TRPs and the relationship between SSB groups and TAG IDs. Here, the terminal may recognize the relationship between SSB groups and TRPs and the relationship between SSB groups and TAG IDs from the PDSCH including SIBy that is system information.

Then, TRP 1 and the terminal may perform uplink synchronization according to a 4-step or 2-step CBRA process according to an RO according to an indication of an SIB obtained based on the system information (S2102). Here, the RO may refer to an uplink time/frequency resource location for random access. In this process, the terminal may configure a TAG 1 for a communication link with TRP 1. In this manner, the terminal may perform uplink synchronization and update of uplink synchronization according to configuration of the TAG 1 for the communication link.

Then, TRP 1 may transmit an RRC setup message to the terminal (S2103). The terminal may receive the RRC setup message from TRP 1. Accordingly, the terminal may complete RRC setup and transmit an RRC setup complete message to TRP 1 (S2104). TRP 1 may confirm the RRC setup by receiving the RRC setup complete message from the terminal. Through this process, the terminal may complete system connection with TRP 1. In the connected state, the terminal may communicate with the other terminals through TRP 1.

To this end, TRP 1 may transmit downlink-related DCI to the terminal (S2110). Then, the terminal may receive the downlink-related DCI from TRP 1. Here, the downlink-related DCI may indicate a DL/joint TCI 1 indicating a reception configuration of the terminal and a scheduled resource location for data reception of the terminal, and may be transmitted on a PDCCH. Thereafter, TRP 1 may transmit downlink data to the terminal according to the downlink-related DCI (S2111). Then, the terminal may receive the downlink data from TRP 1 based on the downlink-related DCI.

On the other hand, TRP 1 may transmit uplink-related DCI to the terminal (S2112). Then, the terminal may receive the uplink-related DCI from TRP 1. Here, the uplink-related DCI may indicate a UL/joint TCI 1 indicating a transmission configuration of the terminal and a scheduled resource location for data transmission of the terminal, and may be transmitted on a PDCCH. Thereafter, the terminal may transmit uplink data to TRP 1 according to the uplink-related DCI (S2113). Then, TRP 1 may receive the uplink data from the terminal based on the uplink-related DCI.

Meanwhile, the terminal may be in an RRC-connected state. TRP 1 may request measurement from the terminal (S2105). Accordingly, the terminal may perform measurement by receiving SSBs from neighbor TRPs. Additionally, the terminal may report SSB-based measurement results for neighbor TRPs to TRP 1 through RRC signaling (S2106). In this case, the terminal may report the SSB 5 as the second best SSB to TRP 1. Accordingly, TRP 1 may receive the measurement report from the terminal. TRP 1 may recognize the SSB 5 as the second best SSB through the measurement report. In this case, the SSB5 may be included in the SSB group used by TRP 1. Accordingly, TRP 1 may recognize itself as a TRP transmitting the SSB 5 based on the relationship between SSB groups and TRPs. Here, the measurement report has been described as being performed by the terminal at the request from TRP 1, but unlike this, the terminal may perform the measurement report even without such request.

In this case, the measurement report may include a first SSB index (i.e. the best SSB index), a second SSB index (i.e. the second best SSB index), a third SSB index, etc. In addition, the measurement report may include information on time differences between a reception synchronization point of the current communication link and reception synchronization points of communication links of the second SSB index, the third SSB index, etc.

If the time differences between the reception synchronization point of the current communication link and the reception synchronization points of communication links of the second SSB index, the third SSB index, etc. do not exceed a predetermined threshold, the terminal may request TRP 1 to configure a TAG therefor to be the same as that of the current communication link. On the other hand, if the time differences between the reception synchronization point of the current communication link and the reception synchronization points of communication links of the second SSB index, the third SSB index, etc. exceed the predetermined threshold, the terminal may request TRP 1 to configure a TAG therefor differently from that of the current communication link. If TRP 1 configures the same TAG for the current communication link and other communication links, the load for reverse synchronization and update of reverse synchronization of the terminal can be reduced.

In addition, the terminal may know the time differences between the reception synchronization point of the current communication link and the reception synchronization points of communication links of the second SSB index, the third SSB index, etc. Therefore, if the time differences between the reception synchronization point of the current communication link and the reception synchronization points of communication links of the second SSB index, the third SSB index, etc. do not exceed the predetermined threshold, the terminal may request a RACH-less second link establishment procedure to TRP 1. On the other hand, if the time differences between the reception synchronization point of the current communication link and the reception synchronization points of communication links of the second SSB index, the third SSB index, etc. exceed the predetermined threshold, the terminal may request a RACH-based second link establishment procedure to TRP 1.

Meanwhile, the terminal may report the SSB 5 to TRP 1 as the second best SSB. In this case, the SSB 5 may be included in the same SSB group as the SSB 1. Accordingly, for example, the communication link associated with the SSB 5 may be a different communication link from the communication link associated with the SSB 1, which comes through a multi-path from TRP 1. The communication link associated with this SSB 5 may follow the uplink synchronization and update of the uplink synchronization for the communication link based on the SSB 1, which are recognized by the TAG 1. According to this, through a RACH-less procedure, TRP 1 and the terminal may perform beam measurement between the terminal and SSB 5 as follows.

To this end, TRP 1 may instruct the terminal to transmit uplink beamformed SRSs to TRPs including TRP 1 using designated scheduled resources (S2107). In this case, TRP 1 may instruct the terminal to transmit the SR Ss through RRC signaling including information on the designated scheduled resources for transmitting the uplink beamformed SR Ss. In this case, TRP 1 may inform neighbor TRPs that the terminal transmits the uplink beamformed SRSs using the determined scheduled time/frequency resources to suppress interference. Alternatively, TRP 1 may not inform neighbor TRPs that the terminal transmits the uplink beamformed SRSs uplink using the determined scheduled time/frequency resources for resource efficiency.

Then, the terminal may transmit the beamformed SR Ss to TRPs including TRP 1 (S2108). TRP 1 may receive SRSs from the terminal. In addition, TRP 1 may select the most appropriate uplink beam based on the received SRSs and inform the terminal of information on the most appropriate uplink beam (i.e. best uplink beam) (S2109). In other words, for example, TRP 1 may inform the terminal of information on an SRS having the highest SINR among the beamformed

SRSs received from the terminal. Accordingly, the terminal may receive the information on the best uplink beam from TRP 1. The terminal may confirm that the best uplink beam belongs to itself. Through this process, the terminal may complete system connection with TRP 1 through the communication link associated with the SSB 5. In the connected state, the terminal may communicate with other terminals through two communication links of TRP 1.

To this end, TRP 1 may transmit DCI related to a downlink associated with the SSB 5 to the terminal (S2114). Then, the terminal may receive the downlink-related DCI from TRP 1. Here, the downlink-related DCI may indicate a DL/joint TCI 1 indicating a reception configuration of the terminal and a scheduled resource location for data reception of the terminal, and may be transmitted on a PDCCH. Thereafter, TRP 1 may transmit downlink data to the terminal according to the downlink-related DCI (S2115). Then, the terminal may receive the downlink data from TRP 1 based on the downlink-related DCI.

On the other hand, TRP 1 may transmit DCI related to an uplink associated with the SSB 5 to the terminal (S2116). Then, the terminal may receive the uplink-related DCI from TRP 1. Here, the uplink-related DCI may indicate a UL/joint TCI 1 indicating a transmission configuration of the terminal and a scheduled resource location for data transmission of the terminal, and may be transmitted on a PDCCH. Thereafter, the terminal may transmit uplink data to TRP 1 according to the uplink-related DCI (S2117).

Then, TRP 1 may receive the uplink data from the terminal based on the uplink-related DCI. Thereafter, the terminal may update the TA by periodically or aperiodically performing uplink synchronization for the TAG 1 with TRP 1 (S2118). Although FIGS. 20 and 21 have described the procedure for establishing two communication links, but methods of the present disclosure are not limited thereto. TRPs and the terminal may establish three or more communication links by applying the methods for establishing communication links, which are illustrated in FIGS. 20 and 21, and perform multi-TRP communication in downlink and uplink.

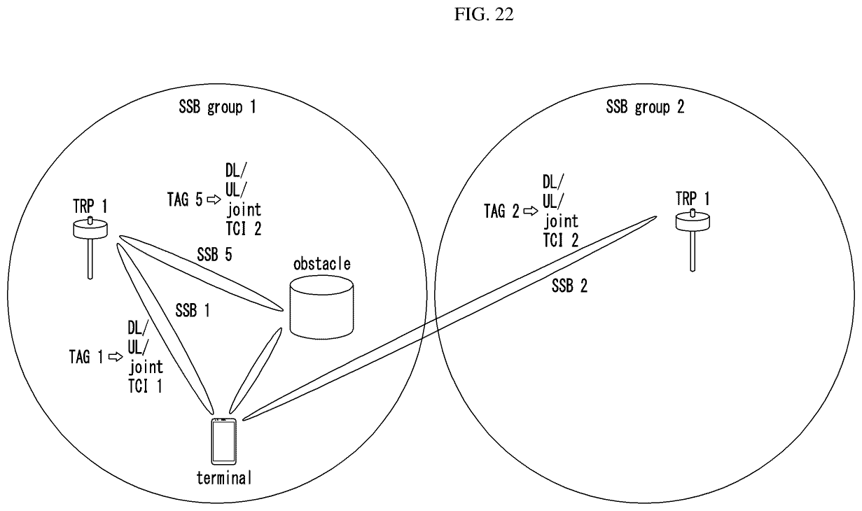

FIG. 22 is a conceptual diagram illustrating a third exemplary embodiment of a tag ID configuration method.

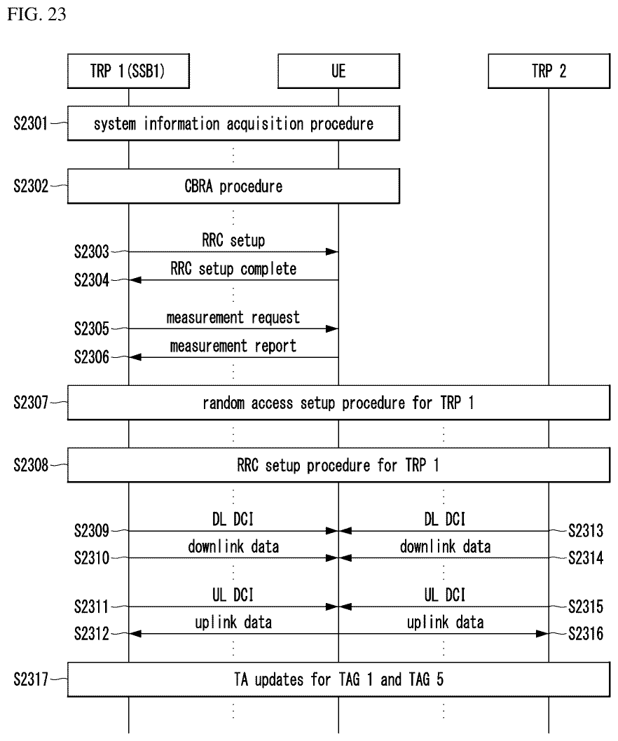

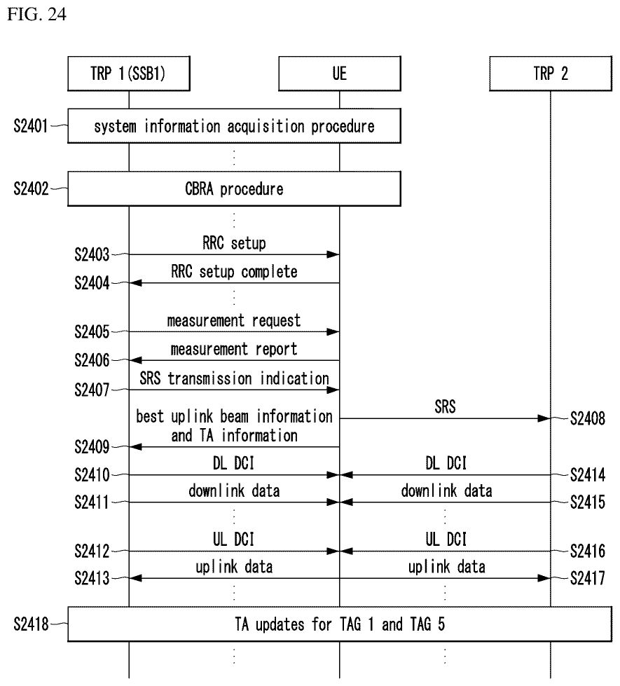

Referring to FIG. 22, each SSB group may be mapped to one TRP to adjust a TA required for uplink synchronization. One tag ID (e.g. TAG 1, TAG 2, or the like) may be associated with one SSB. For example, an SSB 1 of an SSB group 1 may be associated with the TAG 1, and an SSB 5 of an SSB Group 1 may be associated with a TAG 5. In addition, an SSB 2 of the SSB group 2 may be associated with the TAG 2. In this case, the TAG 1 may be associated with a joint transmission configuration indication (TCI) 1. The TAG 2 and TAG 5 may be associated with a joint TCI 2. Since the TAG is managed for each SSB as described above, the terminal may perform uplink synchronization for each SSB, and perform communication for each SSB when one communication link is established for each of the SSBs of TRP 1 and TRP 2. In this case, methods of establishing links in a multi-TRP communication system may be as shown in FIGS. 23 and 24.

FIG. 23 is a sequence chart illustrating a third exemplary embodiment of a link configuration method in a multi-TRP environment.

Referring to FIG. 23, a terminal may establish two communication links with one TRP belonging to one SSB group. The terminal may establish two communication links from an initial access stage. To this end, the terminal may perform SSB beam measurement on beamformed SSBs transmitted from TRP 1. In this case, the terminal may select an SSB 1 as the best SSB (i.e. 1st best SSB) and an SSB 5 as the second best SSB (i.e. 2nd best SSB). The terminal may obtain system information based on the best SSB (S2301). This system information may be carried on a PBCH and PDSCH(s) transmitted in time/frequency resources determined according to the SSB.

The terminal may recognize the SSB 1 as the best SSB through the PBCH. In addition, the terminal may recognize a mapping relationship between SSB groups and TRPs and an association relationship between TAG IDs and SSB groups based on PDSCH(s) including SIB y. TRP may allow the terminal to recognize the relationship between SSB groups and TRPs and the relationship between SSB groups and TAG IDs during an RRC setup procedure after performing a random access procedure. Alternatively, TRP may allow the terminal to recognize the relationship between SSB groups and TRPs and the relationship between SSB groups and TAG IDs through RRC signaling after the RRC setup procedure is completed. Additionally, the TRP may not inform the terminal of the relationship between SSB groups and TRPs and the relationship between SSB groups and TAG IDs. Here, the terminal may recognize the relationship between SSB groups and TRPs and the relationship between SSB groups and TAG IDs from the PDSCH including SIBy that is system information.

Then, TRP 1 and the terminal may perform uplink synchronization according to a 4-step or 2-step CBRA process according to an RO according to an indication of an SIB obtained based on the system information (S2302). Here, the RO may refer to an uplink time/frequency resource location for random access. In this process, the terminal may configure a TAG 1 for a communication link with TRP 1. In this manner, the terminal may perform uplink synchronization and update of the uplink synchronization according to configuration of the TAG 1 for the communication link.

Then, TRP 1 may transmit an RRC setup message to the terminal (S2303). The terminal may receive the RRC setup message from TRP 1. Accordingly, the terminal may complete RRC setup and transmit an RRC setup complete message to TRP 1 (S2304). TRP 1 may confirm the RRC setup by receiving the RRC setup complete message from the terminal. Through this process, the terminal may complete system connection with TRP 1. In the connected state, the terminal may communicate with other terminals through TRP 1.

To this end, TRP 1 may transmit downlink-related DCI to the terminal (S2309). Then, the terminal may receive the downlink-related DCI from TRP 1. Here, the downlink-related DCI may indicate a DL/joint TCI 1 indicating a reception configuration of the terminal and a scheduled resource location for data reception of the terminal, and may be transmitted on a PDCCH. Thereafter, TRP 1 may transmit downlink data to the terminal according to the downlink-related DCI (S2310). Then, the terminal may receive the downlink data from TRP 1 based on the downlink-related DCI.

On the other hand, TRP 1 may transmit uplink-related DCI to the terminal (S2311). Then, the terminal may receive the uplink-related DCI from TRP 1. Here, the uplink-related DCI may indicate a UL/joint TCI 1 indicating a transmission configuration of the terminal and a scheduled resource location for data transmission of the terminal, and may be transmitted on a PDCCH. Thereafter, the terminal may transmit uplink data to TRP 1 according to the uplink-related DCI (S2312). Then, TRP 1 may receive the uplink data from the terminal based on the uplink-related DCI.

Meanwhile, the terminal may be in an RRC-connected state. TRP 1 may request measurement from the terminal (S2305). Accordingly, the terminal may perform measurement by receiving SSBs from neighbor TRPs. Additionally, the terminal may report SSB-based measurement results for neighbor TRPs to TRP 1 through RRC signaling (S2306). In this case, the terminal may report the SSB 5 as the second best SSB to TRP 1. Accordingly, TRP 1 may receive the measurement report from the terminal. TRP 1 may recognize the SSB 5 as the second best SSB through the measurement report. In this case, the SSB5 may be included in the SSB group used by TRP 1. Accordingly, TRP 1 may recognize itself as a TRP transmitting the SSB 5 based on the relationship between SSB groups and TRPs. Here, the measurement reporting has been described as being performed by the terminal at the request from TRP 1, but unlike this, the terminal may perform the measurement reporting even without such request.

In this case, the measurement report may include a first SSB index (i.e. the best SSB index), a second SSB index (i.e. the second best SSB index), a third SSB index, etc. In addition, the measurement report may include information on time differences between a reception synchronization point of the current communication link and reception synchronization points of communication links of the second SSB index, the third SSB index, etc.

If the time differences between the reception synchronization point of the current communication link and the reception synchronization points of communication links of the second SSB index, the third SSB index, etc. do not exceed a predetermined threshold, the terminal may request TRP 1 to configure a TAG therefor to be the same as that of the current communication link. On the other hand, if the time differences between the reception synchronization point of the current communication link and the reception synchronization points of communication links of the second SSB index, the third SSB index, etc. exceed the predetermined threshold, the terminal may request TRP 1 to configure a TAG therefor differently from that of the current communication link. If TRP 1 configures the same TAG for the current communication link and other communication links, the load for reverse synchronization and update of the reverse synchronization of the terminal can be reduced.

In addition, the terminal may know the time differences between the reception synchronization point of the current communication link and the reception synchronization points of communication links of the second SSB index, the third SSB index, etc. Therefore, if the time differences between the reception synchronization point of the current communication link and the reception synchronization points of communication links of the second SSB index, the third SSB index, etc. do not exceed the predetermined threshold, the terminal may request a RACH-less second link establishment procedure to TRP. On the other hand, if the time differences between the reception synchronization point of the current communication link and the reception synchronization points of communication links of the second SSB index, the third SSB index, etc. exceed the predetermined threshold, the terminal may request a RACH-based second link establishment procedure to TRP.

Accordingly, the terminal may perform a random access setup procedure based on the SSB 5 with TRP 1 (S2307). In this process, the terminal may configure a TAG 5 to a communication link with TRP 1 for uplink synchronization and update of the uplink synchronization for the communication link with TRP 1. The random access setup procedure based on the SSB 5 with TRP 1 may be triggered by TRP 1. Alternatively, the random access setup procedure based on the SSB 5 with TRP 1 may be triggered by the terminal.

First, in the triggering method by TRP 1, TRP 1 may trigger the random access setup procedure based on the SSB 5 for TRP 1 by instructing the terminal to perform a CFRA or CBRA random access through high layer signaling or PDCCH. On the other hand, in the triggering method by the terminal, the terminal may recognize a need to manage another TAG through the random access procedure with TRP 1. Accordingly, the terminal may request random access based on the SSB 5 for TRP 1 through a high layer signaling or physical layer control channel (i.e. PUSCH, etc.) to trigger the random access setup procedure for TRP 1.

TRP 1 receiving the request may proceed with the random access setup procedure based on the SSB 5 for TRP 1 by instructing the terminal to perform a CFRA or CBRA random access procedure through high layer signaling or PDCCH. The terminal may receive the indication for the random access setup procedure based on the SSB5 for TRP 1 from TRP 1. Accordingly, the terminal and TRP 1 may complete the random access setup procedure by performing the random access procedure based on the SSB 5.

Then, TRP 1 and the terminal may perform an RRC setup procedure (S2308). In other words, TRP 1 may transmit an RRC setup message to the terminal. The terminal may receive the RRC setup message from TRP 1. Accordingly, the terminal may complete RRC setup and transmit an RRC setup complete message to TRP 1. TRP 1 may confirm the RRC setup by receiving the RRC setup complete message from the terminal. Through this process, the terminal may complete system connection with TRP 1 based on the SSB 5. In the connected state, the terminal may communicate with other terminals through two communication links of TRP 1.

To this end, TRP 1 may transmit DCI related to a downlink associated with the SSB 5 to the terminal (S2313). Then, the terminal may receive the DCI related to the downlink associated with the SSB 5 from TRP 1. Here, the downlink-related DCI may indicate a DL/joint TCI 2 indicating a reception configuration of the terminal and a scheduled resource location for data reception of the terminal, and may be transmitted on a PDCCH. Thereafter, TRP 1 may transmit downlink data to the terminal according to the downlink-related DCI (S2314). Then, the terminal may receive the downlink data from TRP 1 based on the downlink-related DCI.

On the other hand, TRP 1 may transmit uplink-related DCI to the terminal (S2315). Then, the terminal may receive the uplink-related DCI from TRP 1. Here, the uplink-related DCI may indicate a UL/joint TCI 2 indicating a transmission configuration of the terminal and a scheduled resource location for data transmission of the terminal, and may be transmitted on a PDCCH. Thereafter, the terminal may transmit uplink data to TRP 1 according to the uplink-related DCI (S2316). TRP 1 may receive the uplink data from the terminal based on the uplink-related DCI. Thereafter, the terminal may update the TAs by periodically or aperiodically performing uplink synchronization for the TAG 1 and TAG 5 with TRP 1 (S2317).

FIG. 24 is a sequence chart illustrating a fourth exemplary embodiment of a link configuration method in a multi-TRP environment.

Referring to FIG. 24, a terminal may establish two communication links with one TRP belonging to one SSB group. In this case, the terminal may establish two communication links from an initial access stage. To this end, the terminal may perform SSB beam measurement on beamformed SSBs transmitted from TRP 1. In this case, the terminal may select an SSB 1 as the best SSB (i.e. 1st best SSB) and an SSB 5 as the second best SSB (i.e. 2nd best SSB). The terminal may obtain system information based on the best SSB (S2401). This system information may be carried on a PBCH and PDSCH(s) transmitted in time/frequency resources determined according to the SSB.

The terminal may recognize the SSB 1 as the best SSB through the PBCH. In addition, the terminal may recognize a mapping relationship between SSB groups and TRPs and an association relationship between TAG IDs and SSB groups based on PDSCH(s) including SIB y. TRP may allow the terminal to recognize the relationship between SSB groups and TRPs and the relationship between SSB groups and TAG IDs during an RRC setup procedure after performing a random access procedure. Alternatively, TRP may allow the terminal to recognize the relationship between SSB groups and TRPs and the relationship between SSB groups and TAG IDs through RRC signaling after the RRC setup procedure is completed. Additionally, the TRP may not inform the terminal of the relationship between SSB groups and TRPs and the relationship between SSB groups and TAG IDs. Here, the terminal may recognize the relationship between SSB groups and TRPs and the relationship between SSB groups and TAG IDs from the PDSCH including SIBy that is system information.

Then, TRP 1 and the terminal may perform uplink synchronization according to a 4-step or 2-step CBRA process according to an RO according to an indication of an SIB obtained based on the system information (S2102). Here, the RO may refer to an uplink time/frequency resource location for random access. In this process, the terminal may configure a TAG 1 for a communication link with TRP 1. In this manner, the terminal may perform uplink synchronization and update of the uplink synchronization according to configuration of the TAG 1 for the communication link.

Then, TRP 1 may transmit an RRC setup message to the terminal (S2403). The terminal may receive the RRC setup message from TRP 1. Accordingly, the terminal may complete RRC setup and transmit an RRC setup complete message to TRP 1 (S2404). TRP 1 may confirm the RRC setup by receiving the RRC setup complete message from the terminal. Through this process, the terminal may complete system connection with TRP 1. In the connected state, the terminal may communicate with other terminals through TRP 1.

To this end, TRP 1 may transmit downlink-related DCI to the terminal (S2410). Then, the terminal may receive the downlink-related DCI from TRP 1. Here, the downlink-related DCI may indicate a DL/joint TCI 1 indicating a reception configuration of the terminal and a scheduled resource location for data reception of the terminal, and may be transmitted on a PDCCH. Thereafter, TRP 1 may transmit downlink data to the terminal according to the downlink-related DCI (S2411). Then, the terminal may receive the downlink data from TRP 1 based on the downlink-related DCI.

On the other hand, TRP 1 may transmit uplink-related DCI to the terminal (S2412). Then, the terminal may receive the uplink-related DCI from TRP 1. Here, the uplink-related DCI may indicate a UL/joint TCI 1 indicating a transmission configuration of the terminal and a scheduled resource location for data transmission of the terminal, and may be transmitted on a PDCCH. Thereafter, the terminal may transmit uplink data to TRP 1 according to the uplink-related DCI (S2413). Then, TRP 1 may receive the uplink data from the terminal based on the uplink-related DCI.

Meanwhile, the terminal may be in an RRC-connected state. TRP 1 may request measurement from the terminal (S2405). Accordingly, the terminal may perform measurement by receiving SSB s from neighbor TRPs. The terminal may report SSB-based measurement results for neighbor TRPs to TRP 1 through RRC signaling (S2406). In this case, the terminal may report the SSB 5 as the second best SSB to TRP 1. Accordingly, TRP 1 may receive the measurement report from the terminal. TRP 1 may recognize the SSB 5 as the second best SSB through the measurement report. In this case, the SSB5 may be included in the SSB group used by TRP 1. Accordingly, TRP 1 may recognize itself as a TRP transmitting the SSB 5 based on the relationship between SSB groups and TRPs. Here, the measurement reporting has been described as being performed by the terminal at the request from TRP 1, but unlike this, the terminal may perform the measurement reporting even without such request.

In this case, the measurement report may include a first SSB index (i.e. the best SSB index), a second SSB index (i.e. the second best SSB index), a third SSB index, etc. In addition, the measurement report may include information on time differences between a reception synchronization point of the current communication link and reception synchronization points of communication links of the second SSB index, the third SSB index, etc.

If the time differences between the reception synchronization point of the current communication link and the reception synchronization points of communication links of the second SSB index, the third SSB index, etc. do not exceed a predetermined threshold, the terminal may request TRP 1 to configure a TAG therefor to be the same as that of the current communication link. On the other hand, if the time differences between the reception synchronization point of the current communication link and the reception synchronization points of communication links of the second SSB index, the third SSB index, etc. exceed the predetermined threshold, the terminal may request TRP 1 to configure a TAG therefor differently from that of the current communication link. If TRP 1 configures the same TAG for the current communication link and other communication links, the load for reverse synchronization and update of the reverse synchronization of the terminal can be reduced.

In addition, the terminal may know the time differences between the reception synchronization point of the current communication link and the reception synchronization points of communication links of the second SSB index, the third SSB index, etc. Therefore, if the time differences between the reception synchronization point of the current communication link and the reception synchronization points of communication links of the second SSB index, the third SSB index, etc. do not exceed the predetermined threshold, the terminal may request a RACH-less second link establishment procedure to TRP. On the other hand, if the time differences between the reception synchronization point of the current communication link and the reception synchronization points of communication links of the second SSB index, the third SSB index, etc. exceed the predetermined threshold, the terminal may request a RACH-based second link establishment procedure to TRP.

Meanwhile, the terminal may report the SSB 5 to TRP 1 as the second best SSB. In this case, the SSB 5 may be included in the same SSB group as the SSB 1. Accordingly, for example, the communication link associated with the SSB 5 may be a different communication link from the communication link associated with the SSB 1, which comes in a multi-path from TRP 1. TRP 1 may configure a TAG 5 to the communication link associated with the SSB5 to perform uplink synchronization and update of the uplink synchronization for the communication link. According to this, through a RACH-less procedure, TRP 1 and the terminal may perform beam measurement between the terminal and SSB 5 as follows.

To this end, TRP 1 may instruct the terminal to transmit uplink beamformed SR Ss to TRPs including TRP 1 using designated scheduled resources (S2107). In this case, TRP 1 may instruct the terminal to transmit SRSs through RRC signaling including information on the designated scheduled resources for transmitting the uplink beamformed SR Ss. In this case, TRP 1 may inform neighbor TRPs that the terminal transmits the uplink beamformed SR Ss using the determined scheduled time/frequency resources to suppress interference. Alternatively, TRP 1 may not inform neighbor TRPs that the terminal transmits the uplink beamformed SRSs using the determined scheduled time/frequency resources for resource efficiency.

Then, the terminal may transmit the beamformed SR Ss to TRPs including TRP 1 (S2408). TRP 1 may receive SRSs from the terminal. In addition, TRP 1 may select the most appropriate uplink beam based on the received SR Ss and estimate a TA, and inform the terminal of information on the most appropriate uplink beam (i.e. best uplink beam) and information on the estimated TA (S2409). In other words, TRP 1 may inform the terminal of information on an SRS having the highest SINR among the beamformed SR Ss received from the terminal. Accordingly, the terminal may receive the information on the best uplink beam and the information on the TA from TRP 1. The terminal may confirm that the best uplink beam belongs to itself. Through this process, the terminal may complete system connection with TRP 1 through the communication link associated with the SSB 5. In the connected state, the terminal may communicate with other terminals through two communication links of TRP 1.

To this end, TRP 1 may transmit DCI related to a downlink associated with the SSB 5 to the terminal (S2414). Then, the terminal may receive the downlink-related DCI from TRP 1. Here, the downlink-related DCI may indicate a DL/joint TCI 2 indicating a reception configuration of the terminal and a scheduled resource location for data reception of the terminal, and may be transmitted on a PDCCH. Thereafter, TRP 1 may transmit downlink data to the terminal according to the downlink-related DCI (S2415). Then, the terminal may receive the downlink data from TRP 1 based on the downlink-related DCI.

On the other hand, TRP 1 may transmit DCI related to an uplink associated with the SSB 5 to the terminal (S2416). Then, the terminal may receive the uplink-related DCI from TRP 1. Here, the uplink-related DCI may indicate a UL/joint TCI 2 indicating a transmission configuration of the terminal and a scheduled resource location for data transmission of the terminal, and may be transmitted on a PDCCH. Thereafter, the terminal may transmit uplink data to TRP 1 according to the uplink-related DCI (S2417).

Then, TRP 1 may receive the uplink data from the terminal based on the uplink-related DCI. Thereafter, the terminal may update the TAs by periodically or aperiodically performing uplink synchronization for TAG 1 and TAG 5 with TRP 1 (S2418). Although FIGS. 23 and 24 have described the procedure for establishing two communication links, but methods of the present disclosure are not limited thereto. TRP 1 and the terminal may establish three or more communication links by applying the methods for establishing communication links, which are illustrated in FIGS. 23 and 24, and perform multi-TRP communication in downlink and uplink.

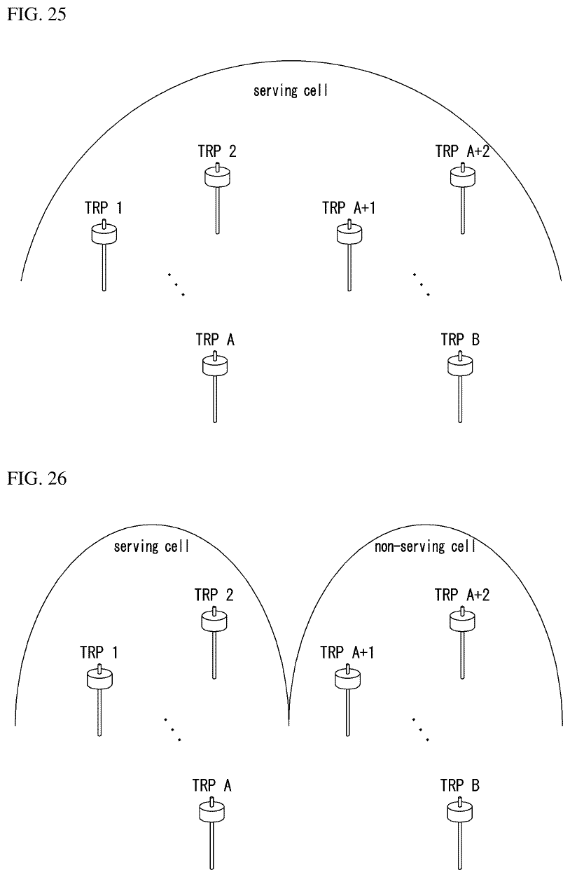

FIG. 25 is a conceptual diagram illustrating a fifth exemplary embodiment of a method for grouping synchronization signal blocks.

Referring to FIG. 25, SSBs (SSB 1 to SSB 8) may be divided into two SSB groups (SSB group 1 and SSB group 2). In this case, the SSB group 1 may include the SSB 1, SSB 3, and SSB 5, and the SSB group 1 may be mapped to TRP 1 to TRP A. Here, A may be a positive integer greater than 1. On the other hand, the SSB group 2 may include the SSB 2, SSB 4, SSB 6, and SSB 8, and the SSB group 2 may be mapped to TRP A+1 to TRP B. The mapping the SSB group 1 to TRP 1 to TRP A may mean that when TRP 1 to TRP A perform SSB sweeping, beamformed SSB s are transmitted in the corresponding directions using only the SSB 1, SSB 3, SSB 5, and SSB 7. Similarly, the mapping the SSB group 2 to TRP A+1 to TRP B may mean that when TRP A+1 to TRP B perform SSB sweeping, beamformed SSBs are transmitted in the corresponding directions using only the SSB 2, SSB 4, SSB 6, and SSB 8. In this case, the number of available SSBs may be 8, but it may may be 4, 16, 64, or the like without being limited thereto. Here, TRP 1 to TRP A and TRP A+1 to TRP B may be included in a serving cell with the same PCI G.

FIG. 26 is a conceptual diagram illustrating a sixth exemplary embodiment of a method for grouping synchronization signal blocks.

Referring to FIG. 26, SSBs (SSB 1 to SSB 8) may be divided into two SSB groups (SSB group 1 and SSB group 2). In this case, the SSB group 1 may include the SSB 1, SSB 3, SSB 5, and SSB 7, and the SSB group 1 may be mapped to TRP 1 to TRP A belonging to a serving cell. On the other hand, the SSB group 2 may include the SSB 2, SSB 4, SSB 6, and SSB 8. The SSB group 2 may be mapped to TRP A+1 to TRP B belonging to a non-serving cell. Here, the mapping the SSB group 1 to TRP 1 to TRP A may mean that when TRP 1 to TRP A perform SSB sweeping, beamformed SSBs are transmitted in the corresponding directions using only the SSB 1, SSB 3, SSB 5, and SSB 7. Similarly, the mapping the SSB group 2 to TRP A+1 to TRP B may mean that when TRP A+1 to TRP B perform SSB sweeping, beamformed SSBs are transmitted in the corresponding directions using only the SSB 2, SSB 4, SSB 6, and SSB 8. In this case, the number of available SSBs may be 8, but it may may be 4, 16, 64, or the like without being limited thereto. Here, TRP 1 to TRP A may belong to a serving cell with a PCI G. TRP A+1 to TRP B may belong to a non-serving cell with a PCI Z. In FIGS. 25 and 26, TRPs in each of the two TRP groups, TRP 1 to TRP A and TRP A+1 to TRP B, are geographically adjacent and may have similar TA values, enabling multi-TRP transmission for a very large number of TRPs.

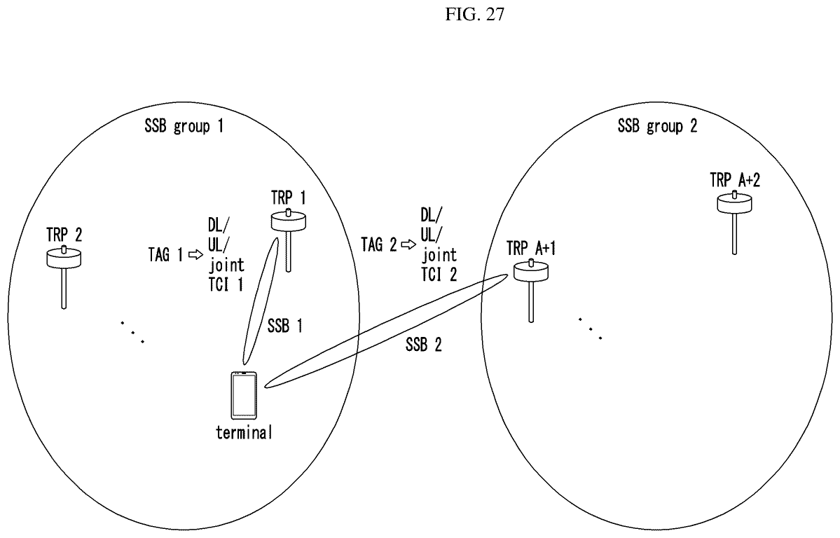

FIG. 27 is a conceptual diagram illustrating a fourth exemplary embodiment of a tag ID configuration method.

Referring to FIG. 27, each SSB group may be mapped to a plurality of TRPs to adjust a TA required for uplink synchronization, and may be associated with one tag ID (e.g. TAG 1, TAG 2, or the like). For example, an SSB group 1 may be associated with a TAG 1, and an SSB group 2 may be associated with a TAG 2. In this case, the TAG 1 may be associated with a joint TCI 1. The TAG 2 may be associated with a joint TCI 2. Since the TAG is managed for each SSB group, the terminal may perform uplink synchronization for each TAG and perform communication when one communication link is established for each of TRP 1 and TRP A+1.

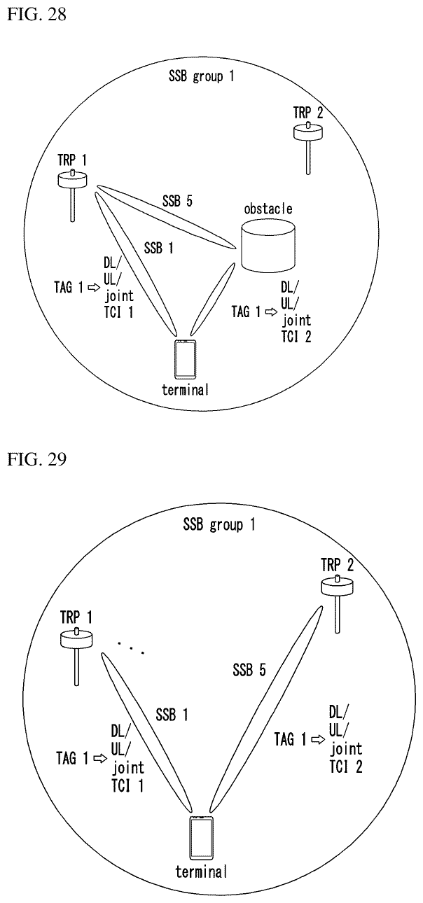

FIG. 28 is a conceptual diagram illustrating a fifth exemplary embodiment of a tag ID configuration method.

Referring to FIG. 28, a terminal may establish two communication links with one TRP 1. In this case, the terminal may establish one communication link with TRP 1 based on an SSB 1. In addition, the terminal may establish another communication link with TRP 1 based on an SSB 5. Two communication links established as described above may have the same TAG 1. Based on the TAG 1, the terminal may perform uplink synchronization for the two communication links and perform communication. Here, one communication link may pass through obstacles. TRP 1 and TRP 2 may be included in the SSB group 1. One link between the terminal and TRP 1 may be associated with the TAG 1 and may be associated with a DL/UL/joint TCI 1. The other link that passes through obstacles between the terminal and TRP 1 may be associated with the TAG 1 and may be associated with a DL/UL/joint TCI 2.

Here, SSBs (SSB 1 to SSB 8) may be divided into two SSB groups (SSB group 1 and SSB group 2). In this case, the SSB group 1 may include the SSB 1, SSB 3, SSB 5, and SSB 7, and the SSB group 1 may be mapped to TRP 1 to TRP A belonging to a serving cell. On the other hand, the SSB group 2 may include the SSB 2, SSB 4, SSB 6, and SSB 8. The SSB group 2 may be mapped to TRP A+1 to TRP B belonging to a non-serving cell. Here, TRP 1 to TRP A may belong to a serving cell with a PCI G. TRP A+1 to TRP B may belong to a non-serving cell with a PCI Z.

FIG. 29 is a conceptual diagram illustrating a sixth exemplary embodiment of a tag ID configuration method.

Referring to FIG. 29, a terminal may establish one communication link with TRP 1 based on an SSB 1. In addition, the terminal may establish another communication link with TRP 2 based on an SSB 5. The two communication links established as described above may have the same TAG 1. The terminal and the TRPs may perform uplink synchronization and communication by assigning the same TAG 1 to the two communication links. TRP 1 and TRP 2 may belong to the SSB group 1. One link between the terminal and TRP 1 may be associated with the TAG 1 and may be associated with a DL/UL/joint TCI 1. The other link between the terminal and TRP 2 may be associated with the TAG 1 and may be associated with a DL/UL/joint TCI 2.

Here, SSBs (SSB 1 to SSB 8) may be divided into two SSB groups (SSB group 1 and SSB group 2). In this case, the SSB group 1 may include the SSB 1, SSB 3, SSB 5, and SSB 7, and the SSB group 1 may be mapped to TRP 1 to TRP A belonging to a serving cell. On the other hand, the SSB group 2 may include the SSB 2, SSB 4, SSB 6, and SSB 8. The SSB group 2 may be mapped to TRP A+1 to TRP B belonging to a non-serving cell. Here, TRP 1 to TRP A may belong to a serving cell with a PCI G. TRP A+1 to TRP B may belong to a non-serving cell with a PCI Z.

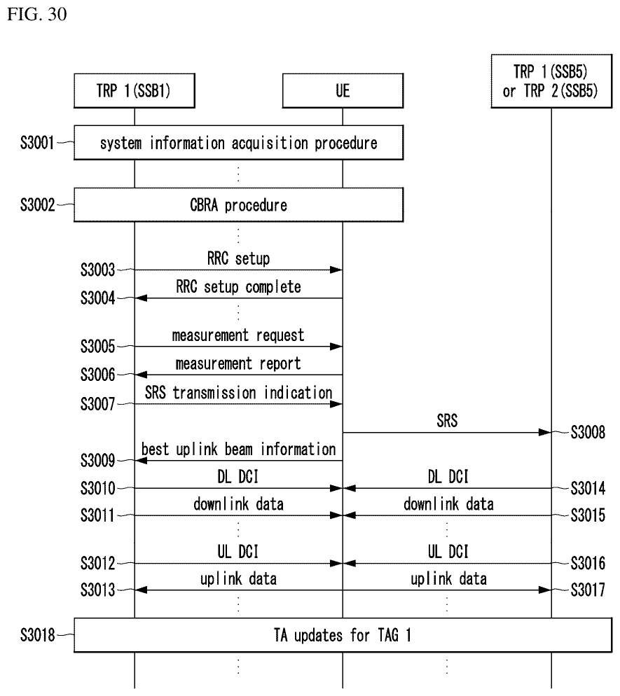

As shown in FIGS. 25 to 29 described above, each SSB group may be mapped to a plurality of TRPs to adjust a TA required for uplink synchronization. One tag ID (e.g. TAG 1, TAG 2, etc.) may be associated with multiple TRPs. As an example, TRP 1 and TRP 2 of the SSB group 1 may be associated with the TAG 1. In this case, the TAG 1 may be associated with a joint TCI 1 or joint TCI 2. Since the TAG is managed for each SSB group, the terminal may perform uplink synchronization and communication when one communication link is established for each of TRP 1 and TRP 2. In the cases of FIGS. 28 and 29, a link configuration method in the multi-TRP communication system may be as shown in FIG. 30 below.

FIG. 30 is a sequence chart illustrating a fifth exemplary embodiment of a link configuration method in a multi-TRP environment.

Referring to FIG. 30, a terminal may establish two communication links with one TRP belonging to one SSB group. Alternatively, the terminal may establish two communication links with two TRPs belonging to one SSB group. The terminal may establish two communication links from an initial access stage. To this end, the terminal may perform SSB beam measurement on beamformed SSBs transmitted from TRP 1. In this case, the terminal may select an SSB 1 as the best SSB (i.e. 1st best SSB) and an SSB 5 as the second best SSB (i.e. 2nd best SSB). The terminal may obtain system information based on the best SSB (S3001). This system information may be carried on a PBCH and PDSCH(s) transmitted in time/frequency resources determined according to the SSB.

The terminal may recognize the SSB 1 as the best SSB through the PBCH. In addition, the terminal may recognize a mapping relationship between SSB groups and TRPs and an association relationship between TAG IDs and SSB groups based on PDSCH(s) including SIB y. TRP may allow the terminal to recognize the relationship between SSB groups and TRPs and the relationship between SSB groups and TAG IDs during an RRC setup procedure after performing a random access procedure. Alternatively, TRP may allow the terminal to recognize the relationship between SSB groups and TRPs and the relationship between SSB groups and TAG IDs through RRC signaling after the RRC setup procedure is completed. Additionally, TRP may not inform the terminal of the relationship between SSB groups and TRPs and the relationship between SSB groups and TAG IDs. Here, the terminal may recognize the relationship between SSB groups and TRPs and the relationship between SSB groups and TAG IDs from the PDSCH including SIBy that is system information.

Then, TRP 1 and the terminal may perform uplink synchronization according to a 4-step or 2-step CBRA process according to an RO according to an indication of an SIB obtained based on the system information (S3002). Here, the RO may refer to an uplink time/frequency resource location for random access. In this process, the terminal may configure a TAG 1 for a communication link with TRP 1. In this manner, the terminal may perform uplink synchronization and update of the uplink synchronization according to configuration of the TAG 1 for the communication link.

Then, TRP 1 may transmit an RRC setup message to the terminal (S3003). The terminal may receive the RRC setup message from TRP 1. Accordingly, the terminal may complete RRC setup and transmit an RRC setup complete message to TRP 1 (S3004). TRP 1 may confirm the RRC setup by receiving the RRC setup complete message from the terminal. Through this process, the terminal may complete system connection with TRP 1. In the connected state, the terminal may communicate with other terminals through TRP 1.

To this end, TRP 1 may transmit downlink-related DCI to the terminal (S3010). Then, the terminal may receive the downlink-related DCI from TRP 1. Here, the downlink-related DCI may indicate a DL/joint TCI 1 indicating a reception configuration of the terminal and a scheduled resource location for data reception of the terminal, and may be transmitted on a PDCCH. Thereafter, TRP 1 may transmit downlink data to the terminal according to the downlink-related DCI (S3011). Then, the terminal may receive the downlink data from TRP 1 based on the downlink-related DCI.

On the other hand, TRP 1 may transmit uplink-related DCI to the terminal (S3012). Then, the terminal may receive the uplink-related DCI from TRP 1. Here, the uplink-related DCI may indicate a UL/joint TCI 1 indicating a transmission configuration of the terminal and a scheduled resource location for data transmission of the terminal, and may be transmitted on a PDCCH. Thereafter, the terminal may transmit uplink data to TRP 1 according to the uplink-related DCI (S3013). Then, TRP 1 may receive the uplink data from the terminal based on the uplink-related DCI.

Meanwhile, the terminal may be in an RRC-connected state. TRP 1 may request measurement from the terminal (S3005). Accordingly, the terminal may perform measurement by receiving SSBs from neighbor TRPs. Additionally, the terminal may report SSB-based measurement results for neighbor TRPs to TRP 1 through RRC signaling (S3006). In this case, the terminal may report the SSB 5 as the second best SSB to TRP 1. Accordingly, TRP 1 may receive the measurement report from the terminal. TRP 1 may recognize the SSB 5 as the second best SSB through the measurement report. In this case, the SSB5 may be included in the SSB group used by TRP 1 and TRP 2. Accordingly, TRP 1 may recognize itself as a TRP transmitting the SSB 5 based on the relationship between SSB groups and TRPs. Alternatively, TRP 1 may recognize TRP 2 as a TRP transmitting the SSB 5 based on the relationship between SSB groups and TRPs. Here, the measurement reporting has been described as being performed by the terminal at the request from TRP 1, but unlike this, the terminal may perform the measurement reporting even without such request.

In this case, the measurement report may include a first SSB index (i.e. the best SSB index), a second SSB index (i.e. the second best SSB index), a third SSB index, etc. In addition, the measurement report may include information on time differences between a reception synchronization point of the current communication link and reception synchronization points of communication links of the second SSB index, the third SSB index, etc.

If the time differences between the reception synchronization point of the current communication link and the reception synchronization points of communication links of the second SSB index, the third SSB index, etc. do not exceed a predetermined threshold, the terminal may request TRP 1 to configure a TAG therefor to be the same as that of the current communication link. On the other hand, if the time differences between the reception synchronization point of the current communication link and the reception synchronization points of communication links of the second SSB index, the third SSB index, etc. exceed the predetermined threshold, the terminal may request TRP 1 to configure a TAG therefor differently from that of the current communication link. If TRP 1 configures the same TAG for the current communication link and other communication links, the load for reverse synchronization and update of the reverse synchronization of the terminal can be reduced.

In addition, the terminal may know the time differences between the reception synchronization point of the current communication link and the reception synchronization points of communication links of the second SSB index, the third SSB index, etc. Therefore, if the time differences between the reception synchronization point of the current communication link and the reception synchronization points of communication links of the second SSB index, the third SSB index, etc. do not exceed the predetermined threshold, the terminal may request a RACH-less second link establishment procedure to TRP. On the other hand, if the time differences between the reception synchronization point of the current communication link and the reception synchronization points of communication links of the second SSB index, the third SSB index, etc. exceed the predetermined threshold, the terminal may request a RACH-based second link establishment procedure to TRP.

Meanwhile, the terminal may report the SSB 5 to TRP 1 as the second best SSB. In this case, the SSB 5 may be included in the same SSB group as the SSB 1. Accordingly, for example, the communication link associated with the SSB 5 may be a different communication link from the communication link associated with the SSB 1, which comes through a multi-path from TRP 1. Alternatively, the communication associated with the SSB 5 may be a communication link from TRP 2. TRP 1 may configure the TAG 1 to the communication link associated with the SSB 5 to perform uplink synchronization and update of the uplink synchronization for the communication link. According to this, through a RACH-less procedure, TRP 1 or TRP 2 and the terminal may perform beam measurement between the terminal and SSB 5 as follows.

To this end, TRP 1 may instruct the terminal to transmit uplink beamformed SR Ss to TRPs using designated scheduled resources (S3007). In this case, TRP 1 may instruct the terminal to transmit SRSs through RRC signaling including information on the designated and scheduled resources for transmitting uplink beamformed SRSs. In this case, TRP 1 may inform neighbor TRPs that the terminal transmits the uplink beamformed SR Ss using the determined scheduled time/frequency resources to suppress interference. Alternatively, TRP 1 may not inform neighbor TRPs that the terminal transmits the uplink beamformed SR Ss using the determined scheduled time/frequency resources for resource efficiency.

Then, the terminal may transmit the beamformed SR Ss to TRPs including TRP 1 and TRP 2 (S3008). TRP 1 and TRP 2 may receive SR Ss from the terminal. In addition, TRP 1 may select the most appropriate uplink beam based on the received SRSs, and TRP 1 may inform the terminal of information on the most appropriate uplink beam (i.e. best uplink beam) (S3009). In other words, TRP 1 may inform the terminal of information on an SRS having the highest SINR among the beamformed SR Ss received from the terminal. Accordingly, the terminal may confirm that the best uplink beam belongs to itself. Through this process, the terminal may complete system connection with TRP 1 through the communication link associated with the SSB 5. In the connected state, the terminal may communicate with other terminals through two communication links of TRP 1.

Alternatively, TRP 2 may select the most appropriate uplink beam based on the received SRSs and inform TRP 1 of information on the most appropriate uplink beam (i.e. best uplink beam). Then, TRP 1 may inform the terminal of information on the most appropriate uplink (i.e. best uplink beam) based on the SR Ss, which is received from TRP 2 (S3009). Accordingly, the terminal may receive the information on the best uplink beam from TRP 1. The terminal may confirm that the best uplink beam belongs to itself. Through this process, the terminal may complete system connection with TRP 2 through the communication link associated with the SSB 5. In the connected state, the terminal may communicate with other terminals through two communication links of TRP 1 and TRP 2.

To this end, TRP 1 or TRP 2 may transmit DCI related to a downlink associated with the SSB 5 to the terminal (S3014). Then, the terminal may receive the downlink-related DCI from TRP 1 or TRP 2. Here, the downlink-related DCI may indicate a DL/joint TCI 2 indicating a reception configuration of the terminal and a scheduled resource location for data reception of the terminal, and may be transmitted on a PDCCH. Thereafter, TRP 1 or TRP 2 may transmit downlink data to the terminal according to the downlink-related DCI (S3015). Then, the terminal may receive the downlink data from TRP 1 or TRP 2 based on the downlink-related DCI.

On the other hand, TRP 1 or TRP 2 may transmit DCI related to an uplink associated with the SSB 5 to the terminal (S3016). Then, the terminal may receive the uplink-related DCI from TRP 1 or TRP 2. Here, the uplink-related DCI may indicate a UL/joint TCI 2 indicating a transmission configuration of the terminal and a scheduled resource location for data transmission of the terminal, and may be transmitted on a PDCCH. Afterwards, the terminal may transmit uplink data to TRP 1 or TRP 2 according to the uplink-related DCI (S3017).

Then, TRP 1 or TRP 2 may receive the uplink data from the terminal based on the uplink-related DCI. Thereafter, the terminal may update the TA by periodically or aperiodically performing uplink synchronization for the TAG 1 with TRP 1 or TRP 2 (S3018). Although FIG. 30 has described the procedure for establishing two communication links, but methods of the present disclosure are not limited thereto. TRP 1 or TRP 2 and the terminal may establishing three or more communication links by applying the method for establishing communication links, which is illustrated in FIG. 30, and perform multi-TRP communication in downlink and uplink.

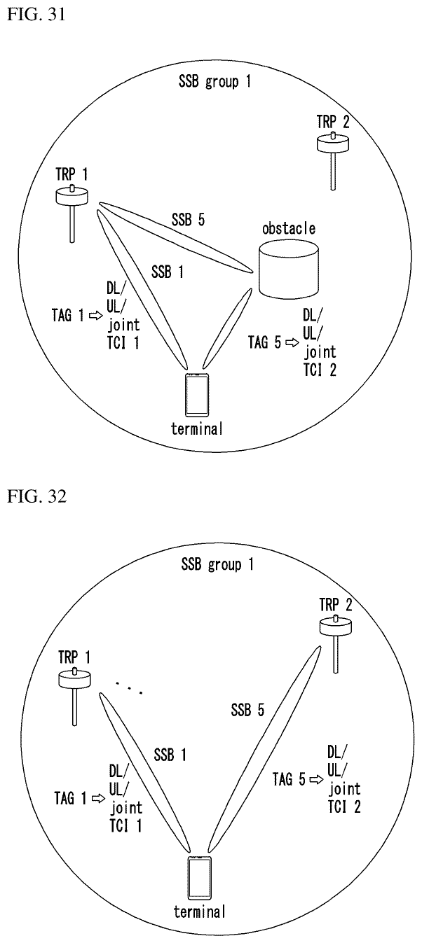

FIG. 31 is a conceptual diagram illustrating a seventh exemplary embodiment of a tag ID configuration method.

Referring to FIG. 31, when establishing two communication links with one TRP, a terminal may perform uplink synchronization and communication by assigning a different TAG to each SSB. Here, one communication link may pass through obstacles. In other words, the terminal may establish two communication links with one TRP 1. In this case, the terminal may establish one communication link with TRP 1 based on an SSB 1. In addition, the terminal may configure the other communication link with TRP 2 based on an SSB 5. The communication link based on the SSB 1 established as described above may have a TAG 1, and the communication link based on the SSB 5 may have a TAG 5. Based on the TAG 1, the terminal may perform uplink synchronization for the communication link and perform communication. In addition, based on the TAG 5, the terminal may perform uplink synchronization for the communication link and perform communication. Here, one communication link may pass through obstacles. TRP 1 and TRP 2 may be included in the SSB group 1. One link between the terminal and TRP 1 may be associated with the TAG 1 and may be associated with a DL/UL/joint TCI 1. In addition, the other link that passes through obstacles between the terminal and TRP 1 may be associated with the TAG 5 and may be associated with a DL/UL/joint TCI 2.

Here, SSBs (SSB 1 to SSB 8) may be divided into two SSB groups (SSB group 1 and SSB group 2). In this case, the SSB group 1 may include the SSB 1, SSB 3, SSB 5, and SSB 7, and the SSB group 1 may be mapped to TRP 1 to TRP A belonging to a serving cell. On the other hand, the SSB group 2 may include the SSB 2, SSB 4, SSB 6, and SSB 8. The SSB group 2 may be mapped to TRP A+1 to TRP B belonging to a non-serving cell. Here, TRP 1 to TRP A may belong to a serving cell with a PCI G. TRP A+1 to TRP B may belong to a non-serving cell with a PCI Z.

FIG. 32 is a conceptual diagram illustrating an eighth exemplary embodiment of a tag ID configuration method.

Referring to FIG. 32, when establishing two communication links with TRP 1 and TRP 2 within one SSB group, the terminal may perform uplink synchronization and communication by assigning a different TAG to each SSB. In other words, the terminal may establish one link with TRP 1 based on an SSB 1. In addition, the terminal may configure the other communication link with TRP 2 based on an SSB 5. The communication link based on the SSB 1 among the two communication links established as described above may have a TAG 1, and the communication link based on the SSB 5 may have a TAG 5. The terminal and TRPs may perform uplink synchronization for the communication link and perform communication by assigning different TAG IDs to the two communication links. TRP 1 and TRP 2 may be included in the SSB group 1. One link between the terminal and TRP 1 may be associated with the TAG 1 and may be associated with a DL/UL/joint TCI 1. In addition, the other link between the terminal and TRP 2 may be associated with the TAG 5 and may be associated with a DL/UL/joint TCI 2.

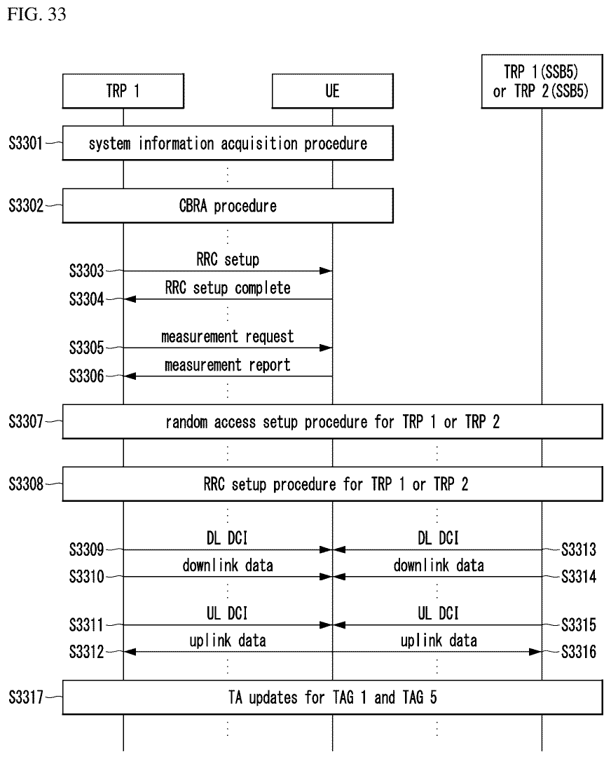

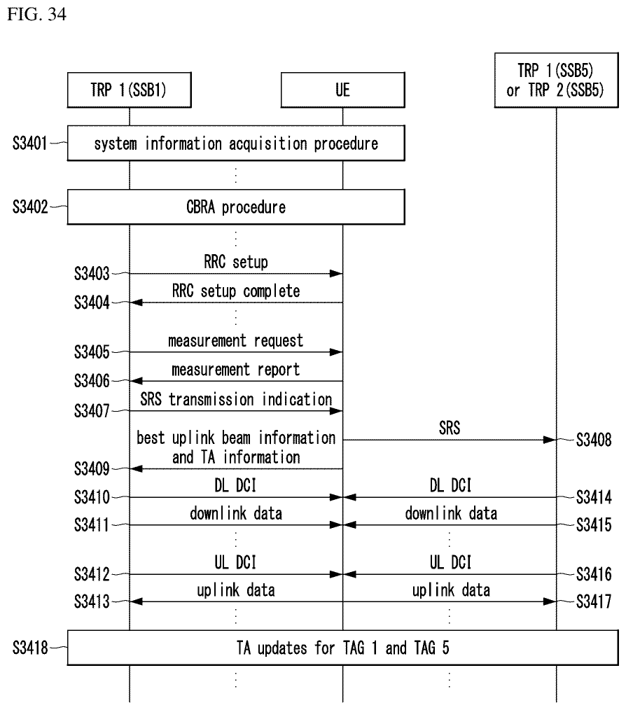

Here, SSBs (SSB 1 to SSB 8) may be divided into two SSB groups (SSB group 1 and SSB group 2). In this case, the SSB group 1 may include the SSB 1, SSB 3, SSB 5, and SSB 7, and the SSB group 1 may be mapped to TRP 1 to TRP A belonging to a serving cell. On the other hand, the SSB group 2 may include the SSB 2, SSB 4, SSB 6, and SSB 8. The SSB group 2 may be mapped to TRP A+1 to TRP B belonging to a non-serving cell. Here, TRP 1 to TRP A may belong to a serving cell with a PCI G. TRP A+1 to TRP B may belong to a non-serving cell with a PCI Z. In the cases of FIGS. 31 and 32, link configuration methods in the multi-TRP communication system may be as shown in FIGS. 33 and 34 below.

FIG. 33 is a sequence chart illustrating a sixth exemplary embodiment of a link configuration method in a multi-TRP environment.

Referring to FIG. 33, a terminal may establish two communication links with one TRP belonging to one SSB group. Alternatively, the terminal may establish two communication links with two TRPs belonging to one SSB group. In this case, the terminal may establish two communication links from an initial access stage. To this end, the terminal may perform SSB beam measurement on beamformed SSBs transmitted from TRP 1. Alternatively, the terminal may perform SSB beam measurement on beamformed SSBs transmitted from TRP 2. In this case, the terminal may select an SSB 1 as the best SSB (i.e. 1st best SSB) and an SSB 5 as the second best SSB (i.e. 2nd best SSB). The terminal may obtain system information based on the best SSB (S3301). This system information may be carried on a PBCH and PDSCH(s) transmitted in time/frequency resources determined according to the SSB.

The terminal may recognize the SSB 1 as the best SSB through the PBCH. In addition, the terminal may recognize a mapping relationship between SSB groups and TRPs and an association relationship between TAG IDs and SSB groups based on PDSCH(s) including SIB y. The TRP may allow the terminal to recognize the relationship between SSB groups and TRPs and the relationship between SSB groups and TAG IDs during an RRC setup procedure after performing a random access procedure. Alternatively, the TRP may allow the terminal to recognize the relationship between SSB groups and TRPs and the relationship between SSB groups and TAG IDs through RRC signaling after the RRC setup procedure is completed. Additionally, the TRP may not inform the terminal of the relationship between SSB groups and TRPs and the relationship between SSB s group and TAG IDs. Here, the terminal may recognize the relationship between SSB groups and TRPs and the relationship between SSB groups and TAG IDs from the PDSCH including SIBy that is system information.

Then, TRP 1 and the terminal may perform uplink synchronization according to a 4-step or 2-step CBRA procedure according to an RO according to an indication of an SIB obtained based on the system information (S3302). Here, the RO may refer to an uplink time/frequency resource location for random access. In this process, the terminal may configure a TAG 1 for a communication link with TRP 1. In this manner, the terminal may perform uplink synchronization and update of the uplink synchronization according to configuration of the TAG 1 for the communication link.

Then, TRP 1 may transmit an RRC setup message to the terminal (S3303). The terminal may receive the RRC setup message from TRP 1. Accordingly, the terminal may complete RRC setup and transmit an RRC setup complete message to TRP 1 (S3304). TRP 1 may confirm the RRC setup by receiving the RRC setup complete message from the terminal. Through this process, the terminal may complete system connection with TRP 1. In the connected state, the terminal may communicate with other terminals through TRP 1.

To this end, TRP 1 may transmit DCI related to a downlink associated with the SSB 1 to the terminal (S3309). Then, the terminal may receive the downlink-related DCI from TRP 1. Here, the downlink-related DCI may indicate a DL/joint TCI 1 indicating a reception configuration of the terminal and a scheduled resource location for data reception of the terminal, and may be transmitted on a PDCCH. Thereafter, TRP 1 may transmit downlink data to the terminal according to the downlink-related DCI (S3310). Then, the terminal may receive the downlink data from TRP 1 based on the downlink-related DCI.

On the other hand, TRP 1 may transmit DCI related to an uplink associated with the SSB 1 to the terminal (S3311). Then, the terminal may receive the uplink-related DCI from TRP 1. Here, the uplink-related DCI may indicate a UL/joint TCI 1 indicating a transmission configuration of the terminal and a scheduled resource location for data transmission of the terminal, and may be transmitted on a PDCCH. Thereafter, the terminal may transmit uplink data to TRP 1 according to the uplink-related DCI (S3312). Then, TRP 1 may receive the uplink data from the terminal based on the uplink-related DCI.

Meanwhile, the terminal may be in an RRC-connected state. TRP 1 may request measurement from the terminal (S3305). Accordingly, the terminal may perform measurement by receiving SSBs from neighbor TRPs. Additionally, the terminal may report SSB-based measurement results for neighbor TRPs to TRP 1 through RRC signaling (S3306). In this case, the terminal may report the SSB 5 as the second best SSB to TRP 1. Accordingly, TRP 1 may receive the measurement report from the terminal. TRP 1 may recognize the SSB 5 as the second best SSB through the measurement report. In this case, the SSB5 may be included in the SSB group used by TRP 1 or TRP 2. Accordingly, TRP 1 may recognize itself as a TRP transmitting the SSB 5 based on the relationship between SSB groups and TRPs. Alternatively, TRP 1 may recognize TRP 2 as a TRP transmitting the SSB 5 based on the relationship between SSB groups and TRPs. Here, the measurement reporting has been described as being performed by the terminal at the request from TRP 1, but unlike this, the terminal may perform the measurement reporting even without such request.

In this case, the measurement report may include a first SSB index (i.e. the best SSB index), a second SSB index (i.e. the second best SSB index), a third SSB index, etc. In addition, the measurement report may include information on time differences between a reception synchronization point of the current communication link and reception synchronization points of communication links of the second SSB index, the third SSB index, etc.

If the time differences between the reception synchronization point of the current communication link and the reception synchronization points of communication links of the second SSB index, the third SSB index, etc. do not exceed a predetermined threshold, the terminal may request TRP 1 to configure a TAG therefor to be the same as that of the current communication link. On the other hand, if the time differences between the reception synchronization point of the current communication link and the reception synchronization points of communication links of the second SSB index, the third SSB index, etc. exceed the predetermined threshold, the terminal may request TRP 1 to configure a TAG therefor differently from that of the current communication link. If TRP 1 configures the same TAG for the current communication link and other communication links, the load for reverse synchronization and update of the reverse synchronization of the terminal can be reduced.

In addition, the terminal may know the time differences between the reception synchronization point of the current communication link and the reception synchronization points of communication links of the second SSB index, the third SSB index, etc. Therefore, if the time differences between the reception synchronization point of the current communication link and the reception synchronization points of communication links of the second SSB index, the third SSB index, etc. do not exceed the predetermined threshold, the terminal may request a RACH-less second link establishment procedure to TRP. On the other hand, if the time differences between the reception synchronization point of the current communication link and the reception synchronization points of communication links of the second SSB index, the third SSB index, etc. exceed the predetermined threshold, the terminal may request a RACH-based second link establishment procedure to TRP.

Meanwhile, the terminal may perform a random access setup procedure with TRP 1 or TRP 2 based on the SSB 5 (S3307). In this process, the terminal may configure a TAG 5 to the communication link with TRP 1 or TRP 2 based on the SSB 5 to perform uplink synchronization and update of the uplink synchronization for the communication link. The random access setup procedure for TRP 1 or TRP 2 may be triggered by TRP. Alternatively, the random access setup procedure for TRP 1 or TRP 2 may be triggered by the terminal.

First, in the triggering method by TRP 1, TRP 1 may trigger the random access setup procedure for TRP 1 or TRP 2 based on the SSB 5 by instructing the terminal to perform a CFRA or CBRA random access procedure through high layer signaling or PDCCH. On the other hand, in the triggering method by the terminal, the terminal may recognize a need to manage another TAG through a random access procedure with TRP 1. Accordingly, the terminal may request random access with TRP 1 or TRP 2 based on the SSB 5 through high layer signaling or a physical layer control channel (i.e. PUSCH, etc.) to trigger the random access setup procedure for TRP 1 or TRP 2.

TRP 1 receiving the request may proceed with the random access setup procedure for TRP 1 or TRP 2 based on the SSB 5 by instructing the terminal to perform a CFRA or CBRA random access procedure through high layer signaling or PDCCH. In this manner, the terminal may receive from TRP 1 the indication for the random access setup procedure for TRP 1 or TRP 2 based on the SSB 5. Accordingly, the terminal and the TRP 1 or TRP 2 may complete the random access setup procedure by performing a random access procedure.

Then, TRP 1 or TRP 2 and the terminal may perform an RRC setup procedure for the communication link established based on the SSB 5 (S3308). In other words, TRP 1 or TRP 2 may transmit an RRC setup message to the terminal. The terminal may receive the RRC setup message from TRP 1 or TRP 2. Accordingly, the terminal may complete RRC setup, and transmit an RRC setup complete message to TRP 1 or TRP 2. TRP 1 or TRP 2 may confirm the RRC setup by receiving the RRC setup complete message from the terminal. Through this process, the terminal may complete system connection to TRP 1 or TRP 2 based on the SSB 5. In the connected state, the terminal may communicate with other terminals through two communication links of TRP 1. Alternatively, in the connected state, the terminal may communicate with other terminals through two communication links of TRP 1 and TRP 2.

To this end, TRP 1 or TRP 2 2 may transmit DCI related to a downlink associated with the SSB 5 to the terminal (S3313). Then, the terminal may receive the DCI related to the downlink associated with the SSB 5 from TRP 1 or TRP 2. Here, the downlink-related DCI may indicates a DL/joint TCI 2 indicating a reception configuration of the terminal and a scheduled resource location for data reception of the terminal, and may be transmitted on a PDCCH. Thereafter, TRP 1 or TRP 2 may transmit downlink data to the terminal according to the downlink-related DCI (S3314). Then, the terminal may receive the downlink data from TRP 1 or TRP 2 based on the downlink-related DCI.

On the other hand, TRP 1 or TRP 2 may transmit uplink-related DCI to the terminal (S3315). Then, the terminal may receive the uplink-related DCI from TRP 1 or TRP 2. Here, the uplink-related DCI may indicate a UL/joint TCI 2 indicating a transmission configuration of the terminal and a scheduled resource location for data transmission of the terminal, and may be transmitted on a PDCCH. Thereafter, the terminal may transmit uplink data to TRP 1 or TRP 2 according to the uplink-related DCI (S3316). Then, TRP 1 or TRP 2 may receive the uplink data from the terminal based on the uplink-related DCI. Then, the terminal may update TAs by performing uplink synchronization for TAG 1 and TAG 5 with TRP 1 or TRP 2 periodically or aperiodically (S3317).

FIG. 34 is a sequence chart illustrating a seventh exemplary embodiment of a link configuration method in a multi-TRP environment.

Referring to FIG. 34, a terminal may establish two communication links with one TRP belonging to one SSB group. Alternatively, the terminal may establish two communication links with two TRPs belonging to one SSB group. In this case, the terminal may establish two communication links from an initial access stage. To this end, the terminal may perform SSB beam measurement on beamformed SSBs transmitted from TRP 1. In this case, the terminal may select an SSB 1 as the best SSB (i.e. 1st best SSB) and an SSB 5 as the second best SSB (i.e. 2nd best SSB). The terminal may obtain system information based on the best SSB (S3401). This system information may be carried on a PBCH and PDSCH(s) transmitted in time/frequency resources determined according to the SSB.

The terminal may recognize the SSB 1 as the best SSB through the PBCH. In addition, the terminal may recognize a mapping relationship between SSB groups and TRPs and an association relationship between TAG IDs and SSB groups based on PDSCH(s) including SIB y. TRP may allow the terminal to recognize the relationship between SSB groups and TRPs and the relationship between SSB groups and TAG IDs during an RRC setup procedure after performing a random access procedure. Alternatively, TRP may allow the terminal to recognize the relationship between SSB groups and TRPs and the relationship between SSB groups and TAG IDs through RRC signaling after the RRC setup procedure is completed. Additionally, the TRP may not inform the terminal of the relationship between SSB groups and TRPs and the relationship between SSB groups and TAG IDs. Here, the terminal may recognize the relationship between SSB groups and TRPs and the relationship between SSB group and TAG ID from the PDSCH including SIBy that is system information.

Then, TRP 1 and the terminal may perform uplink synchronization according to a 4-step or 2-step CBRA procedure according to an RO according to an indication of an SIB obtained based on the system information (S3402). Here, the RO may refer to an uplink time/frequency resource location for random access. In this process, the terminal may configure a TAG 1 for a communication link with TRP 1. In this manner, the terminal may perform uplink synchronization and update of the uplink synchronization according to configuration of the TAG 1 for the communication link.

Then, TRP 1 may transmit an RRC setup message to the terminal (S3403). The terminal may receive the RRC setup message from TRP 1. Accordingly, the terminal may complete RRC setup and transmit an RRC setup complete message to TRP 1 (S3404). TRP 1 may confirm the RRC setup by receiving the RRC setup complete message from the terminal. Through this process, the terminal may complete system connection with TRP 1. In the connected state, the terminal may communicate with other terminals through TRP 1.

To this end, TRP 1 may transmit downlink-related DCI to the terminal (S3410). Then, the terminal may receive the downlink-related DCI from TRP 1. Here, the downlink-related DCI may indicate a DL/joint TCI 1 indicating a reception configuration of the terminal and a scheduled resource location for data reception of the terminal, and may be transmitted on a PDCCH. Thereafter, TRP 1 may transmit downlink data to the terminal according to the downlink-related DCI (S3411). Then, the terminal may receive the downlink data from TRP 1 based on the downlink-related DCI.

On the other hand, TRP 1 may transmit uplink-related DCI to the terminal (S3412). Then, the terminal may receive the uplink-related DCI from TRP 1. Here, the uplink-related DCI may indicate a UL/joint TCI 1 indicating a transmission configuration of the terminal and a scheduled resource location for data transmission of the terminal, and may be transmitted on a PDCCH. Thereafter, the terminal may transmit uplink data to TRP 1 according to the uplink-related DCI (S3413). Then, TRP 1 may receive the uplink data from the terminal based on the uplink-related DCI.

Meanwhile, the terminal may be in an RRC-connected state. TRP 1 may request measurement from the terminal (S3405). Accordingly, the terminal may perform measurement by receiving SSBs from neighbor TRPs. Additionally, the terminal may report SSB-based measurement results for neighbor TRPs to TRP 1 through RRC signaling (S3406). In this case, the terminal may report the SSB 5 as the second best SSB to TRP 1. Accordingly, TRP 1 may receive the measurement report from the terminal. TRP 1 may recognize the SSB 5 as the second best SSB through the measurement report. In this case, the SSB5 may be included in the SSB group used by TRP 1 and TRP 2. Accordingly, TRP 1 may recognize itself as a TRP transmitting the SSB 5 based on the relationship between SSB groups and TRPs. Alternatively, TRP 1 may recognize TRP 2 as a TRP transmitting the SSB 5 based on the relationship between SSB groups and TRPs. Here, the measurement reporting has been described as being performed by the terminal at the request from TRP 1, but unlike this, the terminal may perform the measurement reporting even without such request.

In this case, the measurement report may include a first SSB index (i.e. the best SSB index), a second SSB index (i.e. the second best SSB index), a third SSB index, etc. In addition, the measurement report may include information on time differences between a reception synchronization point of the current communication link and reception synchronization points of communication links of the second SSB index, the third SSB index, etc.

If the time differences between the reception synchronization point of the current communication link and the reception synchronization points of communication links of the second SSB index, the third SSB index, etc. do not exceed a predetermined threshold, the terminal may request TRP 1 to configure a TAG therefor to be the same as that of the current communication link. On the other hand, if the time differences between the reception synchronization point of the current communication link and the reception synchronization points of communication links of the second SSB index, the third SSB index, etc. exceed the predetermined threshold, the terminal may request TRP 1 to configure a TAG therefor differently from that of the current communication link. If TRP 1 configures the same TAG for the current communication link and other communication links, the load for reverse synchronization and update of the reverse synchronization of the terminal can be reduced.

In addition, the terminal may know the time differences between the reception synchronization point of the current communication link and the reception synchronization points of communication links of the second SSB index, the third SSB index, etc. Therefore, if the time differences between the reception synchronization point of the current communication link and the reception synchronization points of communication links of the second SSB index, the third SSB index, etc. do not exceed the predetermined threshold, the terminal may request a RACH-less second link establishment procedure to TRP. On the other hand, if the time differences between the reception synchronization point of the current communication link and the reception synchronization points of communication links of the second SSB index, the third SSB index, etc. exceed the predetermined threshold, the terminal may request a RACH-based second link establishment procedure to TRP.

Meanwhile, the terminal may report the SSB 5 to TRP 1 as the second best SSB. In this case, the SSB 5 may be included in the same SSB group as the SSB 1. Accordingly, for example, the communication link associated with the SSB 5 may be a communication link different from the communication link associated with the SSB 1, which comes through a multi-path from TRP 1. Alternatively, the communication associated with the SSB 5 may be a communication link from TRP 2. TRP 1 may configure a TAG 5 to the communication associated with the SSB 5 to perform uplink synchronization and update of the uplink synchronization for the communication link. Accordingly, through a RACH-less procedure, TRP 1 or TRP 2 and the terminal may perform beam measurement between the terminal and SSB5 as follows.

To this end, TRP 1 may instruct the terminal to transmit uplink beamformed SRSs to TRPs using designated scheduled resources (S3407). In this case, TRP 1 may indicate the terminal to transmit SR Ss through RRC signaling including information on the designated scheduled resources for transmitting uplink beamformed SRSs. In this case, TRP 1 may inform neighbor TRPs that the terminal transmits the uplink beamformed SRSs using the determined scheduled time/frequency resources to suppress interference. Alternatively, TRP 1 may not inform neighbor TRPs that the terminal transmits the uplink beamformed SRSs using the determined scheduled time/frequency resources for resource efficiency.

Then, the terminal may transmit the beamformed SR Ss to TRPs including TRP 1 and TRP 2 (S3408). TRP 1 or TRP 2 may receive SRSs from the terminal. In addition, TRP 1 may select the most appropriate uplink beam based on the received SRSs and estimate a TA, and inform the terminal of information on the most appropriate uplink beam (i.e. best uplink beam) and information on the estimated TA (S3409). In other words, TRP 1 may inform the terminal of information on an SRS having the highest SINR among the beamformed SRSs received from the terminal.

Alternatively, TRP 2 may select the most appropriate uplink beam based on the received SRSs, estimate a TA, and may inform TRP 1 of information on the most appropriate uplink beam (i.e. best uplink beam) and the estimated TA. Then, TRP 1 may inform the terminal of information on the most appropriate uplink beam (i.e. best uplink beam) and the estimated TA based on the SRSs received from TRP 2. Accordingly, the terminal may receive the best uplink beam information and TA information from TRP 1. The terminal may confirm that the best uplink beam belongs to itself. Through this process, the terminal may complete system connection with TRP 1 and TRP 2 through the communication link associated with the SSB 5. In the connected state, the terminal may communicate with other terminals through two communication links of TRP 1. Alternatively, in the connected state, the terminal may communicate with other terminals through two communication links of TRP 1 and TRP 2.

To this end, TRP 1 or TRP 2 may transmit DCI related to a downlink associated with the SSB 5 to the terminal (S3414). Then, the terminal may receive the downlink-related DCI from TRP 1 or TRP 2. Here, the downlink-related DCI may indicate a DL/joint TCI 2 indicating a reception configuration of the terminal and a scheduled resource location for data reception of the terminal, and may be transmitted on a PDCCH. Thereafter, TRP 1 or TRP 2 may transmit downlink data to the terminal according to the downlink-related DCI (S3415). Then, the terminal may receive the downlink data from TRP 1 or TRP 2 based on the downlink-related DCI.

On the other hand, TRP 1 or TRP 2 may transmit DCI related to an uplink associated with the SSB 5 to the terminal (S3416). Then, the terminal may receive the uplink-related DCI from TRP 1 or TRP 2. Here, the uplink-related DCI may indicate a UL/joint TCI 2 indicating a transmission configuration of the terminal and a scheduled resource location for data transmission of the terminal, and may be transmitted on a PDCCH. Thereafter, the terminal may transmit uplink data to TRP 1 or TRP 2 according to the uplink-related DCI (S3417).

Then, TRP 1 or TRP 2 may receive the uplink data from the terminal based on the uplink-related DCI. Thereafter, the terminal may update the TA by periodically or aperiodically performing uplink synchronization for the TAG 1 and TAG 5 with TRP 1 or TRP 2 (S3418). Although FIGS. 33 and 34 have described the procedure for establishing two communication links, but methods of the present disclosure are not limited thereto. TRP 1 or TRP 2 and the terminal may establish three or more communication links by applying the methods for establishing communication links, which are illustrated in FIGS. 33 and 34, and perform multi-TRP communication in downlink and uplink.

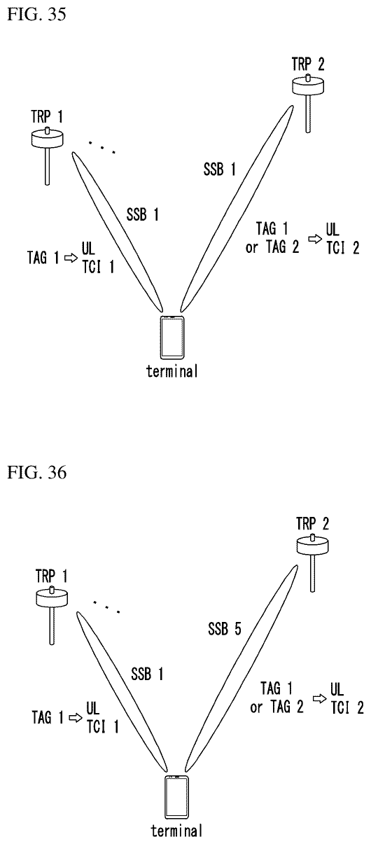

FIG. 35 is a conceptual diagram illustrating a ninth exemplary embodiment of a tag ID configuration method.

Referring to FIG. 35, TRPs may share all SSBs for uplink synchronization. In other words, TRPs may use all SSBs in duplicate and may associate a TAG ID with SSB(s) by triggering of the terminal. As an example, TRP 1 may establish a communication link with the terminal using an SSB 1. In addition, TRP 2 may also establish a communication link with the terminal using the SSB 1. In this case, the communication link established between TRP 1 and the terminal using the SSB 1 may use a TAG 1. The communication link established between TRP 2 and the terminal using the SSB 1 may use the TAG 1 or a TAG 2. Here, the TAG 1 may be associated with a TCI 1, and the TAG 2 may be associated with a TCI 2.

FIG. 36 is a conceptual diagram illustrating a tenth exemplary embodiment of a tag ID configuration method.

Referring to FIG. 36, TRPs may share all SSBs for uplink synchronization. In other words, TRPs may use all SSBs in duplicate and may associate a TAG ID with SSB(s) by triggering of the terminal. As an example, TRP 1 may establish a communication link with the terminal using an SSB 1. In addition, TRP 2 may also establish a communication link with the terminal using an SSB 5. In this case, the communication link established between TRP 1 and the terminal using the SSB 1 may use a TAG 1. The communication link established between TRP 2 and the terminal using the SSB 5 may use the TAG 1 or a TAG 2. Here, the TAG 1 may be associated with a TCI 1, and the TAG 2 may be associated with a TCI 2.

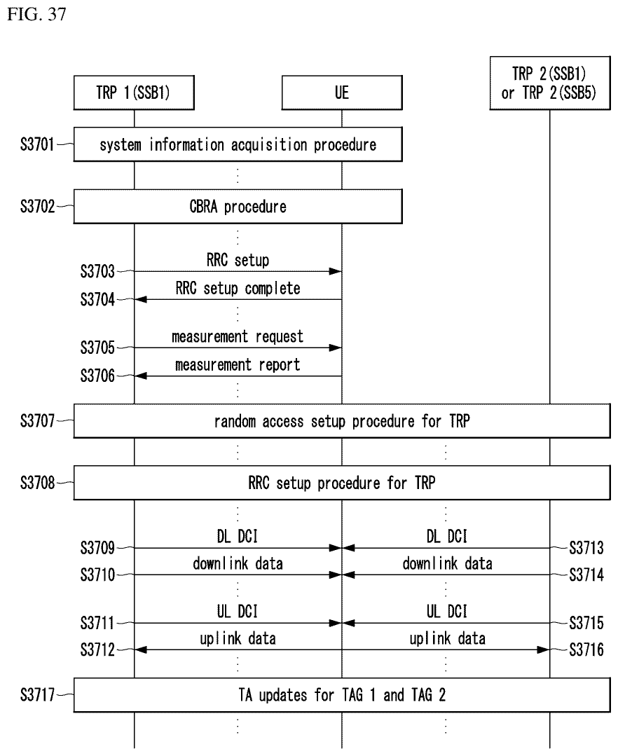

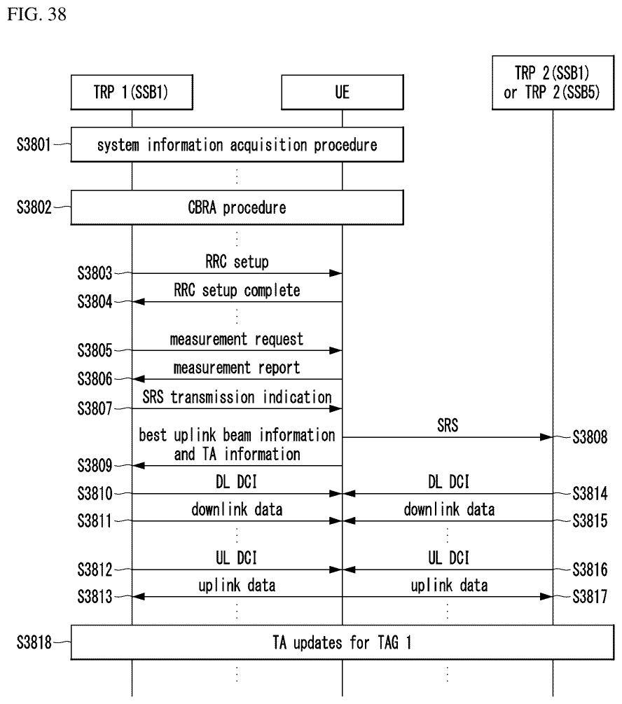

Here, although the SSB 5 has been described as belonging to TRP 2, which is distinct from TRP 1, but this may be merely one example. The SSB 5 may correspond to a multipath link belonging to TRP 1. In the cases of FIGS. 35 and 36, the link establishment method in the multi-TRP communication system may be as shown in FIGS. 37 and 38 below.

FIG. 37 is a sequence chart illustrating an eighth exemplary embodiment of a link configuration method in a multi-TRP environment.

Referring to FIG. 37, a terminal may establish a communication link with each of TRP 1 and TRP 2 based on the same SSB 1 of two different TRP 1 and TRP 2. Alternatively, the terminal may establish a communication link with each of TRP 1 and TRP 2 based on different SSB 1 and SSB 5 of two different TRP 1 and TRP 2. In this case, the terminal may establish two communication links from an initial access stage. To this end, the terminal may perform SSB beam measurement on beamformed SSBs transmitted from each TRP among TRP 1 and TRP 2. In this case, the terminal may select an SSB 1 transmitted from TRP 1 as the best SSB, and the SSB 1 or SSB 5 transmitted from TRP 2 as the second best SSB.

The terminal may detect the same SSB index from different reception beams. In this case, the terminal may know that the same SSB index is used in different TRPs. Accordingly, the terminal may recognize the same SSB 1 as the best SSB and the second best SSB. Alternatively, the terminal may not arbitrarily determine the same SSB 1 received through different reception beams as the best SSB and the second best SSB. In this case, TRP 1 may allow the terminal to report only one SSB 1. Alternatively, TRP 1 may allow the terminal to report the two instances of the SSB 1 by discriminating them into the best SSB and the second best SSB, as described above. In this case, TRP 1 may establish two communication links through the same process as the process of establishing communication links with two different SSBs.

Meanwhile, the terminal may obtain system information based on the best SSB (S3701). This system information may be carried on a PBCH and PDSCH(s) transmitted in time/frequency resources determined according to the SSB. The terminal may recognize the SSB 1 as the best SSB through the PBCH. In addition, the terminal may recognize a mapping relationship between SSB groups and TRPs and an association relationship between TAG IDs and SSB groups based on PDSCH(s) including SIB y. TRP may allow the terminal to recognize the relationship between SSB groups and TRPs and the relationship between SSB groups and TAG IDs during an RRC setup procedure after performing a random access procedure. Alternatively, the TRP may allow the terminal to recognize the relationship between SSB groups and TRPs and the relationship between SSB groups and TAG IDs through RRC signaling after the RRC setup procedure is completed. Additionally, the TRP may not inform the terminal of the relationship between SSB groups and TRPs and the relationship between SSB groups and TAG IDs. Here, the terminal may recognize the relationship between SSB groups and TRPs and the relationship between SSB groups and TAG IDs from the PDSCH including SIBy that is system information.

Then, TRP 1 and the terminal may perform uplink synchronization according to a 4-step or 2-step CBRA process according to an RO according to an indication of an SIB obtained based on the system information (S3702). Here, the RO may refer to an uplink time/frequency resource location for random access. In this process, the terminal may configure a TAG 1 for a communication link with TRP 1. In this manner, the terminal may perform uplink synchronization and update of the uplink synchronization according to configuration of the TAG 1 for the communication link.

Then, TRP 1 may transmit an RRC setup message to the terminal (S3703). The terminal may receive the RRC setup message from TRP 1. Accordingly, the terminal may complete RRC setup and transmit an RRC setup complete message to TRP 1 (S3704). TRP 1 may confirm the RRC setup by receiving the RRC setup complete message from the terminal. Through this process, the terminal may complete system connection with TRP 1. In the connected state, the terminal may communicate with other terminals through TRP 1.

To this end, TRP 1 may transmit downlink-related DCI to the terminal (S3709). Then, the terminal may receive the downlink-related DCI from TRP 1. Here, the downlink-related DCI may indicate a DL/joint TCI 1 indicating a reception configuration of the terminal and a scheduled resource location for data reception of the terminal, and may be transmitted on a PDCCH. Thereafter, TRP 1 may transmit downlink data to the terminal according to the downlink-related DCI (S3710). Then, the terminal may receive the downlink data from TRP 1 based on the downlink-related DCI.

On the other hand, TRP 1 may transmit uplink-related DCI to the terminal (S3711). Then, the terminal may receive the uplink-related DCI from TRP 1. Here, the uplink-related DCI may indicate a UL/joint TCI 1 indicating a transmission configuration of the terminal and a scheduled resource location for data transmission of the terminal, and may be transmitted on a PDCCH. Thereafter, the terminal may transmit uplink data to TRP 1 according to the uplink-related DCI (S3712). Then, TRP 1 may receive the uplink data from the terminal based on the uplink-related DCI. In this case, TRP 1 may associate a TCI 1 with the TAG 1.

Meanwhile, the terminal may be in an RRC-connected state. TRP 1 may request measurement from the terminal (S3705). Accordingly, the terminal may perform measurement by receiving SSBs from neighbor TRPs. Additionally, the terminal may report SSB-based measurement results for neighbor TRPs to TRP 1 through RRC signaling (S3706). In this case, the terminal may report the SSB 1 or SSB 5 transmitted from TRP 2 to TRP 1 as the second best SSB. Accordingly, TRP 1 may receive the measurement report from the terminal. TRP 1 may recognize the SSB 1 or SSB 5 transmitted from TRP 2 as the second best SSB through the measurement report.

In this case, the measurement report may include a first SSB index (i.e. the best SSB index), a second SSB index (i.e. the second best SSB index), a third SSB index, etc. In addition, the measurement report may include information on time differences between a reception synchronization point of the current communication link and reception synchronization points of communication links of the second SSB index, the third SSB index, etc.

If the time differences between the reception synchronization point of the current communication link and the reception synchronization points of communication links of the second SSB index, the third SSB index, etc. do not exceed a predetermined threshold, the terminal may request TRP 1 to configure a TAG therefor to be the same as that of the current communication link. On the other hand, if the time differences between the reception synchronization point of the current communication link and the reception synchronization points of communication links of the second SSB index, the third SSB index, etc. exceed the predetermined threshold, the terminal may request TRP 1 to configure a TAG therefor differently from that of the current communication link. If TRP 1 configures the same TAG for the current communication link and other communication links, the load for reverse synchronization and update of the reverse synchronization of the terminal can be reduced.

In addition, the terminal may know the time differences between the reception synchronization point of the current communication link and the reception synchronization points of communication links of the second SSB index, the third SSB index, etc. Therefore, if the time differences between the reception synchronization point of the current communication link and the reception synchronization points of communication links of the second SSB index, the third SSB index, etc. do not exceed the predetermined threshold, the terminal may request a RACH-less second link establishment procedure to TRP. On the other hand, if the time differences between the reception synchronization point of the current communication link and the reception synchronization points of communication links of the second SSB index, the third SSB index, etc. exceed the predetermined threshold, the terminal may request a RACH-based second link establishment procedure to TRP.

Meanwhile, TRP 1 may receive measurement information from the terminal. Alternatively, TRP 1 may obtain capability information of the terminal through a communication link between the terminal and TRP 1 based on the SSB 1. In addition, TRP 1 may accept the measurement information or request from the terminal if TRP 1 can trust the terminal considering the terminal's capability. TRP 1 may not accept the measurement information or request from the terminal if TRP 1 cannot trust the terminal considering the terminal's capability.

Then, as an example, the time difference between the reception synchronization points of the second best SSB index in the measurement information may be greater than a predetermined threshold. Alternatively, TRP 1 may receive a request from the terminal to establish a communication link based on a RACH. In cases like this, TRP 1 may trigger random access. The terminal may establish a communication link through the SSB 1 or SSB 5 of TRP 2 through a random access procedure. Then, the terminal may configure a TAG 2 for the communication link established through the SSB 1 or SSB 5 of TRP 2 for uplink synchronization and update of the uplink synchronization, and associate a UL TCI 2 with the TAG 2. Association information between the TAG 2 and UL TCI 2 (e.g. mapping/association information between TAG IDs and UL TCI(s)) may be, for example, notified by TRP 1 to the terminal before, after, or while establishing the RACH-based communication link.

Then, the terminal may perform a random access setup procedure with TRP 2 (S3707). In this process, the terminal may configure the TAG 2 to the communication link with TRP 2 for uplink synchronization and update of the uplink synchronization for the communication link with TRP 2. The random access setup procedure for TRP 2 may be triggered by TRP 1. TRP 1 may trigger the random access setup procedure for TRP 2 by instructing the terminal to perform a CFRA or CBRA random access procedure through high layer signaling or a PDCCH. Optionally, TRP 1 may instruct neighbor TRPs to perform estimation and reporting of time/frequency resources related to random access.

In other words, the terminal receiving the indication from TRP 1 may perform a CFRA random access procedure for the second communication link (e.g. link between the terminal and TRP 2 (i.e. SSB 1/SSB 5)). In this case, based on a direction pointed by the second communication link (i.e. based on a transmission beam direction corresponding to a reception beam direction of the second communication link obtained during the SSB sweeping procedure), the terminal may transmit a preamble in a time/frequency resource location of an indicated RO. In this case, the terminal may transmit the preamble in a downlink synchronized state of the first communication link (i.e. link between the terminal and TRP 1 (SSB 1)). Alternatively, the terminal may know information on a time difference of reception synchronization points between the first communication link and the second best SSB. Therefore, by reflecting information on the time difference, the terminal may perform downlink synchronization between the terminal and the second best SSB (e.g. TRP 2 (SSB 1/SSB 5)) and transmit beamformed SRSs to TRP 2. In the case of a two-step random access procedure, an entity transmitting an RAR may be TRP 1, which established the first communication link. Alternatively, in the case of a two-step random access procedure, the entity transmitting the RAR may be TRP 2, which established the second communication link.

Then, TRP 2 and the terminal may perform an RRC setup procedure (S3708). In other words, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 1 and TRP 2. In other words, once the connection with the link between the terminal and TRP 2 (SSB 1/SSB 5) is established, the terminal may communicate with other terminals through communication links based on the SSB 1 of TRP 1 and the SSB 1/SSB 5 of TRP 2. On the SSB 1/SSB 5-based communication link of TRP 2, the terminal may transmit and receive data beamformed according to DCI that indicates a DL/UL/Joint TCI 2 indicating a transmission configuration and a scheduled resource location for data transmission and reception and is transmitted on a PDCCH.

To this end, TRP 2 may transmit downlink-related DCI to the terminal (S3713). Then, the terminal may receive the downlink-related DCI from TRP 2. Here, the downlink-related DCI may indicate a DL/joint TCI 2 indicating a reception configuration of the terminal and a scheduled resource location for data reception of the terminal, and may be transmitted on a PDCCH. Thereafter, TRP 2 may transmit downlink data to the terminal according to the downlink-related DCI (S3714). Then, the terminal may receive the downlink data from TRP 2 based on the downlink-related DCI.

On the other hand, TRP 2 may transmit uplink-related DCI to the terminal (S3715). Then, the terminal may receive the uplink-related DCI from TRP 2. Here, the uplink-related DCI may indicate a UL/joint TCI 2 indicating a transmission configuration of the terminal and a scheduled resource location for data transmission of the terminal, and may be transmitted on a PDCCH. Thereafter, the terminal may transmit uplink data to TRP 2 according to the uplink-related DCI (S3716). Then, TRP 2 may receive the uplink data from the terminal based on the uplink-related DCI. Afterwards, the terminal may update the TAs by periodically or aperiodically performing uplink synchronization with TRP 1 or TRP 2 for the TAG 1 and TAG 2 (S3717).

FIG. 38 is a sequence chart illustrating a ninth exemplary embodiment of a link configuration method in a multi-TRP environment.

Referring to FIG. 38, a terminal may establish a communication link with each of TRP 1 and TRP 2 based on the same SSB 1 of two different TRP 1 and TRP 2. Alternatively, the terminal may establish a communication link with each of TRP 1 and TRP 2 based on different SSB 1 and SSB 5 of two different TRP 1 and TRP 2. In this case, the terminal may select an SSB 1 transmitted from TRP 1 as the best SSB, and the SSB 1 or SSB 5 transmitted from TRP 2 as the second best SSB. The terminal may detect the same SSB index from different reception beams. In this case, the terminal may know that the same SSB indexes are used by different TRPs. Accordingly, the terminal may recognize the same SSB 1 as the best SSB and the second best SSB. Alternatively, the terminal may not arbitrarily determine the same SSB 1 received through different reception beams as the best SSB and the second best SSB. In this case, TRP 1 may allow the terminal to report only one SSB 1. Alternatively, TRP 1 may allow the terminal to report the two instances of the SSB 1 by discriminating them into the best SSB and the second best SSB, as described above. In this case, TRP 1 may establish two communication links through the same process as the process of establishing communication links with two different SSBs.

Meanwhile, the terminal may obtain system information based on the best SSB (S3801). This system information may be carried on a PB CH and PDSCH(s) transmitted in time/frequency resources determined according to the SSB. The terminal may recognize the SSB 1 as the best SSB through the PBCH. In addition, the terminal may recognize a mapping relationship between SSB groups and TRPs and an association relationship between TAG IDs and SSB groups based on PDSCH(s) including SIB y. TRP may allow the terminal to recognize the relationship between SSB groups and TRPs and the relationship between SSB groups and TAG IDs during an RRC setup procedure after performing a random access procedure. Alternatively, TRP may allow the terminal to recognize the relationship between SSB groups and TRPs and the relationship between SSB groups and TAG IDs through RRC signaling after the RRC setup procedure is completed. Additionally, TRP may not inform the terminal of the relationship between SSB groups and TRPs and the relationship between SSB groups and TAG IDs. Here, the terminal may recognize the relationship between SSB groups and TRPs and the relationship between SSB groups and TAG IDs from the PDSCH including SIBy that is system information.

Then, TRP 1 and the terminal may perform uplink synchronization according to a 4-step or 2-step CBRA process using an RO according to an indication of an SIB obtained based on the system information (S3802). Here, the RO may refer to an uplink time/frequency resource location for random access. In this process, the terminal may configure a TAG 1 for a communication link with TRP 1. In this manner, the terminal may perform uplink synchronization and update of the uplink synchronization according to configuration of the TAG 1 for the communication link.

Then, TRP 1 may transmit an RRC setup message to the terminal (S3803). The terminal may receive the RRC setup message from TRP 1. Accordingly, the terminal may complete RRC setup and transmit an RRC setup complete message to TRP 1 (S3804). TRP 1 may confirm the RRC setup by receiving the RRC setup complete message from the terminal. Through this process, the terminal may complete system connection to TRP 1. In the connected state, the terminal may communicate with other terminals through TRP 1.

To this end, TRP 1 may transmit downlink-related DCI to the terminal (S3811). Then, the terminal may receive the downlink-related DCI from TRP 1. Here, the downlink-related DCI may indicate a DL/joint TCI 1 indicating a reception configuration of the terminal and a scheduled resource location for data reception of the terminal, and may be transmitted on a PDCCH. Thereafter, TRP 1 may transmit downlink data to the terminal according to the downlink-related DCI (S3812). Then, the terminal may receive the downlink data from TRP 1 based on the downlink-related DCI.

On the other hand, TRP 1 may transmit uplink-related DCI to the terminal (S3813). Then, the terminal may receive the uplink-related DCI from TRP 1. Here, the uplink-related DCI may indicate a UL/joint TCI 1 indicating a transmission configuration of the terminal and a scheduled resource location for data transmission of the terminal, and may be transmitted on a PDCCH. Thereafter, the terminal may transmit uplink data to TRP 1 according to the uplink-related DCI (S3814). Then, TRP 1 may receive the uplink data from the terminal based on the uplink-related DCI. In this case, TRP 1 may associate a TCI 1 with the TAG 1.

Meanwhile, the terminal may be in an RRC-connected state. TRP 1 may request measurement from the terminal (S3805). Accordingly, the terminal may perform measurement by receiving SSBs from neighbor TRPs. Additionally, the terminal may report SSB-based measurement results for neighbor TRPs to TRP 1 through RRC signaling (S3806). In this case, the terminal may report the SSB 1 or SSB 5 as the second best SSB to TRP 1. Accordingly, TRP 1 may receive the measurement report from the terminal. TRP 1 may recognize the SSB 1 or SSB 5 as the second best SSB through the measurement report.

In this case, the measurement report may include a first SSB index (i.e. the best SSB index), a second SSB index (i.e. the second best SSB index), a third SSB index, etc. In addition, the measurement report may include information on time differences between a reception synchronization point of the current communication link and reception synchronization points of communication links of the second SSB index, the third SSB index, etc.

If the time differences between the reception synchronization point of the current communication link and the reception synchronization points of communication links of the second SSB index, the third SSB index, etc. do not exceed a predetermined threshold, the terminal may request TRP 1 to configure a TAG therefor to be the same as that of the current communication link. On the other hand, if the time differences between the reception synchronization point of the current communication link and the reception synchronization points of communication links of the second SSB index, the third SSB index, etc. exceed the predetermined threshold, the terminal may request TRP 1 to configure a TAG therefor differently from that of the current communication link. If TRP 1 configures the same TAG for the current communication link and other communication links, the load for reverse synchronization and update of the reverse synchronization of the terminal can be reduced.

In addition, the terminal may know the time differences between the reception synchronization point of the current communication link and the reception synchronization points of communication links of the second SSB index, the third SSB index, etc. Therefore, if the time differences between the reception synchronization point of the current communication link and the reception synchronization points of communication links of the second SSB index, the third SSB index, etc. do not exceed the predetermined threshold, the terminal may request a RACH-less second link establishment procedure to TRP. On the other hand, if the time differences between the reception synchronization point of the current communication link and the reception synchronization points of communication links of the second SSB index, the third SSB index, etc. exceed the predetermined threshold, the terminal may request a RACH-based second link establishment procedure to TRP.

Meanwhile, TRP 1 may receive measurement information from the terminal. Alternatively, TRP 1 may obtain capability information of the terminal through a communication link between the terminal and TRP 1 based on the SSB 1. In addition, TRP 1 may accept the measurement information or request from the terminal if TRP 1 can trust the terminal considering the terminal's capability. TRP 1 may not accept the measurement information or request from the terminal if TRP 1 cannot trust the terminal considering the terminal's capability.

As an example, the time difference between the reception synchronization points of the second best SSB index in the measurement information may be less than a predetermined threshold. Alternatively, TRP 1 may receive a request from the terminal to establish a communication link without RACH. Accordingly, through a RACH-less procedure, TRP 2 and the terminal may perform beam measurement between the terminal and SSB 5 as follows.

To this end, TRP 1 may instruct the terminal to transmit uplink beamformed SRSs to TRPs using designated scheduled resources (S3807). In this case, TRP 1 may instruct the terminal to transmit SR Ss through RRC signaling including information on the designated scheduled resources for transmitting uplink beamformed SRSs. In this case, TRP 1 may inform neighbor TRPs that the terminal transmits the uplink beamformed SRSs using the determined scheduled time/frequency resources to suppress interference. Alternatively, TRP 1 may not inform neighbor TRPs that the terminal transmits the uplink beamformed SRSs using the determined scheduled time/frequency resources for resource efficiency.

Then, the terminal may transmit the beamformed SR Ss to TRPs including TRP 2 (S3808). Then, TRP 2 may receive the SRSs from the terminal. TRP 2 may select the most appropriate uplink beam and estimate a TA based on the received SRSs. Afterwards, TRP 2 may inform TRP 1 of information on the most appropriate uplink beam (i.e. the best uplink beam) and the estimated TA. Then, TRP 1 may inform the terminal of information on the most appropriate uplink beam (i.e. the best uplink beam) received from TRP 2 and the estimated TA (S3809). In other words, TRP 1 may inform the terminal of information on an SRS having the highest SINR among the beamformed SR Ss received by TRP 2 from the terminal. Accordingly, the terminal may receive the information on the best uplink beam and the information on the TA from TRP 1. The terminal may confirm that the best uplink beam belongs to itself. Through this process, the terminal may complete system connection to TRP 2 through the communication link associated with the SSB 1 or SSB 5. In this process, the terminal may configure TAG 1 on the communication link with TRP 2. In this manner, the terminal may perform uplink synchronization and update of the uplink synchronization according to configuration of TAG 1 for the communication link. In the connected state, the terminal may communicate with other terminals through two communication links with TRP 1 and TRP 2.

To this end, TRP 2 may transmit DCI related to a downlink associated with the SSB 1 or SSB 5 to the terminal (S3814). Then, the terminal may receive the downlink-related DCI from TRP 1. Here, the downlink-related DCI may indicate a DL/joint TCI 2 indicating a reception configuration of the terminal and a scheduled resource location for data reception of the terminal, and may be transmitted on a PDCCH. Thereafter, TRP 2 may transmit downlink data to the terminal according to the downlink-related DCI (S3815). Then, the terminal may receive the downlink data from TRP 2 based on the downlink-related DCI.

On the other hand, TRP 2 may transmit DCI related to an uplink associated with the SSB 1 or SSB 5 to the terminal (S3816). Then, the terminal may receive the uplink-related DCI from TRP 2. Here, the uplink-related DCI may indicate a UL/joint TCI 2 indicating a transmission configuration of the terminal and a scheduled resource location for data transmission of the terminal, and may be transmitted on a PDCCH. Thereafter, the terminal may transmit uplink data to TRP 2 according to the uplink-related DCI (S3817).

Then, TRP 2 may receive the uplink data from the terminal based on the uplink-related DCI. Afterwards, the terminal may update the TAs by periodically or aperiodically performing uplink synchronization for TAG 1 with TRP 1 and TRP 2 (S3818). Although FIGS. 37 and 38 have described the procedure for establishing two communication links, but methods of the present disclosure are not limited thereto. TRPs and the terminal may establish three or more communication links by applying the methods for establishing communication links, which are illustrated in FIGS. 37 and 38, and perform multi-TRP communication in downlink and uplink.

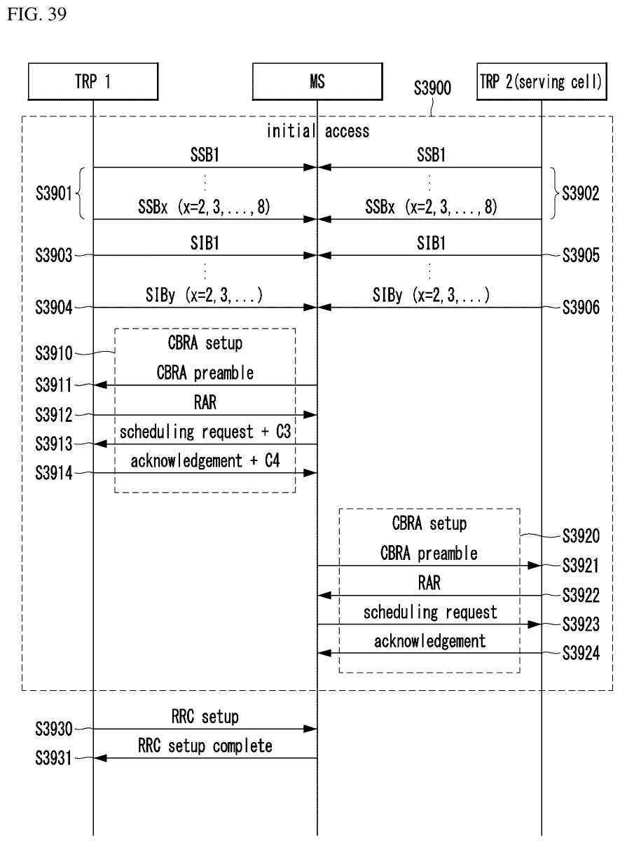

Meanwhile, a first intra-cell/inter-cell M-TRP method will be described with reference to FIGS. 39 to 49. The first intra-cell/inter-cell M-TRP method may apply the second SSB grouping method among the SSB grouping methods. Additionally, in the first intra-cell/inter-cell M-TRP method, the terminal may estimate the SSB 8 belonging to TRP 1 as the best SSB and estimate the SSB 1 belonging to TRP 2 as the second best SSB.

In other words, when the terminal is turned on, the terminal may estimate the best SSB and the second best SSB from the beamformed SSBs transmitted by TRP 1 and TRP 2. In this case, the terminal may not know whether the SSBs that the terminal estimated belong to TRP 1 or TRP 2. Then, in order to acquire uplink synchronization with TRP 1 that transmitted the best SSB and obtain a C-RNTI from TRP 1, the terminal may obtain information on an index of the SSB included in a message within an MIB transmitted through a PBCH existing within the best SSB. In this case, the best SSB index obtained may indicate the SSB 8, which is transmitted in the first half-frame of one frame.

FIG. 39 is a sequence chart illustrating a first exemplary embodiment of a transmission method in a multi-TRP environment.

Referring to FIG. 39, a terminal may proceed with an initial access procedure for TRP 1 and TRP 2 (S3900). Here, TRP 1 and TRP 2 may belong to a serving cell. To this end, TRP 1 may transmit beamformed SSBs (e.g. SSB 1 to SSB 8) in multiple directions using the first half frame of one frame (S3901). Accordingly, the terminal may receive SSBs from TRP 1, and the terminal may estimate the best SSB among the received SSBs. In this case, the best SSB may be the SSB 8 transmitted from TRP 1. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

On the other hand, TRP 2 may transmit beamformed SSBs (e.g. SSB 1 to SSB 8) in multiple directions using the second half frame of one frame (S3902). Accordingly, the terminal may receive SSBs from TRP 2, and the terminal may estimate the second best SSB among the received SSBs. In this case, the second best SSB may be the SSB 1 transmitted from TRP 2. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. An MIB may be transmitted to the terminal on a PBCH. The MIB may be the first system information obtained by the terminal from TRP 2.

Then, TRP 1 may transmit an SIB1 to the terminal using a PDSCH (S3903). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S3904). In this case, TRP 1 may transmit control information to inform that SIBs are to be delivered in succession following the SIB1 by including the control information in the SIB1. The terminal may receive the SIBs other than the SIB1 from TRP 1.

On the other hand, TRP 2 may transmit an SIB1 to the terminal using a PDSCH (S3905). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S3906). In this case, TRP 2 may transmit control information to inform that SIBs are to be delivered in succession following the SIB1 by including the control information in the SIB1. The terminal may receive the SIBs other than the SIB1 from TRP 2.

Meanwhile, the terminal may obtain information on a PDCCH/SIB bandwidth, common control resource set (CORSET), common search space (CSS), and related PDCCH parameter(s) from the MIB obtained from the SSB received from TRP 1, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

Meanwhile, the terminal may obtain information on a PDCCH/SIB bandwidth, CORSET, CSS, and related PDCCH parameter(s) from the MIB obtained from the SSB received from TRP 2, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

Thereafter, the terminal that has completed downlink synchronization and system information acquisition may perform a 4-step CBRA-based random access setup procedure with TRP 1 for uplink synchronization (S3910).

First, in the first step, the terminal may randomly select one preamble from all preambles provided by TRP 1. The terminal may transmit the selected preamble to TRP 1 through a PRA CH (S3911). Then, TRP 1 may receive the preamble from the terminal through the PRACH. In this case, a beam direction may follow an uplink direction reciprocal to a beam direction used when receiving a signal in downlink. A resource for transmitting the preamble to TRP 1 from the terminal may be based on information on an association between SSBs and RACHs obtained in advance. TRP 1 may estimate the terminal's propagation delay using the preamble.

Thereafter, in the second step, TRP 1 may determine whether a preamble is present in a signal received through the PRACH. The preamble may be randomly selected and transmitted by the terminal. Therefore, TRP 1 may not specify which terminal transmitted the preamble through whether or not the preamble is detected. Therefore, TRP 1 cannot determine how many terminals used the detected preamble. Accordingly, TRP 1 may transmit an RAR based on an index of the detected preamble to the terminal through a PDSCH (S3912). Then, the terminal may receive the RAR from TRP 1. In this case, the RAR may include the preamble index, TA value, uplink grant information, and temporary C-RNTI.

Thereafter, in the third step, the terminal may transmit a message including a scheduling request (or connection request message) and a C3 message to TRP 1 through a PUSCH by applying the temporary C-RNTI and using an uplink radio resource indicated by the uplink grant information included in the corresponding RAR (S3913). TRP 1 may receive the connection request message and the C3 message from the terminal. In this case, there may be more than one terminal that transmitted the same preamble in the first step. Accordingly, a collision of preambles may occur. In this case, all terminals that transmitted the same preamble may transmit the messages by utilizing the same radio resource indicated by the RAR. This may cause a collision.

Here, the C3 message may include C3-1 information to C3-5 information. Here, the C3-1 information may be information on the second best SSB. The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB.

The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs. On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure. When the second SSB grouping method is used, the C3-5 information may include information on a time, which can specify the second half-frame in which the second best SSB is received.

In other words, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit a PDSCH including acknowledgment and a C4 message to the terminal in response to the successfully decoded message (S3914). Then, the terminal may receive the message including the acknowledgment and the C4 message from TRP 1. The terminal may receive the message including the acknowledgment and the C4 message before expiration of the contention resolution timer started in the third step. Here, the C4 message may include C4-1 information to C4_5 information. In this case, the C4-1 information may be information indicating whether ‘TRP 2’ is true or false. Here, ‘TRP 2’ set to true may mean that a TRP using the second best SSB informed by the terminal is qualified as TRP 2.

The C4-2 information may be information indicating whether ‘RA’ is true or false. Here, ‘RA’ set to true may mean that random access needs to be performed to TRP of the second best SSB. In addition, the C4-3 information may be information indicating whether ‘CBRA’ is true or false. Here, ‘CBRA’ set to true may mean that contention-based random access needs to be performed. In addition, the C4_4 information may include information on CFRA preamble(s). A CFRA preamble may refer to a preamble to be used when performing non-contention-based random access. The CFRA preamble may be indicated by a natural number greater than 1. In addition, the C4_5 information may be other information. The C4-5 information may be any possible information that reduces the overhead of the procedure.

TRP 1 may generate the C4-1 information of the C4 message based on the information in the C3 message of the third-step message. In other words, TRP 1 may identify that the second best SSB included in the C3 message corresponds to an SSB of TRP 2 based on SSB group-related information. Then, TRP 1 may set the C4_1 information to true. In addition, TRP 1 may generate the C4-2 information of the C4 message based on the information in the C3 message of the third-step message. In other words, when a time difference between a starting point of the best SSB and a starting point of the second best SSB of the C3_3 information of the C3 message is equal to or greater than a predetermined threshold, TRP 1 may set ‘RA’ of the C4-2 information of the C4 message to true. In addition, TRP 1 may arbitrarily decide whether to set ‘CBRA’ to true.

In this situation, the premise that the PCI is the same in the C3-2 information may be true, and ‘TRP 2’ in the C4_1 information may be false. Then, the terminal may ignore other message information, may not perform an additional random access procedure, and perform an RRC setup procedure with TRP 1.

In contrast, the premise that the PCI is the same may be true in the C3_2 information, ‘TRP 2’ in the C4_1 information may be true, and ‘RA’ in the C4-2 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

Meanwhile, the premise that PCI is the same may be true in the C3-2 information, ‘TRP 2’ in the C4_1 information may be true, ‘RA’ in the C4-2 information may be true, and ‘CBRA’ in the C4 3 information may be true. The terminal may proceed with a 4-step CBRA-based setup procedure for TRP 2 (S3920).

First, in the first step, the terminal may randomly select one preamble from all preambles provided by TRP 2. The terminal may transmit the selected preamble to TRP 2 through a PRA CH (S3921). Then, TRP 2 may receive the preamble from the terminal through the PRACH. In this case, a beam direction may follow an uplink direction reciprocal to a beam direction used when receiving a signal in downlink. A resource for transmitting the preamble to TRP 2 from the terminal may be based on information on an association between SSBs and RACHs, which is obtained in advance. TRP 2 may estimate the terminal's propagation delay using the preamble.

Thereafter, in the second step, TRP 2 may determine whether a preamble is present in a signal received through the PRACH. The preamble may be randomly selected and transmitted by the terminal. Therefore, TRP 2 may not specify which terminal transmitted the preamble through whether or not the preamble is detected. Therefore, TRP 2 cannot determine how many terminals used the detected preamble. Accordingly, TRP 2 may transmit an RAR based on an index of the detected preamble to the terminal through a PDSCH (S3922). Then, the terminal may receive the RAR from TRP 2. In this case, the RAR may include the preamble index, TA value, uplink grant information, and temporary C-RNTI.

Thereafter, in the third step, the terminal may transmit a message including a scheduling request message (or connection request message) to TRP 2 through a PUSCH by applying the temporary C-RNTI and using an uplink radio resource indicated by the uplink grant information included in the corresponding RAR (S3923). TRP 2 may receive the connection request message from the terminal. In this case, there may be more than one terminal that transmitted the same preamble in the first step. Accordingly, a collision of preambles may occur. In this case, all terminals that transmitted the same preamble may transmit the messages by utilizing the same radio resource indicated by the RAR. This may cause a collision.

In other words, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 2 may decode the received third-step message. TRP 2 may transmit an acknowledgment message to the terminal through a PDSCH in response to the successfully decoded message (S3924). Then, the terminal may receive the acknowledgement message from TRP 2. The terminal may receive the acknowledgement message before expiration of the contention resolution timer started in the third step. Once the fourth step is completed as described above, the terminal may proceed to a RRC setup procedure.

Then, TRP 1 may transmit an RRC setup message to the terminal (S3930). The terminal may receive the RRC setup message from TRP 1. Accordingly, the terminal may complete RRC setup and transmit an RRC setup complete message to TRP 1 (S3931). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

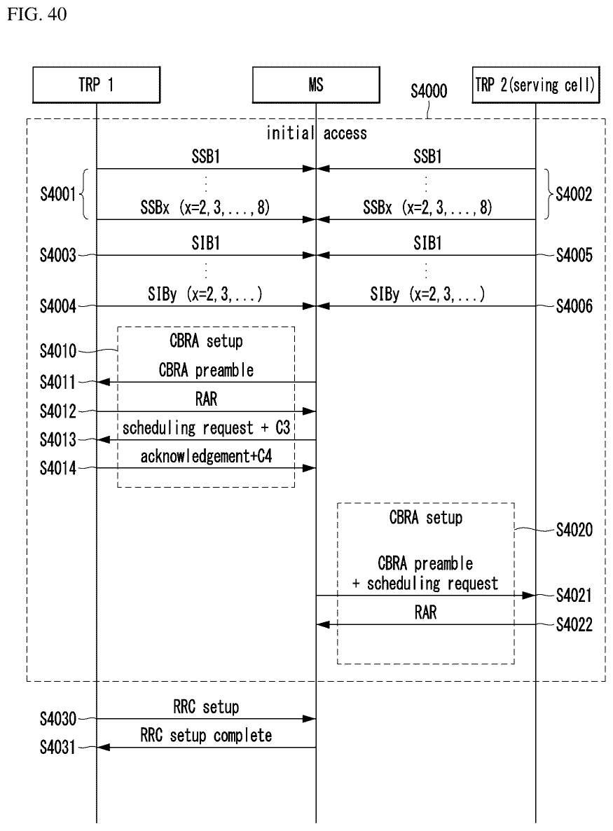

FIG. 40 is a sequence chart illustrating a second exemplary embodiment of a transmission method in a multi-TRP environment.

Referring to FIG. 40, a terminal may proceed with an initial access procedure for TRP 1 and TRP 2 (S4000). TRP 1 and TRP 2 may belong to a serving cell. TRP 1 may transmit beamformed SSBs (e.g. SSB 1 to SSB 8) in multiple directions using the first half frame of one frame (S4001). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSB s periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

On the other hand, TRP 2 may transmit beamformed SSBs (e.g. SSB 1 to SSB 8) in multiple directions using the second half frame of one frame (S4002). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. An MIB may be transmitted to the terminal on a PBCH. The MIB may be the first system information obtained by the terminal from TRP 2.

Then, TRP 1 may transmit an SIB1 to the terminal using a PDSCH (S4003). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S4004). In this case, TRP 1 may transmit control information to inform that SIBs are to be delivered in succession following the SIB1 by including the control information in the SIB1. The terminal may receive the SIBs other than the SIB1 from TRP 1.

On the other hand, TRP 2 may transmit an SIB1 to the terminal using a PDSCH (S4005). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S4006). In this case, TRP 2 may transmit control information to inform that SIBs are to be delivered in succession following the SIB1 by including the control information in the SIB1. The terminal may receive the SIBs other than the SIB1 from TRP 2.

Meanwhile, the terminal may obtain information on a PDCCH/SIB bandwidth, CORSET, CSS, and related PDCCH parameter(s) from the MIB obtained from the SSB received from TRP 1, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

In addition, the terminal may obtain information on a PDCCH/SIB bandwidth, CORSET, CSS, and related PDCCH parameter(s) from the MIB obtained from the SSB received from TRP 2, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1. Thereafter, the terminal that has completed downlink synchronization and system information acquisition may perform a 4-step CBRA-based random access setup procedure with TRP 1 for uplink synchronization (S4010).

First, in the first step, the terminal may randomly select one preamble from all preambles provided by TRP 1. Then, the terminal may transmit the selected preamble to TRP 1 through a PRACH (S4011). Then, TRP 1 may receive the preamble from the terminal through the PRACH. In this case, a beam direction may follow an uplink direction reciprocal to a beam direction used when receiving a signal in downlink. A resource for transmitting the preamble to TRP 1 from the terminal may be based on information on an association between SSBs and RACHs, which is obtained in advance. TRP 1 may estimate the terminal's propagation delay using the preamble.

Thereafter, in the second step, TRP 1 may determine whether a preamble is present in a signal received through the PRACH. The preamble may be randomly selected and transmitted by the terminal. Therefore, TRP 1 may not specify which terminal transmitted the preamble through whether or not the preamble is detected. Therefore, TRP 1 cannot determine how many terminals used the detected preamble. Accordingly, TRP 1 may transmit an RAR based on an index of the detected preamble to the terminal through a PDSCH (S4012). Then, the terminal may receive the RAR from TRP 1. In this case, the RAR may include the preamble index, TA value, uplink grant information, and temporary C-RNTI.

Thereafter, in the third step, the terminal may transmit a message including a scheduling request (or connection request) and a C3 message to TRP 1 through a PUSCH by applying the temporary C-RNTI and using an uplink radio resource indicated by the uplink grant information included in the corresponding RAR (S4013). TRP 1 may receive the connection request message and the C3 message from the terminal. In this case, there may be more than one terminal that transmitted the same preamble in the first step. Accordingly, a collision of preambles may occur. In this case, all terminals that transmitted the same preamble may transmit the messages by utilizing the same radio resource indicated by the RAR. This may cause a collision.

Here, the C3 message may include C3-1 information to C3-5 information. Here, the C3-1 information may be information on the second best SSB. The C3_2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB.

The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs. On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure. When the second SSB grouping method is used, the C3-5 information may include information on a time, which can specify the second half-frame in which the second best SSB is received.

In other words, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit a PDSCH including acknowledgment and a C4 message to the terminal in response to the successfully decoded message (S4014). Then, the terminal may receive the message including the acknowledgment and the C4 message from TRP 1. The terminal may receive the message including the acknowledgment and the C4 message before expiration of the contention resolution timer started in the third step. Here, the C4 message may include C4-1 information to C4_5 information. In this case, the C4_1 information may be information indicating whether ‘TRP 2’ is true or false. Here, ‘TRP 2’ set to true may mean that a TRP using the second best SSB informed by the terminal is qualified as TRP 2.

The C4-2 information may be information indicating whether ‘RA’ is true or false. Here, ‘RA’ set to true may mean that random access needs to be performed to TRP of the second best SSB. In addition, the C4-3 information may be information indicating whether ‘CBRA’ is true or false. Here, ‘CBRA’ set to true may mean that contention-based random access needs to be performed. In addition, the C4-4 information may include information on CFRA preamble(s). A CFRA preamble may refer to a preamble to be used when performing non-contention-based random access. The CFRA preamble may be indicated by a natural number greater than 1. In addition, the C4_5 information may be other information. The C4-5 information may be any possible information that reduces the overhead of the procedure.

TRP 1 may generate the C4-1 information of the C4 message based on the information in the C3 message of the third-step message. In other words, TRP 1 may identify that the second best SSB included in the C3 message corresponds to an SSB of TRP 2 based on SSB group-related information. Then, TRP 1 may set the C4-1 information to true. In addition, TRP 1 may generate the C4 2 information of the C4 message based on the information in the C3 message of the third-step message. In other words, when a time difference between a starting point of the best SSB and a starting point of the second best SSB of the C3-3 information of the C3 message is equal to or greater than a predetermined threshold, TRP 1 may set ‘RA’ of the C4 2 information of the C4 message to true. In addition, TRP 1 may arbitrarily decide whether to set ‘CBRA’ to true.

In this situation, the premise that the PCI is the same in the C3-2 information may be true, and ‘TRP 2’ in the C4_1 information may be false. Then, the terminal may ignore other message information, may not perform an additional random access procedure, and perform an RRC setup procedure with TRP 1.

In contrast, the premise that the PCI is the same may be true in the C3-2 information, ‘TRP 2’ in the C4_1 information may be true, and ‘RA’ in the C4-2 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

Meanwhile, the premise that PCI is the same may be true in the C3-2 information, ‘TRP 2’ in the C4_1 information may be true, ‘RA’ in the C4-2 information may be true, and ‘CBRA’ in the C4_3 information may be false. The terminal may proceed with a 2-step CFRA-based setup procedure for TRP 2 (S4020).

To this end, in the first step, the terminal may randomly select one preamble from among CFRA preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S4021). Then, TRP 2 may receive the message including the preamble and the scheduling request from the terminal.

In this case, TRP 2 may transmit a message including an RAR and a C-RNTI to the terminal through a PDSCH (S4022). Accordingly, the terminal may receive the message including the successful RAR and the C-RNTI from TRP 2. This message may serve as an acknowledgement.

Then, TRP 1 may transmit an RRC setup message to the terminal (S4030). The terminal may receive the RRC setup message from TRP 1. Accordingly, the terminal may complete RRC setup and transmit an RRC setup complete message to TRP 1 (S4031). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

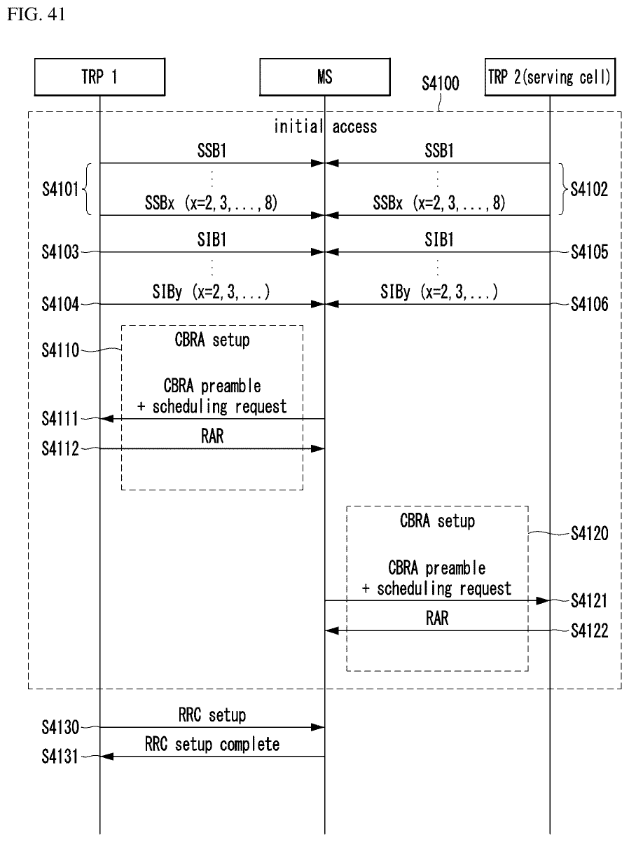

FIG. 41 is a sequence chart illustrating a third exemplary embodiment of a transmission method in a multi-TRP environment.

Referring to FIG. 41, a terminal may proceed with an initial access procedure for TRP 1 and TRP 2 (S4100). TRP 1 and TRP 2 may belong to a serving cell. TRP 1 may transmit beamformed SSBs (e.g. SSB 1 to SSB 8) in multiple directions using the first half frame of one frame (S4101). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSB s periodically or aperiodically for initial synchronization and maintenance of the synchronization for beamforming-based downlink. After performing such synchronization, the terminal may obtain an MIB from the best SSB. The MIB may be transmitted to the terminal on a PB CH. The MIB may be the first system information obtained by the terminal from TRP 1.

On the other hand, TRP 2 may transmit beamformed SSBs (e.g. SSB 1 to SSB 8) in multiple directions using the second half frame of one frame (S4102). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. An MIB may be transmitted to the terminal on a PBCH. The MIB may be the first system information obtained by the terminal from TRP 2.

Then, TRP 1 may transmit an SIB1 to the terminal using a PDSCH (S4103). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S4104). In this case, TRP 1 may transmit control information to inform that SIBs are to be delivered in succession following the SIB1 by including the control information in the SIB1. The terminal may receive the SIBs other than the SIB1 from TRP 1.

On the other hand, TRP 2 may transmit an SIB1 to the terminal using a PDSCH (S4105). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S4106). In this case, TRP 2 may transmit control information to inform that SIBs are to be delivered in succession following the SIB1 by including the control information in the SIB1. The terminal may receive the SIBs other than the SIB1 from TRP 2.

Meanwhile, the terminal may obtain information on a PDCCH/SIB bandwidth, CORSET, CSS, and related PDCCH parameter(s) from the MIB obtained from the SSB received from TRP 1, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

In addition, the terminal may obtain information on a PDCCH/SIB bandwidth, CORSET, CSS, and related PDCCH parameter(s) from the MIB obtained from the SSB received from TRP 2, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

Thereafter, the terminal that has completed downlink synchronization and system information acquisition may perform a 2-step CBRA-based random access setup procedure with TRP 1 for uplink synchronization (S4110).

To this end, in the first step, the terminal may randomly select one preamble from among all preambles. Then, the terminal may transmit the selected one preamble to TRP 1 through a PRACH. In addition, at the same time, the terminal may transmit a message including a scheduling request (i.e. connection request) and a C3 message to TRP 1 through a pre-allocated uplink radio resource (i.e. uplink shared channel) (S4111). Then, TRP 1 may receive the preamble and the message including the scheduling request and the C3 message from the terminal. Here, the C3 message may include C3-1 information to C3-5 information. Here, the C3_1 information may be information on the second best SSB. The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB.

The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs. On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3_5 information may be any possible information that reduces the overhead of the procedure. When the second SSB grouping method is used, the C3-5 information may include information on a time, which can specify the second half-frame in which the second best SSB is received.

In the second step, TRP may determine whether a preamble is detected. In addition, TRP may determine whether a message is successfully decoded. TRP may transmit a different type of message to the terminal according to a result of the determination. This may cause a subsequent procedure to be different.

Describing in further detail, if TRP does not detect a preamble, TRP may not perform any action. In other words, TRP may not check whether a message is received through an uplink radio resource associated with a preamble. As a result, TRP may not make any response when a preamble is not detected. Accordingly, the terminal may reattempt the random access because it did not receive any message from TRP. This case may be referred to as ‘Case 1’.

On the other hand, TRP may detect a preamble normally and successfully decode a message from an uplink radio resource associated with the preamble. In this case, TRP 1 may transmit a message including an RAR, a C-RNTI, and a C4 message to the terminal through a PDSCH (S4112). Accordingly, the terminal may receive the message including the successful RAR, C-RNTI, and C4 message from the TRP. This message may serve as an acknowledgement.

Here, the C4 message may include C4-1 information to C4_5 information. In this case, the C4_1 information may be information indicating whether ‘TRP 2’ is true or false. Here, ‘TRP 2’ set to true may mean that a TRP using the second best SSB informed by the terminal is qualified as TRP 2.

The C4-2 information may be information indicating whether ‘RA’ is true or false. Here, ‘RA’ set to true may mean that random access needs to be performed to TRP of the second best SSB. In addition, the C4-3 information may be information indicating whether ‘CBRA’ is true or false. Here, ‘CBRA’ set to true may mean that contention-based random access needs to be performed. In addition, the C4-4 information may include information on CFRA preamble(s). A CFRA preamble may refer to a preamble to be used when performing non-contention-based random access. The CFRA preamble may be indicated by a natural number greater than 1. In addition, the C4_5 information may be other information. The C4-5 information may be any possible information that reduces the overhead of the procedure.

In this case, TRP 1 may generate the C4-1 information of the C4 message based on the information in the C3 message of the third-step message. In other words, TRP 1 may identify that the second best SSB included in the C3 message corresponds to an SSB of TRP 2 based on SSB group-related information. Then, TRP 1 may set the C4_1 information to true. In addition, TRP 1 may generate the C4-2 information of the C4 message based on the information in the C3 message of the third-step message. In other words, when a time difference between a starting point of the best SSB and a starting point of the second best SSB of the C3-3 information of the C3 message is equal to or greater than a predetermined threshold, TRP 1 may set ‘RA’ of the C4-2 information of the C4 message to true. In addition, TRP 1 may arbitrarily decide whether to set ‘CBRA’ to true.

In this situation, the premise that the PCI is the same in the C3-2 information may be true, and ‘TRP 2’ in the C4_1 information may be false. Then, the terminal may ignore other message information, may not perform an additional random access procedure, and perform an RRC setup procedure with TRP 1.

In contrast, the premise that the PCI is the same may be true in the C3-2 information, ‘TRP 2’ in the C4_1 information may be true, and ‘RA’ in the C4-2 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

Meanwhile, the premise that PCI is the same may be true in the C3-2 information, ‘TRP 2’ in the C4-1 information may be true, ‘RA’ in the C4-2 information may be true, and ‘CBRA’ in the C4-3 information may be true. The terminal may proceed with a 2-step CBRA-based setup procedure for TRP 2 (S4120).

To this end, in the first step, the terminal may randomly select one preamble from among all preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S4121). Then, TRP 2 may receive the preamble and the message including the scheduling request from the terminal.

In the second step, TRP 2 may determine whether a preamble is detected. In addition, TRP 2 may determine whether a message is successfully decoded. TRP 2 may transmit a different type of message to the terminal according to a result of the determination. This may cause a subsequent procedure to be different.

Describing in further detail, if TRP 2 does not detect a preamble, TRP 2 may not perform any action. In other words, TRP 2 may not check whether a message is received through an uplink radio resource associated with a preamble. As a result, TRP 2 may not make any response when a preamble is not detected. Accordingly, the terminal may reattempt the random access because it did not receive any message from TRP 2. This case may be referred to as ‘Case 1’.

On the other hand, TRP 2 may detect a preamble normally and successfully decode a message from an uplink radio resource associated with the preamble. In this case, TRP 2 may transmit a message including an RAR and a C-RNTI to the terminal through a PDSCH (S4122). Accordingly, the terminal may receive the message including the successful RAR and C-RNTI from TRP 2. This message may serve as an acknowledgement. Accordingly, the terminal may successfully complete the random access. This case may be referred to as ‘Case 2’. Meanwhile, TRP 2 may detect the preamble normally, but may not be able to successfully decode the message from the uplink radio resource associated with the preamble. In this case, TRP 2 may transmit a message including a fallback RAR to the terminal through a PDSCH. In this case, the terminal receiving the message may retransmit the message that it intended to transmit using an uplink radio resource indicated by uplink grant information included in the fallback RAR.

Then, TRP 1 may transmit an RRC setup message to the terminal (S4130). The terminal may receive the RRC setup message from TRP 1. Accordingly, the terminal may complete RRC setup and transmit an RRC setup complete message to TRP 1 (S4131). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

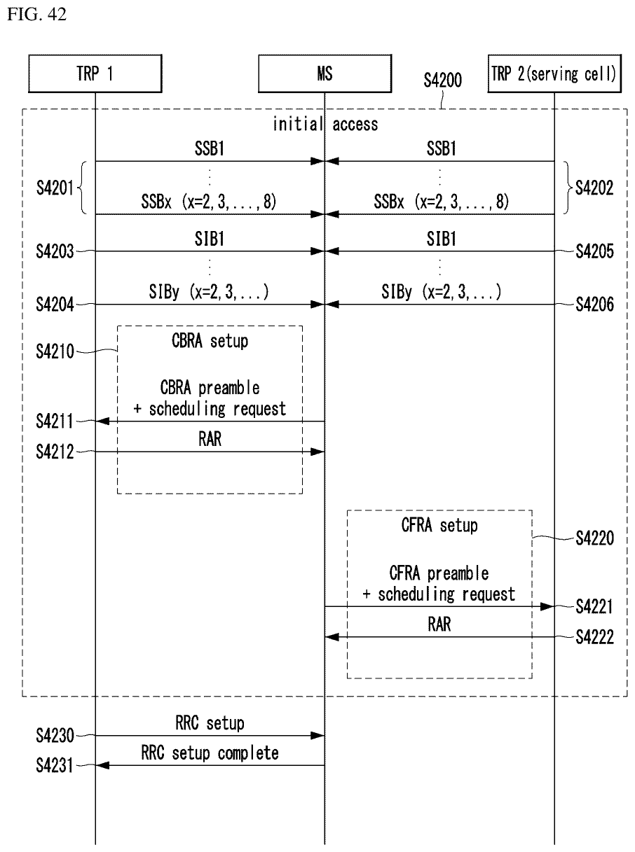

FIG. 42 is a sequence chart illustrating a fourth exemplary embodiment of a transmission method in a multi-TRP environment.

Referring to FIG. 42, a terminal may proceed with an initial access procedure for TRP 1 and TRP 2 (S4200). TRP 1 and TRP 2 may belong to a serving cell. TRP 1 may transmit beamformed SSBs (e.g. SSB 1 to SSB 8) in multiple directions using the first half frame of one frame (S4201). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSB s periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

On the other hand, TRP 2 may transmit beamformed SSBs (e.g. SSB 1 to SSB 8) in multiple directions using the second half frame of one frame (S4202). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. An MIB may be transmitted to the terminal on a PB CH. The MIB may be the first system information obtained by the terminal from TRP 2.

Then, TRP 1 may transmit an SIB1 to the terminal using a PDSCH (S4203). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S4204). In this case, TRP 1 may transmit control information to inform that SIBs are to be delivered in succession following the SIB1 by including the control information in the SIB1. The terminal may receive the SIBs other than the SIB1 from TRP 1.

On the other hand, TRP 2 may transmit an SIB1 to the terminal using a PDSCH (S4205). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S4206). In this case, TRP 2 may transmit control information to inform that SIBs are to be delivered in succession following the SIB1 by including the control information in the SIB1. The terminal may receive the SIBs other than the SIB1 from TRP 2.

Meanwhile, the terminal may obtain information on a PDCCH/SIB bandwidth, CORSET, CSS, and related PDCCH parameter(s) from the MIB obtained from the SSB received from TRP 1, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

In addition, the terminal may obtain information on a PDCCH/SIB bandwidth, CORSET, CSS, and related PDCCH parameter(s) from the MIB obtained from the SSB received from TRP 2, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

Thereafter, the terminal that has completed downlink synchronization and system information acquisition may perform a 2-step CBRA-based random access setup procedure with TRP 1 for uplink synchronization (S4210).

To this end, in the first step, the terminal may randomly select one preamble from among all preambles. Then, the terminal may transmit the selected one preamble to TRP 1 through a PRACH. In addition, at the same time, the terminal may transmit a scheduling request (i.e. connection request) message and a C3 message to TRP 1 through a pre-allocated uplink radio resource (i.e. uplink shared channel) (S4211). Then, TRP 1 may receive the preamble and the message including the scheduling request and the C3 message from the terminal. Here, the C3 message may include C3-1 information to C3-5 information. Here, the C3-1 information may be information on the second best SSB. The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB.

The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs. On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3-5 information may be other information. The C3_5 information may be any possible information that reduces the overhead of the procedure.

When the second SSB grouping method is used, the C3-5 information may include information on a time, which can specify the second half-frame in which the second best SSB is received.

In the second step, TRP may determine whether a preamble is detected. In addition, TRP may determine whether a message is successfully decoded. TRP may transmit a different type of message to the terminal according to a result of the determination. This may cause a subsequent procedure to be different.

Describing in further detail, if TRP does not detect a preamble, TRP may not perform any action. In other words, TRP may not check whether a message is received through an uplink radio resource associated with a preamble. As a result, TRP may not make any response when a preamble is not detected. Accordingly, the terminal may reattempt the random access because it did not receive any message from TRP. This case may be referred to as ‘Case l’.

On the other hand, TRP may detect a preamble normally and successfully decode a message from an uplink radio resource associated with the preamble. In this case, TRP 1 may transmit a message including an RAR, a C-RNTI, and a C4 message to the terminal through a

PDSCH (S4212). Accordingly, the terminal may receive the message including the successful RAR, C-RNTI, and C4 message from the TRP. This message may serve as an acknowledgement.

Here, the C4 message may include C4-1 information to C4-5 information. In this case, the C4_1 information may be information indicating whether ‘TRP 2’ is true or false. Here, ‘TRP 2’ set to true may mean that a TRP using the second best SSB informed by the terminal is qualified as TRP 2.

The C4-2 information may be information indicating whether ‘RA’ is true or false. Here, ‘RA’ set to true may mean that random access needs to be performed to TRP of the second best SSB. In addition, the C4-3 information may be information indicating whether ‘CBRA’ is true or false. Here, ‘CBRA’ set to true may mean that contention-based random access needs to be performed. In addition, the C4-4 information may include information on CFRA preamble(s). A CFRA preamble may refer to a preamble to be used when performing non-contention-based random access. The CFRA preamble may be indicated by a natural number greater than 1. In addition, the C4_5 information may be other information. The C4-5 information may be any possible information that reduces the overhead of the procedure.

In this case, TRP 1 may generate the C4_1 information of the C4 message based on the information in the C3 message of the third-step message. In other words, TRP 1 may identify that the second best SSB included in the C3 message corresponds to an SSB of TRP 2 based on SSB group-related information. Then, TRP 1 may set the C4_1 information to true. In addition, TRP 1 may generate the C4-2 information of the C4 message based on the information in the C3 message of the third-step message. In other words, when a time difference between a starting point of the best SSB and a starting point of the second best SSB of the C3-3 information of the C3 message is equal to or greater than a predetermined threshold, TRP 1 may set ‘RA’ of the C4 2 information of the C4 message to true. In addition, TRP 1 may arbitrarily decide whether to set ‘CBRA’ to true.

In this situation, the premise that the PCI is the same in the C3-2 information may be true, and ‘TRP 2’ in the C4_1 information may be false. Then, the terminal may ignore other message information, may not perform an additional random access procedure, and perform an RRC setup procedure with TRP 1.

In contrast, the premise that the PCI is the same may be true in the C3-2 information, ‘TRP 2’ in the C4_1 information may be true, and ‘RA’ in the C4-2 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

Meanwhile, the premise that PCI is the same may be true in the C3-2 information, ‘TRP 2’ in the C4-1 information may be true, ‘RA’ in the C4-2 information may be true, and ‘CBRA’ in the C4_3 information may be false. The terminal may proceed with a 2-step CFRA-based setup procedure for TRP 2 (S4220).

To this end, in the first step, the terminal may randomly select one preamble from among CFRA preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S4221). Then, TRP 2 may receive the preamble and the message including the scheduling request from the terminal.

In this case, TRP 2 may transmit a message including an RAR and a C-RNTI to the terminal through a PDSCH (S4222). Accordingly, the terminal may receive the message including the successful RAR and the C-RNTI from TRP 2. This message may serve as an acknowledgement. In this case, ‘RA’ in the C4-2 information of the C4 message may be false. Then, TRP 2 may complete the second step. Alternatively, ‘RA’ may be true. Then, the terminal may perform the random access procedure from the first step again. After the second step is completed, the terminal may proceed with an RRC setup procedure.

Then, TRP 1 may transmit an RRC setup message to the terminal (S4230). The terminal may receive the RRC setup message from TRP 1. Accordingly, the terminal may complete RRC setup and transmit an RRC setup complete message to TRP 1 (S4231). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

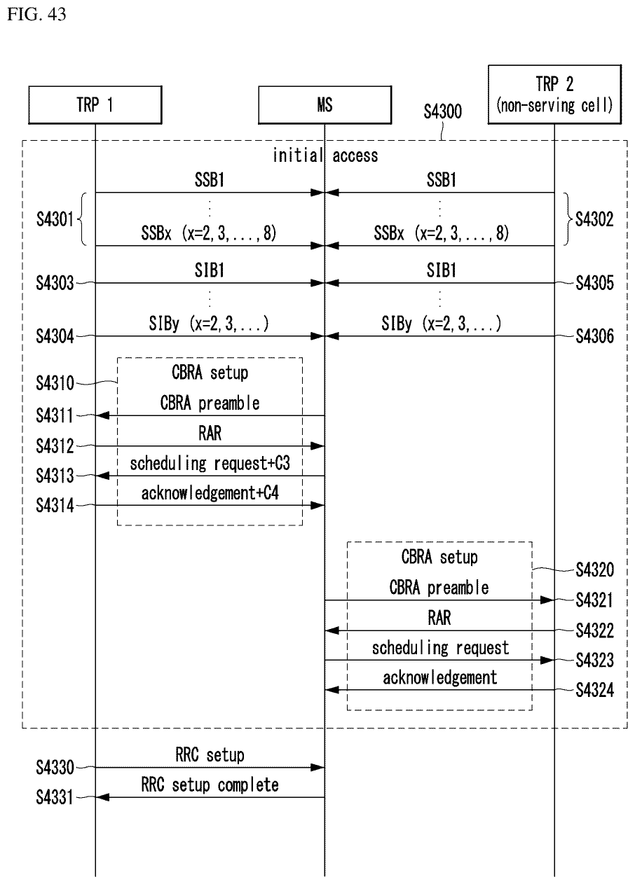

FIG. 43 is a sequence chart illustrating a fifth exemplary embodiment of a transmission method in a multi-TRP environment.

Referring to FIG. 43, a terminal may proceed with an initial access procedure for TRP 1 and TRP 2 (S4300). Here, TRP 1 may belong to a serving cell, and TRP 2 may belong to a non-serving cell. To this end, TRP 1 may transmit beamformed SSBs (e.g. SSB 1 to SSB 8) in multiple directions using the first half frame of one frame (S4301). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

On the other hand, TRP 2 may transmit beamformed SSBs (e.g. SSB 1 to SSB 8) in multiple directions using the second half frame of one frame (S4302). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. An MIB may be transmitted to the terminal on a PBCH. The MIB may be the first system information obtained by the terminal from TRP 2.

Then, TRP 1 may transmit an SIB1 to the terminal using a PDSCH (S4303). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S4304). In this case, TRP 1 may transmit control information to inform that SIBs are to be delivered in succession following the SIB1 by including the control information in the SIB1. The terminal may receive the SIBs other than the SIB1 from TRP 1.

On the other hand, TRP 2 may transmit an SIB1 to the terminal using a PDSCH (S4305). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S4306). In this case, TRP 2 may transmit control information to inform that SIBs are to be delivered in succession following the SIB1 by including the control information in the SIB1. The terminal may receive the SIBs other than the SIB1 from TRP 2.

Meanwhile, the terminal may obtain information on a PDCCH/SIB bandwidth, CORSET, CSS, and related PDCCH parameter(s) from the MIB obtained from the SSB received from TRP 1, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

In addition, the terminal may obtain information on a PDCCH/SIB bandwidth, CORSET, CSS, and related PDCCH parameter(s) from the MIB obtained from the SSB received from TRP 2, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

Thereafter, the terminal that has completed downlink synchronization and system information acquisition may perform a 4-step CBRA-based random access setup procedure with TRP 1 for uplink synchronization (S4310).

First, in the first step, the terminal may randomly select one preamble from all preambles provided by TRP 1. The terminal may transmit the selected preamble to TRP 1 through a PRA CH (S4311). Then, TRP 1 may receive the preamble from the terminal through the PRACH. In this case, a beam direction may follow an uplink direction reciprocal to a beam direction used when receiving a signal in downlink. A resource for transmitting the preamble to TRP 1 from the terminal may be based on information on an association between SSBs and RACHs, which is obtained in advance. TRP 1 may estimate the terminal's propagation delay using the preamble.

Thereafter, in the second step, TRP 1 may determine whether a preamble is present in a signal received through the PRACH. The preamble may be randomly selected and transmitted by the terminal. Therefore, TRP 1 may not specify which terminal transmitted the preamble through whether or not the preamble is detected. Therefore, TRP 1 cannot determine how many terminals used the detected preamble. Accordingly, TRP 1 may transmit an RAR based on an index of the detected preamble to the terminal through a PDSCH (S4312). Then, the terminal may receive the RAR from TRP 1. In this case, the RAR may include the preamble index, TA value, uplink grant information, and temporary C-RNTI.

Thereafter, in the third step, the terminal may transmit a message including a scheduling request message (or connection request message) and a C3 message to TRP 1 through a PUSCH by applying the temporary C-RNTI and using an uplink radio resource indicated by the uplink grant information included in the corresponding RAR (S4313). TRP 1 may receive the connection request message and the C3 message from the terminal. In this case, there may be more than one terminal that transmitted the same preamble in the first step. Accordingly, a collision of preambles may occur. In this case, all terminals that transmitted the same preamble may transmit the messages by utilizing the same radio resource indicated by the RAR. This may cause a collision.

Here, the C3 message may include C3-1 information to C3-5 information. Here, the C3-1 information may be information on the second best SSB. The C3 2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB.

The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs. On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3_5 information may be any possible information that reduces the overhead of the procedure. When the second SSB grouping method is used, the C3-5 information may include information on a time, which can specify the second half-frame in which the second best SSB is received.

In other words, terminals that transmitted the same preamble in the first step may eventually experience resource conflicts when transmitting the messages of the third step. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit an acknowledgment message and a C4 message to the terminal through a PDSCH in response to the successfully decoded message (S4314). Then, the terminal may receive the acknowledgment message and the C4 message from TRP 1. The terminal may receive the acknowledgment message and the C4 message before expiration of the contention resolution timer started in the third step. Here, the C4 message may include C4-1 information to C4-5 information. In this case, the C4_1 information may be information indicating whether ‘TRP 2’ is true or false. Here, ‘TRP 2’ set to true may mean that a TRP using the second best SSB informed by the terminal is qualified as TRP 2.

The C4-2 information may be information indicating whether ‘RA’ is true or false. Here, ‘RA’ set to true may mean that random access needs to be performed to TRP of the second best SSB. In addition, the C4-3 information may be information indicating whether ‘CBRA’ is true or false. Here, ‘CBRA’ set to true may mean that contention-based random access needs to be performed. In addition, the C4-4 information may include information on CFRA preamble(s). A CFRA preamble may refer to a preamble to be used when performing non-contention-based random access. The CFRA preamble may be indicated by a natural number greater than 1. In addition, the C4_5 information may be other information. The C4_5 information may be any possible information that reduces the overhead of the procedure.

In this case, TRP 1 may generate the C4-1 information of the C4 message based on the information in the C3 message of the third-step message. In other words, TRP 1 may identify that the second best SSB included in the C3 message corresponds to an SSB of TRP 2 based on SSB group-related information. Then, TRP 1 may set the C4_1 information to true. In addition, TRP 1 may generate the C4-2 information of the C4 message based on the information in the C3 message of the third-step message. In other words, when a time difference between a starting point of the best SSB and a starting point of the second best SSB of the C3_3 information of the C3 message is equal to or greater than a predetermined threshold, TRP 1 may set ‘RA’ of the C4 2 information of the C4 message to true. In addition, TRP 1 may arbitrarily decide whether to set ‘CBRA’ to true.

In this situation, the premise that the PCI is the same in the C3-2 information may be true, and ‘TRP 2’ in the C4_1 information may be false. Then, the terminal may ignore other message information, may not perform an additional random access procedure, and perform an RRC setup procedure with TRP 1.

In contrast, the premise that the PCI is the same may be true in the C3-2 information, ‘TRP 2’ in the C4_1 information may be true, and ‘RA’ in the C4-2 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

Meanwhile, the premise that PCI is the same may be true in the C3-2 information, ‘TRP 2’ in the C4-1 information may be true, ‘RA’ in the C4-2 information may be true, and ‘CBRA’ in the C4-3 information may be true. The terminal may proceed with a 4-step CBRA-based setup procedure for TRP 2 (S4320).

First, in the first step, the terminal may randomly select one preamble from all preambles provided by TRP 2. The terminal may transmit the selected preamble to TRP 2 through a PRA CH (S4321). Then, TRP 2 may receive the preamble from the terminal through the PRACH. In this case, a beam direction may follow an uplink direction reciprocal to a beam direction used when receiving a signal in downlink. A resource for transmitting the preamble to TRP 2 from the terminal may be based on information on an association between SSB and RACH, which is obtained in advance. TRP 2 may estimate the terminal's propagation delay using the preamble.

Thereafter, in the second step, TRP 2 may determine whether a preamble is present in a signal received through the PRACH. The preamble may be randomly selected and transmitted by the terminal. Therefore, TRP 2 may not specify which terminal transmitted the preamble through whether or not the preamble is detected. Therefore, TRP 2 cannot determine how many terminals used the detected preamble. Accordingly, TRP 2 may transmit an RAR based on an index of the detected preamble to the terminal through a PDSCH (S4322). Then, the terminal may receive the RAR from TRP 2. In this case, the RAR may include the preamble index, TA value, uplink grant information, and temporary C-RNTI.

Thereafter, in the third step, the terminal may transmit a scheduling request message (or connection request message) to TRP 2 through a PUSCH by applying the temporary C-RNTI and using an uplink radio resource indicated by the uplink grant information included in the corresponding RAR (S4323). TRP 2 may receive the connection request message from the terminal. In this case, there may be more than one terminal that transmitted the same preamble in the first step. Accordingly, a collision of preambles may occur. In this case, all terminals that transmitted the same preamble may transmit the messages by utilizing the same radio resource indicated by the RAR. This may cause a collision.

In other words, terminals that transmitted the same preamble in the first step may eventually experience resource conflicts when transmitting the messages of the third step. Accordingly, each terminal may start a contention resolution timer when transmitting the third-step message as a procedure to check whether the transmitted third-step message collides and whether it is successfully decoded.

Finally, in the fourth step, TRP 2 may decode the received third-step message. TRP 2 may transmit an acknowledgment message to the terminal through a PDSCH in response to the successfully decoded message (S4324). Then, the terminal may receive the acknowledgement message from TRP 2. The terminal may receive the acknowledgement message before expiration of the contention resolution timer started in the third step. Once the fourth step is completed as described above, the terminal may proceed to an RRC setup procedure.

Then, TRP 1 may transmit an RRC setup message to the terminal (S4330). The terminal may receive the RRC setup message from TRP 1. Accordingly, the terminal may complete RRC setup and transmit an RRC setup complete message to TRP 1 (S4331). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

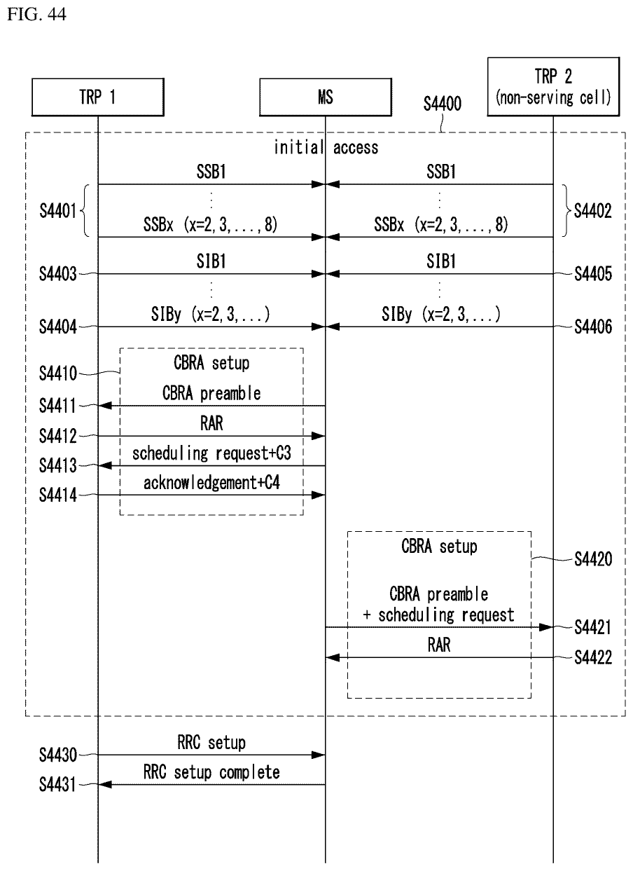

FIG. 44 is a sequence chart illustrating a sixth exemplary embodiment of a transmission method in a multi-TRP environment.

Referring to FIG. 44, a terminal may proceed with an initial access procedure for TRP 1 and TRP 2 (S4400). Here, TRP 1 may belong to a serving cell, and TRP 2 may belong to a non-serving cell. To this end, TRP 1 may transmit beamformed SSBs (e.g. SSB 1 to SSB 8) in multiple directions using the first half frame of one frame (S4401). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

On the other hand, TRP 2 may transmit beamformed SSBs (e.g. SSB 1 to SSB 8) in multiple directions using the second half frame of one frame (S4402). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. An MIB may be transmitted to the terminal on a PBCH. The MIB may be the first system information obtained by the terminal from TRP 2.

Then, TRP 1 may transmit an SIB1 to the terminal using a PDSCH (S4403). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S4404). In this case, TRP 1 may transmit control information to inform that SIBs are to be delivered in succession following the SIB1 by including the control information in the SIB1. The terminal may receive the SIBs other than the SIB1 from TRP 1.

On the other hand, TRP 2 may transmit an SIB1 to the terminal using a PDSCH (S4405). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S4406). In this case, TRP 2 may transmit control information to inform that SIBs are to be delivered in succession following the SIB1 by including the control information in the SIB1. The terminal may receive the SIBs other than the SIB1 from TRP 2.

Meanwhile, the terminal may obtain information on a PDCCH/SIB bandwidth, CORSET, CSS, and related PDCCH parameter(s) from the MIB obtained from the SSB received from TRP 1, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

In addition, the terminal may obtain information on a PDCCH/SIB bandwidth, CORSET, CSS, and related PDCCH parameter(s) from the MIB obtained from the SSB received from TRP 2, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

Thereafter, the terminal that has completed downlink synchronization and system information acquisition may perform a 4-step CBRA-based random access setup procedure with TRP 1 for uplink synchronization (S4410).

First, in the first step, the terminal may randomly select one preamble from all preambles provided by TRP 1. The terminal may transmit the selected preamble to TRP 1 through a PRA CH (S4411). Then, TRP 1 may receive the preamble from the terminal through the PRACH. In this case, a beam direction may follow an uplink direction reciprocal to a beam direction used when receiving a signal in downlink. A resource for transmitting the preamble to TRP 1 from the terminal may be based on information on an association between SSBs and RACHs, which is obtained in advance. TRP 1 may estimate the terminal's propagation delay using the preamble.

Thereafter, in the second step, TRP 1 may determine whether a preamble is present in a signal received through the PRACH. The preamble may be randomly selected and transmitted by the terminal. Therefore, TRP 1 may not specify which terminal transmitted the preamble through whether or not the preamble is detected. Therefore, TRP 1 cannot determine how many terminals used the detected preamble. Accordingly, TRP 1 may transmit an RAR based on an index of the detected preamble to the terminal through a PDSCH (S4412). Then, the terminal may receive the RAR from TRP 1. In this case, the RAR may include the preamble index, TA value, uplink grant information, and temporary C-RNTI.

Thereafter, in the third step, the terminal may transmit a scheduling request message (or connection request message) and a C3 message to TRP 1 through a PUSCH by applying the temporary C-RNTI and using an uplink radio resource indicated by the uplink grant information included in the corresponding RAR (S4413). TRP 1 may receive the connection request message and the C3 message from the terminal. In this case, there may be more than one terminal that transmitted the same preamble in the first step. Accordingly, a collision of preambles may occur. In this case, all terminals that transmitted the same preamble may transmit the messages by utilizing the same radio resource indicated by the RAR. This may cause a collision.

Here, the C3 message may include C3-1 information to C3-5 information. Here, the C3-1 information may be information on the second best SSB. The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB.

The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs. On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3_5 information may be any possible information that reduces the overhead of the procedure. When the second SSB grouping method is used, the C3-5 information may include information on a time, which can specify the second half-frame in which the second best SSB is received.

In other words, terminals that transmitted the same preamble in the first step may eventually experience resource conflicts when transmitting the messages of the third step. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit an acknowledgment message and a C4 message to the terminal through a PDSCH in response to the successfully decoded message (S4414). Then, the terminal may receive the acknowledgment message and the C4 message from TRP 1. The terminal may receive the acknowledgment message and the C4 message before expiration of the contention resolution timer started in the third step. Here, the C4 message may include C4-1 information to C4_5 information. In this case, the C4-1 information may be information indicating whether ‘TRP 2’ is true or false. Here, ‘TRP 2’ set to true may mean that a TRP using the second best SSB informed by the terminal is qualified as TRP 2.

The C4-2 information may be information indicating whether ‘RA’ is true or false. Here, ‘RA’ set to true may mean that random access needs to be performed to TRP of the second best SSB. In addition, the C4-3 information may be information indicating whether ‘CBRA’ is true or false. Here, ‘CBRA’ set to true may mean that contention-based random access needs to be performed. In addition, the C4-4 information may include information on CFRA preamble(s). A CFRA preamble may refer to a preamble to be used when performing non-contention-based random access. The CFRA preamble may be indicated by a natural number greater than 1. In addition, the C4_5 information may be other information. The C4-5 information may be any possible information that reduces the overhead of the procedure.

In this case, TRP 1 may generate the C4-1 information of the C4 message based on the information in the C3 message of the third-step message. In other words, TRP 1 may identify that the second best SSB included in the C3 message corresponds to an SSB of TRP 2 based on SSB group-related information. Then, TRP 1 may set the C4_1 information to true. In addition, TRP 1 may generate the C4-2 information of the C4 message based on the information in the C3 message of the third-step message. In other words, when a time difference between a starting point of the best SSB and a starting point of the second best SSB of the C3_3 information of the C3 message is equal to or greater than a predetermined threshold, TRP 1 may set ‘RA’ of the C4-2 information of the C4 message to true. In addition, TRP 1 may arbitrarily decide whether to set ‘CBRA’ to true.

In this situation, the premise that the PCI is the same in the C3-2 information may be true, and ‘TRP 2’ in the C4_1 information may be false. Then, the terminal may ignore other message information, may not perform an additional random access procedure, and perform an RRC setup procedure with TRP 1.

In contrast, the premise that the PCI is the same may be true in the C3-2 information, ‘TRP 2’ in the C4_1 information may be true, and ‘RA’ in the C4-2 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

Meanwhile, the premise that PCI is the same may be true in the C3-2 information, ‘TRP 2’ in the C4_1 information may be true, ‘RA’ in the C4-2 information may be true, and ‘CBRA’ in the C4_3 information may be false. The terminal may proceed with a 2-step CFRA-based setup procedure for TRP 2 (S4420).

To this end, in the first step, the terminal may randomly select one preamble from CFRA preambles. Then, the terminal may transmit one selected preamble to the TRP on a PRACH. Additionally, at the same time, the terminal may transmit a scheduling request (i.e. connection request) message to TRP 2 through a pre-allocated uplink radio resource (i.e. uplink shared channel) (S4421). Then, TRP 2 may receive the preamble and the message including the scheduling request from the terminal.

In this case, TRP 2 may transmit a message including an RAR and a C-RNTI to the terminal on a PDSCH (S4422). Accordingly, the terminal may receive the message including the successful RAR and C-RNTI from TRP 2. The message may serve as acknowledgment. In this case, ‘RA’ may be false in the C4-2 information of the C4 message. Then, TRP 2 may complete the second step. Alternatively, ‘RA’ may be true. Then, the terminal may perform the random access procedure again from the first step. After the second step is completed, the terminal may proceed with an RRC setup procedure.

Then, TRP 1 may transmit an RRC setup message to the terminal (S4430). The terminal may receive the RRC setup message from TRP 1. Accordingly, the terminal may complete RRC setup and transmit an RRC setup complete message to TRP 1 (S4431). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

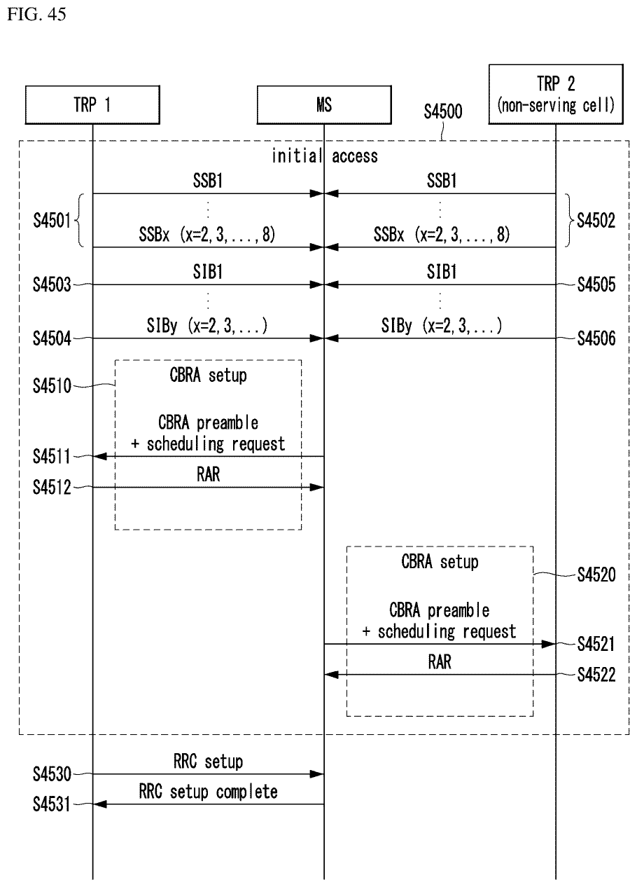

FIG. 45 is a sequence chart illustrating a seventh exemplary embodiment of a transmission method in a multi-TRP environment.

Referring to FIG. 45, a terminal may proceed with an initial access procedure for TRP 1 and TRP 2 (S4500). Here, TRP 1 may belong to a serving cell, and TRP 2 may belong to a non-serving cell. To this end, TRP 1 may transmit beamformed SSBs (e.g. SSB 1 to SSB 8) in multiple directions using the first half frame of one frame (S4501). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

On the other hand, TRP 2 may transmit beamformed SSBs (e.g. SSB 1 to SSB 8) in multiple directions using the second half frame of one frame (S4502). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. An MIB may be transmitted to the terminal on a PBCH. The MIB may be the first system information obtained by the terminal from TRP 2.

Then, TRP 1 may transmit an SIB1 to the terminal using a PDSCH (S4503). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S4504). In this case, TRP 1 may transmit control information to inform that SIBs are to be delivered in succession following the SIB1 by including the control information in the SIB1. The terminal may receive the SIBs other than the SIB1 from TRP 1.

On the other hand, TRP 2 may transmit an SIB1 to the terminal using a PDSCH (S4505). The terminal may obtain the SIB1 located in a time and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S4506). In this case, TRP 2 may transmit control information to inform that SIBs are to be delivered in succession following the SIB1 by including the control information in the SIB1. The terminal may receive the SIBs other than the SIB1 from TRP 2.

Meanwhile, the terminal may obtain information on a PDCCH/SIB bandwidth, CORSET, CSS, and related PDCCH parameter(s) from the MIB obtained from the SSB received from TRP 1, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

In addition, the terminal may obtain information on a PDCCH/SIB bandwidth, CORSET, CSS, and related PDCCH parameter(s) from the MIB obtained from the SSB received from TRP 2, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

Thereafter, the terminal that has completed downlink synchronization and system information acquisition may perform a 2-step CBRA-based random access setup procedure with TRP 1 for uplink synchronization (S4510).

To this end, in the first step, the terminal may randomly select one preamble from all preambles. Then, the terminal may transmit one selected preamble to TRP 1 on a PRACH. Additionally, at the same time, the terminal may transmit a scheduling request (i.e. connection request) message and a C3 message to the TRP through a pre-allocated uplink radio resource (i.e. uplink shared channel) (S4511). Then, TRP 1 may receive the preamble, the scheduling request message, and the C3 message from the terminal. Here, the C3 message may include C3-1 information to C3-5 information. Here, the C3-1 information may be information on the second best SSB. The C3 2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB.

The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs. On the other hand, the C3-3 information may be set to a time difference value measured by the terminal if the time difference is equal to or greater than the predetermined threshold. In addition, the C3 4 information may be information on a difference between the maximum correlation value of an output of a timing estimator or the like for the best SSB and the maximum correlation value of an output of a timing estimator or the like for the second best SSB. The C3-5 information may be other information. The C3_5 information may be any possible information that reduces the overhead of the procedure. When the second SSB grouping method is used, the C3-5 information may include information on a time, which can specify the second half-frame in which the second best SSB is received.

In the second step, TRP may determine whether a preamble is detected. In addition, TRP may determine whether a message is successfully decoded. TRP may transmit a different type of message to the terminal according to a result of the determination. This may cause a subsequent procedure to be different.

Describing in further detail, if TRP does not detect the preamble, TRP may not perform any operation. In other words, TRP may not even check whether a message is received through an uplink radio resource associated with a preamble. As a result, TRP may not make any response in the case where a preamble is not detected. Accordingly, the terminal may reattempt random access because it has not received any message from TRP. This case may be referred to as ‘Case 1’.

On the other hand, TRP may detect the preamble normally and successfully decode the message from an uplink radio resource associated with the preamble. In this case, TRP may transmit a message including an RAR, a C-RNTI, and a C4 message to the terminal on a PDSCH (S4512). Accordingly, the terminal may receive the message including the successful RAR, C-RNTI, and C4 message from TRP 1. The message may serve as acknowledgment.

Here, the C4 message may include C4-1 information to C4_5 information. In this case, the C4_1 information may be information indicating whether ‘TRP 2’ is true or false. Here, ‘TRP 2’ set to true may mean that a TRP using the second best SSB informed by the terminal is qualified as TRP 2.

The C4-2 information may be information indicating whether ‘RA’ is true or false. Here, ‘RA’ set to true may mean that random access needs to be performed to TRP of the second best SSB. In addition, the C4_3 information may be information indicating whether ‘CBRA’ is true or false. Here, ‘CBRA’ set to true may mean that contention-based random access needs to be performed. In addition, the C4 4 information may include information on CFRA preamble(s). A CFRA preamble may refer to a preamble to be used when performing non-contention-based random access. The CFRA preamble may be indicated by a natural number greater than 1. In addition, the C4_5 information may be other information. The C4-5 information may be any possible information that reduces the overhead of the procedure.

In this case, TRP 1 may generate the C4-1 information of the C4 message based on the information in the C3 message of the third-step message. In other words, TRP 1 may identify that the second best SSB included in the C3 message corresponds to an SSB of TRP 2 based on SSB group-related information. Then, TRP 1 may set the C4_1 information to true. In addition, TRP 1 may generate the C4-2 information of the C4 message based on the information in the C3 message of the third-step message. In other words, when a time difference between a starting point of the best SSB and a starting point of the second best SSB of the C3-3 information of the C3 message is equal to or greater than a predetermined threshold, TRP 1 may set ‘RA’ of the C4-2 information of the C4 message to true. In addition, TRP 1 may arbitrarily decide whether to set ‘CBRA’ to true.

In this situation, the premise that the PCI is the same in the C3-2 information may be true, and ‘TRP 2’ in the C4_1 information may be false. Then, the terminal may ignore other message information, may not perform an additional random access procedure, and perform an RRC setup procedure with TRP 1.

In contrast, the premise that the PCI is the same may be true in the C3-2 information, ‘TRP 2’ in the C4_1 information may be true, and ‘RA’ in the C4-2 information may be false. Then, the terminal may not perform an additional random access procedure. In addition, the terminal may adjust a transmission timing of TRP 2 using the C3-3 information and C3 4 information, and perform an RRC setup procedure with TRP 2 by performing power control and assuming that the terminal has accessed TRP 2 transmitting the second best SSB.

Meanwhile, the premise that PCI is the same may be true in the C3-2 information, ‘TRP 2’ in the C4_1 information may be true, ‘RA’ in the C4-2 information may be true, and ‘CBRA’ in the C4_3 information may be true. The terminal may proceed with a 2-step CBRA-based setup procedure for TRP 2 (S4520).

To this end, in the first step, the terminal may randomly select one preamble from among all preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S4521). Then, TRP 2 may receive the preamble and the message including the scheduling request from the terminal.

In the second step, TRP 2 may determine whether a preamble is detected. In addition, TRP 2 may determine whether a message is successfully decoded. TRP 2 may transmit a different type of message to the terminal according to a result of the determination. This may cause a subsequent procedure to be different.

As described above, if the TRP 2 does not detect the preamble, the TRP 2 may not perform any action. In other words, the TRP 2 may not check whether the message is received through the uplink radio resource associated with the preamble. As a result, the TRP 2 may not make any response when the preamble is not detected. Accordingly, the terminal may reattempt the random access because it did not receive any message from the TRP 2. This case may be referred to as Case 1.

On the other hand, TRP 2 may detect the preamble normally and successfully decode the message from the uplink radio resources associated with the preamble. In this case, TRP 2 may transmit a message including an RAR and a C-RNTI to the terminal through a PDSCH (S4512). Accordingly, the terminal may receive the message including the successful RAR and the C-RNTI from TRP 2. This message may serve as an acknowledgement. Accordingly, the terminal may successfully complete the random access procedure. This case may be referred to as ‘Case 2’. Meanwhile, TRP 2 may detect the preamble normally, but may not be able to successfully decode the message from the uplink radio resource associated with the preamble. In this case, TRP 2 may transmit a message including a fallback RAR to the terminal through a PDSCH. In this case, the terminal receiving the message may retransmit the message that it intended to transmit using an uplink radio resource indicated by uplink grant information included in the fallback RAR.

Then, TRP 1 may transmit an RRC setup message to the terminal (S4530). The terminal may receive the RRC setup message from TRP 1. Accordingly, the terminal may complete RRC setup and transmit an RRC setup complete message to TRP 1 (S4531). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

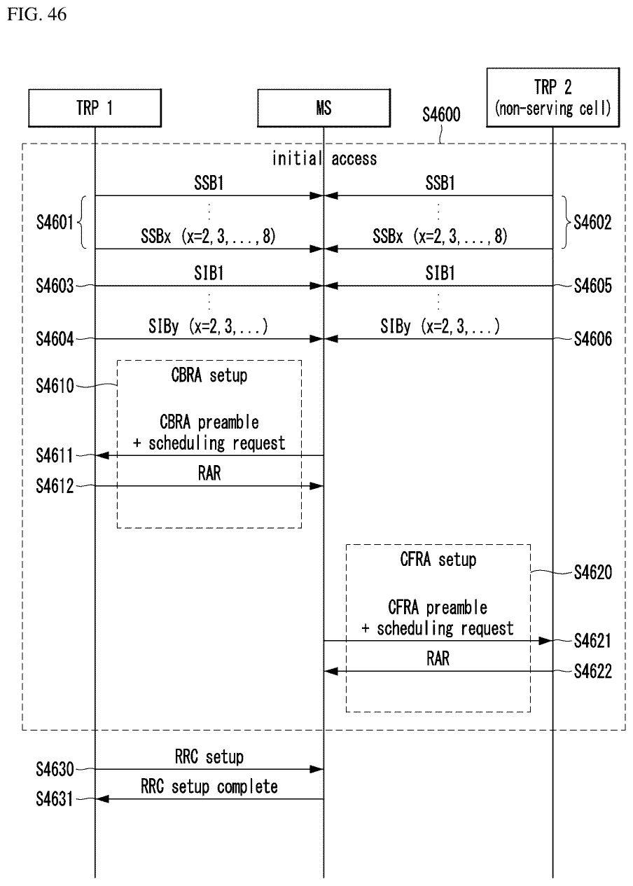

FIG. 46 is a sequence chart illustrating an eighth exemplary embodiment of a transmission method in a multi-TRP environment.

Referring to FIG. 46, a terminal may proceed with an initial access procedure for TRP 1 and TRP 2 (S4600). Here, TRP 1 may belong to a serving cell, and TRP 2 may belong to a non-serving cell. To this end, TRP 1 may transmit beamformed SSBs (e.g. SSB 1 to SSB 8) in multiple directions using the first half frame of one frame (S4601). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

On the other hand, TRP 2 may transmit beamformed SSBs (e.g. SSB 1 to SSB 8) in multiple directions using the second half frame of one frame (S4602). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. An MIB may be transmitted to the terminal on a PBCH. The MIB may be the first system information obtained by the terminal from TRP 2.

Then, TRP 1 may transmit an SIB1 to the terminal using a PDSCH (S4603). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S4604). In this case, TRP 1 may transmit control information to inform that SIBs are to be delivered in succession following the SIB1 by including the control information in the SIB1. The terminal may receive the SIBs other than the SIB1 from TRP 1.

On the other hand, TRP 2 may transmit an SIB1 to the terminal using a PDSCH (S4605). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S4606). In this case, TRP 2 may transmit control information to inform that SIBs are to be delivered in succession following the SIB1 by including the control information in the SIB1. The terminal may receive the SIBs other than the SIB1 from TRP 2.

Meanwhile, the terminal may obtain information on a PDCCH/SIB bandwidth, CORSET, CSS, and related PDCCH parameter(s) from the MIB obtained from the SSB received from TRP 1, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

In addition, the terminal may obtain information on a PDCCH/SIB bandwidth, CORSET, CSS, and related PDCCH parameter(s) from the MIB obtained from the SSB received from TRP 2, as informed by Pdcch-ConfigSIB1. Then, the terminal may obtain a message within the SIB1 by decoding the SIB1 as indicated by the obtained information. In addition, the terminal may obtain messages within the SIBy by successively decoding the SIBy using indication information included in the message within the SIB1.

Thereafter, the terminal that has completed downlink synchronization and system information acquisition may perform a 2-step CBRA-based random access setup procedure with TRP 1 for uplink synchronization (S4610).

To this end, in the first step, the terminal may randomly select one preamble from all preambles. Then, the terminal may transmit one selected preamble to TRP 1 on a PRACH. Additionally, at the same time, the terminal may transmit a scheduling request (i.e. connection request) message and a C3 message to TRP through a pre-allocated uplink radio resource (i.e. uplink shared channel) (S4611). Then, TRP 1 may receive the preamble, the scheduling request message, and the C3 message from the terminal. Here, the C3 message may include C3-1 information to C3_5 information. Here, the C3-1 information may be information on the second best SSB. The C3_2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB.

The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs. On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure. When the second SSB grouping method is used, the C3-5 information may include information on a time, which can specify the second half-frame in which the second best SSB is received.

In the second step, TRP may determine whether a preamble is detected. In addition, TRP may determine whether a message is successfully decoded. TRP may transmit a different type of message to the terminal according to a result of the determination. This may cause a subsequent procedure to be different.

Describing in further detail, if TRP does not detect the preamble, TRP may not perform any operation. In other words, TRP may not even check whether a message is received through an uplink radio resource associated with a preamble. As a result, TRP may not make any response in the case where a preamble is not detected. Accordingly, the terminal may reattempt random access because it has not received any message from TRP. This case may be referred to as ‘Case 1’.

On the other hand, TRP may detect the preamble normally and successfully decode the message from an uplink radio resource associated with the preamble. In this case, TRP may transmit a message including an RAR, a C-RNTI, and a C4 message to the terminal on a PDSCH (S4612). Accordingly, the terminal may receive the message including the successful RAR, C-RNTI, and C4 message from TRP 1. The message may serve as acknowledgment.

Here, the C4 message may include C4-1 information to C4-5 information. In this case, the C4_1 information may be information indicating whether ‘TRP 2’ is true or false. Here, ‘TRP 2’ set to true may mean that a TRP using the second best SSB informed by the terminal is qualified as TRP 2.

The C4-2 information may be information indicating whether ‘RA’ is true or false. Here, ‘RA’ set to true may mean that random access needs to be performed to TRP of the second best SSB. In addition, the C4-3 information may be information indicating whether ‘CBRA’ is true or false. Here, ‘CBRA’ set to true may mean that contention-based random access needs to be performed. In addition, the C4-4 information may include information on CFRA preamble(s). A CFRA preamble may refer to a preamble to be used when performing non-contention-based random access. The CFRA preamble may be indicated by a natural number greater than 1. In addition, the C4-5 information may be other information. The C4-5 information may be any possible information that reduces the overhead of the procedure.

In this case, TRP 1 may generate the C4-1 information of the C4 message based on the information in the C3 message of the third-step message. In other words, TRP 1 may identify that the second best SSB included in the C3 message corresponds to an SSB of TRP 2 based on SSB group-related information. Then, TRP 1 may set the C4-1 information to true. In addition, TRP 1 may generate the C4-2 information of the C4 message based on the information in the C3 message of the third-step message. In other words, when a time difference between a starting point of the best SSB and a starting point of the second best SSB of the C3-3 information of the C3 message is equal to or greater than a predetermined threshold, TRP 1 may set ‘RA’ of the C4-2 information of the C4 message to true. In addition, TRP 1 may arbitrarily decide whether to set ‘CBRA’ to true.

In this situation, the premise that the PCI is the same in the C3-2 information may be true, and ‘TRP 2’ in the C4-1 information may be false. Then, the terminal may ignore other message information, may not perform an additional random access procedure, and perform an RRC setup procedure with TRP 1.

In contrast, the premise that the PCI is the same may be true in the C3-2 information, ‘TRP 2’ in the C4_1 information may be true, and ‘RA’ in the C4-2 information may be false. Then, the terminal may not perform an additional random access procedure. In addition, the terminal may adjust a transmission timing of TRP 2 using the C3-3 information and C3 4 information, and perform an RRC setup procedure with TRP 2 by performing power control and assuming that the terminal has accessed TRP 2 transmitting the second best SSB.

Meanwhile, the premise that PCI is the same may be true in the C3-2 information, ‘TRP 2’ in the C4_1 information may be true, ‘RA’ in the C4-2 information may be true, and ‘CBRA’ in the C4_3 information may be false. The terminal may proceed with a 2-step CFRA-based setup procedure for TRP 2 (S4620).

To this end, in the first step, the terminal may randomly select one preamble from among CFRA preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S4621). Then, TRP 2 may receive the preamble and the message including the scheduling request from the terminal.

In this case, TRP 2 may transmit a message including an RAR and a C-RNTI to the terminal through a PDSCH (S4622). Accordingly, the terminal may receive the message including the successful RAR and the C-RNTI from TRP 2. This message may serve as an acknowledgement. In this case, ‘RA’ may be false in the C4-2 information in the C4 message. Then, TRP 2 may complete the second step. Alternatively, ‘RA’ may be true. Then, the terminal may perform the random access procedure from the first step 1 again. After the second step is completed, the terminal may proceed with an RRC setup procedure.

Then, TRP 1 may transmit an RRC setup message to the terminal (S4630). The terminal may receive the RRC setup message from TRP 1. Accordingly, the terminal may complete RRC setup and transmit an RRC setup complete message to TRP 1 (S4631). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

In the above-described procedure in which the terminal initially accesses TRP 1 and TRP 2, the terminal may obtain a propagation delay with TRP 1 and a propagation delay with TRP 2. In this case, TRP 1 may obtain a propagation delay with the terminal, and TRP 2 may also obtain a propagation delay with the terminal. Using this information, TRP 1 and TRP 2 may individually manage their transmission synchronization points and transmit downlink data to the terminal in a distributed synchronous or sequential manner. In this case, TRP 1 may allow the downlink data to reach the terminal without a time offset with respect to a reception synchronization point of the terminal between TRP 1 and the terminal. Alternatively, TRP 1 may allow the downlink data to reach the terminal with a minimal time offset with respect to the reception synchronization point of the terminal between TRP 1 and the terminal. Alternatively, TRP 1 may allow the downlink data to reach the terminal with a certain time offset with respect to the reception synchronization point of the terminal between TRP 1 and the terminal. In addition, TRP 2 may allow the downlink data to reach the terminal without a time offset with respect to a reception synchronization point of the terminal between TRP 2 and the terminal. Alternatively, TRP 2 may allow the downlink data to reach the terminal with a minimal time offset with respect to the reception synchronization point of the terminal between TRP 2 and the terminal. Alternatively, TRP 2 may allow the downlink data to reach the terminal with a certain time offset with respect to the reception synchronization point of the terminal between TRP 2 and the terminal.

Similarly, the terminal may transmit cooperative uplink data synchronously or sequentially by using the propagation delay with TRP 1 and the propagation delay with TRP 2. The terminal may allow a signal transmitted from the terminal to TRP 1 and a signal transmitted from the terminal to TRP 2 to reach TRP 1 and TRP 2 without an absolute time offset with respect to a reception synchronization point of TRP 1 between TRP 1 and the terminal.

Meanwhile, the propagation delay between TRP 1 and the terminal may be τ1. A propagation delay between TRPm and the terminal may be τm. In this case, a time difference Δτm between the propagation delays may be τ1-τm. The difference Atm between the propagation delays may be defined as a propagation delay difference (PDD) of TRPm. Here, m may be a positive integer. In this case, frequency domain data transmitted from TRPm to the terminal may be allocated to a total of four subcarrier resources with subcarrier indices 1, 2, 3, and 4. Accordingly, the frequency domain data may be expressed as dm having a total of four data vectors, as in Equation 1 below. Here, d1,m may be data transmitted from TRPm to the terminal through the subcarrier with index 1. d2,m may be data transmitted from TRPm to the terminal through the subcarrier with index 2. d3,m may be data transmitted from TRPm to the terminal through the subcarrier with index 3. d4,m may be data transmitted from TRPm to the terminal through the subcarrier with index 4.

$${d}_{m} = [ \begin{matrix}{d}_{1 , m} \\ {d}_{2 , m} \\ {d}_{3 , m} \\ {d}_{4 , m}\end{matrix} ] \qquad [ Equation 1 ]$$

Meanwhile, a propagation delay difference matrix Qm of TRPm may be as shown in Equation 2 below.

$${Q}_{m} = [ \begin{matrix}{Q}_{11 , m} & 0 & 0 & 0 \\ 0 & {Q}_{22 , m} & 0 & 0 \\ 0 & 0 & {Q}_{33 , m} & 0 \\ 0 & 0 & 0 & {Q}_{44 , m}\end{matrix} ] \qquad [ Equation 2 ]$$

Here, Qii,m may be as shown in Equation 3 below. Here, i may be a subcarrier index and may be 1, 2, 3, or 4. k may be 1, 2, 3, or 4.

$${Q}_{i i , m} = {e}^{j \frac{\pm 2 π Δ {τ}_{m} k}{N}} \qquad [ Equation 3 ]$$

Meanwhile, a final frequency domain data vector obtained by compensating for the propagation delay difference of TRPm may be as shown in Equation 4 below.

$${\overline{d}}_{m} = {Q}_{m} {d}_{m} \qquad [ Equation 4 ]$$

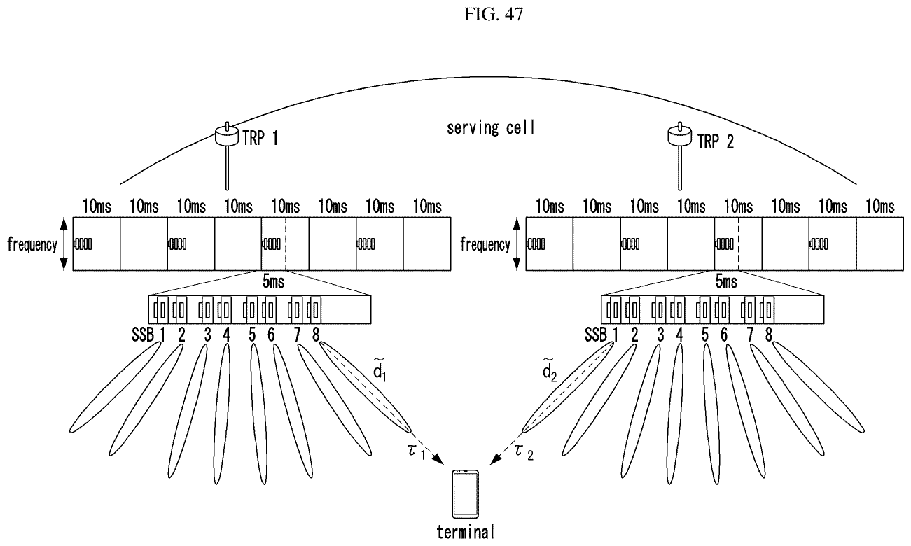

FIG. 47 is a conceptual diagram illustrating a first exemplary embodiment of a method for controlling downlink timings of multiple transmission and reception points in a communication system.

Referring to FIG. 47, if TRP 1 and TRP 2 belonging to a serving cell transmit PDD-compensated data vectors in allocated frequency resources as in Equation 4, distributed downlink synchronous or sequential cooperative transmission may be possible without affecting signals of other terminals.

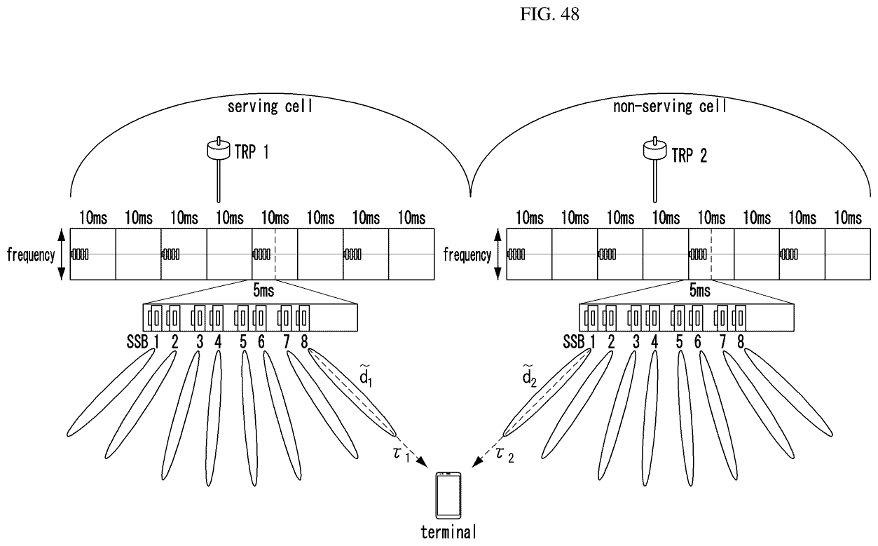

FIG. 48 is a conceptual diagram illustrating a second exemplary embodiment of a method for controlling downlink timings of multiple transmission and reception points in a communication system.

Referring to FIG. 48, if TRP 1 belonging to a serving cell and TRP 2 belonging to a non-serving cell transmit PDD-compensated data vectors in allocated frequency resources as in Equation 4, distributed downlink synchronous or sequential cooperative transmission may be possible without affecting signals of other terminals.

Then, the terminal may know the PDD Δτ1 with TRP 1 and the PDD Δτ2 with TRP 2. Using these, the terminal may allow a signal transmitted from the terminal to TRP 1 and a signal transmitted from the terminal to TRP 2 to reach a reception synchronization point of TRP 1 between the terminal and TRP 1 without an absolute time offset in the frequency domain or the time domain.

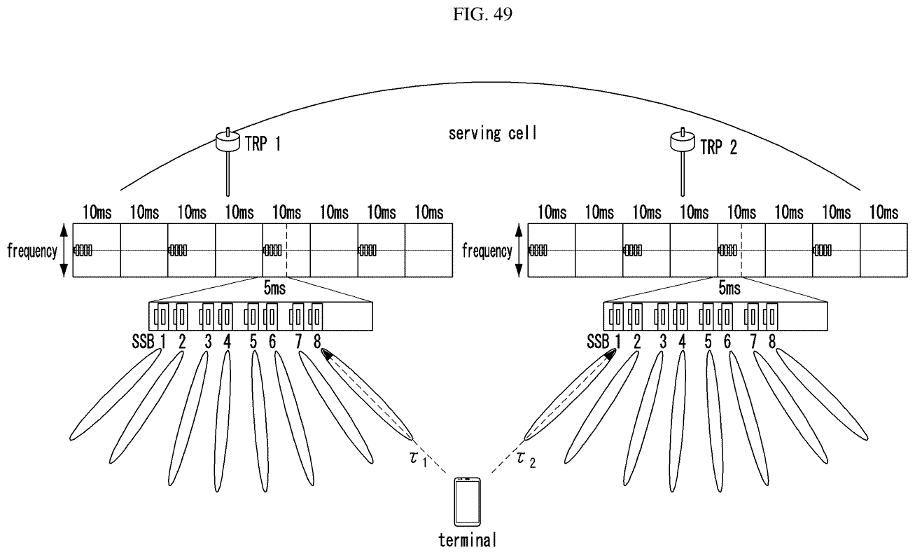

FIG. 49 is a conceptual diagram illustrating a first exemplary embodiment of a method for controlling uplink timings of multiple transmission and reception points in a communication system.

Referring to FIG. 49, in a frequency domain-based uplink M-TRP transmission method, the terminal may generate a compensated equivalent signal that is physically advanced by Atm, by compensating for a PDD in the frequency domain and converting it into a time domain signal. A time domain uplink M-TRP transmission method may transmit a signal by physically advancing the signal by Atm.

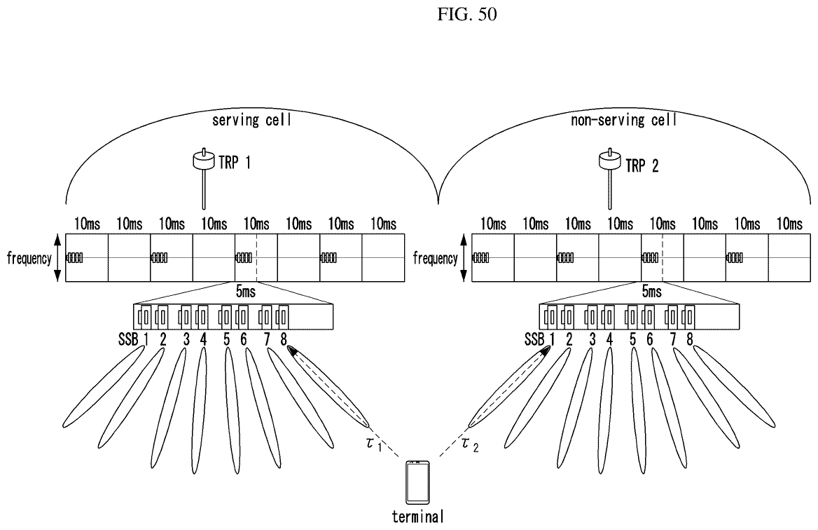

FIG. 50 is a conceptual diagram illustrating a second exemplary embodiment of a method for controlling uplink timings of multiple transmission and reception points in a communication system.

Referring to FIG. 50, in a frequency domain-based uplink M-TRP transmission method, the terminal may generate a compensated equivalent signal that is physically advanced by Atm, by compensating for a PDD in the frequency domain and converting it into a time domain signal. A time domain uplink M-TRP transmission method may transmit a signal by physically advancing the signal by Atm.

The first intra-cell/inter-cell M-TRP procedure method may have the following characteristics.

The first intra-cell/inter-cell M-TRP procedure method has been described with the second best SSB, but may not be limited thereto. The first intra-cell/inter-cell M-TRP procedure method may be extended and applied to the third best SSB, etc.

The first intra-cell/inter-cell M-TRP procedure method has been described with an example with up to TRP 2. However, the first intra-cell/inter-cell M-TRP procedure method may not be limited thereto. The first intra-cell/inter-cell M-TRP procedure method may be extended and applied to TRP3, TRP4, etc.

In the first intra-cell/inter-cell M-TRP procedure method, information on a difference between the maximum correlation value of an output of a timing estimator or the like for the best SSB and the maximum correlation value of an output of a timing estimator or the like for the second best SSB, which is obtained during the timing and PCI estimation process for the SSBs in the initial access stage, may be used for power control for TRP 2 to improve link quality and reduce co-channel interference to adjacent MS/TRP/cells.

Meanwhile, the second intra-cell/inter-cell M-TRP procedure method may apply the second SSB grouping method. In the second intra-cell/inter-cell M-TRP procedure method, the terminal may estimate the SSB 8 belonging to TRP 1 as the best SSB, and may estimate the SSB 1 belonging to TRP 2 as the second best SSB. In other words, in the second intra-cell/inter-cell M-TRP procedure method, the terminal may estimate the best SSB and the second best SSB from the beamformed SSBs transmitted by TRP 1 and TRP 2 when the terminal is powered on. At this time, the terminal cannot know whether the SSBs estimated by the terminal belong to TRP 1 or TRP 2. Then, the terminal may obtain an MIB from a PBCH existing in the SSB. The terminal may obtain information on an index of the SSB from the MIB. Thereafter, the terminal may acquire uplink synchronization with TRP 1 that transmitted the best SSB and a C-RNTI by using the index of the SSB. At this time, the index of the best SSB obtained by the terminal may indicate the SSB 8 transmitted in the first half frame.

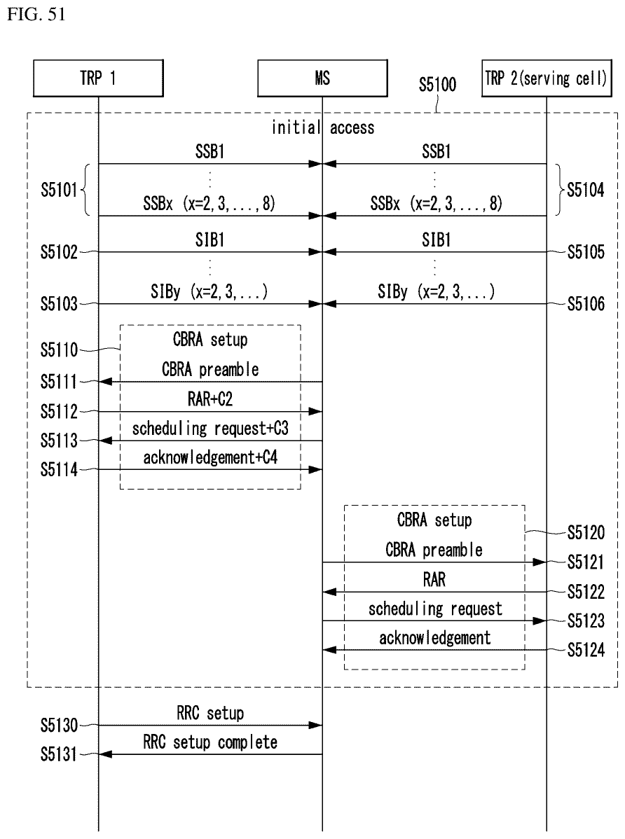

FIG. 51 is a sequence chart illustrating a ninth exemplary embodiment of a transmission method in a multi-TRP environment.

Referring to FIG. 51, a terminal may proceed with an initial access procedure for TRP 1 and TRP 2 (S5100). Here, TRP 1 and TRP 2 may belong to a serving cell. First, TRP 1 may transmit beamformed SSBs (e.g. SSB 1 to SSB 8) in multiple directions using the first half frame of one frame (S5101). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

Then, TRP 1 may transmit an SIB1 to the terminal using a PDSCH (S5102). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S5103). In this case, TRP 1 may transmit control information to inform that SIBs are to be delivered in succession following the SIB1 by including the control information in the SIB1. The terminal may receive the SIBs other than the SIB1 from TRP 1.

Accordingly, the terminal may obtain information on a PDCCH/SIB bandwidth, CORSET, CSS, and related PDCCH parameter(s) from the MIB of the best SSB, as informed by Pdcch-ConfigSIB1. Then, the terminal may obtain a message within the SIB1 by decoding the SIB1 received from TRP 1 as indicated by the obtained information. In addition, the terminal may obtain messages within the SIBy by successively decoding the SIBy using indication information included in the message within the SIB1 received from TRP 1.

TRP 2 may transmit beamformed SSBs (e.g. SSB 1 to SSB 8) in multiple directions using the second half frame of one frame (S5104). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

Then, TRP 2 may transmit an SIB1 to the terminal using a PDSCH (S5105). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S5106). In this case, TRP 2 may transmit control information to inform that SIBs are to be delivered in succession following the SIB1 by including the control information in the SIB1. The terminal may receive the SIBs other than the SIB1 from TRP 2.

Accordingly, the terminal may obtain information on a PDCCH/SIB bandwidth, CORSET, CSS, and related PDCCH parameter(s) from the MIB of the second best SSB, as informed by Pdcch-ConfigSIB1. Then, the terminal may obtain a message within the SIB1 by decoding the SIB1 received from TRP 2 as indicated by the obtained information. In addition, the terminal may obtain messages within the SIBy by successively decoding the SIBy using indication information included in the message within the SIB1 received from TRP 2.

Thereafter, the terminal that has completed downlink synchronization and system information acquisition may perform a 4-step CBRA-based random access setup procedure with TRP 1 for uplink synchronization (S5110).

In the first step, the terminal may randomly select one preamble among all preambles provided by TRP 1. Then, the terminal may transmit the selected preamble to TRP 1 on a PRACH (S5111). Then, TRP 1 may receive the preamble from the terminal on the PRACH. In this case, a beam direction may follow an uplink direction reciprocal to a beam direction used when receiving a signal in downlink. A resource for transmitting the preamble from the terminal to TRP 1 may be based on information on association between SSBs and RACH occasions, which is obtained in advance. TRP 1 may estimate the terminal's propagation delay using the preamble.

Then, in the second step, TRP 1 may determine whether a preamble is present in a signal received through the PRACH. The preamble may be randomly selected and transmitted by the terminal. Therefore, TRP 1 cannot specify which terminal transmitted the preamble based on whether or not the preamble is detected. Therefore, TRP 1 cannot determine how many terminals used the detected preamble. Accordingly, TRP 1 may transmit an RAR based on an index of the detected preamble and a C2 message to the terminal on a PDSCH (S5112). Then, the terminal may receive the RAR and C2 message from TRP 1. In this case, the RAR may include the preamble index, TA value, uplink grant information, and temporary C-RNTI.

Here, the C2 message may include C2-1 information and C2-2 information. The C2-1 information may include SSB group-related information. In this case, the SSB group-related information may include SSB group information. In addition, the SSB group information may include SSB group type information and information on SSBs included in each of SSB groups based on the SSB group type information. The SSB group type information may indicate an SSB grouping method. For example, when the total number of SSBs is 8, an SSB group type 0 may indicate the methods of FIGS. 9 and 10, and an SSB group type 1 may indicate the methods of FIGS. 11 and 12. The C2-2 information may be all possible information that reduces the overhead of the procedure. For example, the C2-2 information may be a TAG ID for a communication link between the terminal and TRP 1 for uplink synchronization. TRP 1 may not include the C2_1 information in the C2 message to further increase the efficiency of uplink synchronization. The C2_2 information may include the TAG ID. In this case, the messages of the random access procedures may use the messages in FIGS. 6 and 7.

Then, in the third step, the terminal may transmit a scheduling request message (or connection request message) and a C3 message to TRP 1 through a PUSCH by applying the temporary C-RNTI and using an uplink radio resource indicated by the uplink grant information included in the RAR (S5113). Then, TRP 1 may receive the connection request message and the C3 message from the terminal. Here, there may be more than one terminal that transmitted the same preamble in the first step. As a result, preamble collisions may occur. In this case, all terminals that transmitted the same preamble may refer to the same RAR, and transmit messages using the same radio resource. This may cause a collision.

Here, the C3 message may include C3-1 information to C3-5 information. In this case, the C3_1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on the SSB group-related information in the C2 message. In other words, the terminal may know that the second best SSB is an SSB of TRP 2 based on the SSB group-related information. Then, the terminal may set the C3-1 information to true.

In other words, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit a message including acknowledgment and a C4 message to the terminal through a PD SCH in response to the successfully decoded message (S5114). Then, the terminal may receive the message including the acknowledgement message and the C4 message from TRP 1. The terminal may receive the message including the acknowledgement and the C4 message before expiration of the contention resolution timer started in the third step. Here, the C4 message may include C4-1 information to C4_4 information. In this case, the C4_1 information may be information indicating whether ‘RA’ is true or false. ‘RA’ set to true may mean that random access needs to be performed for a TRP of the second best SSB. In addition, the C4 2 information may be information indicating whether ‘CBRA’ is true or false. Here, ‘CB RA’ set to true may mean that contention-based random access needs to be performed. In addition, the C4-3 information may include information on indices for CFRA preambles. The CFRA preamble may mean a preamble to be used when performing non-contention-based random access. The index of the CFRA preamble may be a natural number greater than 1. In addition, the C4_4 information may be other information. The C4_4 information may be any possible information that reduces the overhead of the procedure.

In this case, TRP 1 may generate the C4-1 information of the C4 message based on the information in the C3 message of the third-step message. In other words, when a time difference between a starting point of the best SSB and a starting point of the second best SSB, which is included in the C3-3 information of the C3 message, is equal to or greater than a predetermined threshold, TRP 1 may set ‘RA’ of the C4_1 information of the C4 message to true. In addition, TRP 1 may arbitrarily decide whether to set ‘CBRA’ to true.

In this situation, ‘TRP 2’ may be true in the C3-1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be true in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be true in the C3-2 information. ‘RA’ may be true in the C4_1 information, and ‘CBRA’ may be true in the C4-2 information. TRP 1 may indicate the terminal to perform CBRA random access for an RO indicated by the SIB obtained based on the second best SSB through high layer signaling or PDCCH. Accordingly, the terminal may receive the indication to perform the CBRA random access from TRP 1. Accordingly, the terminal may perform a 4-step CBRA-based setup procedure for TRP 2 (S5120).

In the first step, the terminal may randomly select one preamble among all preambles provided by TRP 1. Then, the terminal may transmit the selected preamble to TRP 2 on a PRACH (S5121). Then, TRP 1 may receive the preamble from the terminal on the PRACH. In this case, a beam direction may follow an uplink direction reciprocal to a beam direction used when receiving a signal in the downlink. A resource for transmitting the preamble from the terminal to TRP 2 may be based on information on association between SSBs and RACH occasions, which is obtained in advance. TRP 2 may estimate the terminal's propagation delay based on the preamble.

Then, in the second step, TRP 2 may determine whether a preamble is present in a signal received through the PRACH. The preamble may be randomly selected and transmitted by the terminal. Therefore, TRP 2 cannot specify which terminal transmitted the preamble based on whether or not the preamble is detected. Therefore, TRP 2 cannot determine how many terminals used the detected preamble. Accordingly, TRP 2 may transmit an RAR based on an index of the detected preamble to the terminal on a PDSCH (S5122). Then, the terminal may receive the RAR from TRP 2. In this case, the RAR may include the preamble index, a TA value, uplink grant information, and a temporary C-RNTI. Here, TRP 2 may transmit information related to the RAR to TRP 1. Then, TRP 1 may receive the information related to the RAR from TRP 2. TRP 1 may transmit the RAR to the terminal based on the information related to the RAR received from TRP 2.

Then, in the third step, the terminal may transmit a scheduling request message (or connection request message) to TRP 2 through a PUSCH by applying the temporary C-RNTI and using an uplink radio resource indicated by the uplink grant information included in the RAR (S5123). Then, TRP 2 may receive the connection request message from the terminal. Here, there may be more than one terminal that transmitted the same preamble in the first step. As a result, preamble collisions may occur. In this case, all terminals that transmitted the same preamble may refer to the same RAR, and transmit messages using the same radio resource. This may cause a collision.

In other words, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 2 may decode the received third-step message. TRP 2 may transmit an acknowledgment message to the terminal through a PDSCH in response to the successfully decoded message (S5124). Then, the terminal may receive the acknowledgement message from TRP 2. The terminal may receive the acknowledgement message before expiration of the contention resolution timer started in the third step.

Then, TRP 1 may transmit an RRC setup message to the terminal (S5130). The terminal may receive the RRC setup message from TRP 1. Accordingly, the terminal may complete RRC setup and transmit an RRC setup complete message to TRP 1 (S5131). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

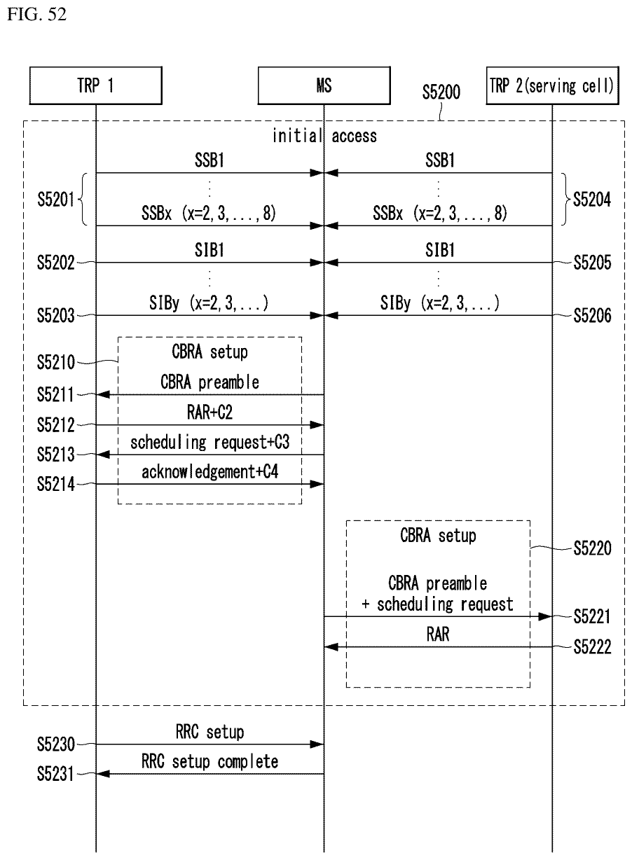

FIG. 52 is a sequence chart illustrating a tenth exemplary embodiment of a transmission method in a multi-TRP environment.

Referring to FIG. 52, a terminal may proceed with an initial access procedure for TRP 1 and TRP 2 (S5200). Here, TRP 1 and TRP 2 may belong to a serving cell. First, TRP 1 may transmit beamformed SSBs (e.g. SSB 1 to SSB 8) in multiple directions using the first half frame of one frame (S5201). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

Then, TRP 1 may transmit an SIB1 to the terminal using a PDSCH (S5202). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S5203). In this case, TRP 1 may transmit control information to inform that SIBs are to be delivered in succession following the SIB1 by including the control information in the SIB1. The terminal may receive the SIBs other than the SIB1 from TRP 1.

Accordingly, the terminal may obtain information on a PDCCH/SIB bandwidth, CORSET, CSS, and related PDCCH parameter(s) from the MIB of the best SSB, as informed by Pdcch-ConfigSIB1. Then, the terminal may obtain a message within the SIB1 by decoding the SIB1 received from TRP 1 as indicated by the obtained information. In addition, the terminal may obtain messages within the SIBy by successively decoding the SIBy using indication information included in the message within the SIB1 received from TRP 1.

Then, TRP 2 may transmit beamformed SSBs (e.g. SSB 1 to SSB 8) in multiple directions using the second half frame of one frame (S5204). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

Then, TRP 2 may transmit an SIB1 to the terminal using a PDSCH (S5205). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S5206). In this case, TRP 2 may transmit control information to inform that SIBs are to be delivered in succession following the SIB1 by including the control information in the SIB1. The terminal may receive the SIBs other than the SIB1 from TRP 2.

Accordingly, the terminal may obtain information on a PDCCH/SIB bandwidth, CORSET, CSS, and related PDCCH parameter(s) from the MIB of the second best SSB, as informed by Pdcch-ConfigSIB1. Then, the terminal may obtain a message within the SIB1 by decoding the SIB1 received from TRP 2 as indicated by the obtained information. In addition, the terminal may obtain messages within the SIBy by successively decoding the SIBy using indication information included in the message within the SIB1 received from TRP 2.

Thereafter, the terminal that has completed downlink synchronization and system information acquisition may perform a 4-step CBRA-based random access setup procedure with TRP 1 for uplink synchronization (S5210).

In the first step, the terminal may randomly select one preamble among all preambles provided by TRP 1. Then, the terminal may transmit the selected preamble to TRP 1 on a PRACH (S5211). Then, TRP 1 may receive the preamble from the terminal on the PRACH. In this case, a beam direction may follow an uplink direction reciprocal to a beam direction used when receiving a signal in downlink. A resource for transmitting the preamble from the terminal to TRP 1 may be based on information on association between SSBs and RACH occasions, which is obtained in advance. TRP 1 may estimate the terminal's propagation delay based on the preamble.

Then, in the second step, TRP 1 may determine whether a preamble is present in a signal received through the PRACH. The preamble may be randomly selected and transmitted by the terminal. Therefore, TRP 1 cannot specify which terminal transmitted the preamble based on whether or not the preamble is detected. Therefore, TRP 1 cannot determine how many terminals used the detected preamble. Accordingly, TRP 1 may transmit an RAR based on an index of the detected preamble and a C2 message to the terminal on a PDSCH (S5212). Then, the terminal may receive the RAR and C2 message from TRP 1. In this case, the RAR may include the preamble index, a TA value, uplink grant information, and a temporary C-RNTI.

Here, the C2 message may include C2-1 information and C2-2 information. The C2-1 information may include SSB group-related information. In this case, the SSB group-related information may include SSB group information. In addition, the SSB group information may include SSB group type information and information on SSBs included in each of SSB groups based on the SSB group type information. The SSB group type information may indicate an SSB grouping method. For example, when the total number of SSBs is 8, an SSB group type 0 may indicate the methods of FIGS. 9 and 10, and an SSB group type 1 may indicate the methods of FIGS. 11 and 12. The C2-2 information may be all possible information that reduces the overhead of the procedure. For example, the C2-2 information may be a TAG ID for a communication link between the terminal and TRP 1 for uplink synchronization. TRP 1 may not include the C2_1 information in the C2 message to further increase the efficiency of uplink synchronization. The C2-2 information may include the TAG ID. In this case, the messages of the random access procedures may use the messages in FIGS. 6 and 7.

Then, in the third step, the terminal may transmit a scheduling request message (or connection request message) and a C3 message to TRP 1 through a PUSCH by applying the temporary C-RNTI and using an uplink radio resource indicated by the uplink grant information included in the RAR (S5213). Then, TRP 1 may receive the connection request message and the C3 message from the terminal. Here, there may be more than one terminal that transmitted the same preamble in the first step. As a result, preamble collisions may occur. In this case, all terminals that transmitted the same preamble may refer to the same RAR, and transmit messages using the same radio resource. This may cause a collision.

Here, the C3 message may include C3-1 information to C3-5 information. In this case, the C3-1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on the SSB group-related information in the C2 message. In other words, the terminal may know that the second best SSB is an SSB of TRP 2 based on the SSB group-related information. Then, the terminal may set the C3-1 information to true.

Meanwhile, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit a message including acknowledgment and a C4 message to the terminal through a PD SCH in response to the successfully decoded message (S5214). Then, the terminal may receive the message including the acknowledgement message and the C4 message from TRP 1. The terminal may receive the message including the acknowledgement and the C4 message before expiration of the contention resolution timer started in the third step. Here, the C4 message may include C4-1 information to C4_4 information. In this case, the C4_1 information may be information indicating whether ‘RA’ is true or false. ‘RA’ set to true may mean that random access needs to be performed for a TRP of the second best SSB. In addition, the C4-2 information may be information indicating whether ‘CBRA’ is true or false. Here, ‘CBRA’ set to true may mean that contention-based random access needs to be performed. In addition, the C4-3 information may include information on indices for CFRA preambles. The CFRA preamble may mean a preamble to be used when performing non-contention-based random access. The index of the CFRA preamble may be a natural number greater than 1. In addition, the C4_4 information may be other information. The C4_4 information may be any possible information that reduces the overhead of the procedure.

In this case, TRP 1 may generate the C4-1 information of the C4 message based on the information in the C3 message of the third-step message. In other words, when a time difference between a starting point of the best SSB and a starting point of the second best SSB, which is included in the C3-3 information of the C3 message, is equal to or greater than a predetermined threshold, TRP 1 may set ‘RA’ of the C4_1 information of the C4 message to true. In addition, TRP 1 may arbitrarily decide whether to set ‘CBRA’ to true.

In this situation, ‘TRP 2’ may be true in the C3-1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be true in the C3-2 information, and ‘RA’ in the C4_1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be true in the C3_2 information. ‘RA’ may be true in the C4-1 information, and ‘CBRA’ may be false in the C4-2 information. TRP 1 may indicate the terminal to perform CFRA random access for non-contention preamble index(es) and an RO indicated by the SIB obtained based on the second best SSB through high layer signaling or PDCCH. Accordingly, the terminal may receive the indication to perform the CFRA random access from TRP 1. Accordingly, the terminal may perform a 2-step CFRA-based setup procedure for TRP 2 (S5220).

To this end, in the first step, the terminal may randomly select one preamble from among CFRA preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S5221). Then, TRP 2 may receive a message including the preamble and the scheduling request message from the terminal. Here, TRP 2 may be aware of the terminal's CFRA-based setup procedure before the start of the first step.

In this case, TRP 2 may transmit a message including an RAR and a C-RNTI to the terminal through a PDSCH (S5222). Accordingly, the terminal may receive the message including the successful RAR and the C-RNTI from TRP 2. This message may serve as an acknowledgement. The terminal may proceed with an RRC setup procedure after the second step is completed. Here, TRP 2 may transmit information related to the RAR to TRP 1. Then, TRP 1 may receive the information related to the RAR from TRP 2. Then, TRP 1 may transmit the RAR to the terminal based on the information related to the RAR received from TRP 2.

Then, TRP 1 may transmit an RRC setup message to the terminal (S5230). The terminal may receive the RRC setup message from TRP 1. Accordingly, the terminal may complete RRC setup and transmit an RRC setup complete message to TRP 1 (S5231). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

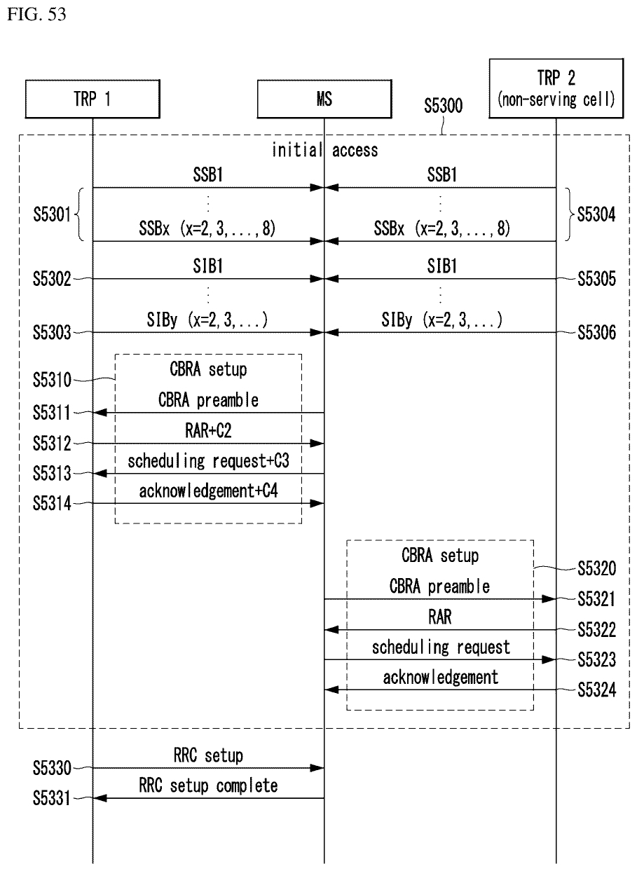

FIG. 53 is a sequence chart illustrating an eleventh exemplary embodiment of a transmission method in a multi-TRP environment.

Referring to FIG. 53, a terminal may proceed with an initial access procedure for TRP 1 and TRP 2 (S5300). Here, TRP 1 may belong to a serving cell, and TRP 2 may belong to a non-serving cell. First, TRP 1 may transmit beamformed SSBs (e.g. SSB 1 to SSB 8) in multiple directions using the first half frame of one frame (S5301). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

Then, TRP 1 may transmit an SIB1 to the terminal using a PDSCH (S5302). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S5303). In this case, TRP 1 may transmit control information to inform that SIBs are to be delivered in succession following the SIB1 by including the control information in the SIB1. The terminal may receive the SIBs other than the SIB1 from TRP 1.

Accordingly, the terminal may obtain information on a PDCCH/SIB bandwidth, CORSET, CSS, and related PDCCH parameter(s) from the MIB of the best SSB, as informed by Pdcch-ConfigSIB1. Then, the terminal may obtain a message within the SIB1 by decoding the SIB1 received from TRP 1 as indicated by the obtained information. In addition, the terminal may obtain messages within the SIBy by successively decoding the SIBy using indication information included in the message within the SIB1 received from TRP 1.

Then, TRP 2 may transmit beamformed SSBs (e.g. SSB 1 to SSB 8) in multiple directions using the second half frame of one frame (S5304). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

Then, TRP 2 may transmit an SIB1 to the terminal using a PDSCH (S5305). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S5306). In this case, TRP 2 may transmit control information to inform that SIBs are to be delivered in succession following the SIB1 by including the control information in the SIB1. The terminal may receive the SIBs other than the SIB1 from TRP 2.

Accordingly, the terminal may obtain information on a PDCCH/SIB bandwidth, CORSET, CSS, and related PDCCH parameter(s) from the MIB of the second best SSB, as informed by Pdcch-ConfigSIB1. Then, the terminal may obtain a message within the SIB1 by decoding the SIB1 received from TRP 2 as indicated by the obtained information. In addition, the terminal may obtain messages within the SIBy by successively decoding the SIBy using indication information included in the message within the SIB1 received from TRP 2.

Thereafter, the terminal that has completed downlink synchronization and system information acquisition may perform a 4-step CBRA-based random access setup procedure with TRP 1 for uplink synchronization (S5310).

In the first step, the terminal may randomly select one preamble among all preambles provided by TRP 1. Then, the terminal may transmit the selected preamble to TRP 1 on a PRACH (S5311). Then, TRP 1 may receive the preamble from the terminal on the PRACH. In this case, a beam direction may follow an uplink direction reciprocal to a beam direction used when receiving a signal in downlink. A resource for transmitting the preamble from the terminal to TRP 1 may be based on information on association between SSBs and RACH occasions, which is obtained in advance. TRP 1 may estimate the terminal's propagation delay based on the preamble.

Then, in the second step, TRP 1 may determine whether a preamble is present in a signal received through the PRACH. The preamble may be randomly selected and transmitted by the terminal. Therefore, TRP 1 cannot specify which terminal transmitted the preamble based on whether or not the preamble is detected. Therefore, TRP 1 cannot determine how many terminals used the detected preamble. Accordingly, TRP 1 may transmit an RAR based on an index of the detected preamble and a C2 message to the terminal on a PDSCH (S5312). Then, the terminal may receive the RAR and C2 message from TRP 1. In this case, the RAR may include the preamble index, a TA value, uplink grant information, and a temporary C-RNTI.

Here, the C2 message may include C2-1 information and C2-2 information. The C2_1 information may include SSB group-related information. In this case, the SSB group-related information may include SSB group information. In addition, the SSB group information may include SSB group type information and information on SSBs included in each of SSB groups based on the SSB group type information. The SSB group type information may indicate an SSB grouping method. For example, when the total number of SSBs is 8, an SSB group type 0 may indicate the methods of FIGS. 9 and 10, and an SSB group type 1 may indicate the methods of FIGS. 11 and 12. The C2-2 information may be all possible information that reduces the overhead of the procedure. For example, the C2-2 information may be a TAG ID for a communication link between the terminal and TRP 1 for uplink synchronization. TRP 1 may not include the C2_1 information in the C2 message to further increase the efficiency of uplink synchronization. The C2-2 information may include the TAG ID. In this case, the messages of the random access procedures may use the messages in FIGS. 6 and 7.

Then, in the third step, the terminal may transmit a scheduling request message (or connection request message) and a C3 message to TRP 1 through a PUSCH by applying the temporary C-RNTI and using an uplink radio resource indicated by the uplink grant information included in the RAR (S5313). Then, TRP 1 may receive the connection request message and the C3 message from the terminal. Here, there may be more than one terminal that transmitted the same preamble in the first step. As a result, preamble collisions may occur. In this case, all terminals that transmitted the same preamble may refer to the same RAR, and transmit messages using the same radio resource. This may cause a collision.

Here, the C3 message may include C3-1 information to C3-5 information. In this case, the C3-1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3_3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on the SSB group-related information in the C2 message. In other words, the terminal may know that the second best SSB is an SSB of TRP 2 based on the SSB group-related information. Then, the terminal may set the C3-1 information to true.

Meanwhile, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit a message including acknowledgment and a C4 message to the terminal through a PD SCH in response to the successfully decoded message (S5314). Then, the terminal may receive the message including the acknowledgement message and the C4 message from TRP 1. The terminal may receive the message including the acknowledgement and the C4 message before expiration of the contention resolution timer activated in the third step. Here, the C4 message may include C4-1 information to C4_4 information. In this case, the C4-1 information may be information indicating whether ‘RA’ is true or false. ‘RA’ set to true may mean that random access needs to be performed for a TRP of the second best SSB. In addition, the C4-2 information may be information indicating whether ‘CBRA’ is true or false. Here, ‘CBRA’ set to true may mean that contention-based random access needs to be performed. In addition, the C4_3 information may include information on indices for CFRA preambles. The CFRA preamble may mean a preamble to be used when performing non-contention-based random access. The index of the CFRA preamble may be a natural number greater than 1. In addition, the C4_4 information may be other information. The C4-4 information may be any possible information that reduces the overhead of the procedure.

In this case, TRP 1 may generate the C4-1 information of the C4 message based on the information in the C3 message of the third-step message. In other words, when a time difference between a starting point of the best SSB and a starting point of the second best SSB, which is included in the C3-3 information of the C3 message, is equal to or greater than a predetermined threshold, TRP 1 may set ‘RA’ of the C4-1 information of the C4 message to true. In addition, TRP 1 may arbitrarily decide whether to set ‘CBRA’ to true.

In this situation, ‘TRP 2’ may be true in the C3-1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be false in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be false in the C3-2 information. ‘RA’ may be true in the C4_1 information, and ‘CBRA’ may be true in the C4-2 information. TRP 1 may indicate the terminal to perform CBRA random access for an RO indicated by the SIB obtained based on the second best SSB through high layer signaling or PDCCH. Accordingly, the terminal may receive the indication to perform the CBRA random access from TRP 1. Accordingly, the terminal may perform a 4-step CBRA-based setup procedure for TRP 2 (S5320).

In the first step, the terminal may randomly select one preamble among all preambles provided by TRP 2. Then, the terminal may transmit the selected preamble to TRP 2 on a PRACH (S5321). Then, TRP 2 may receive the preamble from the terminal on the PRACH. In this case, a beam direction may follow an uplink direction reciprocal to a beam direction used when receiving a signal in downlink. A resource for transmitting the preamble from the terminal to TRP 2 may be based on information on association between SSBs and RACH occasions, which is obtained in advance. TRP 2 may estimate the terminal's propagation delay based on the preamble.

Then, in the second step, TRP 2 may determine whether a preamble is present in a signal received through the PRACH. The preamble may be randomly selected and transmitted by the terminal. Therefore, TRP 2 cannot specify which terminal transmitted the preamble based on whether or not the preamble is detected. Therefore, TRP 2 cannot determine how many terminals used the detected preamble. Accordingly, TRP 2 may transmit an RAR based on an index of the detected preamble to the terminal on a PDSCH (S5322). Then, the terminal may receive the RAR from TRP 2. In this case, the RAR may include the preamble index, a TA value, uplink grant information, and a temporary C-RNTI. Here, TRP 2 may transmit information related to the RAR to TRP 1. Then, TRP 1 may receive the information related to the RAR from TRP 2. TRP 1 may transmit the RAR to the terminal based on the information related to the RAR received from TRP 2.

Then, in the third step, the terminal may transmit a scheduling request message (or connection request message) to TRP 2 through a PUSCH by applying the temporary C-RNTI and using an uplink radio resource indicated by the uplink grant information included in the RAR (S5323). Then, TRP 2 may receive the connection request message from the terminal. Here, there may be more than one terminal that transmitted the same preamble in the first step. As a result, preamble collisions may occur. In this case, all terminals that transmitted the same preamble may refer to the same RAR, and transmit messages using the same radio resource. This may cause a collision.

In other words, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 2 may decode the received third-step message. TRP 2 may transmit an acknowledgment message to the terminal through a PDSCH in response to the successfully decoded message (S5324). Then, the terminal may receive the acknowledgement message from TRP 2. The terminal may receive the acknowledgement message before expiration of the contention resolution timer started in the third step.

Then, TRP 1 may transmit an RRC setup message to the terminal (S5330). The terminal may receive the RRC setup message from TRP 1. Accordingly, the terminal may complete RRC setup and transmit an RRC setup complete message to TRP 1 (S5331). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

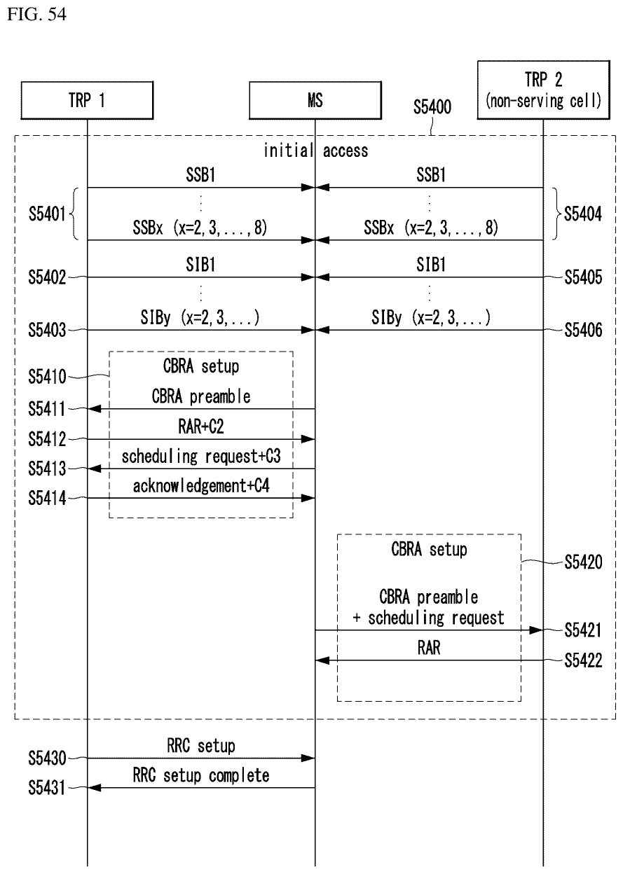

FIG. 54 is a sequence chart illustrating a twelfth exemplary embodiment of a transmission method in a multi-TRP environment.

Referring to FIG. 54, a terminal may proceed with an initial access procedure for TRP 1 and TRP 2 (S5400). Here, TRP 1 may belong to a serving cell, and TRP 2 may belong to a non-serving cell. First, TRP 1 may transmit beamformed SSBs (e.g. SSB 1 to SSB 8) in multiple directions using the first half frame of one frame (S5401). Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

Then, TRP 1 may transmit an SIB1 to the terminal using a PDSCH (S5402). The terminal may obtain the SIB1 located in a time resource and frequency resource indicated by the MIB. In this case, the SIB1 may be transmitted to the terminal on the PDSCH. The SIB may be the second system information obtained by the terminal from TRP 1. TRP 1 may deliver SIBs other than the SIB1 (i.e. SIBy, y is a positive integer of 2 or more) to the terminal in the initial access stage (S5403). In this case, TRP 1 may transmit control information to inform that SIBs are to be delivered in succession following the SIB1 by including the control information in the SIB1. The terminal may receive the SIBs other than the SIB1 from TRP 1.

Accordingly, the terminal may obtain information on a PDCCH/SIB bandwidth, CORSET, CSS, and related PDCCH parameter(s) from the MIB of the best SSB, as informed by Pdcch-ConfigSIB1. Then, the terminal may obtain a message within the SIB1 by decoding the SIB1 received from TRP 1 as indicated by the obtained information. In addition, the terminal may obtain messages within the SIBy by successively decoding the SIBy using indication information included in the message within the SIB1 received from TRP 1.

Then, TRP 2 may transmit beamformed SSBs (e.g. SSB 1 to SSB 8) in multiple directions using the second half frame of one frame (S5404). Accordingly, the terminal may receive SSBs from TRP 2, and the terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

Then, TRP 2 may transmit an SIB1 to the terminal using a PDSCH (S5405). The terminal may obtain the SIB1 located in a time resource and frequency resource indicated by the MIB. In this case, the SIB1 may be transmitted to the terminal on the PDSCH. The SIB may be the second system information obtained by the terminal from TRP 2. TRP 2 may deliver SIBs other than the SIB1 (i.e. SIBy, y is a positive integer of 2 or more) to the terminal in the initial access stage (S5406). In this case, TRP 2 may transmit control information to inform that SIBs are to be delivered in succession following the SIB1 by including the control information in the SIB1. The terminal may receive the SIBs other than the SIB1 from TRP 2.

Accordingly, the terminal may obtain information on a PDCCH/SIB bandwidth, CORSET, CSS, and related PDCCH parameter(s) from the MIB of the second best SSB, as informed by Pdcch-ConfigSIB1. Then, the terminal may obtain a message within the SIB1 by decoding the SIB1 received from TRP 2 as indicated by the obtained information. In addition, the terminal may obtain messages within the SIBy by successively decoding the SIBy using indication information included in the message within the SIB1 received from TRP 2.

Thereafter, the terminal that has completed downlink synchronization and system information acquisition may perform a 4-step CBRA-based random access setup procedure with TRP 1 for uplink synchronization (S5410).

First, in the first step, the terminal may randomly select one preamble among all preambles provided by TRP 1. Then, the terminal may transmit the selected preamble to TRP 1 on a PRACH (S5411). Then, TRP 1 may receive the preamble from the terminal on the PRACH. In this case, a beam direction may follow an uplink direction reciprocal to a beam direction used when receiving a signal in the downlink. A resource for transmitting the preamble from the terminal to TRP 1 may be based on information on association between SSBs and RACH occasions, which is obtained in advance. TRP 1 may estimate the terminal's propagation delay using the preamble.

Then, in the second step, TRP 1 may determine whether a preamble is present in a signal received through the PRACH. The preamble may be randomly selected and transmitted by the terminal. Therefore, TRP 1 cannot specify which terminal transmitted the preamble based on whether or not the preamble is detected. Therefore, TRP 1 cannot determine how many terminals used the detected preamble. Accordingly, TRP 1 may transmit an RAR based on an index of the detected preamble and a C2 message to the terminal on a PDSCH (S5412). Then, the terminal may receive the RAR and C2 message from TRP 1. In this case, the RAR may include the preamble index, a TA value, uplink grant information, and a temporary C-RNTI.

Here, the C2 message may include C2-1 information and C2-2 information. The C2-1 information may include SSB group-related information. In this case, the SSB group-related information may include SSB group information. In addition, the SSB group information may include SSB group type information and information on SSBs included in each of SSB groups based on the SSB group type information. The SSB group type information may indicate an SSB grouping method. For example, when the total number of SSBs is 8, an SSB group type 0 may indicate the methods of FIGS. 9 and 10, and an SSB group type 1 may indicate the methods of FIGS. 11 and 12. The C2-2 information may be all possible information that reduces the overhead of the procedure. For example, the C2-2 information may be a TAG ID for a communication link between the terminal and TRP 1 for uplink synchronization. TRP 1 may not include the C2-1 information in the C2 message to further increase the efficiency of uplink synchronization. The C2-2 information may include the TAG ID. In this case, the messages of the random access procedures may use the messages in FIGS. 6 and 7.

Then, in the third step, the terminal may transmit a scheduling request message (or connection request message) and a C3 message to TRP 1 through a PUSCH by applying the temporary C-RNTI and using an uplink radio resource indicated by the uplink grant information included in the RAR (S5413). Then, TRP 1 may receive the connection request message and the C3 message from the terminal. Here, there may be more than one terminal that transmitted the same preamble in the first step. As a result, preamble collisions may occur. In this case, all terminals that transmitted the same preamble may refer to the same RAR, and transmit messages using the same radio resource. This may cause a collision.

Here, the C3 message may include C3-1 information to C3-5 information. In this case, the C3_1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3 4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on the SSB group-related information in the C2 message. In other words, the terminal may know that the second best SSB is an SSB of TRP 2 based on the SSB group-related information. Then, the terminal may set the C3-1 information to true.

Meanwhile, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit a message including acknowledgment and a C4 message to the terminal through a PD SCH in response to the successfully decoded message (S5414). Then, the terminal may receive the message including the acknowledgement message and the C4 message from TRP 1. The terminal may receive the message including the acknowledgement and the C4 message before expiration of the contention resolution timer started in the third step. Here, the C4 message may include C4-1 information to C4_4 information. In this case, the C4_1 information may be information indicating whether ‘RA’ is true or false. ‘RA’ set to true may mean that random access needs to be performed for a TRP of the second best SSB. In addition, the C4-2 information may be information indicating whether ‘CBRA’ is true or false. Here, ‘CBRA’ set to true may mean that contention-based random access needs to be performed. In addition, the C4-3 information may include information on indices for CFRA preambles. The CFRA preamble may mean a preamble to be used when performing non-contention-based random access. The index of the CFRA preamble may be a natural number greater than 1. In addition, the C4_4 information may be other information. The C4-4 information may be any possible information that reduces the overhead of the procedure.

In this case, TRP 1 may generate the C4-1 information of the C4 message based on the information in the C3 message of the third-step message. In other words, when a time difference between a starting point of the best SSB and a starting point of the second best SSB, which is included in the C3-3 information of the C3 message, is equal to or greater than a predetermined threshold, TRP 1 may set ‘RA’ of the C4_1 information of the C4 message to true. In addition, TRP 1 may arbitrarily decide whether to set ‘CBRA’ to true.

In this situation, ‘TRP 2’ may be false in the C3_1 information. In addition, the premise that the PCI is the same in the C3-2 information may be false. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be false in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be false in the C3-2 information. ‘RA’ may be true in the C4-1 information, and ‘CBRA’ may be false in the C4-2 information. TRP 1 may indicate the terminal to perform CFRA random access for non-contention preamble index(es) and an RO indicated by the SIB obtained based on the second best SSB through high layer signaling or PDCCH. Accordingly, the terminal may receive the indication to perform the CFRA random access from TRP 1. Accordingly, the terminal may perform a 2-step CFRA-based setup procedure for TRP 2 (S5420).

To this end, in the first step, the terminal may randomly select one preamble from among CFRA preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S5421). Then, TRP 2 may receive the preamble and the message including the scheduling request from the terminal. Here, TRP 2 may be aware of the terminal's CFRA setup procedure before the first step starts.

In this case, TRP 2 may transmit a message including an RAR and a C-RNTI to the terminal through a PDSCH (S5422). Accordingly, the terminal may receive the message including the successful RAR and the C-RNTI from TRP 2. This message may serve as an acknowledgement. The terminal may proceed with an RRC setup procedure after the second step is completed. Here, TRP 2 may transmit information related to the RAR to TRP 1. Then, TRP 1 may receive the information related to the RAR from TRP 2. Then, TRP 1 may transmit the RAR to the terminal based on the information related to the RAR received from TRP 2.

Then, TRP 1 may transmit an RRC setup message to the terminal (S5430). The terminal may receive the RRC setup message from TRP 1. Accordingly, the terminal may complete RRC setup and transmit an RRC setup complete message to TRP 1 (S5431). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

Referring to FIGS. 51 to 54 described above, in the procedure in which the terminal initially accesses TRP 1 and TRP 2, the terminal may obtain information on a propagation delay with TRP 1 and information on a propagation delay with TRP 2. In addition, TRP 1 may obtain information on a propagation delay with the terminal, and TRP 2 may also obtain information on a propagation delay with the terminal. Using this information, TRP 1 and TRP 2 may perform distributed synchronous/sequential cooperative downlink transmission, allowing signals to arrive at a reception synchronization point of the terminal between TRP 1 and the terminal without a time offset. Alternatively, the terminal may perform distributed synchronous/sequential cooperative uplink transmission, allowing a signal from the terminal to TRP 1 and a signal from the terminal to TRP 2 to arrive at a reception synchronization point of TRP 1 between the terminal and TRP 2 without an absolute time offset.

The transmission methods described with reference to FIGS. 51 to 54 have been provided as examples using the second-best SSB, but they are not limited thereto. Since the second-best SSB can also be associated with TRP 1, the methods may be extended to apply to the third best SSB, fourth best SSB, and so on. Additionally, although the transmission methods described with reference to FIGS. 51 to 54 have been exemplified with TRP 2, they are not limited to this and may be extended to TRP 3, TRP 4, and so forth. In addition, in the transmission methods with reference to FIGS. 51 to 54, information on a difference between the maximum correlation value of a timing estimator or the like for the best SSB and the maximum correlation value of a timing estimator or the like for the second-best SSB, which is obtained in the process of timing and PCI estimation for the SSBs during the initial access, may be used for power control related to TRP 2, thereby improving link quality and reducing co-channel interference with neighbor terminals/TRPs/cells. Furthermore, although it has been described that in the transmission methods of FIGS. 51 to 54, the process of establishing the second communication link is performed before the RRC setup and RRC setup completion of the first communication link, this is merely one exemplary embodiment. The setup process of the second communication link may be performed after the setup process of the first communication link has been fully completed, that is, after the RRC setup and RRC setup completion process of the first communication link.

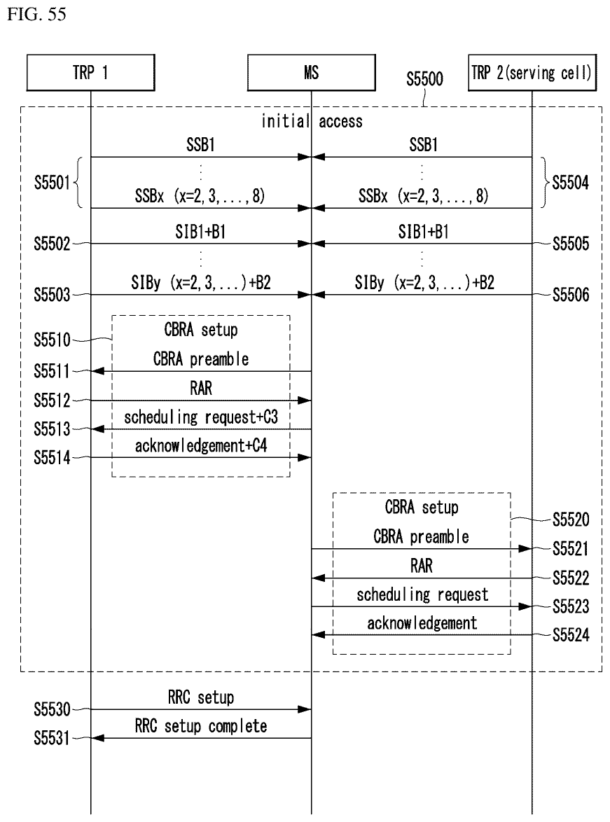

FIG. 55 is a sequence chart illustrating a thirteenth exemplary embodiment of a transmission method in a multi-TRP environment.

Referring to FIG. 55, a terminal may proceed with an initial access procedure for TRP 1 and TRP 2 (S5500). Here, TRP 1 and TRP 2 may belong to a serving cell. TRP 1 may transmit beamformed SSBs (e.g. SSB 1 to SSB 8) in multiple directions using the first half frame of one frame (S5501). The SSBs may include MTRP mode information A within MIBs thereof. Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1. Table 1 may be a first exemplary embodiment of the MIB.

TABLE 1
MIB ::= SEQUENCE {

| | |
|---|---|
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | INTEGER (0..255), |
| cellBarred | ENUMERATED {barred, notBarred}, |
| intraFreqReselection | ENUMERATED {allowed, notAllowed}, |
| MTRP mode | BIT STRING (SIZE (1)) |

}

The MTRP mode information A included in the MIB may be set to 0 or 1 and may be configured as 1 bit. Here, an MTRP mode 0 may specify a mode where M-TRP transmission methods are not used and only transmission by TRP 1 is allowed. In the MTRP mode 0, the terminal may not perform a random access procedure for synchronization with TRP 2. In addition, in the MTRP mode 0, the terminal may not perform a method of using a result of SSB-based timing estimation. The terminal may perform initial access and synchronization only with TRP 1. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. The SSB group-related information may include SSB group information (e.g. ssbGroup). The SSB group information may include SSB group type information and information on SSBs included in each SSB group according to the SSB group type information. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 1 may transmit SIB1 including ssbGroupTrpInfo information B1 to the terminal using a PDSCH (S5502). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1. Table 2 represents a first exemplary embodiment of the SIB1.

TABLE 2
SIB1 ::= SEQUENCE {

| cellSelectionInfo | SEQUENCE { | |
|---|---|---|
| q-RxLevMin | Q-RxLevMin, | |
| q-RxLevMinOffset | INTEGER (1..8) | OPTIONAL, -- Need R |
| q-RxLevMinSUL | Q-RxLevMin | OPTIONAL, -- Need R |
| q-QualMin | Q-QualMin | OPTIONAL, -- Need R |
| q-QualMinOffset | INTEGER (1..8) | OPTIONAL -- Need R |

} OPTIONAL, -- Need S

| cellAccessRelatedInfo | CellAccessRelatedInfo, | |
|---|---|---|
| connEstFailureControl | ConnEstFailureControl | OPTIONAL, -- Need R |
| si-SchedulingInfo | SI-SchedulingInfo | OPTIONAL, -- Need R |

| | | |
|---|---|---|
| servingCellConfigCommon | ServingCellConfigCommonSIB | OPTIONAL, - |

- Need R

| | | |
|---|---|---|
| ims-EmergencySupport | ENUMERATED {true} | OPTIONAL, -- |

Need R

| | | |
|---|---|---|
| eCallOverIMS-Support | ENUMERATED {true} | OPTIONAL, -- |

Cond Absent

| | | |
|---|---|---|
| ue-TimersAndConstants | UE-TimersAndConstants | OPTIONAL, -- |

Need R

| ssbGroupTrpInfo | ssbGroupTrpInfo ...... | |
|---|---|---|
| uac-BarringInfo | SEQUENCE { | |
| uac-BarringForCommon | UAC-BarringPerCatList | OPTIONAL, -- Need |

S

| | | |
|---|---|---|
| uAC-BarringPerPLMN-List | UAC-BarringPerPLMN-List | OPTIONAL, -- |

Need S

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1-SelectionAssistanceInfo, |
| individualPLMNList | SEQUENCE (SIZE (2..maxPLMN)) |
| | OF UAC-AccessCategory1-SelectionAssistanceInfo |

```
      } OPTIONAL
    } OPTIONAL, -- Need R
```

| | | |
|---|---|---|
| useFullResumeID | ENUMERATED {true} | OPTIONAL, -- Need N |
| lateNonCriticalExtension | OCTET STRING | OPTIONAL, |
| nonCriticalExtension | SIB1-v1610-IEs | OPTIONAL |

}

Table 3 may be ssbGroupTrpInfo information.

TABLE 3

| | |
|---|---|
| ssbGroupTrpInfo | SEQUENCE { |
| ssbGroup | INTEGER (1...w) .... |
| ssbGrouptoTrp | INTEGER (1...z) .... |

...
}

In Table 3, ssbGroup which is group type information may define an SSB group type for 8 SSBs as follows. The ssbGroup may include information on SSBs included in each SSB group 5 among SSB groups according to SSB group type information.-ssbGroup=1: SSB group 1={1, 3, 5, 7}, SSB group 2={2, 4, 6, 8}
ssbGroup=2: SSB group 1={1, 2, to, 8} (first half frame), SSB group 2={1, 2, to, 8} (remaining half frames)
ssbGroup=3: any other type (three or more groups)
ssbGroup=w: any other type

In Table 3, ssbGroupTrpInfo may include ssbGrouptoTrp. ssbGrouptoTrp may be optional and may specify a mapping relationship between SSB group IDs and TRPs as follows.
ssbGrouptoTrp=1: SSB group 1→TRP 1, SSB group 2→TRP 2
ssbGrouptoTrp=2: SSB group 1→TRP 2, SSB group 2→TRP 1
ssbGrouptoTrp=3: any other mapping (three or more SSB-TRP mappings)
ssbGrouptoTrp=z: any other mapping

Meanwhile, TRP 1 may deliver SIBs other than SIB1 (i.e. SIBy, y is a positive integer greater than or equal to 2) to the terminal in the initial access stage (S5503). These SIBs may include ssbGroupTrpInfo information B2. Table 4 may represent a first exemplary embodiment of SIBy.

TABLE 4

| SIBy ::= SEQUENCE { | |
|---|---|
| ... | |
| ssbGroupTrpInfo | ssbGroupTrpInfo ... |
| ... | |
| } | |
| ssbGroupTrpInfo | SEQUENCE { |
| ssbGroup | INTEGER (1...w) .... |
| ssbGrouptoTrp | INTEGER (1...z) .... |

...
}

In this case, TRP 1 may transmit control information to notify that SIBs are transmitted sequentially following SIB1. The terminal may receive the SIBs other than the SIB1 from TRP 1. In addition, the terminal may decode SIBy sequentially using the indication information included in the message in the SIB1 to obtain the messages in the SIBy. In order to suppress increase in a bit width of the message of SIB1, TRP 1 may reflect ssbGroupTrpInfo information of the SIB1 to an arbitrary SIBy and transmit it. Meanwhile, TRP 2 may transmit beamformed SSBs (e.g. SSB 1 to SSB 8) in multiple directions using the first half frame of one frame (S5504). These SSBs may include multi-TRP mode (MTRP mode) information A within MIBs thereof. Accordingly, the terminal may receive the SSBs from TRP 2. The terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

The MTRP mode information A included in the MIB may be set to 0 or 1 and may be configured as 1 bit. Here, an MTRP mode 0 may specify a mode where M-TRP transmission methods are not used and only transmission by TRP 2 is allowed. In the MTRP mode 0, the terminal may not perform a random access procedure for synchronization with TRP 1. In addition, in the MTRP mode 0, the terminal may not perform a method of using a result of SSB-based timing estimation. The terminal may perform initial access and synchronization only with TRP 2. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 2 may transmit an SIB1 including ssbGroupTrpInfo information B1 to the terminal using a PDSCH (S5505). The terminal may obtain the SIB1 including the ssbGroupTrpInfo information B1 located in a time resource and frequency resource indicated by the MIB. In this case, the SIB1 may be transmitted to the terminal on the PDSCH. The SIB1 may be the second system information obtained by the terminal from TRP 2.

On the other hand, TRP 1 may deliver SIBs other than the SIB1 (i.e. SIBy, y is a positive integer of 2 or more) to the terminal in the initial access stage (S5506). These SSBs may include ssbGroupTrpInfo information B2. In this case, TRP 1 may transmit control information to inform that SIBs are to be delivered in succession following the SIB1 by including the control information in the SIB1. The terminal may receive the SIBs other than the SIB1 from TRP 1. In addition, the terminal may decode SIBy sequentially using the indication information included in the message in SIB1 to obtain the message in SIBy. In order to suppress increase in a bit width of the message of SIB1, TRP 2 may reflect ssbGroupTrpInfo information of the SIB1 to an arbitrary SIBy and transmit it.

Thereafter, the terminal that has completed downlink synchronization and system information acquisition may perform a 4-step CBRA-based random access setup procedure with TRP 1 for uplink synchronization (S5510).

First, in the first step, the terminal may randomly select one preamble among all preambles provided by TRP 1. Then, the terminal may transmit the selected preamble to TRP 1 on a PRACH (S5511). Then, TRP 1 may receive the preamble from the terminal on the PRACH. In this case, a beam direction may follow an uplink direction reciprocal to a beam direction used when receiving a signal in downlink. A resource for transmitting the preamble from the terminal to TRP 1 may be based on information on association between SSB and RACH occasion, which is obtained in advance. TRP 1 may estimate the terminal's propagation delay using the preamble.

Then, in the second step, TRP 1 may determine whether a preamble is present in a signal received through the PRACH. The preamble may be randomly selected and transmitted by the terminal. Therefore, TRP 1 cannot specify which terminal transmitted the preamble based on whether or not the preamble is detected. Therefore, TRP 1 cannot determine how many terminals used the detected preamble. Accordingly, TRP 1 may transmit an RAR based on an index of the detected preamble to the terminal on a PDSCH (S5512). Then, the terminal may receive the RAR from TRP 1. In this case, the RAR may include the preamble index, a TA value, uplink grant information, and a temporary C-RNTI.

Then, in the third step, the terminal may transmit a scheduling request message (or connection request message) and a C3 message to TRP 1 through a PUSCH by applying the temporary C-RNTI and using an uplink radio resource indicated by the uplink grant information included in the RAR (S5513). Then, TRP 1 may receive the connection request message and the C3 message from the terminal. Here, there may be more than one terminal that transmitted the same preamble in the first step. As a result, preamble collisions may occur. In this case, all terminals that transmitted the same preamble may refer to the same RAR, and transmit messages using the same radio resource. This may cause a collision.

Here, the C3 message may include C3-1 information to C3-5 information. In this case, the C3_1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on SSB group-related information in information B1 or B2. In other words, the terminal may know that the second best SSB is an SSB of TRP 2 based on the SSB group-related information. Then, the terminal may set the C3-1 information to true.

Meanwhile, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit a message including acknowledgment and a C4 message to the terminal through a PDSCH in response to the successfully decoded message (S5514). Then, the terminal may receive the message including the acknowledgement message and the C4 message from TRP 1. The terminal may receive the message including the acknowledgement and the C4 message before expiration of the contention resolution timer started in the third step. Here, the C4 message may include C4-1 information to C4_4 information. In this case, the C4_1 information may be information indicating whether ‘RA’ is true or false. ‘RA’ set to true may mean that random access needs to be performed for a TRP of the second best SSB. In addition, the C4-2 information may be information indicating whether ‘CBRA’ is true or false. Here, ‘CBRA’ set to true may mean that contention-based random access needs to be performed. In addition, the C4-3 information may include information on indices for CFRA preambles. The CFRA preamble may mean a preamble to be used when performing non-contention-based random access. The index of the CFRA preamble may be a natural number greater than 1. In addition, the C4-4 information may be other information. The C4-4 information may be any possible information that reduces the overhead of the procedure.

In this case, TRP 1 may generate the C4-1 information of the C4 message based on the information in the C3 message of the third-step message. In other words, when a time difference between a starting point of the best SSB and a starting point of the second best SSB, which is included in the C3-3 information of the C3 message, is equal to or greater than a predetermined threshold, TRP 1 may set ‘RA’ of the C4-1 information of the C4 message to true. In addition, TRP 1 may arbitrarily decide whether to set ‘CBRA’ to true.

In this situation, ‘TRP 2’ may be false in the C3-1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be true in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be true in the C3-2 information. ‘RA’ may be true in the C4-1 information, and ‘CBRA’ may be true in the C4-2 information. TRP 1 may indicate the terminal to perform CBRA random access for an RO indicated by the SIB obtained based on the second best SSB through high layer signaling or PDCCH. Accordingly, the terminal may receive the indication to perform the CBRA random access from TRP 1. Accordingly, the terminal may perform a 4-step CBRA-based setup procedure for TRP 2 (S5520).

First, in the first step, the terminal may randomly select one preamble from all preambles provided by TRP 2. The terminal may transmit the selected preamble to TRP 2 through a PRA CH (S5521). Then, TRP 2 may receive the preamble from the terminal through the PRACH. In this case, a beam direction may follow an uplink direction reciprocal to a beam direction used when receiving a signal in downlink. A resource for transmitting the preamble to TRP 2 from the terminal may be based on information on an association between SSBs and RACH occasions, which is obtained in advance. TRP 2 may estimate the terminal's propagation delay using the preamble.

Then, in the second step, TRP 2 may determine whether a preamble is present in a signal received through the PRACH. The preamble may be randomly selected and transmitted by the terminal. Therefore, TRP 2 may not specify which terminal transmitted the preamble through whether or not the preamble is detected. Therefore, TRP 2 cannot determine how many terminals used the detected preamble. Accordingly, TRP 2 may transmit an RAR based on an index of the detected preamble to the terminal through a PDSCH (S5522). Then, the terminal may receive the RAR from TRP 2. In this case, the RAR may include the preamble index, TA value, uplink grant information, and temporary C-RNTI. Here, TRP 2 may transmit information related to the RAR to TRP 1. Then, TRP 1 may receive the information related to the RAR from TRP 2. TRP 1 may transmit the RAR to the terminal based on the information related to the RAR received from TRP 2.

Thereafter, in the third step, the terminal may transmit a message including a scheduling request message (or connection request message) to TRP 2 through a PUSCH by applying the temporary C-RNTI and using an uplink radio resource indicated by the uplink grant information included in the corresponding RAR (S5523). TRP 2 may receive the connection request message from the terminal. In this case, there may be more than one terminal that transmitted the same preamble in the first step. Accordingly, a collision of preambles may occur. In this case, all terminals that transmitted the same preamble may transmit the messages by utilizing the same radio resource indicated by the RAR. This may cause a collision.

In other words, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 2 may decode the received third-step message. TRP 2 may transmit an acknowledgment message to the terminal through a PDSCH in response to the successfully decoded message (S5524). Then, the terminal may receive the acknowledgement message from TRP 2. The terminal may receive the acknowledgement message before expiration of the contention resolution timer started in the third step.

Then, TRP 1 may transmit an RRC setup message to the terminal (S5530). The terminal may receive the RRC setup message from TRP 1. Accordingly, the terminal may complete RRC setup and transmit an RRC setup complete message to TRP 1 (S5531). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

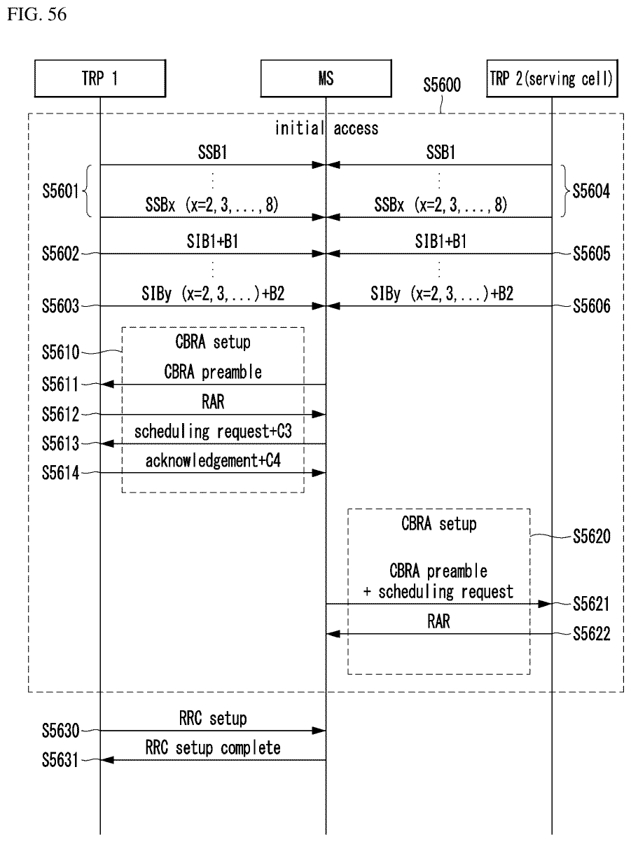

FIG. 56 is a sequence chart illustrating a fourteenth exemplary embodiment of a transmission method in a multi-TRP environment.

Referring to FIG. 56, a terminal may proceed with an initial access procedure for TRP 1 and TRP 2 (S5600). Here, TRP 1 and TRP 2 may belong to a serving cell. TRP 1 may transmit beamformed SSBs (e.g. SSB 1 to SSB 8) in multiple directions using the first half frame of one frame (S5601). The SSBs may include MTRP mode information A within MIBs thereof. Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

The MTRP mode information A included in the MIB may be set to 0 or 1 and may be configured as 1 bit. Here, an MTRP mode 0 may specify a mode where M-TRP transmission methods are not used and only transmission by TRP 1 is allowed. In the MTRP mode 0, the terminal may not perform a random access procedure for synchronization with TRP 2. In addition, in the MTRP mode 0, the terminal may not perform a method of using a result of SSB-based timing estimation. The terminal may perform initial access and synchronization only with TRP 1. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. The SSB group-related information may include SSB group information (e.g. ssbGroup). The SSB group information may include SSB group type information and information on SSBs included in each SSB group according to the SSB group type information. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 1 may transmit an SIB1 including ssbGroupTrpInfo information B1 to the terminal using a PDSCH (S5602). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1. The ssbGroupTrpInfo information may include ssbGroup. As described above, ssbGroup may include information on SSBs included in each SSB group among SSB groups according to the SSB group type information. ssbGroupTrpInfo may also include ssbGrouptoTrp. ssbGrouptoTrp may be optional and may represent a mapping relationship between SSB group IDs and TRPs.

On the other hand, TRP 1 may deliver SIBs other than the SIB1 (i.e. SIBy, y is a positive integer of 2 or more) to the terminal in the initial access stage (S5603). These SSBs may include ssbGroupTrpInfo information B2. In this case, TRP 1 may transmit control information to inform that SIBs are to be delivered in succession following the SIB1 by including the control information in the SIB1. The terminal may receive the SIBs other than the SIB1 from TRP 1. In addition, the terminal may decode SIBy sequentially using the indication information included in the message in SIB1 to obtain the message in SIBy. In order to suppress increase in a bit width of the message of SIB1, TRP 1 may reflect ssbGroupTrpInfo information of the SIB1 to an arbitrary SIBy and transmit it.

Meanwhile, TRP 2 may transmit beamformed SSBs (e.g. SSB 1 to SSB 8) in multiple directions using the first half frame of one frame (S5604). These SSBs may include MTRP mode information A within MIBs thereof. Accordingly, the terminal may receive the SSBs from TRP 2. The terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

The MTRP mode information A included in the MIB may be set to 0 or 1 and may be configured as 1 bit. Here, an MTRP mode 0 may specify a mode where M-TRP transmission methods are not used and only transmission by TRP 2 is allowed. In the MTRP mode 0, the terminal may not perform a random access procedure for synchronization with TRP 1. In addition, in the MTRP mode 0, the terminal may not perform a method of using a result of SSB-based timing estimation. The terminal may perform initial access and synchronization only with TRP 2. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 2 may transmit an SIB1 including ssbGroupTrpInfo information B1 to the terminal using a PDSCH (S5605). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1.

On the other hand, TRP 2 may deliver SIBs other than the SIB1 (i.e. SIBy, y is a positive integer of 2 or more) to the terminal in the initial access stage (S5606). These SSBs may include ssbGroupTrpInfo information B2. In this case, TRP 2 may transmit control information to inform that SIBs are to be delivered in succession following the SIB1 by including the control information in the SIB1. The terminal may receive the SIBs other than the SIB1 from TRP 2. In addition, the terminal may decode SIBy sequentially using the indication information included in the message in SIB1 to obtain the message in SIBy. In order to suppress increase in a bit width of the message of SIB1, TRP 2 may reflect ssbGroupTrpInfo information of the SIB1 to an arbitrary SIBy and transmit it.

Thereafter, the terminal that has completed downlink synchronization and system information acquisition may perform a 4-step CBRA-based random access setup procedure with TRP 1 for uplink synchronization (S5610).

First, in the first step, the terminal may randomly select one preamble from all preambles provided by TRP 1. The terminal may transmit the selected preamble to TRP 1 through a PRA CH (S5611). Then, TRP 1 may receive the preamble from the terminal through the PRACH. In this case, a beam direction may follow an uplink direction reciprocal to a beam direction used when receiving a signal in downlink. A resource for transmitting the preamble to TRP 1 from the terminal may be based on information on an association between SSBs and RACH occasions, which is obtained in advance. TRP 1 may estimate the terminal's propagation delay using the preamble.

Then, in the second step, TRP 1 may determine whether a preamble is present in a signal received through the PRACH. The preamble may be randomly selected and transmitted by the terminal. Therefore, TRP 1 may not specify which terminal transmitted the preamble through whether or not the preamble is detected. Therefore, TRP 1 cannot determine how many terminals used the detected preamble. Accordingly, TRP 1 may transmit an RAR based on an index of the detected preamble to the terminal through a PDSCH (S5612). Then, the terminal may receive the RAR from TRP 1. In this case, the RAR may include the preamble index, TA value, uplink grant information, and temporary C-RNTI.

Thereafter, in the third step, the terminal may transmit a scheduling request message (or connection request message) and a C3 message to TRP 1 through a PUSCH by applying the temporary C-RNTI and using an uplink radio resource indicated by the uplink grant information included in the corresponding RAR (S5613). TRP 1 may receive the connection request message and the C3 message from the terminal. In this case, there may be more than one terminal that transmitted the same preamble in the first step. Accordingly, a collision of preambles may occur. In this case, all terminals that transmitted the same preamble may transmit the messages by utilizing the same radio resource indicated by the RAR. This may cause a collision.

Here, the C3 message may include C3-1 information to C3-5 information. In this case, the C3_1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on SSB group-related information in information B1 or B2. In other words, the terminal may know that the second best SSB is an SSB of TRP 2 based on the SSB group-related information. Then, the terminal may set the C3-1 information to true.

Meanwhile, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit a message including acknowledgment and a C4 message to the terminal through a PD SCH in response to the successfully decoded message (S5614). Then, the terminal may receive the message including the acknowledgement message and the C4 message from TRP 1. The terminal may receive the message including the acknowledgement and the C4 message before expiration of the contention resolution timer started in the third step. Here, the C4 message may include C4-1 information to C4_4 information. In this case, the C4-1 information may be information indicating whether ‘RA’ is true or false. ‘RA’ set to true may mean that random access needs to be performed for a TRP of the second best SSB. In addition, the C4-2 information may be information indicating whether ‘CBRA’ is true or false. Here, ‘CBRA’ set to true may mean that contention-based random access needs to be performed. In addition, the C4-3 information may include information on indices for CFRA preambles. The CFRA preamble may mean a preamble to be used when performing non-contention-based random access. The index of the CFRA preamble may be a natural number greater than 1. In addition, the C4_4 information may be other information. The C4-4 information may be any possible information that reduces the overhead of the procedure.

In this situation, ‘TRP 2’ may be false in the C3_1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be true in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be true in the C3-2 information. ‘RA’ may be true in the C4_1 information, and ‘CBRA’ may be false in the C4-2 information. TRP 1 may indicate the terminal to perform CFRA random access for an RO and CFRA preamble(s) indicated by the SIB obtained based on the second best SSB through high layer signaling or PDCCH. Accordingly, the terminal may receive the indication to perform the CFRA random access from TRP 1. Accordingly, the terminal may perform a 2-step CFRA-based setup procedure for TRP 2 (S5620).

To this end, in the first step, the terminal may randomly select one preamble from among CFRA preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S5621). Then, TRP 2 may receive a message including the preamble and the scheduling request message from the terminal. Here, TRP 2 may be aware of the terminal's CFRA-based setup procedure before the start of the first step.

In this case, TRP 2 may transmit a message including an RAR and a C-RNTI to the terminal through a PDSCH (S5622). Accordingly, the terminal may receive the message including the successful RAR and the C-RNTI from TRP 2. This message may serve as an acknowledgement. The terminal may proceed with an RRC setup procedure after the second step is completed. Here, TRP 2 may transmit information related to the RAR to TRP 1. Then, TRP 1 may receive the information related to the RAR from TRP 2. Then, TRP 1 may transmit the RAR to the terminal based on the information related to the RAR received from TRP 2.

Then, TRP 1 may transmit an RRC setup message to the terminal (S5630). The terminal may receive the RRC setup message from TRP 1. Accordingly, the terminal may complete RRC setup and transmit an RRC setup complete message to TRP 1 (S5631). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

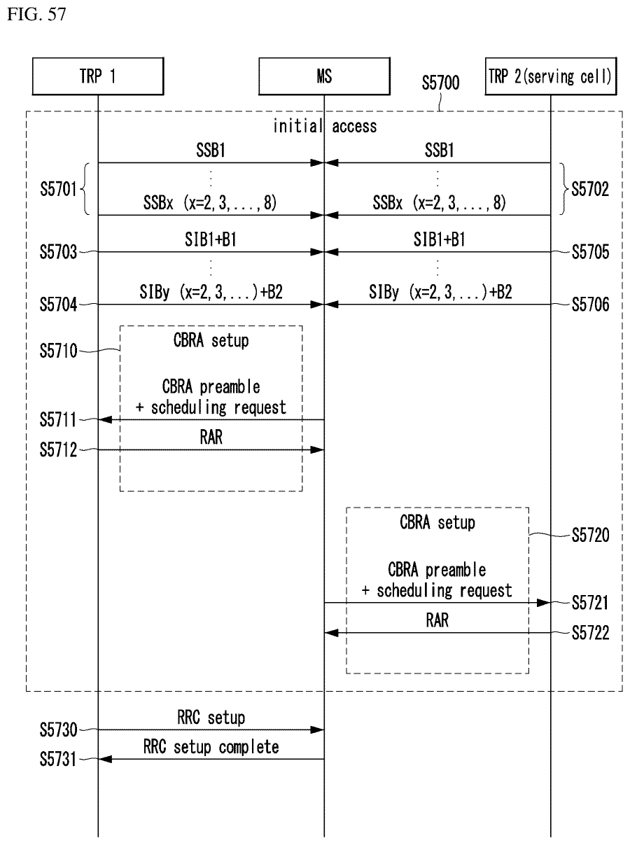

FIG. 57 is a sequence chart illustrating a fifteenth exemplary embodiment of a transmission method in a multi-TRP environment.

Referring to FIG. 57, a terminal may proceed with an initial access procedure for TRP 1 and TRP 2 (S5700). Here, TRP 1 and TRP 2 may belong to a serving cell. TRP 1 may transmit beamformed SSBs (e.g. SSB 1 to SSB 8) in multiple directions using the first half frame of one frame (S5701). The SSBs may include MTRP mode information A within MIBs thereof. Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

The MTRP mode information A included in the MIB may be set to 0 or 1 and may be configured as 1 bit. Here, an MTRP mode 0 may specify a mode where M-TRP transmission methods are not used and only transmission by TRP 1 is allowed. In the MTRP mode 0, the terminal may not perform a random access procedure for synchronization with TRP 2. In addition, in the MTRP mode 0, the terminal may not perform a method of using a result of SSB-based timing estimation. The terminal may perform initial access and synchronization only with TRP 1. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. The SSB group-related information may include SSB group information (e.g. ssbGroup). The SSB group information may include SSB group type information and information on SSBs included in each SSB group according to the SSB group type information. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 1 may transmit an SIB1 including ssbGroupTrpInfo information B1 to the terminal using a PDSCH (S5702). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1. The ssbGroupTrpInfo information may include ssbGroup. As described above, ssbGroup may include information on SSBs included in each SSB group among SSB groups according to the SSB group type information. ssbGroupTrpInfo may also include ssbGrouptoTrp. ssbGrouptoTrp may be optional and may represent a mapping relationship between SSB group IDs and TRPs.

On the other hand, TRP 1 may deliver SIBs other than the SIB1 (i.e. SIBy, y is a positive integer of 2 or more) to the terminal in the initial access stage (S5703). These SSBs may include ssbGroupTrpInfo information B2. In this case, TRP 1 may transmit control information to inform that SIBs are to be delivered in succession following the SIB1 by including the control information in the SIB1. The terminal may receive the SIBs other than the SIB1 from TRP 1. In addition, the terminal may decode SIBy sequentially using the indication information included in the message in SIB1 to obtain the message in SIBy. In order to suppress increase in a bit width of the message of SIB1, TRP 1 may reflect ssbGroupTrpInfo information of the SIB1 to an arbitrary SIBy and transmit it.

Meanwhile, TRP 2 may transmit beamformed SSBs (e.g. SSB 1 to SSB 8) in multiple directions using the first half frame of one frame (S5704). These SSBs may include MTRP mode information A within MIBs thereof. Accordingly, the terminal may receive the SSBs from TRP 2. The terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

The MTRP mode information A included in the MIB may be set to 0 or 1 and may be configured as 1 bit. Here, an MTRP mode 0 may specify a mode where M-TRP transmission methods are not used and only transmission by TRP 2 is allowed. In the MTRP mode 0, the terminal may not perform a random access procedure for synchronization with TRP 1. In addition, in the MTRP mode 0, the terminal may not perform a method of using a result of SSB-based timing estimation. The terminal may perform initial access and synchronization only with TRP 2. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 2 may transmit an SIB1 including ssbGroupTrpInfo information B1 to the terminal using a PDSCH (S5705). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1.

On the other hand, TRP 2 may deliver SIBs other than the SIB1 (i.e. SIBy, y is a positive integer of 2 or more) to the terminal in the initial access stage (S5706). These SSBs may include ssbGroupTrpInfo information B2. In this case, TRP 2 may transmit control information to inform that SIBs are to be delivered in succession following the SIB1 by including the control information in the SIB1. The terminal may receive the SIBs other than the SIB1 from TRP 2. In addition, the terminal may decode SIBy sequentially using the indication information included in the message in SIB1 to obtain the message in SIBy. In order to suppress increase in a bit width of the message of SIB1, TRP 2 may reflect ssbGroupTrpInfo information of the SIB1 to an arbitrary SIBy and transmit it.

Thereafter, the terminal that has completed downlink synchronization and system information acquisition may perform a 2-step CBRA-based random access setup procedure with TRP 1 for uplink synchronization (S5710).

To this end, in the first step, the terminal may randomly select one preamble from among all preambles. Then, the terminal may transmit the selected one preamble to TRP 1 through a PRACH. In addition, at the same time, the terminal may transmit a scheduling request (i.e. connection request) message and a C3 message to TRP 1 through a pre-allocated uplink radio resource (i.e. uplink shared channel) (S5711). Then, TRP 1 may receive the preamble and the message including the scheduling request and the C3 message from the terminal.

Here, the C3 message may include C3-1 information to C3-5 information. In this case, the C3-1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on SSB group-related information in information B1 or B2. In other words, the terminal may know that the second best SSB is an SSB of TRP 2 based on the SSB group-related information. Then, the terminal may set the C3-1 information to true.

In the second step, TRP 1 may determine whether a preamble is detected. In addition, TRP 1 may determine whether the message is successfully decoded. TRP 1 may transmit a different type of message to the terminal according to a result of the determination. This may cause a subsequent procedure to be different. If TRP 1 does not detect a preamble, TRP 1 may not perform any action. In other words, TRP 1 may not check whether a message is received through an uplink radio resource associated with the preamble. As a result, TRP 1 may not make any response when the preamble is not detected. Accordingly, the terminal may reattempt the random access because it did not receive any message from TRP 1. This case may be referred to as ‘Case 1’.

In contrast, TRP 1 may detect a preamble normally and successfully decode a message from an uplink radio resource associated with the preamble. In this case, TRP 1 may transmit a message including an RAR, a C-RNTI, and a C4 message to the terminal through a PDSCH (S5712). Accordingly, the terminal may receive the message including the successful RAR, C-RNTI, and C4 message from the TRP. This message may serve as an acknowledgement.

Here, the C4 message may include C4-1 information to C4-4 information. In this case, the C4-1 information may be information indicating whether ‘RA’ is true or false. ‘RA’ set to true may mean that random access needs to be performed for a TRP of the second best SSB. In addition, the C4_2 information may be information indicating whether ‘CBRA’ is true or false. Here, ‘CBRA’ set to true may mean that contention-based random access needs to be performed. In addition, the C4_3 information may include information on indices for CFRA preambles. The CFRA preamble may mean a preamble to be used when performing non-contention-based random access. The index of the CFRA preamble may be a natural number greater than 1. In addition, the C4_4 information may be other information. The C4_4 information may be any possible information that reduces the overhead of the procedure.

In this case, TRP 1 may generate the C4_1 information of the C4 message based on the information in the C3 message of the third-step message. In other words, when a time difference between a starting point of the best SSB of the C3-3 information of the C3 message and a starting point of the second best SSB is equal to or greater than a predetermined threshold, TRP 1 may set ‘RA’ of the C4_1 information of the C4 message to true. In addition, TRP 1 may arbitrarily decide whether to set ‘CBRA’ to true.

In this situation, ‘TRP 2’ may be false in the C3-1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be true in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be true in the C3-2 information. ‘RA’ may be true in the C4-1 information, and ‘CBRA’ may be true in the C4-2 information. TRP 1 may indicate the terminal to perform CBRA random access for an RO indicated by the SIB obtained based on the second best SSB through high layer signaling or PDCCH. Accordingly, the terminal may receive the indication to perform the CBRA random access from TRP 1. Accordingly, the terminal may perform a 2-step CBRA-based setup procedure for TRP 2 (S5720).

To this end, in the first step, the terminal may randomly select one preamble from among all preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S5721). Then, TRP 2 may receive the preamble and the message including the scheduling request from the terminal.

In this case, TRP 2 may transmit a message including an RAR and a C-RNTI to the terminal on a PDSCH (S5722). Accordingly, the terminal may receive the message including the successful RAR and C-RNTI from TRP 2. The message may serve as acknowledgment.

Then, TRP 1 may transmit an RRC setup message to the terminal (S5730). The terminal may receive the RRC setup message from TRP 1. Accordingly, the terminal may complete RRC setup and transmit an RRC setup complete message to TRP 1 (S5731). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

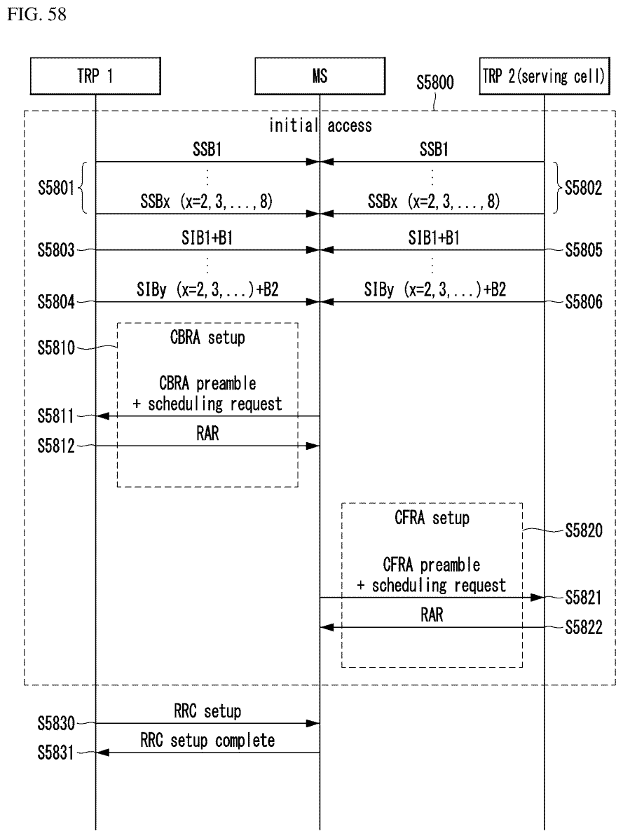

FIG. 58 is a sequence chart illustrating a sixteenth exemplary embodiment of a transmission method in a multi-TRP environment.

Referring to FIG. 58, a terminal may proceed with an initial access procedure for TRP 1 and TRP 2 (S5800). Here, TRP 1 and TRP 2 may belong to a serving cell. TRP 1 may transmit beamformed SSBs (e.g. SSB 1 to SSB 8) in multiple directions using the first half frame of one frame (S5801). The SSBs may include MTRP mode information A within MIBs thereof. Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

The MTRP mode information A included in the MIB may be set to 0 or 1 and may be configured as 1 bit. Here, an MTRP mode 0 may specify a mode where M-TRP transmission methods are not used and only transmission by TRP 1 is allowed. In the MTRP mode 0, the terminal may not perform a random access procedure for synchronization with TRP 2. In addition, in the MTRP mode 0, the terminal may not perform a method of using a result of SSB-based timing estimation. The terminal may perform initial access and synchronization only with TRP 1. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. The SSB group-related information may include SSB group information (e.g. ssbGroup). The SSB group information may include SSB group type information and information on SSBs included in each SSB group according to the SSB group type information. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 1 may transmit an SIB1 including ssbGroupTrpInfo information B1 to the terminal using a PDSCH (S5802). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1. The ssbGroupTrpInfo information may include ssbGroup. As described above, ssbGroup may include information on SSBs included in each SSB group among SSB groups according to the SSB group type information. ssbGroupTrpInfo may also include ssbGrouptoTrp. ssbGrouptoTrp may be optional and may represent a mapping relationship between SSB group IDs and TRPs.

On the other hand, TRP 1 may deliver SIBs other than the SIB1 (i.e. SIBy, y is a positive integer of 2 or more) to the terminal in the initial access stage (S5803). These SSBs may include ssbGroupTrpInfo information B2. In this case, TRP 1 may transmit control information to inform that SIBs are to be delivered in succession following the SIB1 by including the control information in the SIB1. The terminal may receive the SIBs other than the SIB1 from TRP 1. In addition, the terminal may decode SIBy sequentially using the indication information included in the message in SIB1 to obtain the message in SIBy. In order to suppress increase in a bit width of the message of SIB1, TRP 1 may reflect ssbGroupTrpInfo information of the SIB1 to an arbitrary SIBy and transmit it.

Meanwhile, TRP 2 may transmit beamformed SSBs (e.g. SSB 1 to SSB 8) in multiple directions using the first half frame of one frame (S5804). These SSBs may include MTRP mode information A within MIBs thereof. Accordingly, the terminal may receive the SSBs from TRP 2. The terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

The MTRP mode information A included in the MIB may be set to 0 or 1 and may be configured as 1 bit. Here, an MTRP mode 0 may specify a mode where M-TRP transmission methods are not used and only transmission by TRP 2 is allowed. In the MTRP mode 0, the terminal may not perform a random access procedure for synchronization with TRP 1. In addition, in the MTRP mode 0, the terminal may not perform a method of using a result of SSB-based timing estimation. The terminal may perform initial access and synchronization only with TRP 2. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 2 may transmit an SIB1 including ssbGroupTrpInfo information B1 to the terminal using a PDSCH (S5805). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1.

On the other hand, TRP 2 may deliver SIBs other than the SIB1 (i.e. SIBy, y is a positive integer of 2 or more) to the terminal in the initial access stage (S5806). These SSBs may include ssbGroupTrpInfo information B2. In this case, TRP 1 may transmit control information to inform that SIBs are to be delivered in succession following the SIB1 by including the control information in the SIB1. The terminal may receive the SIBs other than the SIB1 from TRP 1. In addition, the terminal may decode SIBy sequentially using the indication information included in the message in SIB1 to obtain the message in SIBy. In order to suppress increase in a bit width of the message of SIB1, TRP 2 may reflect ssbGroupTrpInfo information of the SIB1 to an arbitrary SIBy and transmit it.

Thereafter, the terminal that has completed downlink synchronization and system information acquisition may perform a 2-step CBRA-based random access setup procedure with TRP 1 for uplink synchronization (S5810).

To this end, in the first step, the terminal may randomly select one preamble from among all preambles. Then, the terminal may transmit the selected one preamble to TRP 1 through a PRACH. In addition, at the same time, the terminal may transmit a scheduling request (i.e. connection request) message and a C3 message to TRP 1 through a pre-allocated uplink radio resource (i.e. uplink shared channel) (S5811). Then, TRP 1 may receive the preamble and the message including the scheduling request and the C3 message from the terminal.

Here, the C3 message may include C3-1 information to C3_5 information. In this case, the C3-1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on SSB group-related information in information B1 or B2. In other words, the terminal may know that the second best SSB is an SSB of TRP 2 based on the SSB group-related information. Then, the terminal may set the C3-1 information to true.

In the second step, TRP 1 may determine whether a preamble is detected. In addition, TRP 1 may determine whether a message is successfully decoded. TRP 1 may transmit a different type of message to the terminal according to a result of the determination. This may cause a subsequent procedure to be different. If TRP 1 does not detect a preamble, TRP 1 may not perform any action. In other words, TRP 1 may not check whether a message is received through an uplink radio resource associated with the preamble. As a result, TRP 1 may not make any response when a preamble is not detected. Accordingly, the terminal may reattempt the random access because it did not receive any message from TRP 1. This case may be referred to as ‘Case 1’.

In contrast, TRP 1 may detect a preamble normally and successfully decode a message from an uplink radio resource associated with the preamble. In this case, TRP 1 may transmit a message including an RAR, a C-RNTI, and a C4 message to the terminal through a PDSCH (S5712). Accordingly, the terminal may receive the message including the successful RAR, C-RNTI, and C4 message from the TRP. This message may serve as an acknowledgement.

Here, the C4 message may include C4-1 information to C4_4 information. In this case, the C4-1 information may be information indicating whether ‘RA’ is true or false. ‘RA’ set to true may mean that random access needs to be performed for a TRP of the second best SSB. In addition, the C4-2 information may be information indicating whether ‘CBRA’ is true or false. Here, ‘CBRA’ set to true may mean that contention-based random access needs to be performed. In addition, the C4_3 information may include information on indices for CFRA preambles. The CFRA preamble may mean a preamble to be used when performing non-contention-based random access. The index of the CFRA preamble may be a natural number greater than 1. In addition, the C4_4 information may be other information. The C4_4 information may be any possible information that reduces the overhead of the procedure.

In this case, TRP 1 may generate the C4-1 information of the C4 message based on the information in the C3 message of the third-step message. In other words, when a time difference between a starting point of the best SSB of the C3-3 information of the C3 message and a starting point of the second best SSB is equal to or greater than a predetermined threshold, TRP 1 may set ‘RA’ of the C4_1 information of the C4 message to true. In addition, TRP 1 may arbitrarily decide whether to set ‘CBRA’ to true.

In this situation, ‘TRP 2’ may be false in the C3-1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be true in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be true in the C3-2 information. ‘RA’ may be true in the C4_1 information, and ‘CBRA’ may be false in the C4-2 information. TRP 1 may indicate the terminal to perform CFRA random access for an RO and CFRA preamble(s) indicated by the SIB obtained based on the second best SSB through high layer signaling or PDCCH. Accordingly, the terminal may receive the indication to perform the CFRA random access from TRP 1. Accordingly, the terminal may perform a 2-step CFRA-based setup procedure for TRP 2 (S5820).

To this end, in the first step, the terminal may randomly select one preamble from among CFRA preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S5821). Then, TRP 2 may receive a message including the preamble and the scheduling request from the terminal. Here, TRP 2 may be aware of the terminal's CFRA-based setup procedure before the start of the first step.

In this case, TRP 2 may transmit a message including an RAR and a C-RNTI to the terminal through a PDSCH (S5822). Accordingly, the terminal may receive the message including the successful RAR and the C-RNTI from TRP 2. This message may serve as an acknowledgement. The terminal may proceed with an RRC setup procedure after the second step is completed. Here, TRP 2 may transmit information related to the RAR to TRP 1. Then, TRP 1 may receive the information related to the RAR from TRP 2. Then, TRP 1 may transmit the RAR to the terminal based on the information related to the RAR received from TRP 2.

Then, TRP 1 may transmit an RRC setup message to the terminal (S5830). The terminal may receive the RRC setup message from TRP 1. Accordingly, the terminal may complete RRC setup and transmit an RRC setup complete message to TRP 1 (S5831). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

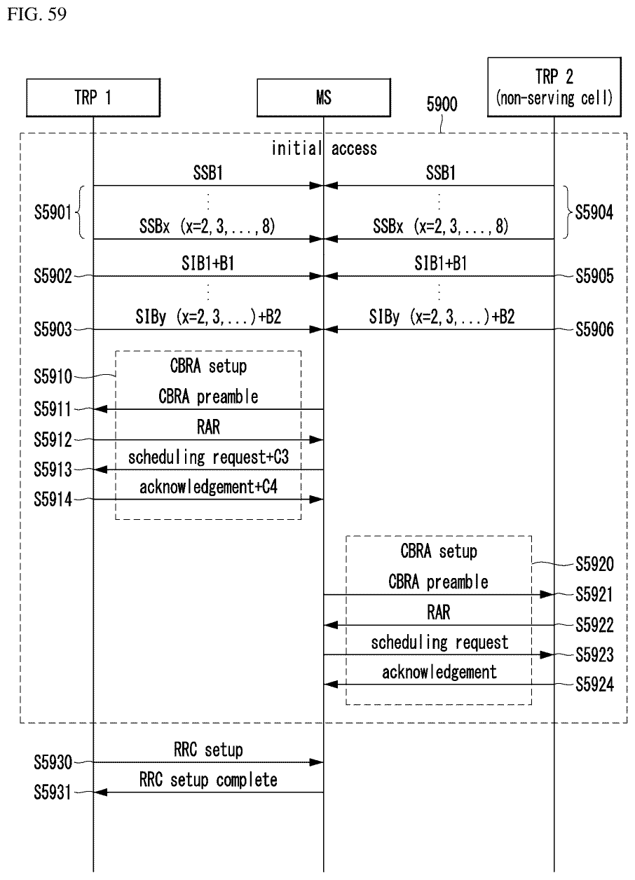

FIG. 59 is a sequence chart illustrating a seventeenth exemplary embodiment of a transmission method in a multi-TRP environment.

Referring to FIG. 59, a terminal may proceed with an initial access procedure for TRP 1 and TRP 2 (S5900). Here, TRP 1 may belong to a serving cell, and TRP 2 may belong to a non-serving cell. TRP 1 may transmit beamformed SSBs (e.g. SSB 1 to SSB 8) in multiple directions using the first half frame of one frame (S5901). The SSBs may include MTRP mode information A within MIBs thereof. Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

The MTRP mode information A included in the MIB may be set to 0 or 1 and may be configured as 1 bit. Here, an MTRP mode 0 may specify a mode where M-TRP transmission methods are not used and only transmission by TRP 1 is allowed. In the MTRP mode 0, the terminal may not perform a random access procedure for synchronization with TRP 2. In addition, in the MTRP mode 0, the terminal may not perform a method of using a result of SSB-based timing estimation. The terminal may perform initial access and synchronization only with TRP 1. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. The SSB group-related information may include SSB group information (e.g. ssbGroup). The SSB group information may include SSB group type information and information on SSBs included in each SSB group according to the SSB group type information. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 1 may transmit an SIB1 including ssbGroupTrpInfo information B1 to the terminal using a PDSCH (S5902). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1. The ssbGroupTrpInfo information may include ssbGroup. As described above, ssbGroup may include information on SSBs included in each SSB group among SSB groups according to the SSB group type information. ssbGroupTrpInfo may also include ssbGrouptoTrp. ssbGrouptoTrp may be optional and may represent a mapping relationship between SSB group IDs and TRPs.

On the other hand, TRP 1 may deliver SIBs other than the SIB1 (i.e. SIBy, y is a positive integer of 2 or more) to the terminal in the initial access stage (S5903). These SSBs may include ssbGroupTrpInfo information B2. In this case, TRP 1 may transmit control information to inform that SIBs are to be delivered in succession following the SIB1 by including the control information in the SIB1. The terminal may receive the SIBs other than the SIB1 from TRP 1. In addition, the terminal may decode SIBy sequentially using the indication information included in the message in SIB1 to obtain the message in SIBy. In order to suppress increase in a bit width of the message of SIB1, TRP 1 may reflect ssbGroupTrpInfo information of the SIB1 to an arbitrary SIBy and transmit it.

Meanwhile, TRP 2 may transmit beamformed SSBs (e.g. SSB 1 to SSB 8) in multiple directions using the first half frame of one frame (S5904). These SSBs may include MTRP mode information A within MIBs thereof. Accordingly, the terminal may receive the SSBs from TRP 2. The terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

The MTRP mode information A included in the MIB may be set to 0 or 1 and may be configured as 1 bit. Here, an MTRP mode 0 may specify a mode where M-TRP transmission methods are not used and only transmission by TRP 2 is allowed. In the MTRP mode 0, the terminal may not perform a random access procedure for synchronization with TRP 1. In addition, in the MTRP mode 0, the terminal may not perform a method of using a result of SSB-based timing estimation. The terminal may perform initial access and synchronization only with TRP 2. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 2 may transmit SIB1 including ssbGroupTrpInfo information B1 to the terminal using a PDSCH (S5905). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 2.

On the other hand, TRP 2 may deliver SIBs other than the SIB1 (i.e. SIBy, y is a positive integer of 2 or more) to the terminal in the initial access stage (S5906). These SSBs may include ssbGroupTrpInfo information B2. In this case, TRP 2 may transmit control information to inform that SIBs are to be delivered in succession following the SIB1 by including the control information in the SIB1. The terminal may receive the SIBs other than the SIB1 from TRP 2. In addition, the terminal may decode SIBy sequentially using the indication information included in the message in SIB1 to obtain the message in SIBy. In order to suppress increase in a bit width of the message of SIB1, TRP 2 may reflect ssbGroupTrpInfo information of the SIB1 to an arbitrary SIBy and transmit it.

Thereafter, the terminal that has completed downlink synchronization and system information acquisition may perform a 4-step CBRA-based random access setup procedure with TRP 1 for uplink synchronization (S5910).

First, in the first step, the terminal may randomly select one preamble from all preambles provided by TRP 1. The terminal may transmit the selected preamble to TRP 1 through a PRACH (S5911). Then, TRP 1 may receive the preamble from the terminal through the PRACH. In this case, a beam direction may follow an uplink direction reciprocal to a beam direction used when receiving a signal in downlink. A resource for transmitting the preamble to TRP 1 from the terminal may be based on information on an association between SSBs and RACH occasions, which is obtained in advance. TRP 1 may estimate the terminal's propagation delay using the preamble.

Then, in the second step, TRP 1 may determine whether a preamble is present in a signal received through the PRACH. The preamble may be randomly selected and transmitted by the terminal. Therefore, TRP 1 may not specify which terminal transmitted the preamble through whether or not the preamble is detected. Therefore, TRP 1 cannot determine how many terminals used the detected preamble. Accordingly, TRP 1 may transmit an RAR based on an index of the detected preamble to the terminal through a PDSCH (S5912). Then, the terminal may receive the RAR from TRP 1. In this case, the RAR may include the preamble index, TA value, uplink grant information, and temporary C-RNTI.

Thereafter, in the third step, the terminal may transmit a scheduling request message (or connection request message) and a C3 message to TRP 1 through a PUSCH by applying the temporary C-RNTI and using an uplink radio resource indicated by the uplink grant information included in the corresponding RAR (S5913). TRP 1 may receive the connection request message and the C3 message from the terminal. In this case, there may be more than one terminal that transmitted the same preamble in the first step. Accordingly, a collision of preambles may occur. In this case, all terminals that transmitted the same preamble may transmit the messages by utilizing the same radio resource indicated by the RAR. This may cause a collision.

Here, the C3 message may include C3-1 information to C3-5 information. In this case, the C3-1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on SSB group-related information in information B1 or B2. In other words, the terminal may know that the second best SSB is an SSB of TRP 2 based on the SSB group-related information. Then, the terminal may set the C3_1 information to true.

Meanwhile, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit a message including acknowledgment and a C4 message to the terminal through a PD SCH in response to the successfully decoded message (S5914). Then, the terminal may receive the message including the acknowledgement message and the C4 message from TRP 1. The terminal may receive the message including the acknowledgement and the C4 message before expiration of the contention resolution timer started in the third step. Here, the C4 message may include C4-1 information to C4_4 information. In this case, the C4_1 information may be information indicating whether ‘RA’ is true or false. ‘RA’ set to true may mean that random access needs to be performed for a TRP of the second best SSB. In addition, the C4-2 information may be information indicating whether ‘CBRA’ is true or false. Here, ‘CBRA’ set to true may mean that contention-based random access needs to be performed. In addition, the C4_3 information may include information on indices for CFRA preambles. The CFRA preamble may mean a preamble to be used when performing non-contention-based random access. The index of the CFRA preamble may be a natural number greater than 1. In addition, the C4-4 information may be other information. The C4-4 information may be any possible information that reduces the overhead of the procedure.

In this case, TRP 1 may generate the C4-1 information of the C4 message based on the information in the C3 message of the third-step message. In other words, when a time difference between a starting point of the best SSB of the C3-3 information of the C3 message and a starting point of the second best SSB is equal to or greater than a predetermined threshold, TRP 1 may set ‘RA’ of the C4_1 information of the C4 message to true. In addition, TRP 1 may arbitrarily decide whether to set ‘CBRA’ to true.

In this situation, ‘TRP 2’ may be false in the C3-1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be true in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be true in the C3-2 information. ‘RA’ may be true in the C4_1 information, and ‘CBRA’ may be true in the C4-2 information. TRP 1 may indicate the terminal to perform CBRA random access for an RO indicated by the SIB obtained based on the second best SSB through high layer signaling or PDCCH. Accordingly, the terminal may receive the indication to perform the CBRA random access from TRP 1. Accordingly, the terminal may perform a 4-step CBRA-based setup procedure for TRP 2 (S5920).

In the first step, the terminal may randomly select one preamble among all preambles provided by TRP 2. Then, the terminal may transmit the selected preamble to TRP 2 on a PRACH (S5921). Then, TRP 2 may receive the preamble from the terminal on the PRACH. In this case, a beam direction may follow an uplink direction reciprocal to a beam direction used when receiving a signal in the downlink. A resource for transmitting the preamble from the terminal to TRP 2 may be based on information on association between SSB and RACH occasion, which is obtained in advance. TRP 2 may estimate the terminal's propagation delay based on the preamble.

Then, in the second step, TRP 2 may determine whether a preamble is present in a signal received through the PRACH. The preamble may be randomly selected and transmitted by the terminal. Therefore, TRP 2 cannot specify which terminal transmitted the preamble based on whether or not the preamble is detected. Therefore, TRP 2 cannot determine how many terminals used the detected preamble. Accordingly, TRP 2 may transmit an RAR based on an index of the detected preamble to the terminal on a PDSCH (S5922). Then, the terminal may receive the RAR from TRP 2. In this case, the RAR may include the preamble index, a TA value, uplink grant information, and a temporary C-RNTI. Here, TRP 2 may transmit information related to the RAR to TRP 1. Then, TRP 1 may receive the information related to the RAR from TRP 2. TRP 1 may transmit the RAR to the terminal based on the information related to the RAR received from TRP 2.

Then, in the third step, the terminal may transmit a scheduling request message (or connection request message) to TRP 2 through a PUSCH by applying the temporary C-RNTI and using an uplink radio resource indicated by the uplink grant information included in the RAR (S5923). Then, TRP 2 may receive the connection request message from the terminal. Here, there may be more than one terminal that transmitted the same preamble in the first step. As a result, preamble collisions may occur. In this case, all terminals that transmitted the same preamble may refer to the same RAR, and transmit messages using the same radio resource. This may cause a collision.

In other words, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 2 may decode the received third-step message. TRP 2 may transmit an acknowledgment message to the terminal through a PDSCH in response to the successfully decoded message (S5924). Then, the terminal may receive the acknowledgement message from TRP 2. The terminal may receive the acknowledgement message before expiration of the contention resolution timer started in the third step.

Then, TRP 1 may transmit an RRC setup message to the terminal (S5930). The terminal may receive the RRC setup message from TRP 1. Accordingly, the terminal may complete RRC setup and transmit an RRC setup complete message to TRP 1 (S5931). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

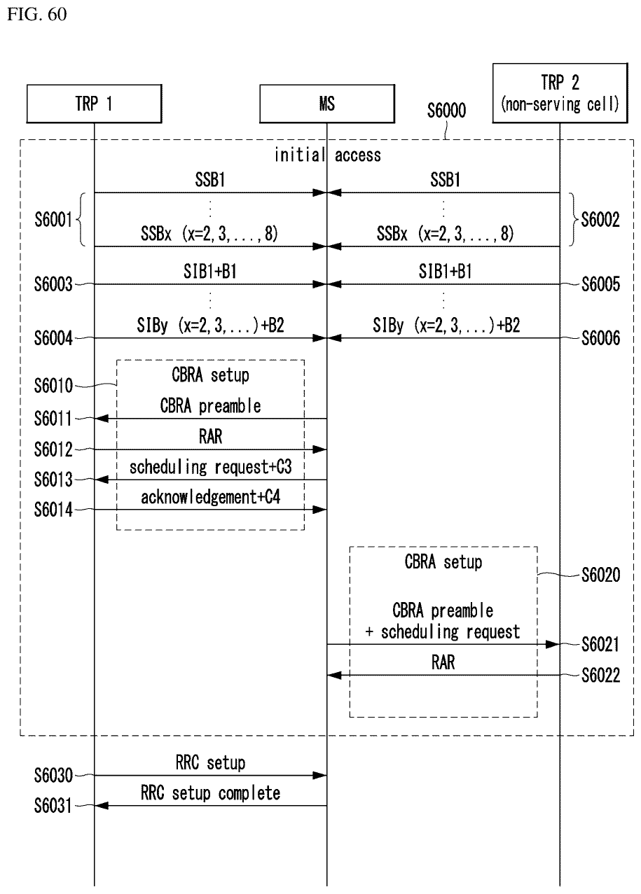

FIG. 60 is a sequence chart illustrating an eighteenth exemplary embodiment of a transmission method in a multi-TRP environment.

Referring to FIG. 60, a terminal may proceed with an initial access procedure for TRP 1 and TRP 2 (S6000). Here, TRP 1 may belong to a serving cell, and TRP 2 may belong to a non-serving cell. TRP 1 may transmit beamformed SSBs (e.g. SSB 1 to SSB 8) in multiple directions using the first half frame of one frame (S6001). The SSBs may include MTRP mode information A within MIBs thereof. Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

The MTRP mode information A included in the MIB may be set to 0 or 1 and may be configured as 1 bit. Here, an MTRP mode 0 may specify a mode where M-TRP transmission methods are not used and only transmission by TRP 1 is allowed. In the MTRP mode 0, the terminal may not perform a random access procedure for synchronization with TRP 2. In addition, in the MTRP mode 0, the terminal may not perform a method of using a result of SSB-based timing estimation. The terminal may perform initial access and synchronization only with TRP 1. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. The SSB group-related information may include SSB group information (e.g. ssbGroup). The SSB group information may include SSB group type information and information on SSBs included in each SSB group according to the SSB group type information. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 1 may transmit an SIB1 including ssbGroupTrpInfo information B1 to the terminal using a PDSCH (S6002). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1. The ssbGroupTrpInfo information may include ssbGroup. As described above, ssbGroup may include information on SSBs included in each SSB group among SSB groups according to the SSB group type information. ssbGroupTrpInfo may also include ssbGrouptoTrp. ssbGrouptoTrp may be optional and may represent a mapping relationship between SSB group IDs and TRPs.

On the other hand, TRP 1 may deliver SIBs other than the SIB1 (i.e. SIBy, y is a positive integer of 2 or more) to the terminal in the initial access stage (S6003). These SSBs may include ssbGroupTrpInfo information B2. In this case, TRP 1 may transmit control information to inform that SIBs are to be delivered in succession following the SIB1 by including the control information in the SIB1. The terminal may receive the SIBs other than the SIB1 from TRP 1. In addition, the terminal may decode SIBy sequentially using the indication information included in the message in SIB1 to obtain the message in SIBy. In order to suppress increase in a bit width of the message of SIB1, TRP 1 may reflect ssbGroupTrpInfo information of the SIB1 to an arbitrary SIBy and transmit it.

Meanwhile, TRP 2 may transmit beamformed SSBs (e.g. SSB 1 to SSB 8) in multiple directions using the first half frame of one frame (S6004). These SSBs may include MTRP mode information A within MIBs thereof. Accordingly, the terminal may receive the SSBs from TRP 2. The terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

The MTRP mode information A included in the MIB may be set to 0 or 1 and may be configured as 1 bit. Here, an MTRP mode 0 may specify a mode where M-TRP transmission methods are not used and only transmission by TRP 2 is allowed. In the MTRP mode 0, the terminal may not perform a random access procedure for synchronization with TRP 1. In addition, in the MTRP mode 0, the terminal may not perform a method of using a result of SSB-based timing estimation. The terminal may perform initial access and synchronization only with TRP 2. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 2 may transmit an SIB1 including ssbGroupTrpInfo information B1 to the terminal using a PDSCH (S6005). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 2.

On the other hand, TRP 2 may deliver SIBs other than the SIB1 (i.e. SIBy, y is a positive integer of 2 or more) to the terminal in the initial access stage (S6006). These SSBs may include ssbGroupTrpInfo information B2. In this case, TRP 2 may transmit control information to inform that SIBs are to be delivered in succession following the SIB1 by including the control information in the SIB1. The terminal may receive the SIBs other than the SIB1 from TRP 2. In addition, the terminal may decode SIBy sequentially using the indication information included in the message in SIB1 to obtain the message in SIBy. In order to suppress increase in a bit width of the message of SIB1, TRP 2 may reflect ssbGroupTrpInfo information of the SIB1 to an arbitrary SIBy and transmit it.

Thereafter, the terminal that has completed downlink synchronization and system information acquisition may perform a 4-step CBRA-based random access setup procedure with TRP 1 for uplink synchronization (S6010).

First, in the first step, the terminal may randomly select one preamble from all preambles provided by TRP 1. The terminal may transmit the selected preamble to TRP 1 through a PRA CH (S6011). Then, TRP 1 may receive the preamble from the terminal through the PRACH. In this case, a beam direction may follow an uplink direction reciprocal to a beam direction used when receiving a signal in downlink. A resource for transmitting the preamble to TRP 1 from the terminal may be based on information on an association between SSBs and RACH occasions, which is obtained in advance. TRP 1 may estimate the terminal's propagation delay using the preamble.

Then, in the second step, TRP 1 may determine whether a preamble is present in a signal received through the PRACH. The preamble may be randomly selected and transmitted by the terminal. Therefore, TRP 1 may not specify which terminal transmitted the preamble through whether or not the preamble is detected. Therefore, TRP 1 cannot determine how many terminals used the detected preamble. Accordingly, TRP 1 may transmit an RAR based on an index of the detected preamble to the terminal through a PDSCH (S6012). Then, the terminal may receive the RAR from TRP 1. In this case, the RAR may include the preamble index, TA value, uplink grant information, and temporary C-RNTI.

Thereafter, in the third step, the terminal may transmit a scheduling request message (or connection request message) and a C3 message to TRP 1 through a PUSCH by applying the temporary C-RNTI and using an uplink radio resource indicated by the uplink grant information included in the corresponding RAR (S6013). TRP 1 may receive the connection request message and the C3 message from the terminal. In this case, there may be more than one terminal that transmitted the same preamble in the first step. Accordingly, a collision of preambles may occur. In this case, all terminals that transmitted the same preamble may transmit the messages by utilizing the same radio resource indicated by the RAR. This may cause a collision.

Here, the C3 message may include C3-1 information to C3-5 information. In this case, the C3-1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on SSB group-related information in information B1 or B2. In other words, the terminal may know that the second best SSB is an SSB of TRP 2 based on the SSB group-related information. Then, the terminal may set the C3-1 information to true.

Meanwhile, terminals that transmitted the same preamble in the first step may eventually experience resource conflicts when transmitting the third-step messages. Accordingly, each terminal may start a contention resolution timer when transmitting the third-step message as a procedure to check whether the transmitted third-step message collides and whether it is successfully decoded.

Finally, in the fourth step, TRP 1 may decode the received third-step message. TRP 1 may transmit a message including acknowledgment and a C4 message to the terminal through a PD SCH in response to the successfully decoded message (S6014). Then, the terminal may receive the message including the acknowledgement message and the C4 message from TRP 1. The terminal may receive the message including the acknowledgement and the C4 message before expiration of the contention resolution timer started in the third step. Here, the C4 message may include C4-1 information to C4_4 information. In this case, the C4_1 information may be information indicating whether ‘RA’ is true or false. ‘RA’ set to true may mean that random access needs to be performed for a TRP of the second best SSB. In addition, the C4-2 information may be information indicating whether ‘CBRA’ is true or false. Here, ‘CBRA’ set to true may mean that contention-based random access needs to be performed. In addition, the C4-3 information may include information on indices for CFRA preambles. The CFRA preamble may mean a preamble to be used when performing non-contention-based random access. The index of the CFRA preamble may be a natural number greater than 1. In addition, the C4_4 information may be other information. The C4-4 information may be any possible information that reduces the overhead of the procedure.

In this case, TRP 1 may generate the C4-1 information of the C4 message based on the information in the C3 message of the third-step message. In other words, when a time difference between a starting point of the best SSB of the C3-3 information of the C3 message and a starting point of the second best SSB is equal to or greater than a predetermined threshold, TRP 1 may set ‘RA’ of the C4_1 information of the C4 message to true. In addition, TRP 1 may arbitrarily decide whether to set ‘CBRA’ to true.

In this situation, ‘TRP 2’ may be false in the C3-1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be true in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be true in the C3-2 information. ‘RA’ may be true in the C4_1 information, and ‘CBRA’ may be false in the C4-2 information. TRP 1 may indicate the terminal to perform CFRA random access for an RO and CFRA preamble(s) indicated by the SIB obtained based on the second best SSB through high layer signaling or PDCCH. Accordingly, the terminal may receive the indication to perform the CFRA random access from TRP 1. Accordingly, the terminal may perform a 2-step CFRA-based setup procedure for TRP 2 (S6020).

To this end, in the first step, the terminal may randomly select one preamble from among CFRA preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S6021). Then, TRP 2 may receive a message including the preamble and the scheduling request from the terminal. Here, TRP 2 may be aware of the terminal's CFRA-based setup procedure before the start of the first step.

In this case, TRP 2 may transmit a message including an RAR and a C-RNTI to the terminal through a PDSCH (S6022). Accordingly, the terminal may receive the message including the successful RAR and the C-RNTI from TRP 2. This message may serve as an acknowledgement. The terminal may proceed with an RRC setup procedure after the second step is completed. Here, TRP 2 may transmit information related to the RAR to TRP 1. Then, TRP 1 may receive the information related to the RAR from TRP 2. Then, TRP 1 may transmit the RAR to the terminal based on the information related to the RAR received from TRP 2.

Then, TRP 1 may transmit an RRC setup message to the terminal (S6030). The terminal may receive the RRC setup message from TRP 1. Accordingly, the terminal may complete RRC setup and transmit an RRC setup complete message to TRP 1 (S6031). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

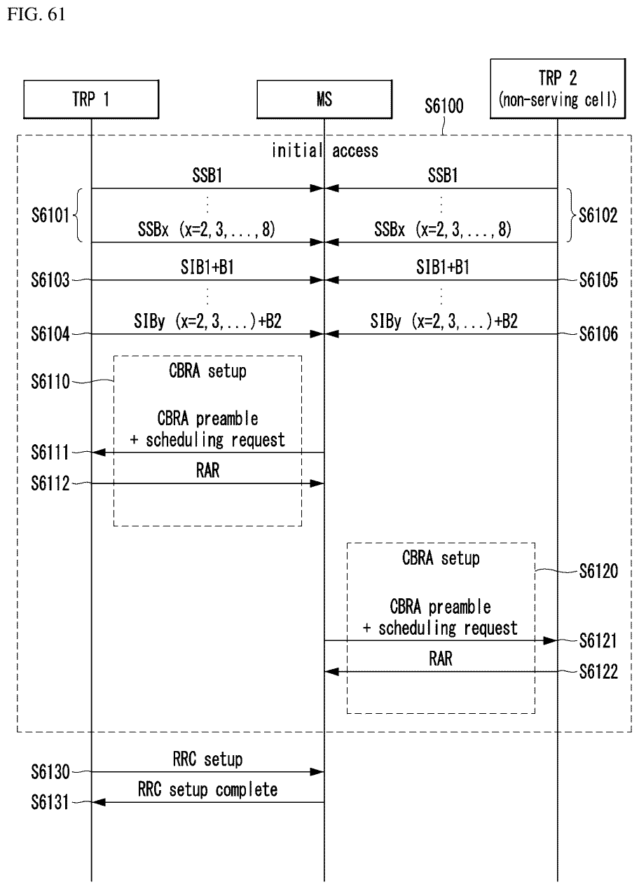

FIG. 61 is a sequence chart illustrating a nineteenth exemplary embodiment of a transmission method in a multi-TRP environment.

Referring to FIG. 61, a terminal may proceed with an initial access procedure for TRP 1 and TRP 2 (S6100). Here, TRP 1 may belong to a serving cell, and TRP 2 may belong to a non-serving cell. TRP 1 may transmit beamformed SSBs (e.g. SSB 1 to SSB 8) in multiple directions using the first half frame of one frame (S6101). The SSBs may include MTRP mode information A within MIBs thereof. Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

The MTRP mode information A included in the MIB may be set to 0 or 1 and may be configured as 1 bit. Here, an MTRP mode 0 may specify a mode where M-TRP transmission methods are not used and only transmission by TRP 1 is allowed. In the MTRP mode 0, the terminal may not perform a random access procedure for synchronization with TRP 2. In addition, in the MTRP mode 0, the terminal may not perform a method of using a result of SSB-based timing estimation. The terminal may perform initial access and synchronization only with TRP 1. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. The SSB group-related information may include SSB group information (e.g. ssbGroup). The SSB group information may include SSB group type information and information on SSBs included in each SSB group according to the SSB group type information. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 1 may transmit an SIB1 including ssbGroupTrpInfo information B1 to the terminal using a PDSCH (S6102). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1. The ssbGroupTrpInfo information may include ssbGroup. As described above, ssbGroup may include information on SSBs included in each SSB group among SSB groups according to the SSB group type information. ssbGroupTrpInfo may also include ssbGrouptoTrp. ssbGrouptoTrp may be optional and may represent a mapping relationship between SSB group IDs and TRPs.

On the other hand, TRP 1 may deliver SIBs other than the SIB1 (i.e. SIBy, y is a positive integer of 2 or more) to the terminal in the initial access stage (S6103). These SSBs may include ssbGroupTrpInfo information B2. In this case, TRP 1 may transmit control information to inform that SIBs are to be delivered in succession following the SIB1 by including the control information in the SIB1. The terminal may receive the SIBs other than the SIB1 from TRP 1. In addition, the terminal may decode SIBy sequentially using the indication information included in the message in SIB1 to obtain the message in SIBy. In order to suppress increase in a bit width of the message of SIB1, TRP 1 may reflect ssbGroupTrpInfo information of the SIB1 to an arbitrary SIBy and transmit it.

Meanwhile, TRP 2 may transmit beamformed SSBs (e.g. SSB 1 to SSB 8) in multiple directions using the first half frame of one frame (S6104). These SSBs may include MTRP mode information A within MIBs thereof. Accordingly, the terminal may receive the SSBs from TRP 2. The terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

The MTRP mode information A included in the MIB may be set to 0 or 1 and may be configured as 1 bit. Here, an MTRP mode 0 may specify a mode where M-TRP transmission methods are not used and only transmission by TRP 2 is allowed. In the MTRP mode 0, the terminal may not perform a random access procedure for synchronization with TRP 1. In addition, in the MTRP mode 0, the terminal may not perform a method of using a result of SSB-based timing estimation. The terminal may perform initial access and synchronization only with TRP 2. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 2 may transmit an SIB1 including ssbGroupTrpInfo information B1 to the terminal using a PDSCH (S6105). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 2.

On the other hand, TRP 2 may deliver SIBs other than the SIB1 (i.e. SIBy, y is a positive integer of 2 or more) to the terminal in the initial access stage (S6106). These SSBs may include ssbGroupTrpInfo information B2. In this case, TRP 2 may transmit control information to inform that SIBs are to be delivered in succession following the SIB1 by including the control information in the SIB1. The terminal may receive the SIBs other than the SIB1 from TRP 2. In addition, the terminal may decode SIBy sequentially using the indication information included in the message in SIB1 to obtain the message in SIBy. In order to suppress increase in a bit width of the message of SIB1, TRP 2 may reflect ssbGroupTrpInfo information of the SIB1 to an arbitrary SIBy and transmit it.

Thereafter, the terminal that has completed downlink synchronization and system information acquisition may perform a 2-step CBRA-based random access setup procedure with TRP 1 for uplink synchronization (S6110).

To this end, in the first step, the terminal may randomly select one preamble from among all preambles. Then, the terminal may transmit the selected one preamble to TRP 1 through a PRACH. In addition, at the same time, the terminal may transmit a scheduling request (i.e. connection request) message and a C3 message to TRP 1 through a pre-allocated uplink radio resource (i.e. uplink shared channel) (S6111). Then, TRP 1 may receive the preamble and the message including the scheduling request and the C3 message from the terminal.

Here, the C3 message may include C3-1 information to C3-5 information. In this case, the C3_1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3-3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3-4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on SSB group-related information in information B1 or B2. In other words, the terminal may know that the second best SSB is an SSB of TRP 2 based on the SSB group-related information. Then, the terminal may set the C3-1 information to true.

In the second step, TRP 1 may determine whether a preamble is detected. In addition, TRP 1 may determine whether a message is successfully decoded. TRP 1 may transmit a different type of message to the terminal according to a result of the determination. This may cause a subsequent procedure to be different. If TRP 1 does not detect a preamble, TRP 1 may not perform any action. In other words, TRP 1 may not check whether a message is received through an uplink radio resource associated with the preamble. As a result, TRP 1 may not make any response when a preamble is not detected. Accordingly, the terminal may reattempt the random access because it did not receive any message from TRP 1. This case may be referred to as ‘Case 1’.

In contrast, TRP 1 may detect a preamble normally and successfully decode a message from an uplink radio resource associated with the preamble. In this case, TRP 1 may transmit a message including an RAR, a C-RNTI, and a C4 message to the terminal through a PDSCH (S6112). Accordingly, the terminal may receive the message including the successful RAR, C-RNTI, and C4 message from the TRP. This message may serve as an acknowledgement.

Here, the C4 message may include C4-1 information to C4_4 information. In this case, the C4-1 information may be information indicating whether ‘RA’ is true or false. ‘RA’ set to true may mean that random access needs to be performed for a TRP of the second best SSB. In addition, the C4_2 information may be information indicating whether ‘CBRA’ is true or false. Here, ‘CBRA’ set to true may mean that contention-based random access needs to be performed. In addition, the C4-3 information may include information on indices for CFRA preambles. The CFRA preamble may mean a preamble to be used when performing non-contention-based random access. The index of the CFRA preamble may be a natural number greater than 1. In addition, the C4_4 information may be other information. The C4_4 information may be any possible information that reduces the overhead of the procedure.

In this case, TRP 1 may generate the C4_1 information of the C4 message based on the information in the C3 message of the third-step message. In other words, when a time difference between a starting point of the best SSB of the C3-3 information of the C3 message and a starting point of the second best SSB is equal to or greater than a predetermined threshold, TRP 1 may set ‘RA’ of the C4_1 information of the C4 message to true. In addition, TRP 1 may arbitrarily decide whether to set ‘CBRA’ to true.

In this situation, ‘TRP 2’ may be false in the C3-1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be true in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be true in the C3-2 information. ‘RA’ may be true in the C4_1 information, and ‘CBRA’ may be true in the C4-2 information. TRP 1 may indicate the terminal to perform CBRA random access for an RO indicated by the SIB obtained based on the second best SSB through high layer signaling or PDCCH. Accordingly, the terminal may receive the indication to perform the CBRA random access from TRP 1. Accordingly, the terminal may perform a 2-step CBRA-based setup procedure for TRP 2 (S6120).

To this end, in the first step, the terminal may randomly select one preamble from among all preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S6121). Then, TRP 2 may receive the preamble and the message including the scheduling request from the terminal.

In this case, TRP 2 may transmit a message including an RAR and a C-RNTI to the terminal on a PDSCH (S6122). Accordingly, the terminal may receive the message including the successful RAR and C-RNTI from TRP 2. The message may serve as acknowledgment.

Then, TRP 1 may transmit an RRC setup message to the terminal (S6130). The terminal may receive the RRC setup message from TRP 1. Accordingly, the terminal may complete RRC setup and transmit an RRC setup complete message to TRP 1 (S6131). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

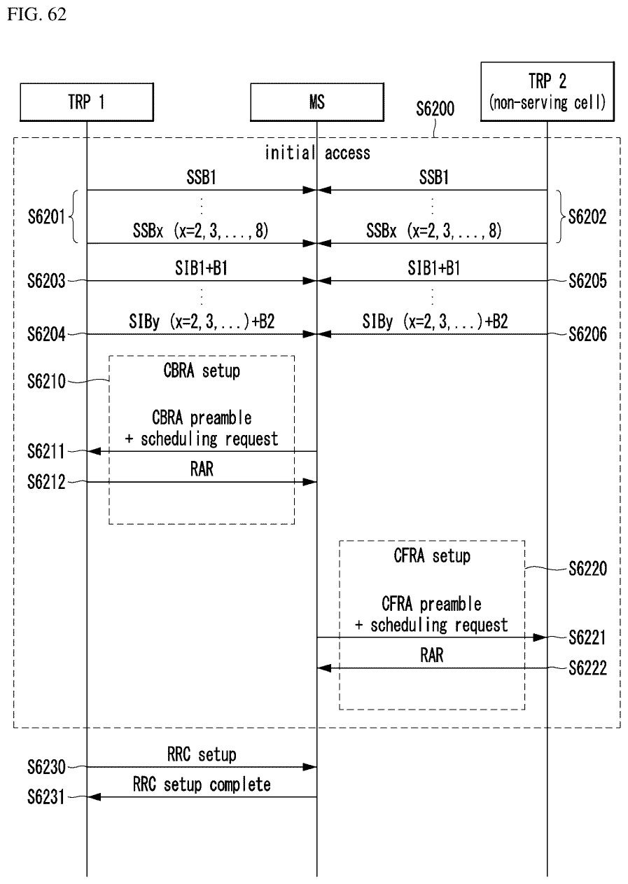

FIG. 62 is a sequence chart illustrating a twentieth exemplary embodiment of a transmission method in a multi-TRP environment.

Referring to FIG. 62, a terminal may proceed with an initial access procedure for TRP 1 and TRP 2 (S56200). Here, TRP 1 may belong to a serving cell, and TRP 2 may belong to a non-serving cell. TRP 1 may transmit beamformed SSBs (e.g. SSB 1 to SSB 8) in multiple directions using the first half frame of one frame (S6201). The SSBs may include MTRP mode information A within MIBs thereof. Accordingly, the terminal may receive SSBs from TRP 1, and the terminal may estimate the best SSB among the received SSBs. In this case, the best SSB may be the SSB 8. The terminal may perform synchronization of a downlink which is a direction from TRP 1 toward the terminal by using the best SSB. Here, TRP 1 may transmit SSBs periodically or aperiodically for initial synchronization and maintenance of the synchronization for beamforming-based downlink. After performing such synchronization, the terminal may obtain an MIB from the best SSB. The MIB may be transmitted to the terminal on a PBCH. The MIB may be the first system information obtained by the terminal from TRP 1.

The MTRP mode information A included in the MIB may be set to 0 or 1 and may be configured as 1 bit. Here, an MTRP mode 0 may specify a mode where M-TRP transmission methods are not used and only transmission by TRP 1 is allowed. In the MTRP mode 0, the terminal may not perform a random access procedure for synchronization with TRP 2. In addition, in the MTRP mode 0, the terminal may not perform a method of using a result of SSB-based timing estimation. The terminal may perform initial access and synchronization only with TRP 1. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. The SSB group-related information may include SSB group information (e.g. ssbGroup). The SSB group information may include SSB group type information and information on SSBs included in each SSB group according to the SSB group type information. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 1 may transmit an SIB1 including ssbGroupTrpInfo information B1 to the terminal using a PDSCH (S6202). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 1. The ssbGroupTrpInfo information may include ssbGroup. As described above, ssbGroup may include information on SSBs included in each SSB group among SSB groups according to the SSB group type information. ssbGroupTrpInfo may also include ssbGrouptoTrp. ssbGrouptoTrp may be optional and may represent a mapping relationship between SSB group IDs and TRPs.

On the other hand, TRP 1 may deliver SIBs other than the SIB1 (i.e. SIBy, y is a positive integer of 2 or more) to the terminal in the initial access stage (S6203). These SSBs may include ssbGroupTrpInfo information B2. In this case, TRP 1 may transmit control information to inform that SIBs are to be delivered in succession following the SIB1 by including the control information in the SIB1. The terminal may receive the SIBs other than the SIB1 from TRP 1. In addition, the terminal may decode SIBy sequentially using the indication information included in the message in SIB1 to obtain the message in SIBy. In order to suppress increase in a bit width of the message of SIB1, TRP 1 may reflect ssbGroupTrpInfo information of the SIB1 to an arbitrary SIBy and transmit it.

Meanwhile, TRP 2 may transmit beamformed SSBs (e.g. SSB 1 to SSB 8) in multiple directions using the first half frame of one frame (S6204). These SSBs may include MTRP mode information A within MIBs thereof. Accordingly, the terminal may receive the SSBs from TRP 2. The terminal may estimate the second best SSB among the received SSBs. In this case, the second best SSB may be the SSB 1. The terminal may perform synchronization of a downlink which is a direction from TRP 2 toward the terminal by using the second best SSB. Here, TRP 2 may transmit SSBs periodically or aperiodically for initial synchronization and maintenance of the synchronization for beamforming-based downlink. After performing such synchronization, the terminal may obtain an MIB from the second best SSB. The MIB may be transmitted to the terminal on a PBCH. The MIB may be the first system information obtained by the terminal from TRP 2.

The MTRP mode information A included in the MIB may be set to 0 or 1 and may be configured as 1 bit. Here, an MTRP mode 0 may specify a mode where M-TRP transmission methods are not used and only transmission by TRP 2 is allowed. In the MTRP mode 0, the terminal may not perform a random access procedure for synchronization with TRP 1. In addition, in the MTRP mode 0, the terminal may not perform a method of using a result of SSB-based timing estimation. The terminal may perform initial access and synchronization only with TRP 2. By doing so, the terminal can significantly reduce battery consumption due to complex intra-cell/inter-cell M-TRP setup and maintenance procedures.

In addition, an MTRP mode 1 may specify a mode that M-TRP transmission methods by TRP 1 and TRP 2 are used. The terminal may perform a random access procedure for synchronization with TRP 1 in the MTRP mode 1. In addition, the terminal may perform a random access procedure for synchronization with TRP 2 in the MTRP mode 1. In addition, the terminal may perform a method of using a result of SSB-based timing estimation in the MTRP mode 1. By acquiring synchronization between TRP 1, TRP 2, and MS as described above, the terminal may apply an intra-cell/inter-cell M-TRP transmission method that helps to improve link quality and transmission rate.

If the terminal identifies the MTRP mode 0 from the MIB, the terminal may ignore SSB group-related information (e.g. ssbGroupTrpInfo) related to M-TRP regulations, which is included in messages in the SIB1 and SIBy (y=2, 3, etc.) to be received later. On the other hand, if the terminal identifies the MTRP mode 1 from the MIB, the terminal may follow ssbGroupTrpInfo information related to M-TRP regulations, which is included in messages in the SIB1 and SIBy (y=2, 3, etc.) to be received later.

Then, TRP 2 may transmit an SIB1 including ssbGroupTrpInfo information B1 to the terminal using a PDSCH (S6205). The terminal may obtain the SIB1 including the ssbGroupTrpInfo information B1 located in a time resource and frequency resource indicated by the MIB. In this case, the SIB1 may be transmitted to the terminal on a PDSCH. The SIB1 may be the second system information obtained by the terminal from TRP 2.

On the other hand, TRP 2 may deliver SIBs other than the SIB1 (i.e. SIBy, y is a positive integer of 2 or more) to the terminal in the initial access stage (S6206). These SSBs may include ssbGroupTrpInfo information B2. In this case, TRP 2 may transmit control information to inform that SIBs are to be delivered in succession following the SIB1 by including the control information in the SIB1. The terminal may receive the SIBs other than the SIB1 from TRP 2. In addition, the terminal may decode SIBy sequentially using the indication information included in the message in SIB1 to obtain the message in SIBy. In order to suppress increase in a bit width of the message of SIB1, TRP 2 may reflect ssbGroupTrpInfo information of the SIB1 to an arbitrary SIBy and transmit it.

Thereafter, the terminal that has completed downlink synchronization and system information acquisition may perform a 2-step CBRA-based random access setup procedure with TRP 1 for uplink synchronization (S6210).

To this end, in the first step, the terminal may randomly select one preamble from among all preambles. Then, the terminal may transmit the selected one preamble to TRP 1 through a PRACH. In addition, at the same time, the terminal may transmit a scheduling request (i.e. connection request) message and a C3 message to TRP 1 through a pre-allocated uplink radio resource (i.e. uplink shared channel) (S6211). Then, TRP 1 may receive the preamble and the message including the scheduling request and the C3 message from the terminal.

Here, the C3 message may include C3-1 information to C3_5 information. In this case, the C3_1 information may be information indicating whether ‘TRP 2’ is true or false. Here, ‘TRP 2’ set to true may mean that a TRP using the second best SSB informed by the terminal is qualified as TRP 2. In addition, ‘TRP 2’ set to true may mean that it is necessary to manage an independent TAG.

The C3-2 information may be information indicating whether a premise that the PCI is the same (i.e. ‘Same PCI’) is true or false. Accordingly, the premise that the PCI is the same (i.e. Same PCI=true) may mean that the second best SSB has the same PCI as the best SSB. The C3_3 information may be information on a time difference between a starting point of the best SSB and a starting point of the second best SSB. In this case, for example, the C3-3 information may be set to 0, so that when the time difference between the starting point of the best SSB and the starting point of the second best SSB is less than a predetermined threshold, it is treated as if there is no time difference. Accordingly, the terminal may reduce complexity caused by synchronization updates (e.g. TA updates, etc.) of multiple TRPs.

On the other hand, the C3-3 information may be set to a time difference value measured by the terminal if the time difference is equal to or greater than the predetermined threshold. In addition, the C3_4 information may be information on a difference between the maximum correlation value of an output of a timing estimator or the like for the best SSB and the maximum correlation value of an output of a timing estimator or the like for the second best SSB. The C3_5 information may be other information. The C3-5 information may be any possible information that reduces the overhead of the procedure.

In this case, the terminal may generate the C3-1 information of the C3 message based on SSB group-related information in information B1 or B2. In other words, the terminal may know that the second best SSB is an SSB of TRP 2 based on the SSB group-related information. Then, the terminal may set the C3-1 information to true.

In the second step, TRP 1 may determine whether a preamble is detected. In addition, TRP 1 may determine whether a message is successfully decoded. TRP 1 may transmit a different type of message to the terminal according to a result of the determination. This may cause a subsequent procedure to be different. If TRP 1 does not detect a preamble, TRP 1 may not perform any action. In other words, TRP 1 may not check whether a message is received through an uplink radio resource associated with the preamble. As a result, TRP 1 may not make any response when the preamble is not detected. Accordingly, the terminal may reattempt the random access because it did not receive any message from TRP 1. This case may be referred to as ‘Case 1’.

In contrast, TRP 1 may detect a preamble normally and successfully decode a message from an uplink radio resource associated with the preamble. In this case, TRP 1 may transmit a message including an RAR, a C-RNTI, and a C4 message to the terminal through a PDSCH (S6212). Accordingly, the terminal may receive the message including the successful RAR, C-RNTI, and C4 message from the TRP. This message may serve as an acknowledgement.

Here, the C4 message may include C4-1 information to C4_4 information. In this case, the C4-1 information may be information indicating whether ‘RA’ is true or false. ‘RA’ set to true may mean that random access needs to be performed for a TRP of the second best SSB. In addition, the C4-2 information may be information indicating whether ‘CBRA’ is true or false. Here, ‘CBRA’ set to true may mean that contention-based random access needs to be performed. In addition, the C4-3 information may include information on indices for CFRA preambles. The CFRA preamble may mean a preamble to be used when performing non-contention-based random access. The index of the CFRA preamble may be a natural number greater than 1. In addition, the C4_4 information may be other information. The C4_4 information may be any possible information that reduces the overhead of the procedure.

In this case, TRP 1 may generate the C4-1 information of the C4 message based on the information in the C3 message of the third-step message. In other words, when a time difference between a starting point of the best SSB of the C3-3 information of the C3 message and a starting point of the second best SSB is equal to or greater than a predetermined threshold, TRP 1 may set ‘RA’ of the C4_1 information of the C4 message to true. In addition, TRP 1 may arbitrarily decide whether to set ‘CBRA’ to true.

In this situation, ‘TRP 2’ may be false in the C3-1 information. In addition, the premise that the PCI is the same in the C3-2 information may be true. Then, the terminal may ignore other message information, may not perform additional random access procedures, and may perform an RRC setup procedure with TRP 1.

In contrast, ‘TRP 2’ may be true in the C3-1 information. In addition, the premise that the PCI is the same may be true in the C3-2 information, and ‘RA’ in the C4-1 information may be false. Then, the terminal may not perform an additional random access procedure. In addition, the terminal may adjust a transmission timing of TRP 2 using the C3-3 information and C3-4 information, and perform an RRC setup procedure with TRP 2 by performing power control and assuming that the terminal has accessed TRP 2 transmitting the second best SSB.

On the other hand, ‘TRP 2’ may be true in the C3-1 information. In addition, the premise that the PCI is the same may be true in the C3-2 information. ‘RA’ may be true in the C4_1 information, and ‘CBRA’ may be false in the C4-2 information. TRP 1 may indicate the terminal to perform CFRA random access for an RO and CFRA preamble(s) indicated by the SIB obtained based on the second best SSB through high layer signaling or PDCCH. Accordingly, the terminal may receive the indication to perform the CFRA random access from TRP 1. Accordingly, the terminal may perform a 2-step CFRA-based setup procedure for TRP 2 (S6220).

To this end, in the first step, the terminal may randomly select one preamble from among CFRA preambles. Then, the terminal may transmit the selected one preamble to TRP 2 through a PRACH. In addition, at the same time, the terminal may transmit a scheduling request (i.e. connection request) message to TRP 2 through a pre-allocated uplink radio resource (i.e. uplink shared channel) (S6621). Then, TRP 2 may receive the preamble and the message including the scheduling request from the terminal. Here, TRP 2 may be aware of the terminal's CFRA-based setup procedure before the start of the first step.

In this case, TRP 2 may transmit a message including an RAR and a C-RNTI to the terminal through a PDSCH (S6222). Accordingly, the terminal may receive the message including the successful RAR and the C-RNTI from TRP 2. This message may serve as an acknowledgement. The terminal may proceed with an RRC setup procedure after the second step is completed. Here, TRP 2 may transmit information related to the RAR to TRP 1. Then, TRP 1 may receive the information related to the RAR from TRP 2. Then, TRP 1 may transmit the RAR to the terminal based on the information related to the RAR received from TRP 2.

Then, TRP 1 may transmit an RRC setup message to the terminal (S6230). The terminal may receive the RRC setup message from TRP 1. Accordingly, the terminal may complete RRC setup and transmit an RRC setup complete message to TRP 1 (S6231). TRP 1 may confirm the RRC setup by receiving the RRC setup complete message from the terminal. Through this process, the terminal may complete system connection to TRP 1. In the connected state, the terminal may communicate with other terminals through TRP 1. In addition, TRP 2 may transmit an RRC setup message to the terminal. The terminal may receive the RRC setup message from TRP 2. Accordingly, the terminal may complete RRC setup and transmit an RRC setup complete message to TRP 2. TRP 2 may confirm the RRC setup by receiving the RRC setup complete message from the terminal. Through this process, the terminal may complete system connection to TRP 2. In the connected state, the terminal may communicate with other terminals through TRP 2.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1-20. (canceled)

21. A method of a user equipment (UE), comprising:
transmitting a first random access (RA) preamble to a first transmission and reception point (TRP);
receiving, from the first TRP, a first response message including a timing advance (TA) value and information indicating a timing advance group (TAG) identifier (ID) in response to the first RA preamble; and
adjusting synchronization for at least one TRP associated with the TAG ID indicated by the first response message among the first TRP or a second TRP, based on the TA value indicated by the first response message.

22. The method of claim 21, further comprising:
receiving information of a first TAG ID associated with the first TRP and information of a second TAG ID associated with the second TRP.

23. The method of claim 21, further comprising:
transmitting a second RA preamble to the second TRP;
receiving, from the second TRP, a second response message including a TA value and information indicating a TAG ID in response to the second RA preamble; and
adjusting synchronization for at least one TRP associated with the TAG ID indicated by the second response message among the first TRP or the second TRP, based on the TA value indicated by the second response message.

24. The method of claim 21, further comprising:
transmitting a sounding reference signal (SRS) to the second TRP;
receiving, from the second TRP, a TA value determined based on the SRS; and
adjusting synchronization for the second TRP based on the TA value received from the second TRP.

25. The method of claim 21, wherein the first TRP and the second TRP belong to the same TAG or different TAGs.

26. The method of claim 21, wherein transmission of the first RA preamble and reception of the first response message are performed in a 2-step RA procedure or a 4-step RA procedure.

27. The method of claim 21, wherein the first TRP is associated with a first transmission configuration indication (TCI) state, and the second TRP is associated with a second TCI state.

28. The method of claim 21, wherein the first TRP is associated with a first synchronization signal block (SSB), and the second TRP is associated with a second SSB.

29. A method of a first transmission and reception point (TRP), comprising:
receiving a random access (RA) preamble from a first user equipment (UE); and
transmitting, to the first UE, a response message including a timing advance (TA) value and information indicating a timing advance group (TAG) identifier (ID) in response to the RA preamble,
wherein uplink synchronization of the first UE for at least one TRP associated with the TAG ID among the first TRP or a second TRP is adjusted based on the TA value.

30. The method of claim 29, further comprising:
transmitting, to the first UE, information of a first TAG ID associated with the first TRP and information of a second TAG ID associated with the second TRP.

31. The method of claim 29, further comprising:
receiving a sounding reference signal (SRS) from a second UE; and
transmitting, to the second UE, a TA value determined based on the SRS,
wherein uplink synchronization of the second UE for the first TRP is adjusted based on the TA value determined based on the SRS.

32. The method of claim 29, wherein the first TRP and the second TRP belong to the same TAG or different TAGs.

33. The method of claim 29, wherein reception of the RA preamble and transmission of the response message are performed in a 2-step RA procedure or a 4-step RA procedure.

34. The method of claim 29, wherein the first TRP is associated with a first transmission configuration indication (TCI) state, and the second TRP is associated with a second TCI state.

35. The method of claim 29, wherein the first TRP is associated with a first synchronization signal block (SSB), and the second TRP is associated with a second SSB.

36. A user equipment (UE), comprising:
at least one processor,
wherein the at least one processor causes the UE to:
transmit a first random access (RA) preamble to a first transmission and reception point (TRP);
receive, from the first TRP, a first response message including a timing advance (TA) value and information indicating a timing advance group (TAG) identifier (ID) in response to the first RA preamble; and
adjust synchronization for at least one TRP associated with the TAG ID indicated by the first response message among the first TRP or a second TRP, based on the TA value indicated by the first response message.

37. The UE of claim 36, wherein the at least one processor further causes the UE to:
receive information of a first TAG ID associated with the first TRP and information of a second TAG ID associated with the second TRP.

38. The UE of claim 36, wherein the at least one processor further causes the UE to:
transmit a second RA preamble to the second TRP;
receive, from the second TRP, a second response message including a TA value and information indicating a TAG ID in response to the second RA preamble; and
adjust synchronization for at least one TRP associated with the TAG ID indicated by the second response message among the first TRP or the second TRP, based on the TA value indicated by the second response message.

39. The UE of claim 36, wherein the at least one processor further causes the UE to:
transmit a sounding reference signal (SRS) to the second TRP;
receive, from the second TRP, a TA value determined based on the SRS; and
adjust synchronization for the second TRP based on the TA value received from the second TRP.

40. The UE of claim 36, wherein the first TRP is associated with a first transmission configuration indication (TCI) state or a first synchronization signal block (SSB), and the second TRP is associated with a second TCI state or a second SSB.
